(19) United States
(12) Patent Application Publication
(10) Pub. No.: US 2025/0281905 A1
(43) Pub. Date: Sep. 11, 2025

(54) FUNCTIONALIZED MATERIALS FOR CARBON CAPTURE AND SYSTEMS THEREOF

(71) Applicant: X Development LLC, Mountain View, CA (US)

(72) Inventors: Chaokun Gong, Sunnyvale, CA (US); Jeremy Aaron Willman, Redwood City, CA (US); Jacques Gagne, Los Gatos, CA (US); Amanda Marie Rampertab, Torrance, CA (US); Kenneth Gerald Robertson, San Jose, CA (US); Anand Saxena, Hayward, CA (US); Robert Nelson, Alameda, CA (US)

(21) Appl. No.: 18/880,190

(22) PCT Filed: Jun. 30, 2023
(86) PCT No.: PCT/US2023/026724

§ 371 Date: Dec. 30, 2024

Related U.S. Application Data
(60) Provisional application No. 63/357,758, filed on Jul. 1, 2022.
(60) Provisional application No. 63/357,770, filed on Jul. 1, 2022.
(60) Provisional application No. 63/357,912, filed on Jul. 1, 2022.
(60) Provisional application No. 63/357,919, filed on Jul. 1, 2022.
(60) Provisional application No. 63/357,932, filed on Jul. 1, 2022.
(60) Provisional application No. 63/357,935, filed on Jul. 1, 2022.
(60) Provisional application No. 63/357,941, filed on Jul. 1, 2022.
(60) Provisional application No. 63/357,950, filed on Jul. 1, 2022.
(60) Provisional application No. 63/357,951, filed on Jul. 1, 2022.
(60) Provisional application No. 63/358,003, filed on Jul. 1, 2022.
(60) Provisional application No. 63/358,006, filed on Jul. 1, 2022.
(60) Provisional application No. 63/460,243, filed on Apr. 18, 2023.

(51) Int. Cl. B01J 20/32; B01D 53/62; B01D 53/83; B01D 53/96; B01J 20/10; B01J 20/22; B01J 20/26; B01J 20/28; B01J 20/30; B01J 20/34

(52) U.S. Cl. CPC B01J 20/3278; B01D 53/62; B01D 53/83; B01D 53/96; B01J 20/103; B01J 20/226; B01J 20/26; B01J 20/28004; B01J 20/28014; B01J 20/28061; B01J 20/28064; B01J 20/28066; B01J 20/28071; B01J 20/28073; B01J 20/28076; B01J 20/28083; B01J 20/28085; B01J 20/3078; B01J 20/3204; B01J 20/3425; B01J 20/3483; B01D 2253/202; B01D 2253/304; B01D 2253/306; B01D 2253/308; B01D 2253/311; B01D 2253/34; B01D 2257/504; B01D 2258/06

(57) ABSTRACT

The present disclosure relates to a functionalized material, which may optionally be employed as a sorbent for carbon dioxide, as well as methods of making such materials and systems of using such materials. The processes, methods, and systems herein can be used for the separation of carbon dioxide from fluid streams.

### CROSS-REFERENCE TO RELATED APPLICATIONS

This application claims the benefit of U.S. Provisional Patent Application No. 63/357,932, filed Jul. 1, 2022, U.S. Provisional Patent Application No. 63/357,950, filed Jul. 1, 2022, U.S. Provisional Patent Application No. 63/357,935, filed Jul. 1, 2022, U.S. Provisional Patent Application No. 63/357,941, filed Jul. 1, 2022, U.S. Provisional Patent Application No. 63/357,919, filed Jul. 1, 2022, U.S. Provisional Patent Application No. 63/357,912, filed Jul. 1, 2022, U.S. Provisional Patent Application No. 63/357,758, filed Jul. 1, 2022, U.S. Provisional Patent Application No. 63/357,770, filed Jul. 1, 2022, U.S. Provisional Patent Application No. 63/357,951, filed Jul. 1, 2022, U.S. Provisional Patent Application No. 63/358,006, filed Jul. 1, 2022, U.S. Provisional Patent Application No. 63/358,003, filed Jul. 1, 2022, and U.S. Provisional Patent Application No. 63/460,243, filed Apr. 18, 2023, each of which is incorporated by reference herein in its entirety.

### FIELD

The disclosure relates to a functionalized material, which may optionally be employed as a sorbent, as well as methods of making such materials and systems of using such materials. The processes, methods, and systems herein can be used for the separation of carbon dioxide from fluid streams.

### BACKGROUND

Atmospheric carbon concentrations have risen in correlation with industrialized activity for decades. Carbon dioxide is a primary contributor to the total carbon concentration. Concern over global climate warming has led to interest in capturing carbon dioxide emissions.

### SUMMARY

In general, the disclosure relates to functionalized materials, method of making and using thereof, and systems that can be configured to use such materials. In particular embodiments, the functionalized material can be used to capture and remove carbon dioxide from gaseous environments.

Accordingly, in one aspect, the present disclosure encompasses a functionalized material including: a plurality of porous particles, and a surface modification layer disposed on at least a portion of a surface of at least one of the plurality of porous particles, wherein the surface modification layer includes an adsorbing moiety including one or more amine moieties. In some embodiments, the material is configured to adsorb atmospheric CO₂ under a first condition and reversibly desorb adsorbed CO₂ under a second condition.

In some embodiments, the plurality of porous particles includes a plurality of porous silica particles, a plurality of porous metal-organic framework (MOF) particles, or a plurality of ion-exchange resin particles. In some embodiments, the plurality of porous particles includes a porous silica or silicate, a porous ceramic, a porous metal-organic substrate, a porous polymeric substrate, a porous ceramic/metal oxide together with porous silica, a porous alumina, a metal-organic framework (MOF), or a resin. In some embodiments, the plurality of porous particles includes a substrate provided in a precipitated form, a sol-gel form, a fumed form, a calcined form, an agglomerated form, a granulated form, a powder, or a granule.

In some embodiments, the plurality of porous particles includes an average dimension or a mean dimension (e.g., diameter) from about 25 μm to 4 mm (e.g., from 25 μm to 3 mm, 25 μm to 2 mm, 25 μm to 1 mm, or other ranges described herein).

In some embodiments, the plurality of porous particles includes a plurality of pores. In some embodiments, the plurality of pores includes a dimension from about 1 to 200 nm, an average pore size from about 30 to 80 nm, and/or a volume greater than about 0.1 mL/g or 0.5 mL/g (e.g., from 0.1 to 5 mL/g).

In some embodiments, the plurality of porous particles includes a greatest dimension of at least 25 μm. In some embodiments, a plurality of pores of the plurality of porous particles include a dimension of at least about 1 nm and/or a volume greater than about 0.5 mL/g.

In some embodiments, the surface modification layer includes 5% to 60% (wt/wt) of a polyamine (e.g., any described herein, such as a small molecule polyamine, a large molecule polyamine, a low molecular weight (MW) polyamine, a high MW polyamine, an oligomeric form of polyamine, or a polymeric form of polyamine) to the plurality of porous particles lacking the surface modification layer. In some embodiments, the polyamine is a large molecule polyamine, a high MW polyamine, or a polymeric form of polyamine. In some embodiments, the polyamine is any described herein (e.g., such as in formulas (IIIa)-(IIIi)). In some embodiments, the polyamine is present in an amount of about 5% to 60% (wt/wt) of the polyamine to the plurality of porous particles (e.g., an amount of 5% to 50%, 5% to 40%, 5% to 30%, 10% to 60%, 10% to 50%, 10% to 40%, 10% to 30%, 20% to 60%, 20% to 50%, 20% to 40%, 20% to 30%, 30% to 60%, 30% to 50%, 40% to 60%, or 50% to 60% (wt/wt)).

In some embodiments, the surface modification layer includes 5% to 80% (wt/wt) of an aminosilane to the plurality of porous particles lacking the surface modification layer. In some embodiments, the aminosilane is any described herein (e.g., such as in formulas (I), (Ia)-(If), (II), or (IIa)-(IId)). In some embodiments, the aminosilane is present in an amount of about 5% to 80% (wt/wt) of the aminosilane to the plurality of porous particles (e.g., an amount of 5% to 70%, 5% to 60%, 5% to 50%, 5% to 40%, 5% to 30%, 10% to 80%, 10% to 70%, 10% to 60%, 10% to 50%, 10% to 40%, 10% to 30%, 20% to 80%, 20% to 70%, 20% to 60%, 20% to 50%, 20% to 40%, 20% to 30%, 30% to 80%, 30% to 70%, 30% to 60%, 30% to 50%, 40% to 80%, 40% to 70%, 40% to 60%, 50% to 80%, 50% to 70%, or 50% to 60% (wt/wt)).

In some embodiments, the plurality of porous particles include a total surface area greater than about 100 m² per dry gram. In some embodiments, the material adsorbs greater than about 0.8 mol of CO₂ per dry kilogram (mol CO₂/kg) or from about 0.8 to 2.5 mol CO₂/kg.

In some embodiments, the material adsorbs CO₂ at a relative humidity in a range from about 0% to 100% or from about 5% to 95%.

In some embodiments, the surface modification layer includes: (i) an amine moiety and a silane moiety, (ii) a plurality of amine moieties, or (iii) both (i) and (ii). In some embodiments, the surface modification layer is provided by interacting one or more compounds with at least a portion of the surface of at least one of the plurality of porous particles. In some embodiments, the one or more compounds are selected from the group consisting of an aminosilane and/or a polyamine. In some embodiments, the aminosilane includes a structure having one of formulas (I), (Ia)-(If), (II), and (IIa)-(IId). In some embodiments, the polyamine includes a structure having one of formulas (IIIa)-(IIIi). In some embodiments, the polyamine is a small molecule polyamine, a low MW polyamine, a large molecule polyamine, a high MW polymer, an oligomeric polyamine, a polymeric polyamine, or mixtures thereof.

In some embodiments, the first condition includes a first temperature range, and the second condition includes a second temperature range higher than the first temperature range. In some embodiments, the first condition includes a first gas pressure (e.g., that is a partial pressure for CO₂), and the second condition includes a second gas pressure (e.g., that is a partial pressure for CO₂) lower than the first gas pressure. In some embodiments, the first condition includes a first CO₂ concentration, and the second condition includes a second CO₂ concentration lower than the first CO₂ concentration.

In some embodiments, the material further includes an antioxidant moiety, an additive, a hydrophobic silane compound, and/or a hydrophobic polymer (e.g., any described herein).

In another aspect, the present disclosure encompasses a method of forming a functionalized material, the method including: introducing a first reagent to a plurality of porous particles and a solvent medium, thereby providing a functionalization mixture, wherein the first reagent includes at least one adsorbing moiety including one or more amine moieties; removing a functionalized material from the functionalization mixture, wherein the functionalized material includes the plurality of porous particles and a surface modification layer disposed on at least a portion of a surface of at least one of the plurality of porous particles, and wherein the surface modification layer includes the at least one adsorbing moiety; and drying the functionalized material.

In some embodiments, the first reagent includes an aminosilane, wherein the aminosilane includes at least one amino moiety and at least one silane moiety. In some embodiments, the at least one silane moiety includes an alkoxysilane moiety, a trihalosilane moiety, a dihalosilane moiety, a monohalosilane moiety, a silanetriol moiety, a dialkoxysilanol moiety, a monoalkoxysilanol moiety, or an aminosilane oligomer. In some embodiments, the at least one silane moiety includes any described herein. In some embodiments, the aminosilane includes a structure having one of formulas (I), (Ia)-(If), (II), and (IIa)-(IId). In some embodiments, the first reagent including the aminosilane is provided in the presence of a second reagent, and the second reagent includes a polyamine. In some embodiments, the first reagent is provided to the plurality of porous particles, and then a second reagent including a polyamine is provided to the functionalization mixture.

In some embodiments, the method further includes a second reagent including a polyamine, which is provided to the functionalization material after removing from the functionalization mixture.

In some embodiments, the first reagent includes a polyamine. In some embodiments, the polyamine is a small molecule polyamine, a low MW polyamine, a large molecule polyamine, a high MW polymer, an oligomeric polyamine, a polymeric polyamine, or mixtures thereof. In some embodiments, the polyamine includes a structure having one of formulas (IIIa)-(IIIi). In some embodiments, the first reagent including the polyamine is provided in the presence of a second reagent, and the second reagent includes an aminosilane. In some embodiments, the first reagent is provided to the plurality of porous particles, and then a second reagent including an aminosilane is provided to the functionalization mixture.

In some embodiments, the first reagent includes a small molecule polyamine or a mixture including a plurality of small molecule polyamines.

In some embodiments, the functionalization mixture includes 5% to 80% (wt/wt) of the first reagent to the plurality of porous particles. In some embodiments, the first reagent includes a polyamine, and the functionalization mixture includes 5% to 60% (wt/wt) of the polyamine to the plurality of porous particles. In some embodiments, the first reagent includes an aminosilane, and the functionalization mixture includes 5% to 80% (wt/wt) of the aminosilane to the plurality of porous particles. Other ranges can be employed (e.g., any range described herein).

In some embodiments, the solvent medium includes water. In some embodiments, the solvent medium includes a polar aprotic solvent or a neutral aprotic solvent. In some embodiments, the solvent medium includes an organic solvent selected from toluene, hexane, cyclohexane, and tetrahydrofuran. In some embodiments, the solvent medium includes methanol, cyclohexane, hexane, ethanol, water, or a combination thereof.

In some embodiments, said drying includes drying to a hydration threshold of about 5% (wt/wt) of the solvent medium to the functionalized material. In some embodiments, the method provides a sorbent material including a functionalized material (e.g., any described herein).

In another aspect, the present disclosure encompasses a method of forming a functionalized material, the method including: introducing a first reagent and a second reagent to water, thereby providing a functionalization mixture; introducing a plurality of porous particles into the functionalization mixture for a time period, thereby forming a functionalized material; removing the functionalized material from the functionalization mixture; and drying the functionalized material.

In some embodiments, the first reagent includes a polyamine, and the second reagent includes an aminosilane. In some embodiments, the aminosilane includes a structure having one of formulas (I), (Ia)-(If), (II), and (IIa)-(IId); and the polyamine includes a structure having one of formulas (IIIa)-(IIIi).

In some embodiments, the functionalized material includes the plurality of porous particles and a surface modification layer disposed on at least a portion of a surface of at least one of the plurality of porous particles, wherein the surface modification layer includes at least one adsorbing moiety.

In some embodiments, the plurality of porous particles includes a quantity of at least 25 kilograms. In some embodiments, the method provides a sorbent material including a functionalized material (e.g., any described herein).

In some embodiments, said drying includes drying to a hydration threshold of about 5% (wt/wt) of the solvent medium to the functionalized material. In some embodiments, said drying is performed in a double cone vacuum dryer, a conveyor belt dryer, or a Nutsche filter dryer.

In another aspect, the present disclosure encompasses a method for removing CO₂ from air, the method including: providing ambient air including CO₂ to a holder including a sorbent material, thereby providing a rich sorbent material; and optionally desorbing CO₂ from the rich sorbent material, thereby providing a lean material. In some embodiments, the sorbent material includes a functionalized material (e.g., any described herein).

In another aspect, the present disclosure encompasses a direct air capture (DAC) system including: a first inlet configured to receive a sorbent material; an adsorber system configured to adsorb CO₂ from ambient air using the sorbent material, thereby providing a rich sorbent material; and a desorber system configured to desorb CO₂ from the rich sorbent material, thereby providing a lean material, and to deliver the lean sorbent material to the adsorber system.

In some embodiments, the sorbent material includes: a plurality of porous particles and a surface modification layer disposed on at least a portion of a surface of at least one of the plurality of porous particles, wherein the surface modification layer includes an adsorbing moiety including one or more amine moieties. In some embodiments, the sorbent material is configured to adsorb atmospheric CO₂ under a first condition and reversibly desorb adsorbed CO₂ under a second condition. In some embodiments, the sorbent material includes a functionalized material (e.g., any described herein).

In another aspect, the present disclosure encompasses a reactor including: a reaction chamber extending along a first direction from a first chamber wall to a second chamber wall opposite the first chamber wall, the reaction chamber including a hollow compartment extending from a base to a top wall in a second direction perpendicular to the first direction, the compartment having, in cross-section perpendicular to the first direction, a base portion proximal to the base and a top portion distal to the base, the base portion being narrower than the top portion.

In some embodiments, the reactor further includes: an inlet into the reaction chamber at the first chamber wall, the inlet providing access for delivery of a powdered sorbent material into the reaction chamber; and an outlet from the reaction chamber at the second chamber wall, the outlet providing an egress for removal of the powdered sorbent material from the reaction chamber.

In some embodiments, the reactor further includes: one or more air chambers each in fluid communication with the hollow compartment via a channel at the base of the hollow compartment; one or more blowers each arranged to receive ambient air and blow air into a corresponding one of the air chambers during operation of the reactor; and one or more exhaust ports, the exhaust ports being configured to remove air from the compartment of the reaction chamber during operation of the reactor.

In some embodiments, the reactor further includes: a distribution plate in fluid communication with the one or more air chambers and the hollow compartment. In some embodiments, the distribution plate is W-shaped. In some embodiments, the distribution plate is flat. In some embodiments, the reactor further includes an additional distribution plate, wherein the additional distribution plate is flat.

In some embodiments, the one or more exhaust ports are arranged at the top wall of the reaction chamber.

In some embodiments, the reactor further includes: a feed arranged in fluid communication with the inlet, the feed being configured to deliver the powdered sorbent material to the reaction chamber during operation of the reactor. In some embodiments, the inlet is located proximate to the base.

In some embodiments, the reactor is configured so that, during operation, a pressure drop from the reaction chamber to the air chamber is 9.0 psi or less.

In some embodiments, the reactor is configured so that, during operation, a sorbent chamber contains about ten liters or more of air per gram of sorbent material.

In some embodiments, the reactor further includes: one or more louvers arranged along the first direction and located on one or more walls of the reactor, wherein the louvers are configured to draw ambient air into the one or more air chambers.

In some embodiments, the hollow compartment, in cross section, includes a first tapered portion proximal to the base. In some embodiments, the hollow compartment further includes, in cross section, a second tapered portion spaced apart from the first tapered portion.

In some embodiments, the powdered sorbent material includes particles with a diameter of about 25 to 4,000 μm. In some embodiments, the powdered sorbent material is a CO₂ sorbent. In some embodiments, the powdered sorbent material includes a functionalized material (e.g., any described herein).

In another aspect, the present disclosure features: a method for removing CO₂ from the atmosphere, including: providing ambient air including CO₂ to a reactor including one or more air chambers; blowing the ambient air so that it travels from the one or more air chambers into a reaction chamber; delivering a powdered sorbent material to the reaction chamber through an inlet; creating a fluidized bed of the powdered sorbent material and the air under conditions in which the powdered sorbent material adsorbs the CO₂ from the air to form CO₂-reduced air and used powdered sorbent material; continuously removing used powdered sorbent material from the reaction chamber; and continuously removing CO₂-reduced air from the reaction chamber through one or more exhaust ports. In some embodiments, the powdered sorbent material includes a functionalized material (e.g., any described herein).

In another aspect, the present disclosure encompasses a direct air capture (DAC) system including: a fluidized bed adsorption reactor configured to adsorb CO₂ from ambient air using a powdered sorbent material; a desorption reactor configured to receive the powdered sorbent material from the fluidized bed adsorption reactor and to desorb CO₂ from the powdered sorbent material; and an industrial process facility which produces waste heat that is provided to the desorption reactor to heat the powdered sorbent material. In some embodiments, the powdered sorbent material includes a functionalized material (e.g., any described herein).

In another aspect, the present disclosure encompasses a structure including: a chamber bordered by a plurality of panels, each panel being suspended between a pair of beams extending in a first direction from a base of the structure, a height of each panel extending in the first direction from a bottom of the panel to a top of the panel.

In some embodiments, each panel includes: a porous inner sheet; a porous outer sheet; and a cavity between the inner sheet and the outer sheet, the cavity extending from the top of the panel to the bottom of the panel.

In some embodiments, the structure further includes: an inlet providing access for delivery of a sorbent material to the cavities at the tops of the plurality of panels; an outlet providing an egress for removal of the sorbent material from the bottom of the cavities of the plurality of panels; and a blower arranged to direct a fluid into the chamber.

In some embodiments, the sorbent material in the cavities of the panels forms a vertical falling moving bed absorber.

In some embodiments, the cavity between the inner sheet and the outer sheet is divided into multiple channels separated by fabric ribs connecting the inner sheet and the outer sheet at intervals between side edges of the panel.

In some embodiments, each channel of the multiple channels has a substantially square cross section in a plane perpendicular to the first direction.

In some embodiments, the cavity has a thickness between the inner sheet and the outer sheet, the thickness being twenty centimeters or less.

In some embodiments, the chamber has a substantially cylindrical shape, with a cylindrical axis extending in the first direction. In some embodiments, the chamber has a substantially rectangular prismic shape having four walls.

In some embodiments, at least one wall of the four walls includes a panel of the plurality of panels.

In some embodiments, the structure further includes: a metering device configured to control a flow of sorbent material from the cavities to the outlet.

In some embodiments, the inner sheet and the outer sheet include a fabric material.

In some embodiments, the sorbent material has a pelletized form and is configured to adsorb carbon dioxide from the fluid. In some embodiments, the sorbent material includes a functionalized material (e.g., any described herein).

In some embodiments, the blower is positioned in a lower third portion of the chamber in the first direction, the lower third portion being the portion that is nearest to the base of the structure; or the blower is positioned in a center third portion of the chamber in the first direction. In some embodiments, the blower is configured to direct the fluid in the first direction. In some embodiments, the fluid includes a gas or air.

In another aspect, the present disclosure encompasses a method including: feeding a sorbent material at an inlet of a structure, the structure including a chamber bordered by a plurality of panels. In some embodiments, each panel is suspended between a pair of beams. In some embodiments, each panel includes: a porous inner sheet; a porous outer sheet; and a cavity between the inner sheet and the outer sheet, the cavity extending from a top of the panel to a bottom of the panel, wherein the inlet provides access for delivery of the sorbent material to the cavities at the tops of the plurality of panels.

In some embodiments, the method further includes: extracting sorbent material from an outlet of the structure, wherein the outlet provides an egress for removal of the sorbent material from the bottom of the cavities of the plurality of panels, and wherein extracting sorbent material from the outlet causes sorbent material in the cavities to fall due to gravity; and directing a fluid through the plurality of panels in a direction from the inner sheet towards the outer sheet.

In some embodiments, the method includes: controlling a rate of extracting the sorbent material from the outlet to control a volumetric flow rate of the sorbent material through the cavities due to gravity.

In some embodiments, the method includes: controlling a rate of feeding the sorbent material at the inlet of the structure based on the rate of extracting the sorbent material from the outlet.

In some embodiments, the method includes: controlling the rate of extracting the sorbent material from the outlet to control an exposure time of the sorbent material to the fluid.

In some embodiments, the method includes: controlling the exposure time of the sorbent material to the fluid to be thirty minutes or more and ninety minutes or less.

In another aspect, the present disclosure encompasses a structure including: a first beam extending in a first direction from a base of the structure toward a top of the structure; a second beam spaced apart from the first beam and extending parallel to the first beam; and a panel coupled at a first edge to the first beam and at a second edge to the second beam, a width of the panel extending from the first edge to the second edge in a direction orthogonal to the first direction, and a height of the panel extending in the first direction from a bottom of the panel to a top of the panel.

In some embodiments, the panel includes: a porous inner sheet; a porous outer sheet; and a cavity between the inner sheet and the outer sheet, the cavity extending from the top of the panel to the bottom of the panel.

In some embodiments, the structure further includes: an inlet providing access for delivery of a sorbent material to the cavity at the top of the panel; an outlet providing an egress for removal of the sorbent material from the bottom of the cavity; and a blower arranged to direct fluid through the panel in a direction from the inner sheet towards the outer sheet.

In another aspect, the present disclosure encompasses a system for removing carbon dioxide from a sorbent material including a bulk solid, the system including: a first heat exchanger configured to evaporate water vapor from the sorbent material by transferring heat from a working fluid and from a heat source fluid to the sorbent material; a condenser configured to condense the water vapor by transferring heat from the water vapor to the working fluid; a second heat exchanger configured to desorb carbon dioxide from the sorbent material by transferring heat from the working fluid to the sorbent material; a pump configured to remove the carbon dioxide from the second heat exchanger; a closed loop flow path for circulating the working fluid between the first heat exchanger, the condenser, and the second heat exchanger; an open loop flow path for providing the heat source fluid to the first heat exchanger; and a channel for transporting the sorbent material from the first heat exchanger to the second heat exchanger.

In some embodiments, the first heat exchanger includes: a first inlet providing access for delivery of the sorbent material to the first heat exchanger; and a first outlet providing an egress for removal of the sorbent material from the first heat exchanger. In some embodiments, during operation, the first inlet has a higher elevation than the first outlet.

In some embodiments, the second heat exchanger includes: a second inlet providing access for delivery of the sorbent material to the second heat exchanger; and a second outlet providing an egress for removal of the sorbent material from the second heat exchanger. In some embodiments, during operation, the second inlet has a higher elevation than the second outlet.

In some embodiments, the second inlet of the second heat exchanger has a higher elevation than the first outlet of the first heat exchanger (e.g., during operation). In some embodiments, the second inlet of the second heat exchanger has a lower elevation than the first outlet of the first heat exchanger (e.g., during operation).

In some embodiments, the first heat exchanger and the second heat exchanger include plate heat exchangers, shell and tube heat exchangers, or shell and plate heat exchangers. In some embodiments, the first heat exchanger includes an evaporator, and the second heat exchanger includes a desorber.

In some embodiments, the closed loop flow path and the open loop flow path are fluidly isolated from each other.

In some embodiments, the structure further includes: a metering device configured to control a flow of sorbent material into the first heat exchanger.

In some embodiments, the sorbent material has a pelletized form and is configured to adsorb carbon dioxide from fluid. In some embodiments, the sorbent material includes a functionalized material (e.g., any described herein).

In another aspect, the present disclosure encompasses a method for removing carbon dioxide from a sorbent material including a bulk solid, the method including: circulating a working fluid in a closed loop between a first heat exchanger, a condenser, and a second heat exchanger; providing a heat source fluid to the first heat exchanger; evaporating water vapor from the sorbent material by transferring heat from the working fluid and from the heat source fluid to the sorbent material in the first heat exchanger; condensing the water vapor by transferring heat from the water vapor to the working fluid in the condenser; transporting the sorbent material from the first heat exchanger to the second heat exchanger through a channel; desorbing carbon dioxide from the sorbent material by transferring heat from the working fluid to the sorbent material in the second heat exchanger; and removing the carbon dioxide from the second heat exchanger by a pump. In some embodiments, the sorbent material includes a functionalized material (e.g., any described herein).

In some embodiments, the method further includes: feeding the sorbent material at an inlet of the first heat exchanger; and extracting the sorbent material from an outlet of the first heat exchanger. In some embodiments, the sorbent material moves from the inlet of the first heat exchanger to the outlet of the first heat exchanger due to gravity.

In some embodiments, the method further includes: feeding the sorbent material at an inlet of the second heat exchanger; and extracting the sorbent material from an outlet of the second heat exchanger. In some embodiments, the sorbent material moves from the inlet of the second heat exchanger to the outlet of the second heat exchanger due to gravity.

In some embodiments, the method further includes: transferring heat from the water vapor evaporated from the sorbent material in the first heat exchanger to the sorbent material in the second heat exchanger through the working fluid; and cooling the sorbent material in the second heat exchanger using heat source fluid that was pre-cooled in the first heat exchanger.

In some embodiments, the method further includes: using a second pump to establish vacuum pressure in the first heat exchanger and to transport the water vapor from the first heat exchanger to the condenser.

In some embodiments, the method further includes: removing the condensed water vapor from the condenser through a water outlet.

In some embodiments, the method further includes: establishing vacuum pressure in the second heat exchanger using the pump; and maintaining vacuum pressures in the first heat exchanger and in the second heat exchanger using airlocks.

In another aspect, the present disclosure encompasses a system for removing carbon dioxide from a sorbent material including a bulk solid, the system including: a first heat exchanger configured to evaporate water vapor from the sorbent material by transferring heat from a heat source fluid to the sorbent material; a second heat exchanger configured to desorb carbon dioxide from the sorbent material by transferring heat from a working fluid to the sorbent material; a pump configured to remove the carbon dioxide from the second heat exchanger; a third heat exchanger configured to cool the sorbent material by transferring heat from the sorbent material to the cooling fluid; and a channel for transporting the sorbent material from the first heat exchanger to the second heat exchanger and to the third heat exchanger.

In some embodiments, the system further includes: an inlet providing access for delivery of the sorbent material to the first heat exchanger; and an outlet providing an egress for removal of the sorbent material from the third heat exchanger. In some embodiments, during operation, the inlet has a higher elevation than the outlet.

In some embodiments, the first heat exchanger includes an evaporator; the second heat exchanger includes a desorber; and the third heat exchanger includes a cooler. In some embodiments, the sorbent material has a pelletized form and is configured to adsorb carbon dioxide from fluid.

In some embodiments, the pump is configured to establish vacuum pressure in the first heat exchanger, the second heat exchanger, and the third heat exchanger. In some embodiments, the sorbent material includes a functionalized material (e.g., any described herein).

The details of one or more embodiments are set forth in the accompanying drawings and the description below. Other features and advantages will be apparent from the description and drawings, and from the claims.

As used herein, the terms “top,” “bottom,” “upper,” “lower,” “above,” and “below” are used to provide a relative relationship between structures. The use of these terms does not indicate or require that a particular structure must be located at a particular location in the apparatus.

### BRIEF DESCRIPTION OF DRAWINGS

FIGS. 1A-1C are non-limiting schematic illustrations of a functionalized material. Provided are functionalized materials having (A) a functional group 106A, (B) a functional group 106B, and (C) a functional group 106C.

FIGS. 2A-2K are chemical illustrations of non-limiting, exemplary compounds, amine moieties, and silane moieties. Provided are illustrations of (A) an aminosilane compound 206, (B, C) non-limiting amine moieties, (D-G) non-limiting aminosilane compounds, and (H-K) non-limiting polyamine compounds.

FIG. 3 is a line chart depicting the breakthrough adsorption curve for CO₂ adsorbed by a non-limiting functionalized material including a silica substrate.

FIG. 4 is a line chart depicting CO₂ uptake over a plurality of cycles by a non-limiting functionalized material including a silica substrate. Provided are the testing cycle number (x-axis) and uptake at each cycle (y-axis).

FIGS. 5A-5I are non-limiting flow chart diagrams showing the steps of producing a functionalized material, which in turn may optionally be used as a sorbent. Provided are diagrams showing methods of producing (A) a functionalized material by using a silane coupling material, (B) a pre-functionalized material by using a silane coupling material and a functionalized material by using an amine compound, (C) a functionalized metal-organic framework (MOF) material, (D) a functionalized resin material, (E) a functionalized material by using a polyamine material, (F) a functionalized material by using an aminosilane material, (G) another functionalized material by using a polyamine material, (H) yet another functionalized material by using a polyamine material. Also provided is (I) a dip-coating method for producing a functionalized material.

FIGS. 6A-6B are schematic illustrations of (A) an example dip-coating method using a double cone mixing and drying system and (B) an example drying method using a double cone mixing and drying system.

FIG. 7 is a schematic illustration of an example dip-coating method using a Nutsche filter mixing/filtration/drying system.

FIG. 8 is a schematic illustration of an example dip-coating method using a bag dip-coating system.

FIG. 9 is a schematic illustration of an example dip-coating and drying method using a paddle dryer.

FIG. 10 is a schematic illustration of an example dip-coating and drying method using a ribbon dryer.

FIGS. 11A-11B are schematic illustrations of (A) an example drying method using a conveyor dryer and (B) operation of an example drying method in continuous mode.

FIGS. 12A-12B are schematic illustrations of (A) an exploded view and an assembled view of a non-limiting sample holder for testing sample CO₂ adsorption and (B) a non-limiting experimental setup for testing sample absorption of CO₂.

FIGS. 13A-13B are schematic illustrations of non-limiting, exemplary implementations of a carbon dioxide extraction system.

FIG. 14 is a schematic illustration of a non-limiting, exemplary implementation of an integrated power and carbon dioxide extraction system.

FIGS. 15A-15E are schematic illustrations of a non-limiting fluidized bed adsorption reactor for direct air capture (DAC) of carbon dioxide. Provided are (A) a perspective cutaway view, (B) another perspective cutaway view of the reactor shown in FIG. 15A, (C) a close up of a portion of the perspective cutaway view of the reactor shown in FIG. 15B, (D) a cross section view of the reactor shown in FIG. 15A, and (E) a close up of a portion of the cross section view of the reactor shown in FIG. 15D.

FIG. 16 is a perspective schematic view of a system including the non-limiting fluidized bed adsorption reactor shown in FIG. 15A.

FIG. 17 is a cross-sectional view of an example silo adsorber

FIG. 18 is a side view of an example silo adsorber.

FIGS. 19A-19B show top views of an example panel of a silo adsorber.

FIG. 20 is a top cross-sectional view of an example silo adsorber.

FIGS. 21A-21B are perspective views of an example adsorber structure.

FIGS. 22A-22B show (A) a top cross-sectional view of an example adsorber structure and (B) is a perspective view showing a scale of an example adsorber structure.

FIGS. 23A-23C show (A) a top cross-sectional view of an example adsorber structure with two filter panels and two end walls and (B, C) top cross-sectional views of example adsorber structures with filter panels arranged in a sawtooth configuration.

FIG. 24 is a block diagram of an example control system for a silo adsorber.

FIG. 25 illustrates an example desorption system including an evaporator and a desorber.

FIG. 26 illustrates an example desorption system including an evaporator stacked with a desorber.

FIGS. 27A-27B illustrate an example desorption system including (A) an evaporator stacked with a desorber including heat source fluid recirculation and (B) an evaporator stacked with a desorber and a cooler.

FIG. 28 illustrates an example heat exchanger.

FIG. 29 is a block diagram of an example control system for a desorption system.

FIGS. 30A-30D illustrate sorbents with differing pore size distributions.

FIG. 31 illustrates pore size distributions for raw silica (3101), dip coated sorbent (3102), and spray coated sorbent (3103).

In the figures, like references indicate like elements.

### DETAILED DESCRIPTION

In general, the disclosure relates to a functionalized material (e.g., a functionalized porous material), and methods of making thereof, that has been functionalized with an adsorbing moiety (e.g., an amine moiety provided by a compound, such as an amine, an aminosilane, a polyamine, a monoamine, or a combination thereof). In some embodiments, functionalization further comprises an interaction moiety (e.g., a silane moiety provided by a compound, such as a silane, an aminosilane, and the like). Such moieties (e.g., amine moieties and/or silane moieties) can be provided any compound and any useful combination of two or more compounds (e.g., one or more of amines, aminosilanes, polyamines, monoamines, or any combination of any of these).

In particular embodiments, the functionalized material can be used to reversibly capture carbon dioxide out of a gas at low concentrations (e.g., <400 ppm) or at atmospheric conditions (e.g., from 350 to 550 ppm). In some embodiments, a porous substrate is employed, in which the substrate features large pore sizes and/or high surface areas, and an amine moiety is employed as the adsorbing moiety to provide increased carbon capture (e.g., >0.8 moles of CO₂ per kg of dry sorbent (mol CO₂/kg), >1.2 mol CO₂/kg, or >2 mol CO₂/kg). One or more compounds can be used to provide adsorbing moieties and/or interaction moieties. Such compounds can include amines, aminosilanes, polyamines, monoamines, as well as others described herein.

In some embodiments, the adsorbing moiety comprises an amine moiety, and the interaction moiety comprises a silane moiety (e.g., any described herein). For example and without limitation, an aminosilane compound having both an amine moiety and a silane moiety can be employed with certain substrates, such that the silane moiety interacts with a surface of the substrate and the amine moiety is thereby accessible at the surface to adsorb CO₂.

In other embodiments, both the adsorbing moiety and the interaction moiety comprises an amine moiety. For example and without limitation, a polyamine compound having at least two amine moieties can be employed with certain substrates, such that the first moiety interacts with a surface of the substrate and a second amine moiety is thereby accessible at the surface to adsorb CO₂.

In yet other embodiments, the adsorbing moiety comprises at least two amine moieties, in which a first amine moiety is provided by a first compound (e.g., an aminosilane) and a second amine moiety is provided by a second compound (e.g., a polyamine). As can be seen, any useful combination of adsorbing moieties and/or interaction moieties can be employed.

Accordingly, described herein are functionalized materials, as well as methods of forming and using such materials (e.g., as a sorbent). In some embodiments, methods include forming or using a functionalized material including a porous structure that allows gas to diffuse through the material and that provides a large surface area for gas to be captured or “adsorbed.” Also described herein are systems for employing such materials in various capture processes. In some embodiments, systems include sample holder, reactors, adsorbers, desorbers, and the like that employ a functionalized material (e.g., any described herein) to adsorb carbon dioxide and/or that regenerate a functionalized material (e.g., any described herein) having adsorbed carbon dioxide.

### I. Functionalized Material

The present disclosure relates to a functionalized material having one or more functional groups. For example and without limitation, an initial material or substrate can be functionalized to include one or more functional groups (e.g., one or more amine groups) configured to capture carbon dioxide (CO₂). In some non-limiting embodiments, the material can have any useful structure (e.g., as a particle), any useful substructure (e.g., one or more pores), and any useful composition (e.g., silica or others described herein). In some non-limiting embodiments, amorphous silica is used as a porous substrate for functionalization to achieve carbon capture. Silica substrates with amine functionalization, e.g., one or more amine-containing moieties covalently bonded on a surface, may achieve reversible capture of carbon dioxide from gaseous mixtures (e.g., the atmosphere). Other substrates and moieties are also described herein, which can provide functionalized material for carbon capture.

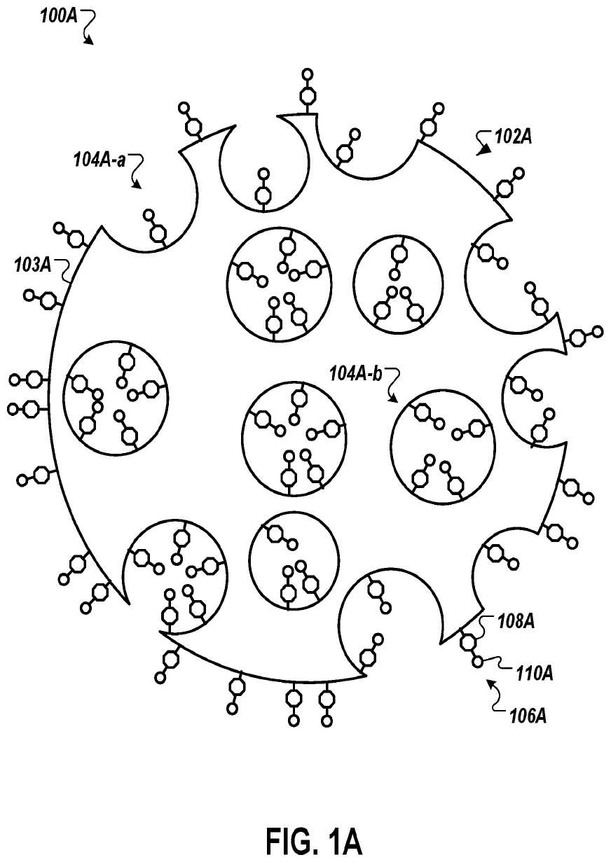

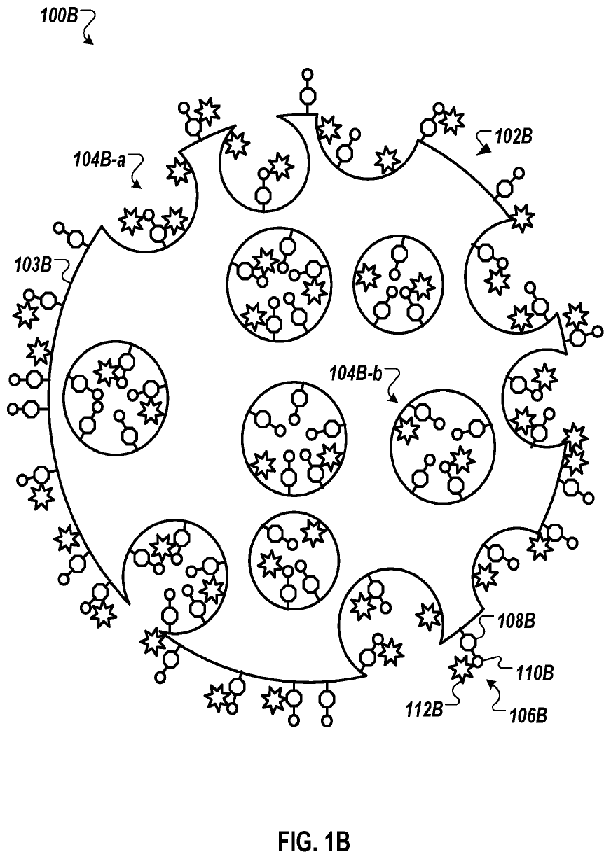

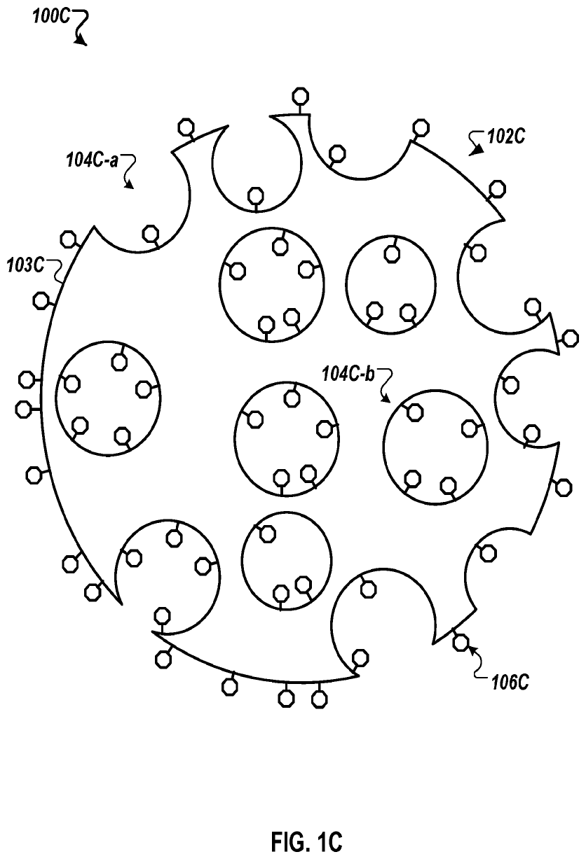

For example, FIG. 1A provides a non-limiting functionalized material 100A including a substrate 102A having a plurality of pores 104A-a, 104A-b. In turn, a surface 103A of the substrate 102A can include a functional portion 106A, which in turn can include an adsorbing moiety 110A (e.g., a CO₂ adsorbing moiety) and an interaction moiety 108A (e.g., a silane-containing interaction moiety). The functional portion 106A may further include other moieties, groups, or molecules to provide an adsorbing material for use as a sorbent. Such moieties, groups, or molecules can include an amine group (e.g., —NR^{N1}R^{N2}, as described herein, which in turn can be present in amines, aminosilanes, polyamines, and the like), polymers (e.g., hydrophobic polymers or polyamines), antioxidants, and the like. Furthermore, such moieties, groups, or molecules may form interactions (e.g., covalent and/or non-covalent interactions) between themselves or between itself and a surface of the substrate.

The functional portion can have any number of moieties to facilitate capture of CO₂. Furthermore, such moieties can be provided by any number of compounds. For example, FIG. 1B provides a non-limiting functionalized material 100B including a substrate 102B having a plurality of pores 1048-a, 1048-b. In turn, a surface 103B of the substrate 102B can include a functional portion 1068, which in turn can include a first adsorbing moiety 110B (e.g., a first CO₂ adsorbing moiety), a second adsorbing moiety 112B (e.g., a second CO₂ adsorbing moiety), and an interaction moiety 108B (e.g., a silane-containing interaction moiety).

Such moieties can be provided in any useful manner. In some embodiments, the surface of a substrate is functionalized by use of a first CO₂ adsorbing compound (e.g., including an aminosilane) and a second CO₂ adsorbing compound (e.g., a polyamine). In turn, the first CO₂ adsorbing compound can provide a first adsorbing moiety (e.g., moiety 110B in FIG. 1B), and the second CO₂ adsorbing compound can provide a second adsorbing moiety (e.g., moiety 112B in FIG. 1B).

When the first CO₂ adsorbing compound is an aminosilane, the aminosilane can include a silane moiety as a non-limiting interaction moiety (e.g., interaction moiety 108B in FIG. 1B) and an amine moiety as a non-limiting first adsorbing moiety (e.g., first adsorbing moiety 110B in FIG. 1B). In some embodiments, the aminosilane is covalently bonded to the exterior surface of the substrate (e.g., surface 102B in FIG. 1B) and within the pores (e.g., pores 104B-a, 104B-b in FIG. 1B). Other examples of adsorbing compounds can include any compounds described herein (e.g., any aminosilanes or other compounds including one or more amine moieties). In some embodiments, together an aminosilane and a polyamine form a network and provide the stable CO₂ adsorbing function.

The second adsorbing moiety may be provided by any useful second adsorbing compound. Examples of adsorbing compounds can include any compounds described herein (e.g., any compounds including one or more amine moieties). Any useful combination of second and first adsorbing compounds can be employed, and such compounds can interact in any useful manner to provide a functionalized network or coating disposed over a surface of a substrate. In turn, such a network or coating can be characterized by any useful combination of adsorbing moieties and interaction moieties.

The second adsorbing moiety can be provided with or without a second interaction moiety. The second interaction moiety can provide direct or indirect attachment to a surface of the substrate. For example and without limitation, a polyamine can include a plurality of amine moieties and at least one linker disposed between at least two amine moieties (e.g., —(R^{A}-L)ₙ-, in which R^{A} is an amine moiety, L is a linker, and n is an integer). The amine moiety R^{A} can act as an adsorbing moiety. Depending on other components present in the functionalized material, either the amine moiety R^{A} or the linker L can act as an interaction moiety. For example, an amine moiety R^{A} of a polyamine may interact with other amine moieties or silane moieties by way of hydrogen bonding or ionic interactions.

In some embodiments, the second adsorbing compound is a polyamine, which can include an amine moiety as a non-limiting second adsorbing moiety (e.g., second adsorbing moiety 112B in FIG. 1B). The second adsorbing moiety may be represented by a certain functional group (e.g., an amine group of —NR^{N1}R^{N2} or —NR^{N1}— as described herein) or a certain compound having certain functional groups (e.g., a compound including one or more amine groups of —NR^{N1}R^{N2} or —NR^{N1}— as described herein). Other examples of adsorbing compounds can include any compounds described herein (e.g., any polyamines or other compounds including one, two, or more amine moieties).

The second adsorbing moiety can interact with other functional groups, moieties, or compounds in the functionalization material in various ways. For example and without limitation, the second adsorbing moiety may interact with the first adsorbing moiety, the interaction moiety, the surface of the substrate, or another second adsorbing moiety. Such interactions can include covalent and/or non-covalent bonding interactions (e.g., any described herein). In some embodiments, the second adsorbing moiety can interact with the first adsorbing moiety. In some embodiments, the second adsorbing moiety can interact with the interaction moiety.

In some embodiments, the second adsorbing moiety comprises a polyamine or amine moieties from a polyamine. When a first adsorbing moiety is provided by an aminosilane, the polyamine can interact with amine moieties of aminosilane or interaction moieties of aminosilane. In some embodiments, amine moieties of aminosilane and polyamine can interact with silanol groups of aminosilane through hydrogen bonding and ionic interactions to form a functional group, thereby forming a complex network over the surface of the substrate. Using FIG. 1B as a reference, a functional group 106B can include amine moieties 110B of aminosilane and amine moieties 112B of polyamine that interact with silanol groups 108B of aminosilane.

FIG. 1C provides a non-limiting functionalized material 1000 including a substrate 102C having a plurality of pores 104C-a, 104C-b. In turn, a surface 103C of the substrate 102C can include a functional portion 106C, which in turn can include at least one adsorbing moiety (e.g., a first CO₂ adsorbing moiety). In some embodiments, a plurality of adsorbing moieties are provided. For instance, a polyamine (e.g., such as polyethylenimine (PEI)) having a plurality of adsorbing moieties can be reacted with the substrate. The polyamine can be characterized by a high interaction surface area which facilitates 1- or 2-D van der Waals interactions with the surfaces of the substrate. The polyamine introduced to the substrate can form a surface modification layer for reversibly binding CO₂ from atmospheric gases. In some embodiments, a polyamine (e.g., PEI having a larger molecular weight such as, e.g., greater than about 800 Da or from about 800 Da to 1 MDa (or 1,000,000 Da)), as compared to short chain amine functionalization) can be less volatile overall.

In another instance, the plurality of adsorbing moieties can be provided by way of one or more oligomeric amines or small molecule polyamines or mixtures of any of these. In some embodiments, the oligomeric amine can include an oligomeric ethylene amine or a mixture including such oligomers (e.g., an ethylene amine/oligomer mixture). For example, the oligomer can include ethylene amine-containing molecules (e.g., molecules including a —CH₂CH₂NR^{N1}— group) or oligomers such as H₂N[CH₂CH₂NH]ₙH (e.g., in which n is 1, 2, 3, 4, 5, 6, 7, 8, 9, 10, or more and R^{N1} can be any described herein). Tetraethylenepentamine (TEPA) and triethylenetetramine (TETA) are non-limiting examples of oligomeric amines with low volatility. In some embodiments, an oligomeric amine can include a small molecule polyamine (e.g., having a molecular weight (MW) between 100 to 800 g/mol). Other examples of oligomers are described herein.

In some embodiments, a small molecule amine mixture (e.g., such as Amix 1000) includes amine-containing molecules, such as 2-[(2-aminoethyl) amino]ethanol, (aminoethyl)piperazine, and/or (hydroxyethyl)piperazines as a commercially available mixture of amines.

In some non-limiting embodiments, Amix 1000, TEPA, TETA, or a mixture of these or similar compounds can be used to functionalize a substrate to form a functionalized material. In some embodiments, Amix 1000, TEPA, TETA, and similar compounds are a low-cost source of reactable amines facilitating low-cost functionalization and carbon capture from atmospheric gases.

In some embodiments, the oligomeric amine or small molecule amine mixture can be reacted with a porous silica substrate to form a functionalized substrate. In some embodiments, the oligomeric amine or the small molecule amine mixture can be a compound bonded to a surface of the substrate and can form a surface modification layer on the surface through van der Waals interactions.

Using FIG. 1C as a reference, a functional group 106C can include a polyamine group. In some implementations, the polyamine group can includes one or more primary, secondary, or tertiary amine groups; repeat units of ethylamine or propylamine; or more than one amine groups connected through various linkers (e.g., alkylene groups); or linear or branched polyamines. In some embodiments, the polyamine group has an increased interaction surface area compared to short chain amine-containing compounds due to the increased number of amine groups in the polymeric chain. In some embodiments, the polyamine group is bonded to the substrate 102C through van der Waals interactions, hydrogen bonding, and/or ionic interactions.

In some embodiments of any functional material herein, the functional portion can include an adsorbing moiety that captures CO₂ (e.g., as in a CO₂ adsorbing moiety). In some embodiments, the CO₂ adsorbing moiety includes one or more amine-containing moieties. Amine-containing moieties can be provided by way of an aminosilane, an amine compound, a polyamine compound, or a combination of any of these. Additional details regarding CO₂ adsorbing moieties are described herein.

As also described herein, the functional portion can include an interaction moiety that interacts with at least a portion of the surface of a substrate. The interaction moiety can be selected based on the substrate to be functionalized. In some embodiments, the substrate to be functionalized includes silica, and the interaction moiety is configured to react with silica. In some embodiments, the interaction moiety comprises a silane moiety that reacts with the surface of the silica substrate. In other embodiments, the substrate to be functionalized includes a metal-organic framework (MOF) material, and the interaction moiety is configured to react with the MOF material. In some embodiments, the interaction moiety comprises a silane moiety that reacts with the surface of the MOF substrate. In other embodiments, the substrate to be functionalized includes a resin material, and the interaction moiety is configured to react with the resin material. In some embodiments, the interaction moiety comprises an amine moiety that reacts with the surface of the resin substrate. The interaction moiety can interact with a surface of the substrate by way of covalent and/or non-covalent bonding interactions (e.g., as described herein). Additional details regarding interaction moieties and substrates are described herein.

Such moieties can be introduced in any useful manner. For instance, such moieties can be present in one or more compounds, which in turn can be provided within a suspension or a mixture (e.g., a functionalization mixture). When a substrate is also present, then the compounds can interact with the substrate to provide a functionalized material. Any useful compound(s) can be employed. In one non-limiting instance, the amine moiety and silane moiety are provided by way of an aminosilane compound, which in turn reacts with or interacts with a surface of a substrate to provide amine-containing groups. In another non-limiting instance, the amine moiety is provided by way of a polyamine compound, which in turn reacts with or interacts with a surface of a substrate to provide amine-containing groups. In yet another non-limiting instance, both an aminosilane compound and a polyamine compound are employed to provide a functionalized surface. Such reactions can result in covalent and/or non-covalent interactions, in which a linking group (e.g., by way of optionally substituted aliphatic, alkylene, alkenylene, alkynylene, heteroaliphatic, heteroalkylene, heteroalkenylene, heteroalkynylene, aromatic, arylene, heteroaromatic, heteroarylene, and the like) is present between a functional group (or a moiety) and a surface of a substrate. An amine moiety can be an amine functional group itself (e.g., —NR^{N1}R^{N2}, as described herein) or can be a portion of a compound including the amine functional group (e.g., -L-NR^{N1}R^{N2}, in which L, R^{N1}, and R^{N2} can be any described herein). Additional details regarding compounds, suspensions, and mixtures to provide functional portions are described herein.

In use, a functionalized material can be provided as a layer (e.g., a layer of beads or powder) or a bed over which or through which a gaseous mixture including CO₂ can be flowed. Such a material can be considered a “sorbent” or “adsorbent,” in which these terms are used interchangeably unless otherwise specified. Gas exiting the sorbent has a lower concentration of CO₂ than the entering gas. In some embodiments, the functionalized material can reversibly adsorb CO₂ over a number of cycles, e.g., a number of adsorption and desorption steps, in which a cycle can include at least one adsorption step and at least one desorption step. Higher cycle counts can be used to characterize materials having longer product lifetimes when used in CO₂ capture applications. In some non-limiting implementations, the functionalized material reversibly adsorbs CO₂ over 100 cycles (e.g., over 500 cycles, over 1000 cycles, over 2000 cycles, or over 3000 cycles). Here and throughout the specification, reference to a measurable value such as an amount, a temporal duration, and the like, the recitation of the value encompasses the precise value, approximately the value, and within ±10% of the value. For example, here 100 cycles includes precisely 100 cycles, approximately 100 cycles, and within ±10% of 100 cycles.

CO₂ adsorbed to the functionalized material may be released (e.g., desorbed) under some conditions. As one example, reducing the gas pressure surrounding the functionalized material can desorb captured CO₂. As another example, reducing the partial pressure of CO₂ surrounding the functionalized material can desorb captured CO₂ (e.g., by purging with N₂ or another gas). One or more of these approaches can facilitate recapture of the adsorbed CO₂ in a secondary environment. In some implementations, the functionalized material is exposed to a reduced gas pressure of less than 5 psi (e.g., less than 3 psi, 1.5 psi, 1 psi, or 0.1 psi).

As a second example, increasing the temperature of the functionalized material can destabilize bonding between an amine group and CO₂, thereby desorbing the CO₂ from the functionalized material. In some implementations, the functionalized material desorbs CO₂ at temperatures above 60° C. (e.g., above 60° C., 70° C., 80° C., or 90° C.). Increasing the temperature and decreasing gas pressure concurrently can increase the rate at which the CO₂ desorbs from the functionalized material.

Indeed, release of gas from a sorbent can include any useful process. In one example, a swing process can be employed. Such swing processes can include application of a change in temperature, of a change in pressure, and/or of a vacuum to release the gas from the sorbent composition. Swing processes can include Temperature Swing Adsorption (TSA), Pressure Swing Adsorption (PSA), and Vacuum Swing Adsorption (VSA), or a combination of these. In some embodiments, the released gas can be provided as outputs, and such outputs can be generated by exposing the sorbent to a temperature swing adsorption process, a pressure swing adsorption, a vacuum swing adsorption process, or a combination of any of these.

i. Substrate

The functionalized material can include any useful substrate. In some embodiments, the substrate provides a porous surface upon which a functional portion can be disposed. In some embodiments, the substrate comprises a porous substrate, such as a porous ceramic (e.g., a porous metal oxide, a porous metalloid oxide, or combinations thereof or mixed forms thereof), a porous metal-organic substrate, or a porous polymeric substrate. In some embodiments, the substrate comprises a porous ceramic/metal oxide together with porous silica (e.g., including porous alumina, calcium silicate, sodium aluminosilicate). Yet other non-limiting examples of substrates include porous silica or silicate (e.g., amorphous silica, calcium silicate, sodium aluminosilicate), porous alumina (e.g., including sodium aluminosilicate), metal-organic framework (MOF), or resin (e.g., as described herein). The substrate can be provided in any form (e.g., precipitated, sol-gel, fumed, calcined, agglomerated, or granulated forms, which in turn can be provided as a powder, a granule, and the like). The substrate can be sourced from standard industrial sources or synthesized. In some embodiments, the substrate is water-stable and/or resistant to corrosion and oxidation.

The dimension of the substrate can vary based on the application and/or the source. Depending on the shape of the substrate, a dimension of the substrate can include a length, width, height, cross-sectional dimension, circumference, radius (e.g., external or internal radius), diameter, or another metric to indicate a size of the substrate. The substrate can include a population of particles, in which the population is characterized by a certain effective average particle size and/or by a certain distribution of sizes. For example and without limitation, the substrate can be characterized by an effective average particle size in which at least 50% of the particles therein are of a specified size. For example and without limitation, the substrate can be characterized by a distribution of sizes that is from about 25 micrometers (μm) to 3 millimeter (mm) or from 25 μm to 4 mm.

In some non-limiting implementations, the substrate can have a distribution of diameters having an average diameter which can be in a range from 25 μm to 4 mm (e.g., from 45 to 800 μm, 50 to 500 μm, 60 to 300 μm, 45 to 150 μm, 70 to 80 μm, 25 μm to 3 mm, 25 μm to 2 mm, 25 μm to 1 mm, 50 μm to 4 mm, 50 μm to 3 mm, 50 μm to 2 mm, 50 μm to 1 mm, 100 μm to 4 mm, 100 μm to 3 mm, 100 μm to 2 mm, 100 μm to 1 mm, 200 μm to 4 mm, 200 μm to 3 mm, 200 μm to 2 mm, 200 μm to 1 mm, 250 μm to 4 mm, 250 μm to 3 mm, 250 μm to 2 mm, 250 μm to 1 mm, 500 μm to 4 mm, 500 μm to 3 mm, 500 μm to 2 mm, 500 μm to 1.5 mm, 1 to 2 mm, 1 to 2.5 mm, 1 to 3 mm, or 1 to 4 mm). In some implementations, the average diameter of the substrate is less than 500 μm (e.g., less than 400 μm, less than 350 μm, less than 300 μm, less than 200 μm, or less than 100 μm). In some embodiments, the substrate (e.g., porous silica particles) has an average radius of at least 0.5 mm.

The width of the distribution around the average can affect adsorption performance of the substrate. In some non-limiting implementations, the width of the distribution is in a range from 5 to 50 μm around the average (e.g., from 10 to 40 μm or 20 to 30 μm). In some examples, the width of the distribution is in a range from 50 μm to 2 mm around the average (e.g., from 75 μm to 1.5 mm, 100 μm to 1.25 mm, 200 μm to 1 mm, 300 to 800 μm, 500 μm to 2 mm, 500 μm to 1.5 mm, 500 μm to 1 mm, 1 to 2 mm, 1.2 to 1.8 mm, 1.4 to 2 mm, or 1.5 to 2 mm).

The width of the distribution can alternatively be described using D₉₀, D₅₀, and/or D₁₀ values. These values signify a percentage of the total distribution of sizes for material within a sample, up to and including the value. For example, a D₅₀ value of 500 μm indicates that 90% of the material within a sample has a size of 500 μm or smaller. In some implementations, the functionalized material has a D₁₀ value of 30 μm or a D-so value of 150 μm. In some examples, the functionalized material has a D₁₀ value of 100 μm or a D₅₀ value of 500 μm, a D₁₀ value of 150 μm or a D₉₀ value of 1000 μm, a D₁₀ value of 400 μm or a D₉₀ value of 1500 μm, a D₁₀ value of 500 μm or a D₉₀ value of 2000 μm, or a D₁₀ value of 1000 μm or a D₉₀ value of 3000 μm. In some implementations, the functionalized material has a D₅₀ value of 1000 μm, 1100 μm, 1200 μm, 1300 μm, 1400 μm, or 1500 μm.

Without wishing to be bound by theory, a smaller particle size with high porosity or high pore volume and BET surface area can facilitate better functionalized material synthesis results, which in turn can enable higher CO₂ capture capacity due to relatively higher surface area leading to higher amine coating concentrations. Such types of smaller particles could permit faster adsorption inside of the particle as the gas diffusion path may be shorter. If gas diffusion to the particle surface rate is not limited, then a smaller particle size may be beneficial to gas adsorption. Smaller particle size (e.g., having a small average diameter, radius, or width) could reduce the adsorption process energy cost for a fluidization process.

Yet other particle effects for smaller particle sizes can include smaller interparticle volume, slower interparticle gas kinetics (e.g., due to longer interparticle diffusion length), faster intraparticle gas kinetics (e.g., due to shorter intraparticle diffusion length), higher packed bed back pressure, higher packing density, and/or higher external surface area. Particle effects for larger particle sizes can include larger interparticle volume, faster interparticle gas kinetics (e.g., due to shorter interparticle diffusion length), slower intraparticle gas kinetics (e.g., due to longer intraparticle diffusion length), lower packed bed back pressure, lower packing density, and/or lower external surface area. A skilled artisan could adapt such sizes and effects to provide a certain adsorbent for particular uses.

The substrate may be characterized by the presence of one or more pores. As seen in FIG. 1A, pores 104 can be considered openings that extend from an exterior surface of the substrate into the interior volume. In some embodiments, the presence of such pores can increase the surface area of the substrate. The dimension of pores can vary from pore to pore, and can vary within an individual pore, see, e.g., pores 104A-a, 104A-b. Furthermore, depending on the shape of the pore, a dimension can include a length, width, height, cross-sectional dimension, circumference, radius (e.g., external or internal radius), diameter, or another metric to indicate a size of the pore.

The pore can have any useful dimension. In some embodiments, a dimension (e.g., a diameter) of the pore(s) is in a range from 60 to 700 angstroms (Å) (e.g., from 60 to 400 Å, 60 to 300 Å, 80 to 300 Å, 100 to 700 Å, 100 to 500 Å, 100 to 200 Å, 150 to 250 Å, 200 to 700 Å, 300 to 700 Å, 300 to 500 Å, or 500 to 700 Å). In some embodiments, a dimension (e.g., a diameter) of the pore(s) is in a range from 100 to 150 Å. In some implementations, the dimension (e.g., a diameter) of the pore(s) is greater than 90 Å (e.g., greater than 100 Å, 120 Å, or 150 Å). Without wishing to be limited by theory, a larger diameter of the pore could increase adsorption and desorption rates and could facilitate higher filling of the pores with amine moieties without pore-clogging, which in turn could reduce adsorption and desorption efficiency.

In some embodiments, a substrate can be characterized by a porosity of 1 to 200 nm and/or an average pore size of 30 to 80 nm. In some embodiments, a dimension (e.g., a diameter) of the pore(s) is in a range from 1 to 200 nm (e.g., 1 to 180 nm, 1 to 160 nm, 1 to 120 nm, 1 to 100 nm, 1 to 70 nm, 1 to 30 nm, 1 to 20 nm, 10 to 200 nm, 10 to 180 nm, 10 to 160 nm, 10 to 120 nm, 10 to 100 nm, 10 to 70 nm, 10 to 50 nm, 30 to 200 nm, 30 to 180 nm, 30 to 160 nm, 30 to 120 nm, 30 to 100 nm, 30 to 90 nm, 30 to 70 nm, 70 to 200 nm, 70 to 180 nm, 70 to 160 nm, or 70 to 120 nm). In some embodiments, an average dimension (e.g., an average diameter) of the pore(s) is in a range from 30 to 80 nm, 20 to 100 nm, or 20 to 70 nm).

In some embodiments, a substrate (e.g., a silica substrate) can be characterized by a plurality of pores of different sizes. For example and without limitation, smaller pores in the range of 1 to 30 nm can contribute to relatively higher surface areas, which can allow for more surface anchoring with amine moieties to improve stability of the coating or surface functionalization layer. Larger pores in the range of 30 to 90 nm can contribute to relatively larger pore volumes that allow for larger volumes of active amine moieties to be contained within the pores to improve the CO₂ uptake. The largest pores in the range of 70 to 200 nm can provide open channels that contribute to relatively higher gas diffusion rates for improved CO₂ adsorption kinetics. Without wishing to be limited by mechanism, a substrate (e.g., a silica substrate) that possesses significant porosity in these three ranges may be employed as substrates for amine-coated sorbents. In some non-limiting embodiments, a substrate having reduced porosity in one or two of these ranges may suffer from relatively decreased performance in the corresponding function but may still function as substrates for amine-coated sorbents.

In some embodiments, a substrate (e.g., a silica substrate) can be characterized by a plurality of pores, wherein each pore can be characterized by a pore dimension, wherein at least one pore dimension is in a first range of about 1 to 30 nm, a second range of about 30 to 90 nm, and/or a third range of about 70 to 200 nm. Such ranges can be any other ranges of pore dimensions described herein.

Pores can have any useful shape (e.g., cylindrical, spherical, tubular, and the like), configuration, distribution, and arrangement (e.g., hexagonal, cubic, and the like). The pores can have an irregularly round cross-sectional shape, or a hexagonal cross-sectional shape, though this is not limiting. Pores may also be characterized by pore size distributions, which can be determined in any useful manner (e.g., using mercury, nitrogen, argon, helium, etc. in porosimetry or using Brunauer-Emmett-Teller (BET) analysis with appropriate methods such as the Barrett Joyner Halenda (BJH) or Non-Local Density Functional Theory (NLDFT) models).

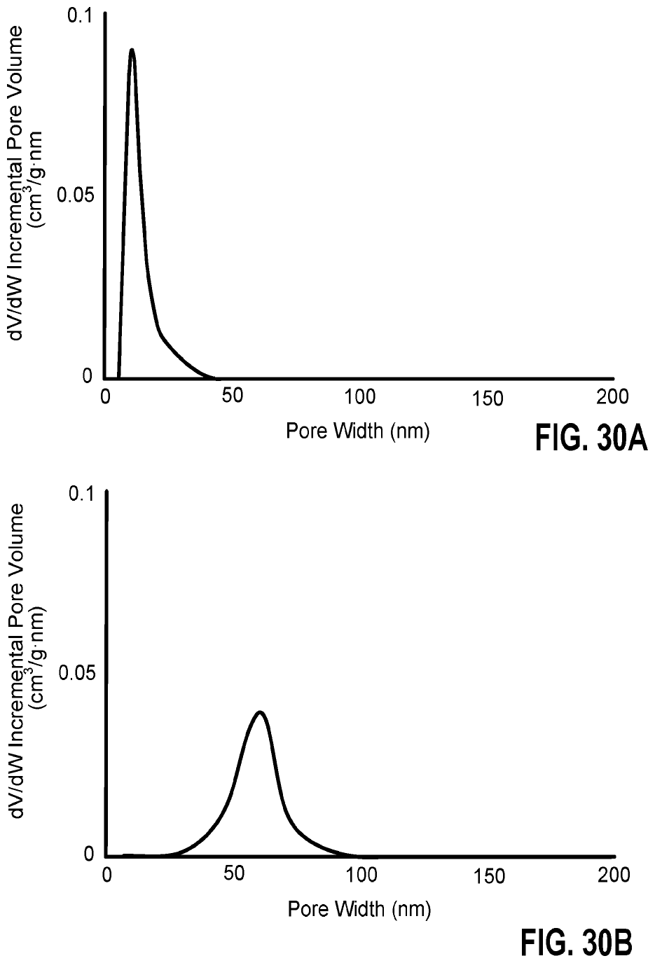

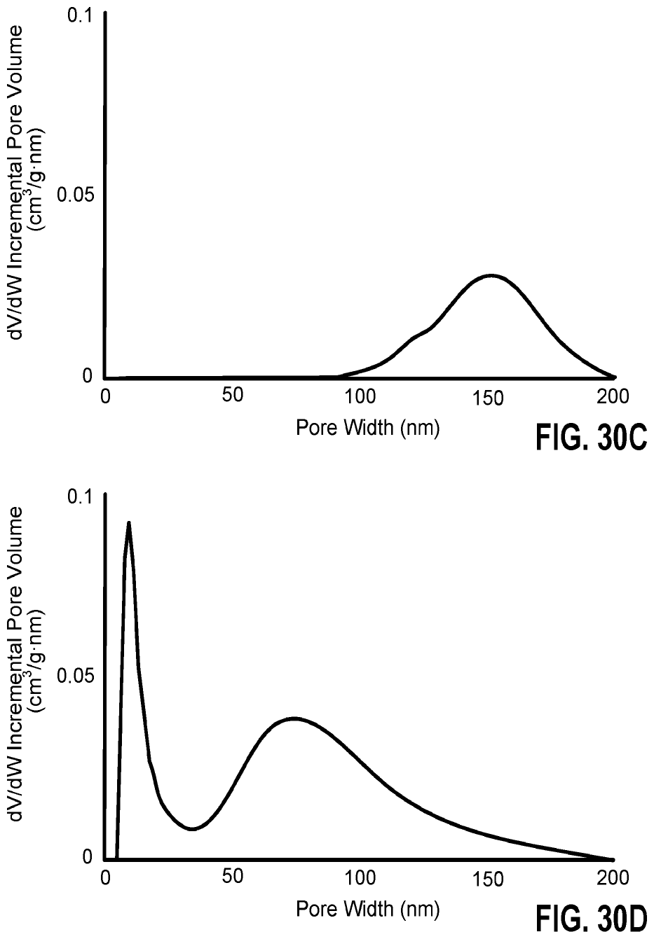

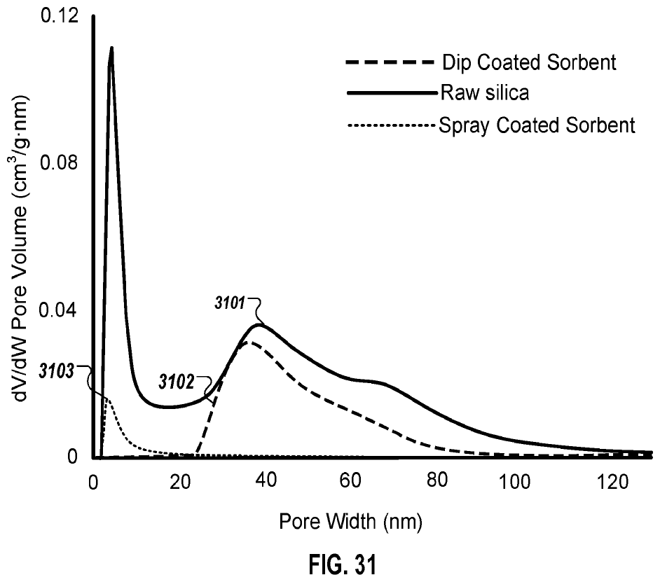

Non-limiting examples of pore size distributions are provided in FIGS. 30A-30D and FIG. 31. Provided are pore size distribution profiles for non-limiting sorbents with only narrow pores having high surface areas but relatively lower pore volumes and gas kinetics (FIG. 30A), non-limiting sorbents with only moderately sized pores having high pore volumes and moderate surface areas and gas kinetics (FIG. 30B), non-limiting sorbents with only large pores having fast gas kinetics and high pore volumes but relatively lower surface areas (FIG. 30C), and non-limiting sorbents with pores in a plurality of ranges having high surface areas, pore volumes, and channels for gas diffusion allowing for stable surface coating, relatively higher concentrations of active amines, and fast gas kinetics (FIG. 30D). Also provided are pore size distributions for raw silica, dip coated sorbents, and spray coated sorbents (FIG. 31).

The pores can have any useful configuration. In some embodiments, pores may be provided on a surface of the substrate. Such pores may or may not be interconnected. For example and without limitation, pores could extend into the central volume of the substrate and form interconnected channels. Without wishing to be limited by theory, the pores can create a volume within the substrate in which gases may flow for enhanced capture of such gases. Furthermore, such pores may create additional (e.g., and accessible) surface area for functionalization.

Pores can be characterized by pore volume, total surface area, accessible surface area, porosity, and the like. In some embodiments, the volume of the pores is greater than 0.1 mL/g, (e.g., greater than 0.5 mL/g, greater than 0.8 mL/g, greater than 1 mL/g, greater than 1.2 mL/g, greater than 1.5 mL/g, or greater than 1.8 mL/g). In some embodiments, the volume of the pores is from 0.1 to 5 mL/g (e.g., from 0.1 to 4.5 mL/g, 0.1 to 4 mL/g, 0.1 to 3 mL/g, 0.1 to 3.5 mL/g, 0.1 to 3 mL/g, 0.1 to 2.5 mL/g, 0.1 to 2 mL/g, 0.1 to 1.5 mL/g, 0.1 to 1.2 mL/g, 0.1 to 1 mL/g, 0.5 to 5 mL/g, 0.5 to 4.5 mL/g, 0.5 to 4 mL/g, 0.5 to 3.5 mL/g, 0.5 to 3 mL/g, 0.5 to 2.5 mL/g, 0.5 to 2 mL/g, 0.5 to 1.5 mL/g, 0.5 to 1 mL/g, 1 to 5 mL/g, 1 to 4.5 mL/g, 1 to 4 mL/g, 1 to 3.5 mL/g, 1 to 3 mL/g, 1 to 2.5 mL/g, 1 to 2 mL/g, 1.5 to 5 mL/g, 1.5 to 4.5 mL/g, 2.5 to 5 mL/g, 2.5 to 4.5 mL/g, 3.5 to 5 mL/g, 3.5 to 4.5 mL/g, 1.5 to 3.5 mL/g, 1 to 3 mL/g, 1 to 1.5 mL/g, 1 to 1.2 mL/g, or 1.5 to 2.5 mL/g). Without wishing to be limited theory, increased total volume of the pores could allow more amine moieties to be grafted or into the pores and, thus increase the adsorption potential of the functionalized material.

Total surface area can be used to characterize the substrate. The total surface area of the substrate includes the surface area of not only the outer surface but also the surface area within the pores. In some embodiments, the total surface area is greater than 100 m² per dry gram (m²/g) of substrate. In some implementations, the total surface area is greater than 300 m²/g (e.g., greater than 200 m²/g, 400 m²/g, 500 m²/g, or 800 m²/g). In some implementations, the total surface area is greater than 1200 m²/g (e.g., greater than 200 m²/g, 400 m²/g, 500 m²/g, or 800 m²/g). In some implementations, the total surface area is greater than 2000 m²/g (e.g., greater than 2500 m²/g, 3000 m²/g, 4000 m²/g, 5000 m²/g, or 6000 m²/g). In some examples, the total surface area is in a range from 100 to 1200 m²/g (e.g., from 200 to 1200 m²/g, 400 to 1200 m²/g, 500 to 1200 m²/g, 700 to 1200 m²/g, 800 to 1200 m²/g, 1000 to 1200 m²/g, 100 to 1000 m²/g, 100 to 800 m²/g, 100 to 500 m²/g, 100 to 400 m²/g, 100 to 900 m²/g, 200 to 900 m²/g, 400 to 900 m²/g, 500 to 1000 m²/g, or 500 to 800 m²/g). In some examples, the total surface area is in a range from 1000 to 12000 m²/g (e.g., from 1000 to 11000 m²/g, 1000 to 10000 m²/g, 1000 to 9000 m²/g, 1000 to 8000 m²/g, 1000 to 7000 m²/g, 1000 to 6000 m²/g, 1000 to 5000 m²/g, 1000 to 4000 m²/g, 2000 to 12000 m²/g, 2000 to 11000 m²/g, 2000 to 10000 m²/g, 2000 to 9000 m²/g, 2000 to 8000 m²/g, 2000 to 7000 m²/g, 2000 to 6000 m²/g, 2000 to 5000 m²/g, 2000 to 4000 m²/g, 3000 to 12000 m²/g, 3000 to 11000 m²/g, 3000 to 10000 m²/g, 3000 to 9000 m²/g, 3000 to 8000 m²/g, 3000 to 7000 m²/g, 3000 to 6000 m²/g, 3000 to 5000 m²/g, 3000 to 4000 m²/g, 4000 to 12000 m²/g, 4000 to 11000 m²/g, 4000 to 10000 m²/g, 4000 to 9000 m²/g, 4000 to 8000 m²/g, 4000 to 7000 m²/g, 4000 to 6000 m²/g, or 4000 to 5000 m²/g). In some examples, the total surface area is in a range from 100 to 12000 m²/g (e.g., including ranges therebetween, such as any described herein).

Without wishing to be limited by theory, higher total surface area could increase the available area for functionalization (e.g., by way of interactions between a silane moiety and a surface of the substrate) and/or increase the adsorption potential of the functionalized material. Surface area can be determined in any useful manner, e.g., by using the BET model or other methodologies described herein.

Any useful combination of features may be present in a substrate. In some embodiments, the substrate comprises a greatest dimension (e.g., an average greatest dimension) of at least 70 μm and a plurality of pores, wherein the plurality of pores is characterized by a volume that is greater than 0.8 mL/g and by a size (e.g., an average size) of at least 90 Å. In some embodiments, the substrate comprises a greatest dimension (e.g., an average greatest dimension) in a range from 0.5 to 2 mm and a plurality of pores, wherein the plurality of pores is characterized by a volume greater than 0.5 ml/g and a size in a range from 20 to 1000 Å. Other combinations of features are possible.

a. Silica

In some embodiments, the substrate comprises silica (e.g., silicon dioxide). Any methods or compounds herein can be used to functionalize a silica substrate to provide a functionalized silica. For example and without limitation, functionalized silica can feature amine moieties that are bound to the silica surface (e.g., by way of siloxane bonds, other covalent bonds, or even non-covalent bonds).

Silica can be provided in any useful form, such as beads (e.g., microbeads, nanobeads, or combinations thereof), powders (e.g., micropowders, nanopowders, or combinations thereof; or from micrometer size to millimeter size), particles (e.g., microparticles, nanoparticles, or combinations thereof), and the like. Furthermore, silica can include any useful type, such as amorphous or non-crystalline silica (e.g., precipitated, sol-gel, fumed, calcined, agglomerated, or other forms of silica) or silicates (e.g., calcium silicate, sodium aluminosilicate, and the like). In some embodiments, silica can include one or more pores (e.g., as in porous silica). Furthermore, within such a substrate, pores can have any useful shape, configuration, distribution, and arrangement (e.g., hexagonal arrangement of pores in MCM-41, which in turn can be spherical or any other shape). In some embodiments, the substrate can be bead-shaped, though this is not limiting. Silica can be obtained or provided in any useful manner, such as by employing synthetic methods or by sourcing from standard industrial sources.

In some non-limiting embodiments, the substrate 102A, 102B, 102C is a silica substrate. In some non-limiting embodiments, the substrate 102A, 102B, 102C is composed of amorphous silica, e.g., non-crystalline silica.

### B. Metal-Organic Framework (MOF)

Metal organic frameworks (MOFs) are a class of compounds including metal ions or clusters coordinated to organic ligands to form one-, two-, or three-dimensional structures (e.g., porous three-dimensional structures). Various kinds of MOF can be synthesized with different combinations of metal ions and organic ligands (e.g., as described herein). In some embodiments, MOF substrates are used as a porous structure for functionalization to achieve carbon capture.

In some embodiments, the substrate comprises a MOF. Any methods or compounds herein can be used to functionalize a MOF substrate to provide a functionalized MOF. Without wishing to be limited by theory, a functionalized MOF can feature surface areas larger than alternative substrates (e.g., zeolite, silica, etc.) for increased functionalization (e.g., >2000 m²/g). For example and without limitation, a functionalized MOF can feature amine moieties that are bound to hydroxy functional side groups present on the surface, thereby allowing for CO₂ uptake. The amine moiety can be provided by any compound described herein (e.g., an aminosilane compound) for increased carbon capture (e.g., >2 mol CO₂/kg).

MOFs can be provided in any useful manner. In some embodiments, MOFs can be produced using reactor-based, solvothermal (e.g., hydrothermal) synthesis methods in which a metal source (e.g., a metallic substrate or a metal-containing salt), an organic ligand, and an optional competing agent/additive are reacted together to produce MOF crystals of 10 μm to 1 mm in size (e.g., in diameter), including ranges therebetween (e.g., from 10 to 500 μm, 10 to 300 μm, 50 to 300 μm, or 50 to 100 μm in size). The crystals can be extruded, pelletized, and functionalized with adsorbing moieties to provide a functional group disposed on a surface of the MOF, thereby providing a functionalized MOF.

MOFs can be synthesized by providing a metal source and an organic ligand. Under certain conditions, metal-containing centers form nodes, and organic ligands form bridges between the nodes to provide self-assembled, networked structures. By selecting certain metals and ligands with certain reaction conditions, various structural characteristics (e.g., topology, pore structure, pore size, and the like) of the MOF material can be controlled.

Any useful metal source can be employed. Non-limiting examples include a metal source comprising aluminum (Al), chromium (Cr), copper (Cu), iron (Fe), titanium (Ti), vanadium (V), zinc (Zn), zirconium (Zr), as well as salts thereof (e.g., halide salts, nitrate salts, or others described herein). In some embodiments, the metal source can be an aluminum-based metal source, an iron-based metal source, a titanium-based metal source, a zinc-based metal source, or a zirconium-based metal source. In some embodiments, the metal ions selected for the MOF substrate may include an economical, commercially available, cost-effective metal ion source, such as aluminum (Al), iron (Fe), titanium (Ti), zinc (Zn) (e.g., zinc nitrate (ZnNO₃)), zirconium (Zr) (e.g., zirconium tetrachloride (ZrCl₄)).

Any useful organic ligand can be employed. Non-limiting ligands include, e.g., 3,3′,5,5′-azobenzenetetracarboxylate (ABTC⁴⁻); 1,4-benzenedicarboxylate (BDC²⁻); (X)-BDC²⁻ or (X)₂-BDC²⁻, where each X is, independently, alkyl, halo, hydroxy, nitro, amino, carboxyl, alkoxy, cycloalkoxy, aryloxy, or benzyloxy (e.g., 2-amino-1,4-benzenedicarboxylate (NH₂-BDC²⁻), 2-hydroxy-1,4-benzenedicarboxylate (OH-BDC2−), 2,5-diamino-1,4-benzenedicarboxylate ((NH₂)₂-BDC²⁻), 2,5-dihydroxy-1,4-benzenedicarboxylate ((OH)₂-BDC²⁻ or DHBDC²⁻), 2,3-dihydroxy-1,4-benzenedicarboxylate, or 2,6-dihydroxy-1,4-benzenedicarboxylate); 1,1′-biphenyl-4,4′-dicarboxylate (BPDC²⁻); (X)-BPDC²⁻ or (X)₂-BPDC²⁻, where each X is, independently, alkyl, halo, hydroxy, nitro, amino, carboxyl, alkoxy, cycloalkoxy, aryloxy, or benzyloxy (e.g., 2-amino-1,1′-biphenyl-4,4′-dicarboxylate (NH₂-BPDC²⁻), 2-hydroxy-1,1′-biphenyl-4,4′-dicarboxylate (OH-BPDC²⁻), 2,2′-diamino-1,1′-biphenyl-4,4′-dicarboxylate ((NH₂)₂-BPDC²⁻), or 2,2′-dihydroxy-1,1′-biphenyl-4,4′-dicarboxylate ((OH)₂-BPDC²⁻)); 1,3,5-benzenetricarboxylate or 1,2,4-benzenetricarboxylate (BTC³⁻); 2,5-dihydroxy-1,4-benzenedicarboxylate (DHBDC²⁻); 2,5-dioxido-1,4-benzenedicarboxylate (DOBDC⁴⁻); 4,4′,4″-s-triazine-2,4,6-triyl-tribenzoate (TATB³⁻); 1,3,6,8-tetrakis(p-benzoate)pyrene (TBAPy⁴⁻); 1,1′-triphenyl-4,4′-dicarboxylate (TPDC²⁻); and (X)₂-TPDC²⁻ or (X)₄-TPDC²⁻, where each X is, independently, alkyl, halo, hydroxy, nitro, amino, carboxyl, alkoxy, cycloalkoxy, aryloxy, or benzyloxy (e.g., 2,2′-dihydroxy-1,1′-triphenyl-4,4′-dicarboxylate (di-OH-TPDC) or 2,2′,6,6′-tetrahydroxy-1,1′-triphenyl-4,4′-dicarboxylate (tetra-OH-TPDC)). Such ligands can be provided as a compound in its protonated form to the metal source. In some embodiments, the ligand can optionally include one or more counterions (e.g., one or more counteranions or countercations), as well as a cation thereof, an anion thereof, a protonated form thereof, a salt thereof, or an ester thereof.

In some embodiments, the ligand includes hydroxy functional side groups. Without wishing to be limited by theory or mechanism, the presence of hydroxy functional side groups may facilitate post-synthetic functionalization of the MOF surface with adsorbing moieties (e.g., amine moieties).

In some embodiments, the hydroxy reacts with a silane moiety of an aminosilane compound to covalently bond the silane moiety to the hydroxy group of the organic ligand, while increasing the density of amine moieties on a surface of the MOF substrate, thereby increasing the CO₂ capture capacity of the MOF substrate. Non-limiting examples of aminosilanes suitable for bonding with the MOF substrate for carbon capture include methoxysilanes, chlorosilanes, ethoxysilanes, as well as others described herein.

In some embodiments, the organic ligand is provided by a compound that is 1,4-di-(4-carboxy-2,6-dihydroxyphenyl)benzene. Within the MOF, this compound can provide a 2,2′,6,6′-tetrahydroxy-1,1′-triphenyl-4,4′-dicarboxylate (tetra-OH-TPDC) ligand. In some embodiments, this compound is employed with a metal source that includes Zn(NO₃)₂·6H₂O.

In some embodiments, the organic ligand is provided by a compound that is 2-hydroxyterephthalic acid (e.g., to provide a 2-hydroxy-BDC ligand), 2,5-dihydroxyterephthalic acid (e.g., to provide a 2,5-dihydroxy-BDC ligand), 2,3-dihydroxyterephthalic acid (e.g., to provide a 2,3-dihydroxy-BDC ligand), 2,6-dihydroxyterephthalic acid (e.g., to provide a 2,6-dihydroxy-BDC ligand), or a 2-boronobenzene-1,4-dicarboxylic acid (e.g., to provide a 2-borono-BDC ligand).

Any useful MOF can be employed. Non-limiting examples of MOF include, e.g., HCC-1 [Zn₄O(di-OH-TPDC)₃], HCC-2 [Zn₄O(tetra-OH-TPDC)₃], HKUST-1 [Cu₃(BTC)₂ or Cu₃(BTC)₃(H₂O)₃], IRMOF-1 or MOF-5 [Zn₄O(BDC)₃], IRMOF-3 [Zn₄O(NH₂-BDC)₃], IRMOF-10 [Zn₄O(BPDC)₃], IRMOF-16 [Zn₄O(TPDC)₃], MIL-47 [VO(BDC)], MIL-101-Cr [Cr₃O(BDC)₃(H₂O)₂F or Cr₃O(BDC)₃(H₂O)₃], MIL-101-Fe [Fe₃O(BDC)₃(H₂O)₂X or Fe₃O(BDC)₃X, where X is a monoanion, such as OH⁻ or Cl⁻], NH₂-MIL-101-Fe [Fe₃O(NH₂-BDC)₃(H₂O)₂X or Fe₃O(NH₂-BDC)₃X, where X is a monoanion, such as OH⁻ or Cl⁻], NH₂-MIL-101-Al [Al₃O(NH₂-BDC)₆X₃ or Al₃O(NH₂-BDC)₃(H₂O)₂X, where X is a monoanion, such as OH⁻ or Cl⁻], MIL-125 [Ti₈O₈(OH)₄ (BDC)₆], NH₂-MIL-125 [Ti₈O₈(OH)₄(NH₂-BDC)₆], MOF-2 [Zn₂(BDC)₂], MOF-74 [Zn₂(DHBDC)], MOF-808 [Zr₆O₄(μ₃-OH)₄(OH)₆(H₂O)₆(BTC)₂], NU-1000 [Zr₆(μ₃-O)₄(μ₃-OH)₄(OH)₄(H₂O)₄(TBAPy)₂], PCN-250 [Fe₃O(ABTC)₆ or (Fe₃O)₂(ABTC)₃ or (Fe₃O)₂(ABTC)₃—(OH)₂(H₂O)₄], PCN-777 [Zr₆O₄(μ₃-OH)₄(TATB)₂(OH)₆(H₂O)₆ or Zr₃O₄(OH)(TATB)(H₂O)₆], UiO-66 [Zr₆(O)₄(OH)₄(BDC)₁₂], UiO-66 [Zr₅O₄(OH)₄ (BDC)₆], UiO-66-DOBDC [Zr₆O₄(OH)₄(DOBC)₆], UiO-66-NH₂ [Zr₆O₄(OH)₄(NH₂-BDC)₆], UiO-66-OH [Zr₆O₄(OH)₄(OH-BDC)₆], or UiO-67 [Zr₆O₄(OH)₄(BPDC)₆]. Any of these may be modified to include one or more hydroxy groups or additional hydroxy groups (e.g., if a hydroxy group is already present). In some embodiments, the hydroxy group is provided on the organic ligand.

MOFs can be provided in any useful form, e.g., particles, crystals, powders, and the like. In some embodiments, the MOF particles include MIL-101-Fe, MIL-101-AI, MIL-125-Ti, PCN-250, UiO-66, or UiO-67. In some embodiments, the MOF particles can be water-stable MOF particles.

MOF substrates can be processed under a variety of synthetic conditions to yield different pore sizes and porosities. In some embodiments, the MOF substrate is a mesoporous or a macroporous MOF material. In general and without wishing to be bound by theory, higher pore opening size can facilitate increased surface area, increasing the number of exposed active sites on which post-synthetic modification can occur. Increased exposed active sites could facilitate higher concentrations of the adsorbing moiety on the MOF substrate, which in turn could enable higher CO₂ capture capacity.

The MOF substrate may include pores, which are openings that extend into the interior volume of the MOF substrate. The pores can increase the surface area of the MOF substrate. The dimensions of the pores vary, and can vary within an individual pore. Mesoporous and macroporous MOF materials can allow for a large volume of adsorbing moieties (e.g., amines moieties) to be incorporated into the porous matrix. In some embodiments, a mesoporous material includes pores having a greatest opening dimension (e.g., a diameter) in a range from 2 nanometers (nm) and 50 nm, and a macroporous material includes pores having a greatest opening dimension greater than 50 nm. For a MOF substrate, pore dimension, pore volume, and/or total surface area can be any described herein (e.g., a pore dimension from a range from 30 to 400 Å or greater than 90 Å; a pore volume from 0.5 to 5 mL/g; and/or a total surface area greater than 100 m²/g).

The MOF substrate can be functionalized to provide a functional portion having an adsorbing moiety. In some embodiments, the adsorbing moiety is an amine moiety (e.g., a primary, secondary, or tertiary amine group, as described herein). In some embodiments, the amine moieties bind to the surface of the MOF from which the hydroxy functional side groups extend. In this example, the interaction moiety can include any that reacts with hydroxy groups present on the surface of the MOF. Non-limiting interaction moieties can be, e.g., a silane moiety (e.g., any described herein). By forming interactions between the interaction moiety and the surface, amine bonding stability and/or lifetime of the sorbent could be improved. The functionalization methods herein can be applicable to all form factors of the MOF substrates.

In some embodiments, an aminosilane is provided to the surface of the MOF. In some embodiments, the aminosilane can include a silane moiety (e.g., a trimethoxysilane moiety, a triethoxysilane moiety, a dimethoxyethoxysilane moiety, a diethoxymethoxysilane moiety, and the like) and an amine moiety. In some embodiments, the aminosilane includes one, two, or three amine moieties (e.g., any described herein for R^{A}). In some embodiments, the aminosilane includes a structure having formula [R^{A}]₃SiX, wherein each R^{A} is, independently, an amine moiety comprising at least one amine group (e.g., any described herein) and X is a side group, a reactive group, or a leaving group (e.g., any described herein). In some embodiments, the aminosilane includes a structure having formula [R^{N1}R^{N2}N]₃SiX, wherein each of R^{N1} and R^{N2} is, independently, any described herein (e.g., optionally substituted aliphatic, alkyl, aromatic, or aryl); and X is a side group, a reactive group, or a leaving group (e.g., any described herein, such as halo, hydroxy, and the like). In some embodiments, the aminosilane is or includes tris(ethylmethylamino)chlorosilane. Other examples of aminosilanes include any described herein (e.g., an aminosilane including a structure having formula (1)).

In some embodiments, an aminosilane is provided to the surface of the MOF, wherein the aminosilane interacts with a hydroxy group present on an organic ligand within the MOF. In some embodiments, the organic ligand interacts with (e.g., binds to) the metal center within the MOF, and the hydroxy group is unbound from the metal center. In particular embodiments, the silane moiety of the aminosilane interacts with (e.g., binds to or/reacts with) the hydroxy group present on the organic ligand.

In some non-limiting embodiments, the substrate 102A, 102B, 102C is a MOF substrate, and the pores 104A-a,b, 104B-a,b, 104C-a,b, represent pores provide by the MOF structure. In some non-limiting embodiments, the substrate 102A, 102B, 102C is composed of crystalline, nanoporous MOF.

c. Resin

Ion-exchange resins generally possess a porous structure, which can provide a large surface area for the exchange of ionic compounds. To provide a functionalized resin, functional portion-containing compounds can be adsorbed within the pores and interact with reactive moieties present within such pores. Such interactions can include ionic bonding interactions, hydrogen bonding interactions, van der Waals force interactions, and the like. This process can be conducted with multiple types of ion-exchange resin having various types of reactive sites, such as polystyrene sulfonate (e.g., in which the sulfonic acid in the ion-exchange resin includes an acidic reactive site that forms ionic bonds with various amines through ionic bonding). In some embodiments, resin substrates are used as a porous structure for functionalization to achieve carbon capture. In particular embodiments, reactive sites present in the resin are employed during functionalization.

In some embodiments, the substrate comprises a resin (e.g., an ion-exchange resin). Any methods or compounds herein can be used to functionalize a resin substrate to provide a functionalized resin. For example and without limitation, a functionalized resin can feature amine moieties that are bound to acidic reactive sites present on the surface, thereby allowing for CO₂ uptake. The amine moiety can be provided by any compound described herein (e.g., a polyamine) for increased carbon capture (e.g., >1 mol CO₂/kg or from 1 to 3 mol CO₂/kg).

In some embodiments, the substrate comprises an ion-exchange resin (e.g., ion-exchange resin particles). In some embodiments, the ion-exchange resin is sufficiently cross-linked to retain porosity sufficient to facilitate gas diffusion and adsorption when dry.

In general, a resin substrate is a portion of an ion-exchange resin that can be sourced from standard industrial sources. Non-limiting types of ion-exchange resins include a “weak base” functionalized resin, an “acid” functionalized resin such as those with carboxylic or sulfonic acid groups, and a neutral resin with no chemical functionalization.

In these types, different molecular interactions can be used to retain the introduced amine moieties. In weak base resins, amine moieties are present in the resin and serve as reactive sites. In turn, these reactive sites can interact (e.g., by way of hydrogen bonding) to adsorbing moieties that are introduced during functionalization (e.g., by introducing a polyamine, a monoamine, an aminosilane, and the like). In acidic resins, acidic moieties are present as reactive sites in the resin. Introducing an amine (e.g., a polyamine, a monoamine, an aminosilane, etc.) to this resin can result in acid-base reactions, which can form ionic bonds between the reactive sites and the amine. In neutral resins, van der Waals forces and entrapment of larger amines within resin pores are the primary interactions. Without wishing to be limited by theory, ionic bonding interactions with an acidic resin can provide the highest bonding strength, relative to the other bonding modes; hydrogen bonding with a weak base rein has less strength than the ionic bonding; and van der Waals forces with neutral resins have the lowest bonding strength, relative to the other two bonding modes.

Ion-exchange resins are a class of porous polymers that includes polystyrene (e.g., optionally crosslinked with divinylbenzene), polyacrylate, polymethacrylate (e.g., optionally crosslinked with divinylbenzene), polyphenols/phenol-aldehyde resins (e.g., phenol-formaldehyde), melamine resins, agarose, cellulose, polyacrylamides, polycarbohydrates (e.g., dextrans), polyolefins, or similar resins and thermosets, as well as crosslinked forms of any of these or copolymers of any of these.

Resins can include ionizable, chelating, ionic, acidic, or basic functional groups, which can interact with ions. These functional groups may include but are not limited to carboxylic acids, phosphonic acids, sulfonic acids, sulfoalkyl acids, thiols, iminodiacetic acid, thiourea, aminophosphonic acids, pyridines, phenols, picolylamines, primary amines, secondary amines, tertiary amines, quaternary amines, and alcohol amines.

Any useful resin can be employed. Non-limiting examples of resin include a base-functionalized resin, an acid-functionalized resin, or a neutral resin including no chemical functionalization. In some embodiments, the acid-functionalized resin can include carboxylic and/or sulfonic acid groups. In some embodiments, the resin can be a porous polystyrene, polyacrylamide, or phenol-formaldehyde resin that retains its porosity when dry combined with a molecular alkyl amine. Non-limiting examples of porous ion-exchange resins include but are not limited to Purolite® A110 (polystyrenic macroporous, weak base anion resin, free base form, having a primary amine as a functional group), Purolite® A105 (polystyrenic macroporous, weak base anion resin, free base form, having a tertiary amine as a functional group), Purolite® C145H (polystyrenic macroporous, strong acid cation resin, hydrogen form, having sulfonic acid as a functional group), Purolite® C160H (polystyrenic macroporous, strong acid cation resin, hydrogen form, having sulfonic acid as a functional group), Purolite® Macronet™ MN502 (hyper-crosslinked polystyrenic macroporous, adsorbent resin, strong acid functionality, hydrogen form, having sulfonic acid as a functional group), Purolite® C104Plus (polyacrylic porous, weak acid cation resin, hydrogen form, having carboxylic acid as a functional group), PuroSorb™ PAD900 (polydivinylbenzene macroporous, adsorbent resin, non-ionic form), Amberlite® IRA-402 (strongly basic anion exchanger, Cl⁻ form, having quaternary ammonium as a functional group), or Dowex® 50W-X8 (strongly acidic cation exchanger, H⁺ form, having sulfonic acid as a functional group). Resins can be provided in any useful form, e.g., beads, granules, powders, membranes, fibers, particles, crystals, and the like.

Resins can be sufficiently porous to facilitate diffusion of gaseous ions into and out of the polymeric matrices. Some resins are highly crosslinked and rigid and retain porosity in a dry state (e.g., a hydration of <15% (wt/wt) of water). The term “(wt/wt)” is in reference to a ratio of the weight (wt) of a first component to the weight of a second component. For example, 1 g of a first substance and 10 g of a second substance defines a 10% (wt/wt) ratio of the first substance to the second substance.

In some embodiments, the resin substrate is porous in the dry state. Without wishing to be limited by mechanism, such substrates can facilitate diffusion of gas containing CO₂ into the polymeric matrix for CO₂ capture. Ion-exchange resins can be polymerized under a variety of synthetic conditions to yield different pore sizes and porosities. Larger meso- and macro-pores can allow for a large volume of adsorbing groups to be incorporated into the porous matrices. In some embodiments, a mesoporous resin includes pores having a greatest opening dimension (e.g., diameter) in a range from 2 to 50 nm; and a macroporous resin includes pores having a greatest opening dimension greater than 50 nm.

In general and without wishing to be bound by theory, proper pore size (e.g., as in a sorbent with pores in any range herein) can be characterized by high surface areas, pore volumes, and channels for gas diffusion that allows for a stable coating or surface functionalization layer, relatively higher concentrations of adsorbing moieties (e.g., active amines), and/or fast gas kinetics. This, in turn, could enable higher CO₂ capture capacity. In some embodiments, higher porosity can reduce the adsorption process energy cost for a fluidization process.

The resin substrate may include pores, which are openings that extend into the interior volume of the resin substrate. The pores can increase the surface area of the resin substrate. For a resin substrate, pore dimension, pore volume, and/or total surface area can be any described herein (e.g., a pore dimension greater than 90 Å or in a range from 60 to 400 Å or 1 to 200 nm; an average pore size in a range from 30 to 80 nm; a pore volume greater than 0.5 mL/g or in a range from 0.1 to 5 mL/g, 0.1 to 4 mL/g, or 0.1 to 1.5 mL/g; and/or a total surface area greater than 100 m²/g, greater than 1200 m²/g, or in a range from a range from 100 to 1200 m²/g).

The resin substrate can be functionalized to provide a functional portion having an adsorbing moiety. In some embodiments, the adsorbing moiety is an amine moiety (e.g., a primary, secondary, or tertiary amine group, as described herein). In some embodiments, the amine moieties bind to the reactive sites of the resin. In this example, the interaction moiety can include any that reacts with reactive sites present on the surface of the resin. Non-limiting interaction moieties can be, e.g., an amine moiety (e.g., any described herein). In some implementations, the resin includes a first amine moiety, and the reaction introduces a second amine moiety bonded to the first. By forming interactions between the interaction moiety and the surface, amine bonding stability and/or lifetime of the sorbent could be improved. The functionalization methods herein can be applicable to all form factors of the ion-exchange resins.

ii. Functional Portion

The functional portion can include any combination of moieties, groups, or compounds to facilitate adsorption of desired gases by the sorbent. In some embodiments, the functional portion includes an adsorbing moiety and an interaction moiety. Whereas the adsorbing moiety is configured to adsorb a desired gas, the interaction moiety is configured to attach (directly or indirectly) the adsorbing moiety to a surface of the substrate. Optionally, the interaction moiety can be further configured to stabilize the functional portion, such as by forming bonds with the adsorbing moiety and/or the surface of the substrate. In another optional embodiment, the interaction moiety can be further configured to provide additional adsorbing moiety to enhance adsorption of the sorbent. The functional portion can include any useful combination of one or more adsorbing moieties (e.g., one or more amine moieties) with one or more interaction moieties (e.g., one or more silane moieties). In some embodiments, when a plurality of amine moieties are present (e.g., when a first amine moiety and a second amine moiety are present), such moieties can react with or bind to carbon dioxide.

As seen in FIGS. 1A-1C, a surface 103A-C of the substrate 102A-C can be functionalized to provide a functional portion 106A-C. In some embodiments (e.g., as in FIG. 1A), the functional portion 106A includes an interaction moiety 108A bonded to an adsorbing moiety 110A. In some embodiments (e.g., as in FIG. 1B), the functional portion 106B includes an interaction moiety 108B bonded to a first adsorbing moiety 110B and includes a second adsorbing moiety 112B associated with the interaction moiety 108B and/or the first adsorbing moiety 110B. In some embodiments (e.g., as in FIG. 1C), the functional portion 106C includes an adsorbing moiety.

The functional portion can include an adsorbing moiety. In some embodiments, the adsorbing moiety can include one, two, three, or more amine moieties (e.g., any described herein). In some implementations, the amine moiety can include one or more of the following: a primary amine (e.g., —NH₂), a secondary amine (e.g., —NHR^{N1}, in which R^{N1} can be any described herein that is not hydrogen), a tertiary amine (e.g., —NR^{N1}R^{N2}, in which each of R^{N1} and R^{N}₂ can be any described herein that is not hydrogen), an aminoalkyl group (e.g., -Ak-NR^{N1}R^{N2}), a terminal amine group (e.g., —NR^{N1}R^{N2}), an internal amine group (e.g., —NR^{N3}—, such as —NH—), a linked group (e.g., —N(-L¹-NR^{N1}R^{N2})—; —N(-L²-NR^{N3}-L¹-NR^{N1}R^{N2})—; —N[-L²-N(-L¹-NR^{N1}R^{N2})₂]—; -L¹-NR^{N1}R^{N2}; —NR^{N3}-L¹-NR^{N1}R^{N2}; -L²-NR^{N3}-L¹-NR^{N1}R^{N2}; —NR^{N4}-L²-NR^{N3}-L¹-NR^{N1}R^{N2}; or —NR^{N2}) an aminoalkylamino group (e.g., —NR^{N3}-Ak-NR^{N1}R^{N2}), an aminoalkylaminoalkyl group (e.g., -Ak-NR^{N3}-Ak-NR^{N1}R^{N2} or -Ak-N(-Ak-NR^{N1}R^{N2})₂), a linked group including amino and silane groups (e.g., -L¹-SiR^{S1}R^{S2}—NR^{N1}R^{N2}, -L²-SiR^{S1}R^{S2}-L¹-NR^{N1}R^{N2}, and -L³-SiR^{S1}R^{S2}-L²-NR^{N3}-L¹-NR^{N1}R^{N2}), a nitrogen-containing heterocyclyl (e.g., optionally substituted piperazinyl, such as unsubstituted piperazinyl or piperazinyl substituted with optionally substituted alkyl, aminoalkyl, hydroxyalkyl, amino, etc.), and the like.

In other embodiments, the adsorbing moiety can include one or more R^{A} moieties described herein. In some embodiments, R^{A} is or includes —NH—, —NR^{N1}—, —N(-L¹-NR^{N1}R^{N2})—, —N(-L²-NR^{N3}-L¹-NR^{N1}R^{N2})—, —N[-L²-N(-L¹-NR^{N1}R^{N2})₂]—, —NH₂, —NR^{N1}R^{N2}-L¹-NR^{N1}R^{N2}, —NR^{N3}-L¹-NR^{N1}R^{N2}, -L²-NR^{N3}-L¹-NR^{N1}R^{N2}, or —NR^{N4}-L²-NR^{N3}-L¹-NR^{N1}R^{N2}.

The amine moiety includes any combination of linkers and R^{A} moieties. In some implementations, the amine moiety include one or more of the following: -L¹-[R^{A1}-L²]ₙ₁-R^{A2}; —NR^{N1}-[L¹-NR^{N2}]ₙ₁-L²-NR^{N3}R^{N4}; —NH-[L-NH]ₙ—H; —N[L-NH₂]₂; —NH[CH₂CH₂NH]ₙH; —[CH₂CH₂NH]ₙR^{N1}; —[CH₂CH₂NH]ₙ—; —[CH₂CH₂NR^{A}]ₙR^{N1}; —[CH₂CH₂NR^{A}]ₙ—; and the like.

In some non-limiting embodiments for any amine moiety herein, each of R^{A}, R^{A1}, or R^{A2} is or includes any described herein for R^{A}; each of R^{N1} and R^{N2} can be any described herein; each of R^{N3}, R^{N4}, and R^{N5} can be any described herein for R^{N1} and R^{N2}; each of R^{S1} and R^{S2} can be any described herein; each of L, L¹, L², or L³ is independently a linker; each Ak is independently optionally substituted alkylene; and each of n and n1 is independently an integer (e.g., an integer of 1 or more, such as from 1-25000, 1-24000, 1-23000, 1-22000, 1-21000, 1-20000, 1-19000, 1-18000, 1-17000, 1-16000, 1-15000, 1-14000, 1-13000, 1-12000, 1-11000, 1-10000, 1-7500, 1-5000, 1-4000, 1-3000, 1-2000, 1-1000, 1-500, 1-100, 1-50, 1-20, 1-10, 1-5, 2-25000, 2-24000, 2-23000, 2-22000, 2-21000, 2-20000, 2-19000, 2-18000, 2-17000, 2-16000, 2-15000, 2-14000, 2-13000, 2-12000, 2-11000, 2-10000, 2-7500, 2-5000, 2-4000, 2-3000, 2-2000, 2-1000, 2-500, 2-100, 2-50, 2-20, 2-10, 2-5, 5-25000, 5-24000, 5-23000, 5-22000, 5-21000, 5-20000, 5-19000, 5-18000, 5-17000, 5-16000, 5-15000, 5-14000, 5-13000, 5-12000, 5-11000, 5-10000, 5-7500, 5-5000, 5-4000, 5-3000, 5-2000, 5-1000, 5-500, 5-100, 5-50, 5-20, 5-10, as well as ranges therebetween).

In some embodiments, R^{A}, R^{A1}, or R^{A2} is or includes —NH—, —NR^{N1}—, —N(-L¹-NR^{N1}R^{N2})—, —N(-L²-NR^{N3}-L¹-NR^{N1}R^{N2})—, —N[-L²-N(-L¹-NR^{N1}R^{N2})₂]—, —NH₂, —NR^{N1}R^{N2}-L¹-NR^{N1}R^{N2}, —NR^{N3}-L¹-NR^{N1}R^{N2}, -L²-NR^{N3}-L¹-NR^{N1}R^{N2}, or —NR^{N4}-L²-NR^{N3}-L¹-NR^{N1}R^{N2}.

In some embodiments, each of R^{N1}, R^{N2}, R^{N3}, R^{N4}, and R^{N5} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl. In some embodiments, each of R^{N1}, R^{N2}, R^{N3}, R^{N4}, R^{N5}, and R is, independently, H, optionally substituted aliphatic, optionally substituted heteroaliphatic, optionally substituted aromatic, or optionally substituted heteroaromatic.

In some embodiments, each of R^{S1} and R^{S2} is, independently, a side group (e.g., any described herein), a leaving group (e.g., halo, acyl, acyloxy, and the like), a reactive group (e.g., hydroxy, halo, alkoxy, and the like), hydrogen (H), optionally substituted alkyl, optionally substituted heteroalkyl, optionally substituted aryl, optionally substituted amine, or an R^{A} moiety (e.g., any described herein); or R^{S1} and R^{S2}, taken together with the silicon atom to which each are attached, form a heterocyclyl group. In some embodiments, each of R^{S1} and R^{S2} is independently hydrogen (H), optionally substituted aliphatic, optionally substituted heteroaliphatic, optionally substituted aromatic, or optionally substituted heteroaromatic.

In some embodiments, the linker includes, e.g., a covalent bond, an atom (e.g., carbonyl, oxy, thio, imino, and the like), optionally substituted alkylene, optionally substituted heteroalkylene, optionally substituted arylene, or optionally substituted heteroarylene.

The functional portion can include an interaction moiety. In some embodiments, the interaction moiety can include one, two, three, or more silane moieties (e.g., any described herein). In some embodiments, the interaction moiety comprises one or more Si—O bonds.

In some implementations, the silane moiety includes an alkoxysilane group (e.g., —Si(OAk)_{d}(X)_{3-d} or —Si(OAk)_{d1}(X)_{2-d1}— or —Si(OAk)_{d}(X)_{2-d}R^{A}); a trialkoxysilane group (e.g., —SiR^{S1}R^{S2}R^{S3}, in which each of R^{S1}, R^{S2}, and R^{S3} is, independently, alkoxy; such as trimethoxysilane or triethoxysilane); a dialkoxysilane group (e.g., e.g., —SiR^{S1}R^{S2}R^{S3} or —SiR^{S1}R^{S2}—, in which each of R^{S1} and R^{S2} is, independently, alkoxy, and a R³ is a side group, a leaving group, a reactive group, or any described herein); a monoalkoxysilane group (e.g., —SiR^{S1}R^{S2}R^{S3} or —SiR^{S1}R^{S2}—, in which R^{S1} is alkoxy, and each of R^{S2} and R^{S3} is independently a side group, a leaving group, a reactive group, or any described herein); a dialkoxysilanol group (e.g., —Si(OR)₂OH, in which each R is independently alkyl); a monoalkoxysilanol group (e.g., —Si(OR)(R^{S1})OH, in which each R is independently alkyl and R^{S1} is a side group, a leaving group, a reactive group, or any described herein); a hydrosilane group (e.g., —SiH₃ or —SiH₂—); a monoalkylsilane group (e.g., —SiR^{S1}R^{S2}R^{S3} or —SiR^{S1}R^{S2}—, in which R^{S1} is alkyl, and each of R^{S2} and R^{S3} is independently a side group, a leaving group, a reactive group, or any described herein; in which non-limiting examples of monoalkylsilane is alkyldialkoxysilane or alkyldihalosilane); a dialkylsilane group (e.g., —SiR^{S1}R^{S2}R^{S3} or —SiR^{S1}R^{S2}—, in which each of R^{S1} and R^{S2} is independently alkyl, and R^{S3} is a side group, a leaving group, a reactive group, or any described herein; in which non-limiting examples of dialkylsilane includes dialkylalkoxysilane or dialkylhalosilane); a trihalosilane group (e.g., —SiZ₃, in which each Z is independently halo, such as trichlorosilane); a dihalosilane group (e.g., —SiZ₂R^{S1}, in which each Z is independently halo and each of R^{S1} is a side group, a leaving group, a reactive group, or any described herein); a monohalosilane group (e.g., —SiZR^{S1}R^{S2}, in which Z is halo and each of R^{S1} and R^{S2} is independently a side group, a leaving group, a reactive group, or any described herein); a silanetriol group (e.g., —Si(OH)₃); or a hydroxysilane group (e.g., —Si(OH)R^{S1}—, —Si(OH)₂—, or —Si(OH)₃).

In some non-limiting embodiments for any silane moiety herein, Ak is optionally substituted aliphatic, alkyl, or alkylene; each X is, independently, a side group, a reactive group, or a leaving group, as any described herein; d is an integer of 1, 2, or 3; and d1 is an integer of 1 or 2. In some embodiments, each of R^{S1}, R^{S2} and R^{S3} is, independently, a side group (e.g., any described herein), a leaving group (e.g., halo, acyl, acyloxy, and the like), a reactive group (e.g., hydroxy, halo, alkoxy, and the like), hydrogen (H), optionally substituted alkyl, optionally substituted heteroalkyl, optionally substituted aryl, optionally substituted amine, or an R^{A} moiety (e.g., any described herein); or R^{S1} and R^{S2}, taken together with the silicon atom to which each are attached, form a heterocyclyl group. In some embodiments, each of R^{S1} and R^{S2} is independently hydrogen (H), optionally substituted aliphatic, optionally substituted heteroaliphatic, optionally substituted aromatic, or optionally substituted heteroaromatic.

Any useful combination of moieties may be present. For example, the functional portion can include a combination of one or more adsorbing moieties, a combination of one or more interaction moieties, a combination of an adsorbing moiety with an interaction moiety, and a combination of one or more adsorbing moieties with one or more interaction moieties.

The functional portion can be provided in any useful manner. For example, a compound having both the adsorbing moiety and the interaction moiety can be provided to a substrate. A non-limiting example of such a compound can include an aminosilane comprising an amino moiety (e.g., as the adsorbing moiety) and a silane moiety (e.g., as the interaction moiety). In some embodiments, the compound provides a long-chain multi-amine containing moiety. In some embodiments, the compound provides a silane moiety, which is chemically bonded to a surface of each of the particles (e.g., porous silica particles) serving as the substrate.

In another example, a plurality of compounds can be used to provide the one or more adsorbing moieties and one or more interaction moieties. For instance, a first compound can include both an adsorbing moiety and an interaction moiety, and a second compound can include one or more adsorbing moieties. A non-limiting example includes a first compound that is an aminosilane comprising an amino moiety (e.g., as the adsorbing moiety) and a silane moiety (e.g., as the interaction moiety), which can be used in combination with a second compound that is a polyamine comprising a plurality of amino moieties (e.g., as the adsorbing moieties). In some embodiments, the first compound is attached to a surface of the substrate (e.g., by way of one or more covalent bonds or non-covalent bonds), and the second compound may or may not be attached to the substrate. In some embodiments, the second compound may interact with the first compound (or a portion thereof). In some embodiments, the second compound may interact with the first compound (or a portion thereof) and with a surface of the substrate. Such attachments and interactions can include covalent and/or non-covalent bonding interactions. Non-covalent bonding interactions include, without limitation, hydrogen bonding, ionic interactions, halogen bonding, electrostatic interactions, η bond interactions, hydrophobic interactions, inclusion complexes, clathration, van der Waals interactions, and combinations thereof.

Upon providing one or more compounds to a substrate, reactions can occur to provide covalent and/or non-covalent bonding interactions, thereby providing a functional portion disposed on a surface of the substrate. Non-limiting examples of compounds for providing a functional portion include amines, aminosilanes, polymers, polyamines, as well as others described herein.

a. Aminosilanes

In some embodiments, the compound is an aminosilane. For example and without limitation, a surface of a substrate (e.g., a silica substrate) is functionalized with an aminosilane compound including a silane moiety bonded to an amine moiety. In turn, the surface can include a functional group having the silane moiety and the amine moiety. As used herein, such moieties also include reacted forms of these moieties (e.g., a reacted form of a silane moiety upon reacting with a surface of the substrate) that may be present upon forming one or more bonds, as would be understood by a skilled artisan.

The aminosilane can include at least one silane moiety (e.g., one, two, three, or more silane moieties) and at least one amine moiety (e.g., one, two, three, or more amine moieties). Non-limiting examples of aminosilane compounds, silane moieties, and amine moieties can be any described herein.

The aminosilane compound can include one, two, three, or more silane moieties. In some implementations, the silane moiety can include a trialkoxysilane (e.g., —SiR^{S1}R^{S2}R^{S3}, in which each of R^{S1}, R^{S2}, and R^{S3} is, independently, alkoxy; such as trimethoxysilane or triethoxysilane), a dialkoxysilane (e.g., —SiR^{S1}R^{S2}R^{S3}, in which each of R^{S1} and R^{S2} is, independently, alkoxy, and R^{S3} is a leaving group or a reactive group, such as any described herein), a dialkoxysilanol group (e.g., —Si(OR)₂OH, in which each R is independently alkyl), a hydrosilane group (e.g., —SiH₃), a monoalkylsilane group (e.g., —SiR^{S1}R^{S2}R^{S3}, in which R^{S1} is alkyl, and each of R^{S2} and R^{S3} is independently a leaving group or a reactive group, such as any described herein; in which non-limiting examples of monoalkylsilane is alkyldialkoxysilane or alkyldihalosilane), a dialkylsilane group (e.g., —SiR^{S1}R^{S2}R^{S3}, in which each of R^{S1} and R^{S2} is independently alkyl, and R^{S3} is a reactive group or a leaving group, such as any described herein; in which non-limiting examples of dialkylsilane includes dialkylalkoxysilane or dialkylhalosilane), a trihalosilane group (e.g., —SiZ₃, in which each Z is independently halo, such as trichlorosilane), or a silanetriol (e.g., —Si(OH)₃). Higher numbers (e.g., three or more) of silane moieties in the aminosilane compound can increase the covalent bond stability with the substrate as higher numbers of siloxane bonds between the silane moieties and the substrate surface can increase. Additionally, a silane group can form up to three siloxane bonds (Si—O—Si) to the surface, which may increase stability. The number of siloxane bonds that can be formed by silane moiety depends on the composition of the side groups (e.g., one or more of X¹, X², and/or X³) capable of forming siloxane bonds (e.g., —OMe, —OEt, —Cl, —OH, or a combination of any of these).

The aminosilane compound can include one, two, three, or more amine moieties. In some implementations, the amine moiety can include a primary amine (e.g., —NH₂), a secondary amine (e.g., —NHR^{N1}, in which R^{N1} can be any described herein that is not hydrogen), a tertiary amine (e.g., —NR^{N1}R^{N2}, in which each of R^{N1} and R^{N}₂ can be any described herein that is not hydrogen), or an aminoalkyl group (e.g., -Ak-NR^{N1}R^{N2}, in which Ak is optionally substituted alkylene and each of R^{N1} and R^{N2} can be any described herein). In some embodiments, each of R^{N1} and R^{N2} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl. In some embodiments, each of R^{N1}, R^{N2}, and R is, independently, H, optionally substituted aliphatic, optionally substituted heteroaliphatic, optionally substituted aromatic, or optionally substituted heteroaromatic.

In some implementations, the amine moiety includes more than one amine groups connected through various linkers (e.g., any described herein for L). For instance, the amine moiety can include a terminal amine group (e.g., —NR^{N1}R^{N2}), one or more internal amine groups (e.g., —NR^{N3}—), and a linker (e.g., -L-) disposed between the terminal and internal amine groups. Non-limiting examples of amine moieties can include an aminoalkylamino group (e.g., —NR^{N3}-Ak-NR^{N1}R^{N2}, in which Ak is optionally substituted alkylene and each of R^{N1}, R^{N2}, and R^{N3} can be any described herein) or an aminoalkylaminoalkyl group (e.g., -Ak-NR^{N3}-Ak-NR^{N1}R^{N2}, in which each Ak is independently optionally substituted alkylene and each of R^{N1}, R^{N2}, and R^{N3} can be any described herein). In some embodiments, each of R^{N1}, R^{N}₂, and R^{N3} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl. In some embodiments, each of R^{N1}, R^{N2}, R^{N3}, and R is, independently, H, optionally substituted aliphatic, optionally substituted heteroaliphatic, optionally substituted aromatic, or optionally substituted heteroaromatic.

Higher numbers (e.g., three or more) of amine moieties in the aminosilane compound can increase the adsorption ability of a sorbent. In some embodiments, amine moieties may interact with other moieties and groups to stabilize stability of the functional group.

In some embodiments, an amine moiety (e.g., which can be amine groups) of one aminosilane can interact with a neighboring aminosilane (e.g., with silane moieties or side groups within a silane moiety of the neighboring aminosilane). Alternatively, an amine moiety of one aminosilane may not interact with a neighboring aminosilane (e.g., may not interact with silane moieties or side groups within a silane moiety of the neighboring aminosilane). In yet another embodiment, an amine moiety of one aminosilane may interact with other groups, moieties, or compounds (e.g., present in another compound, such as a polyamine or another type of aminosilane). In some embodiments, an amine moiety (e.g., which can be an amine group) of aminosilane can interact with a polyamine (e.g., an amine moiety of a polyamine).

The aminosilane compound can have any useful structure. In one non-limiting example, the aminosilane includes a structure having formula (1):

[R^{A}]ₐSi[X]₄₋ₐ (1),

wherein each R^{A} is, independently, an amine moiety comprising at least one amine group; each X is, independently, a side group, a reactive group, or a leaving group; and a is an integer from 1 to 4.

The amine moiety (e.g., R^{A}) can include one or more amine groups. In one instance, the amine group can be —NR^{N1}R^{N2} or —NR^{N1}—, in which each of R^{N1} and R^{N2} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl). In some embodiments, each of R^{N1}, R^{N2}, and R is, independently, H, optionally substituted aliphatic, optionally substituted heteroaliphatic, optionally substituted aromatic, or optionally substituted heteroaromatic.

In some embodiments, the amine moiety (e.g., R^{A}) includes one, two, three, or more amine groups. In other embodiments, the amine moiety includes a terminal amine group (e.g., as —NR^{N1}R^{N1}) and/or an internal amine group (e.g., as —NR^{N1}—).

Non-limiting examples of amine moieties (e.g., R^{A}) include —NR^{N1}R^{N2}, -L-NR^{N1}R^{N2}, —NR^{N3}-L-NR^{N1}R^{N2}, -L²-NR^{N3}-L¹-NR^{N1}R^{N2}, -L³-NR^{N4}-L²-NR^{N3}-L¹-NR^{N2}, -L²-SiR^{S1}R^{S2}-L¹-NR^{N1}R^{N2}, and -L³-SiR^{S1}R^{S2}-L²-NR^{N3}-L¹-NR^{N1}R^{N2}, in which each of R^{N1}, R^{N2}, R^{S1}, and R^{S2} can be any described herein; in which each of R^{N3} and R^{N4} can be any described herein for R^{N1} and R^{N2}; and in which each L, L¹, L², or L³ is independently a linker. Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some non-limiting embodiments, each of R^{N1}, R^{N2}, R^{N3}, R^{N4}, R^{S1}, and R^{S2} is, independently, H, optionally substituted aliphatic, or optionally substituted alkyl. Other examples of R^{N1}, R^{N2}, and R^{N3} are described herein.

The aminosilane can include a reactive group, a leaving group, or another group (e.g., X). Non-limiting examples of such groups include H, halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), or optionally substituted alkanoyloxy. In some embodiments, X is, independently, H, optionally substituted aliphatic, optionally substituted heteroaliphatic, optionally substituted aromatic, or optionally substituted heteroaromatic.

In one non-limiting example, the aminosilane includes a structure having formula (Ia):

R^{A1}SiX¹X²X³ (Ia),

wherein R^{A1} is an amine moiety comprising at least one amine group; and each of X¹, X², and X³ is, independently, a side group, a reactive group, or a leaving group. Each of R^{A1}, X¹, X², and X³ can be any described herein for R^{A} and X, respectively.

In another non-limiting example, the aminosilane includes a structure having formula (Ib)-(Ie):

R^{A1}-L¹-SiX¹X²X³ (Ib),

R^{N1}R^{N2}N-L¹-SiX¹X²X³₃ (Ic),

R^{A1}-L¹-R^{A2}-L²-SiX¹X²X³ (Id), or

R^{N1}R^{N2}N-L¹-N(R^{N3})-L²-SiX¹X²X³ (Ie),

wherein each R^{A1} or R^{A2} is, independently, an amine moiety comprising at least one amine group; each of R^{N1}, R^{N2}, and R^{N3} can be any described herein; each of X¹, X², and X³ is, independently, a side group, a reactive group, or a leaving group; and each of L¹ and L² is a linker. Each of R^{A1}, R^{A2}, X¹, X², X³, L¹, and L² can be any described herein for R^{A}, X, and L, respectively. In some embodiments, each of X¹, X², and X³ is, independently, H, halo, optionally substituted alkyl (e.g., optionally substituted C₁₋₃ alkyl), or optionally substituted alkoxy (e.g., optionally substituted C₁₋₃ alkoxy). In other embodiments, each of X¹, X², and X³ is, independently, optionally substituted alkoxy (e.g., optionally substituted C₁₋₃ alkoxy). In yet other embodiments, L is optionally substituted alkylene (e.g., optionally substituted C₁₋₁₂, C₁₋₁₀, C₁₋₈, or C₁₋₆ alkylene).

In yet another non-limiting example, the aminosilane includes a structure having formula (If):

R^{A1}R^{A2}R^{A3}SiX¹ (If),

wherein each R^{A1}, R^{A2}, or R^{A3} is, independently, an amine moiety comprising at least one amine group; and X¹ is a side group, a reactive group, or a leaving group. Each of R^{A1}, R^{A2}, R^{A3}, and X¹ can be any described herein for R^{A} and X, respectively.

In some examples, the aminosilane includes a structure of formula (II):

[R^{B}]_{b}N[Y]_{3-b} (II),

wherein each R^{B} is, independently, a silane moiety comprising at least one silane group; each Y is, independently, H, optionally substituted alkyl, or optionally substituted aryl; and b is an integer from 1 to 3. In some embodiments, each Y is, independently, H, optionally substituted aliphatic, optionally substituted heteroaliphatic, optionally substituted aromatic, or optionally substituted heteroaromatic.

The silane moiety (e.g., R^{B}) can include one or more silane groups. In one instance, the silane group can be —SiR^{S1}R^{S2}R^{S3} or —SiR^{S1}R^{S2}—, in which each of R^{S1}, R^{S2}, and R^{S3} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSi^{R3}, in which each R is independently an optionally substituted alkyl), or trialkoxylsilyloxy (e.g., —OSi[OR]₃, in which each R is independently an optionally substituted alkyl). In some embodiments, each of R^{S1}, R^{S2}, R^{S3}, and R is, independently, H, optionally substituted aliphatic, optionally substituted heteroaliphatic, optionally substituted aromatic, or optionally substituted heteroaromatic.

In some embodiments, the silane moiety (e.g., R^{B}) includes one, two, three, or more silane groups. In other embodiments, the silane moiety includes a terminal silane group (e.g., as —SiR^{S1}R^{S2}R^{S3}) and an internal silane group (e.g., as —SiR^{S1}R^{S2}—).

Non-limiting examples of silane moieties (e.g., RB) include —SiR^{S1}R^{S2}R^{S3}, —Si(OR^{S1})(R^{S2})(R^{S3}), —Si(OR^{S1})(OR^{S2})(R^{S3}), —Si(OR^{S1})(OR^{S2})(OR^{S3}), -L-SiR^{S1}R^{S2}R^{S3}, -L-Si(OR^{S1})(R^{S2})(R^{S3}), -L-Si(OR^{S1})(OR^{S2})(R^{S3}), -L-Si(OR^{S1})(OR^{S2})(OR^{S3}), —SiR^{S4}R^{S5}-L-SiR^{S1}R^{S2}R^{S3}, and —SiR^{S1}R^{S2}—NR^{N1}R^{N2}, in which each of R^{S1}, R^{S2}, R^{S3}, R^{N1} and R^{N2} can be any described herein; in which each of R^{S4} and R^{S5} can be any described herein for R^{S1}, R^{S2}, and R^{S3}; and in which L is a linker. Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some non-limiting embodiments, each of R^{S1}, R^{S2}, R^{S3}, R^{S4}, R^{S5}, R^{N1} and R^{N2} is, independently, H, optionally substituted aliphatic, or optionally substituted alkyl.

In one non-limiting example, the aminosilane includes a structure having formula (IIa):

R^{B1}NY¹Y² (IIa),

wherein R^{B1} is a silane moiety comprising at least one silane group; and each of Y¹ and Y² is any described herein for Y (e.g., a side group, a reactive group, or a leaving group). R^{B1} can be any described herein for R^{B}.

In another non-limiting example, the aminosilane includes a structure having formula (IIb)-(IId):

R^{B1}R^{B2}NY¹ (IIb),

[R^{S1}R^{S2}R^{S3}Si-L¹-]NY¹Y² (IIc), or

[R^{S1}R^{S2}R^{S3}Si-L¹-]NY¹[-L²-SiR^{S1}R^{S2}R^{S3}] (IId),

wherein each R^{B1} or R^{B2} is, independently, a silane moiety comprising at least one silane group; each of Y¹ and Y² is, independently, a side group, a reactive group, or a leaving group; each of R^{S1}, R^{S2}, and R^{S3} can be any described herein; and each of L¹ and L² is a linker. Each of R^{B1}, R^{B2}, Y¹, Y², L¹, and L² can be any described herein for R^{B}, Y, and L, respectively.

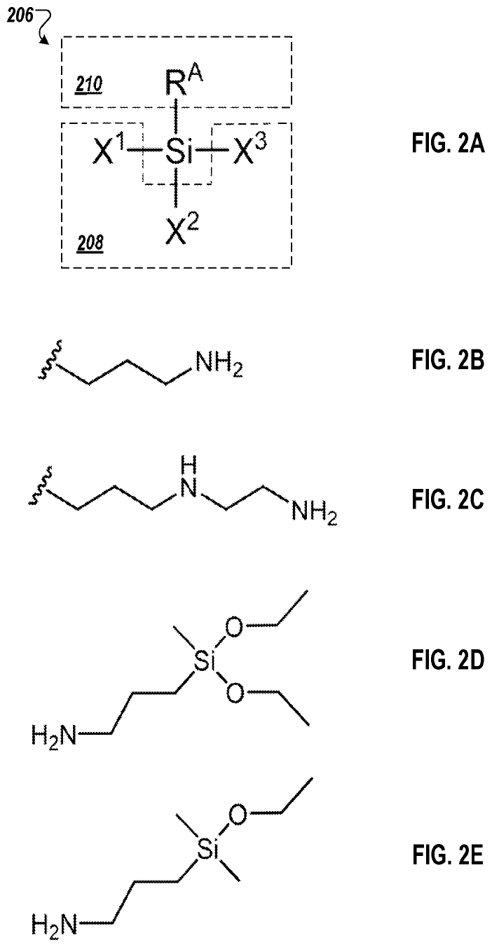

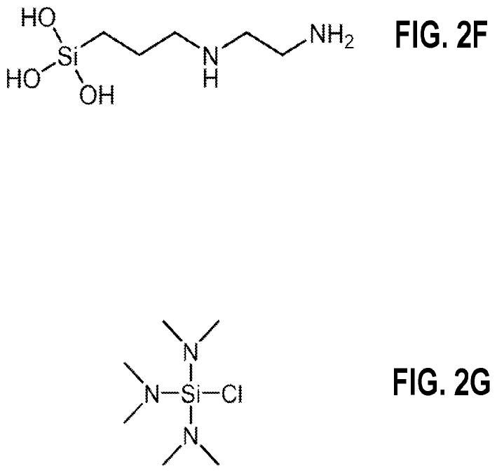

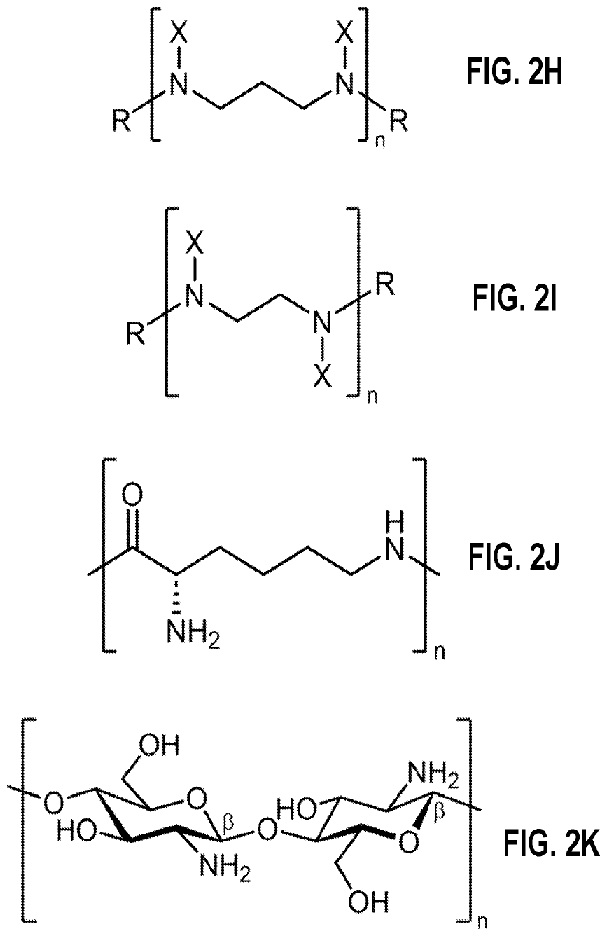

FIG. 2A depicts an example of an aminosilane 206 having an amine moiety 210 (denoted as R^{A}) and a non-limiting silane moiety 208 having three potential interaction sites or side groups (denoted as X¹, X², and X³). Side groups X¹-X³ are occupied by functional groups which include, but are not limited to, a methoxy group (—OMe), an ethoxy group (—OEt), a chloro (—Cl), a hydroxy group (—OH), a hydrogen (—H), or an alkyl group (e.g., a linear alkyl group such as —(CH₂)ₙ(CH₃), in which n is an integer from 0-10; or a branched alkyl group). Yet other examples of functional groups can include any reactive or leaving group described herein. Non-limiting examples of functional groups for X can include halo, as well as optionally substituted aliphatic, alkyl, alkoxy, alkanoyloxy, heteroaliphatic, heteroalkyl, aromatic, aryl, aryloxy, and the like.

In some embodiments, the amine moieties 210 (e.g., which can be amine groups) of one aminosilane can interact with one or more of the side groups 208 of a neighboring aminosilane. Alternatively, amine moieties 210 may not interact with other side groups. In yet another embodiment, the amine moieties 201 may interact with other groups, moieties, or compounds (e.g., present in another compound, such as a polyamine or another type of aminosilane). In some embodiments, the amine moieties 210 (e.g., which can be amine groups) of aminosilane 208 can interact with a polyamine.

Optionally, a further linker can be present between the amine moiety and the silane moiety of the aminosilane compound. For example, a linker can be present between the amine moiety 210 and the silane moiety 208. In some embodiments, an aminosilane can include R^{A}-L-SiX¹X²X³, in which R^{A} is an amine moiety (e.g., any described herein), L is a linker (e.g., any described herein), and each of X¹, X², and X³ is a side group, a reactive group, or a leaving group (e.g., any described herein).

An aminosilane 206 can have any combination of these functional groups, e.g., amine moiety 210 and side groups 208 (e.g., which can include side group X¹, side group X², or side group X³), and must have at least one amine moiety 210 and at least one side group 208 (e.g., —OMe, —OEt, —Cl, —OH, —H, alkyl, or others described herein) capable of forming a siloxane bond (e.g., an Si—O or Si—O—Si linkage). FIG. 2B is a non-limiting example of a 3-aminopropyl group which, in some examples, serves as one or more side groups 208 (e.g., one or more of X¹, X², and X³) or amine moiety 210. FIG. 2C is an example of an N-(2-aminoethyl)-3-aminopropyl group which, in some examples, serves as one or more amine moieties 210.

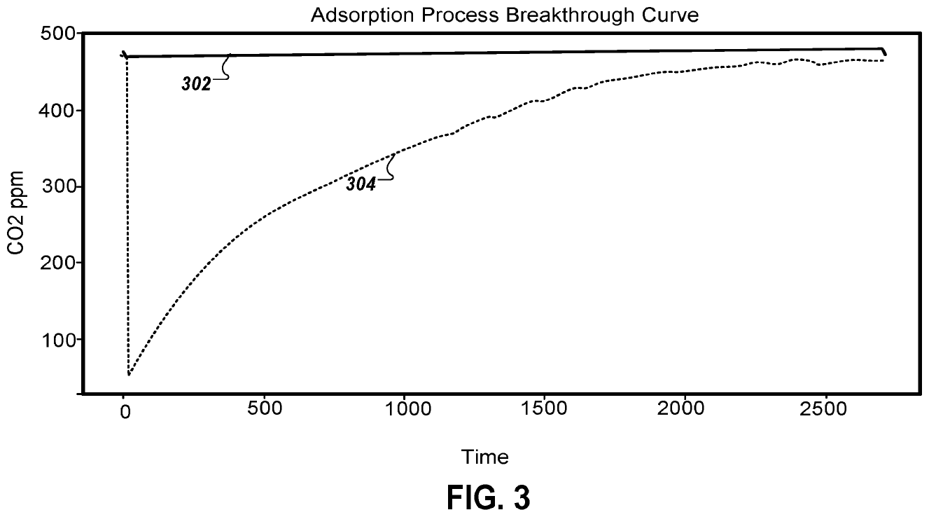

As non-limiting examples, FIGS. 2D-2G indicate examples of aminosilanes having side groups and amine moieties. In some embodiments, the aminosilane is an alkylalkoxyaminosilane having a formula of R^{A}(Ak)_{c}Si(OAk)_{d}, in which each of c and d can be 1 or 2; R^{A} is an amine moiety (e.g., any described herein); and each of Ak is, independently, an optionally substituted alkyl. Non-limiting examples of alkylalkoxyaminosilane include 3-aminopropyl(diethoxy)methylsilane (FIG. 2D) and 3-(ethoxydimethylsilyl)propylamine (FIG. 2E).

In some embodiments, the aminosilane is an aminosilanetriol having a formula of (HO)₃SiR^{A}, in which R^{A} is an amine moiety (e.g., any described herein). A non-limiting example of aminosilanetriol is (3-((2-aminoethyl)amino)propyl)silanetriol (FIG. 2F).

In some embodiments, the aminosilane is a haloaminosilane having a formula of (R^{A})₃SiX, in which each R^{A} is, independently, an amine moiety (e.g., any described herein) and X is halo (e.g., any described herein). Non-limiting examples of haloaminosilane include tris(dimethylamino)chlorosilane (FIG. 2G), tris(ethylmethylamino)chlorosilane, and the like.

Other non-limiting examples of aminosilanes include (3-aminopropyl) trimethoxysilane, (3-aminopropyl)triethoxysilane, 3-aminopropyl(diethoxy) methylsilane, [3-(2-aminoethylamino)propyl]trimethoxysilane, N-(2-aminoethyl)-3-aminopropylsilanetriol, N-[3-(trimethoxysilyl)propyl]ethylenediamine, N1-(3-trimethoxysilylpropyl)diethylenetriamine, 3-aminopropylsilanetriol, tris(ethylmethylamino)chlorosilane, tris(dimethylamino)chlorosilane, bis(3-(methylamino)propyl)trimethoxysilane, bis[3-(trimethoxysilyl)propyl]amine, N-[3-(trimethoxysilyl)propyl]aniline, (N,N-dimethylaminopropyl)trimethoxysilane, or an aminosilane oligomer (e.g., such as VPS SIVO 280, a modified organofunctional polysiloxane from Evonik Industries AG, Essen, Germany).

b. Silanes

As used herein, a silane compound can include any having a —SiR^{S1}R^{S2}R^{S3} moiety or a —SiR^{S1}R^{S2}— moiety, in which each of R^{S1}, R^{S2}, and R^{S3} can be any described herein. In some embodiments, each of R^{S1}, R^{S2}, and R^{S3} is, independently, H, optionally substituted aliphatic, alkyl, heteroaliphatic, heteroalkyl, aromatic, aryl, amine, or others described herein; or R^{S1} and R^{S2}, taken together with the silicon atom to which each are attached, form a heterocyclyl group. In some embodiments, each of R^{S1}, R^{S2}, and R^{S3} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSi^{R3}, in which each R is independently an optionally substituted alkyl), or trialkoxylsilyloxy (e.g., —OSi[OR]₃, in which each R is independently an optionally substituted alkyl).

In some embodiments, the silane can include one or more amino moieties, such as in an aminosilane compound (e.g., any described herein).

In some embodiments, the silane does not include an amino moiety. In one non-limiting example, the silane includes a structure having formula (IV):

[R^{C1}]ₐSi[X]₄₋ₐ (IV),

wherein each R^{C1} does not comprise amino; each X is, independently, a side group, a reactive group, or a leaving group (e.g., any described herein); and a is an integer from 1 to 4.

In some embodiments, R^{C1} is optionally substituted aliphatic, heteroaliphatic, alkyl, aromatic, heteroaromatic, or aryl, wherein the optional substituent is not amino (e.g., as defined herein). In some embodiments, R^{C1} is a branched, optionally substituted aliphatic, heteroaliphatic, alkyl, aromatic, heteroaromatic, or aryl. In some embodiments, R^{C1} is a hydrophobic group (e.g., optionally substituted C₄₋₃₀ aliphatic, heteroaliphatic, alkyl, perfluoroalkyl, cycloalkyl, aromatic, heteroaromatic, or aryl). Non-limiting examples of hydrophobic groups include optionally substituted C₄₋₂₄, C₆₋₂₄, C₈₋₂₄, C₄₋₁₈, C₆₋₁₈, C₈₋₁₈ alkyl, haloalkyl, perfluoroalkyl, cycloalkyl, and the like (e.g., hexyl, octyl, nonyl, decyl, dodecyl, perfluorohexyl, perfluorooctyl, cyclohexyl, and cyclopentyl).

In some embodiments, the silane includes a structure having formula (IVa):

[X]₃Si-L-Si[X]₃ (IVa),

wherein L is a linker (e.g., any described herein) and each X is, independently, a side group, a reactive group, or a leaving group (e.g., any described herein).

Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. Other examples of linkers include any described herein (e.g., described herein for L, L¹, L², and L³).

The silane can include a reactive group, a leaving group, or another group (e.g., X). Non-limiting examples of such groups include hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), optionally substituted alkanoyloxy, trialkylsilyloxy (e.g., —OSi^{R3}, in which each R is independently an optionally substituted alkyl), or trialkoxylsilyloxy (e.g., —OSi[OR]₃, in which each R is independently an optionally substituted alkyl). In some embodiments, X is, independently, H, optionally substituted aliphatic, optionally substituted heteroaliphatic, optionally substituted aromatic, or optionally substituted heteroaromatic.

In some embodiments, a silane can be employed as a crosslinker or as an additive for any composition or use herein (e.g., for any coating, surface functionalization layer, functionalization mixture, pre-functionalization mixture, and the like). Non-limiting examples of silanes include 1,2-bis(triethoxysilyl)ethane (BTESE) or 1,2-bis(trimethoxysilyl)ethane (BTME).

c. Polyamines

As described herein, the functional portion can be provided by any useful compound or combination of compounds. In some embodiments, the compound is a polyamine. A polyamine can include any compound or moiety having two or more amine moieties. In some embodiments, the polyamine is a non-polymeric compound, in which the polyamine does not include repeating units. In some embodiments, the polyamine is a polymeric compound (e.g., as in a polymeric polyamine). In other embodiments, the polyamine is an oligomeric compound (e.g., as in an oligomeric polyamine). Unless otherwise specified, discussion related to “polymeric” and “oligomeric” forms of compounds can be applied interchangeably. In some embodiments, a polyamine can include dimeric, trimeric, tetrameric, pentameric, hexameric, and higher order amines. In some embodiments, a polyamine can include a small molecule polyamine (e.g., having a MW between 100 to 800 g/mol). In some embodiments, a polyamine can include a large molecule polyamine (e.g., having a MW greater than 800 g/mol).

A polyamine can be used alone or with other compounds (e.g., any described herein, such as an aminosilane and the like). In some embodiments, a polyamine can be used in the presence of aminosilane. In some embodiments, a first polyamine (e.g., having a high MW, such as any described herein) can be used in the presence of a second polyamine (e.g., having a low MW, such as any described herein).

In some embodiments, a high MW can include a weight-average molecular weight (M_{w}) or number-average molecular weight (Mₙ) of greater than 300 daltons (Da), 400 Da, 500 Da, or 600 Da or from a range of 300 to 1,000,000 Da (e.g., 300 to 900000 Da, 300 to 800000 Da, 300 to 700000 Da, 300 to 600000 Da, 300 to 500000 Da, 300 to 400000 Da, 300 to 300000 Da, 300 to 200000 Da, 300 to 100000 Da, 300 to 90000 Da, 300 to 80000 Da, 300 to 70000 Da, 300 to 60000 Da, 300 to 50000 Da, 300 to 40000 Da, 300 to 30000 Da, 300 to 20000 Da, 300 to 10000 Da, 300 to 9000 Da, 300 to 8000 Da, 300 to 7000 Da, 300 to 6000 Da, 300 to 5000 Da, 300 to 4000 Da, 300 to 3000 Da, 300 to 2000 Da, 300 to 1000 Da, 500 to 1000000 Da, 500 to 900000 Da, 500 to 800000 Da, 500 to 700000 Da, 500 to 600000 Da, 500 to 500000 Da, 500 to 400000 Da, 500 to 300000 Da, 500 to 200000 Da, 500 to 100000 Da, 500 to 90000 Da, 500 to 80000 Da, 500 to 70000 Da, 500 to 60000 Da, 500 to 50000 Da, 500 to 40000 Da, 500 to 30000 Da, 500 to 20000 Da, 500 to 10000 Da, 500 to 9000 Da, 500 to 8000 Da, 500 to 7000 Da, 500 to 6000 Da, 500 to 5000 Da, 500 to 4000 Da, 500 to 3000 Da, 500 to 2000 Da, 500 to 1000 Da, 700 to 1000000 Da, 700 to 900000 Da, 700 to 800000 Da, 700 to 700000 Da, 700 to 600000 Da, 700 to 500000 Da, 700 to 400000 Da, 700 to 300000 Da, 700 to 200000 Da, 700 to 100000 Da, 700 to 90000 Da, 700 to 80000 Da, 700 to 70000 Da, 700 to 60000 Da, 700 to 50000 Da, 700 to 40000 Da, 700 to 30000 Da, 700 to 20000 Da, 700 to 10000 Da, 700 to 9000 Da, 700 to 8000 Da, 700 to 7000 Da, 700 to 6000 Da, 700 to 5000 Da, 700 to 4000 Da, 700 to 3000 Da, 700 to 2000 Da, 700 to 1000 Da, 800 to 1000000 Da, 800 to 900000 Da, 800 to 800000 Da, 800 to 700000 Da, 800 to 600000 Da, 800 to 500000 Da, 800 to 400000 Da, 800 to 300000 Da, 800 to 200000 Da, 800 to 100000 Da, 800 to 90000 Da, 800 to 80000 Da, 800 to 70000 Da, 800 to 60000 Da, 800 to 50000 Da, 800 to 40000 Da, 800 to 30000 Da, 800 to 20000 Da, 800 to 10000 Da, 800 to 9000 Da, 800 to 8000 Da, 800 to 7000 Da, 800 to 6000 Da, 800 to 5000 Da, 800 to 4000 Da, 800 to 3000 Da, 800 to 2000 Da, or 800 to 1000 Da). The high MW polyamine can include linear or branched forms. The high MW polyamine can include a plurality of primary amine moieties and/or a plurality of secondary amine moieties. In some embodiments, a high MW polyamine is provided in polymeric form.

In some embodiments, a low MW can include a weight-average molecular weight (M_{w}) or number-average molecular weight (Mₙ) of less than 300 Da, from a range of 30 to 300 Da, from a range of 100 to 800 Da, or ranges therebetween (e.g., 30 to 800 Da, 30 to 700 Da, 30 to 500 Da, 30 to 200 Da, 30 to 100 Da, 50 to 800 Da, 50 to 700 Da, 50 to 600 Da, 50 to 500 Da, 100 to 700 Da, 100 to 600 Da, 100 to 500 Da, 100 to 400 Da, 100 to 300 Da, 150 to 800 Da, 150 to 700 Da, 150 to 600 Da, 150 to 500 Da, 150 to 400 Da, 150 to 300 Da, 200 to 800 Da, and 300 to 800 Da). The low MW polyamine (e.g., which can be considered to be an oligomeric amine) can include linear or branched forms. The low MW polyamine can include a plurality of primary amine moieties and/or a plurality of secondary amine moieties. In some embodiments, a low MW polyamine is provided in oligomeric form.

Without wishing to be limited by mechanism, high MW amines may be useful for their lower volatility (e.g., as compared to low MW amines). Higher MW polyamines can be characterized by a higher viscosity, which may make handling more difficult. Higher MW polyamines are generally more expensive. In some non-limiting embodiments, polyamines with high relative concentrations of primary and secondary amine moieties can be employed. In some non-limiting embodiments, tertiary amine moieties may be characterized by lower performance for DAC applications and are less desired. Secondary amines have higher oxidation resistance equating to longer operational lifetimes. Primary amines have higher reactivity equating to higher performance at low CO₂ concentrations (DAC conditions).

The polyamine can have any useful structure. In one non-limiting example, the polyamine includes a structure having formula (IIIa) to (IIIi):

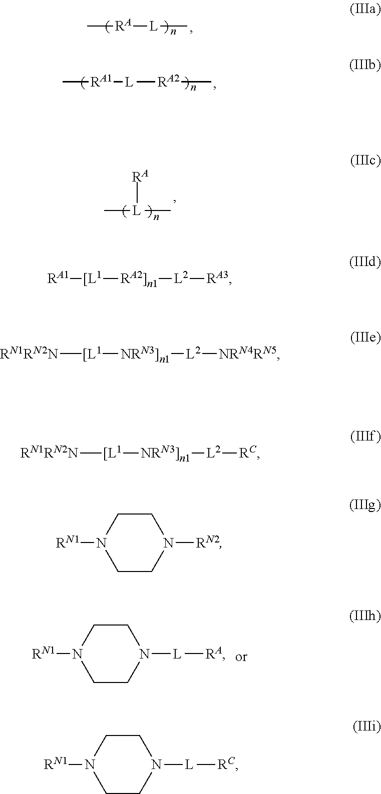

wherein each R^{A}, R^{A1}, R^{A2}, and R^{A3} is, independently, an amine moiety comprising at least one amine group; each L, L¹, or L² is, independently, a linker; each of R^{N1}, R^{N2}, R^{N3}, R^{N4}, and R^{N5} can be any described herein, optionally wherein R^{N1} and R^{N2}, taken together with the nitrogen atom to which each are attached, can form a heterocyclyl group, as defined herein or optionally wherein R^{N4} and R^{N5}, taken together with the nitrogen atom to which each are attached, can form a heterocyclyl group, as defined herein; R^{C} is hydrogen (H), halo, hydroxy, amino (e.g., —NR^{N1}R^{N2}), optionally substituted aliphatic, heteroaliphatic, alkyl, hydroxyalkyl, aromatic, heteroaromatic, or aryl; n is an integer greater than 1 (e.g., from 1-25000, 1-24000, 1-23000, 1-22000, 1-21000, 1-20000, 1-19000, 1-18000, 1-17000, 1-16000, 1-15000, 1-14000, 1-13000, 1-12000, 1-11000, 1-10000, 1-7500, 1-5000, 1-4000, 1-3000, 1-2000, 1-1000, 1-500, 1-100, 1-50, 1-20, 1-10, 1-5, 2-25000, 2-24000, 2-23000, 2-22000, 2-21000, 2-20000, 2-19000, 2-18000, 2-17000, 2-16000, 2-15000, 2-14000, 2-13000, 2-12000, 2-11000, 2-10000, 2-7500, 2-5000, 2-4000, 2-3000, 2-2000, 2-1000, 2-500, 2-100, 2-50, 2-20, 2-10, 2-5, 5-25000, 5-24000, 5-23000, 5-22000, 5-21000, 5-20000, 5-19000, 5-18000, 5-17000, 5-16000, 5-15000, 5-14000, 5-13000, 5-12000, 5-11000, 5-10000, 5-7500, 5-5000, 5-4000, 5-3000, 5-2000, 5-1000, 5-500, 5-100, 5-50, 5-20, 5-10, as well as ranges therebetween); and n1 is an integer of 1 or more (e.g., from 1-1000, 1-100, 1-50, 1-20, 1-10, 5-1000, 5-100, 5-50, 5-20, 5-10, as well as ranges therebetween). R^{A}, R^{A1}, and R^{A2} can be any amine moiety described herein; L, L¹, and L² can be any linker described herein; and each of R^{N1}, R^{N2}, R^{N3}, R^{N4}, and R^{N5} can be any described herein for R^{N1} or R^{N2}.

In some embodiments, R^{A}, R^{A1}, R^{A2}, or R^{A3} is or includes —NH—, —NR^{N1}—, —N(-L¹-NR^{N1}R^{N2})—, —N(-L²-NR^{N3}-L¹-NR^{N1}R^{N2})—, —N[-L²-N(-L¹-NR^{N1}R^{N2})₂]—, —NH₂, —NR^{N1}R^{N2}, -L-NR^{N1}R^{N2}, —NR^{N3}-L¹NR^{N1}R^{N2}, -L²NR^{N3}-L¹-NR^{N1}R^{N2}, or —NR^{N4}-L²-NR^{N3}-L¹-NR^{N1}R^{N2}, in which each of R^{N1} and R^{N2} can be any described herein; each of R^{N3} and R^{N4} can be any described herein for R^{N1} and R^{N2}; and each of L¹ or L² is independently a linker.

Examples of linkers (e.g., for L¹, L², or L) include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some embodiments, the linker is a monomer or a polymer, which can be employed as a backbone to which an amine moiety R^{A} can be attached. Alternatively, the backbone of the polymer itself can also include an amine moiety. Non-limiting examples of monomers include a saccharide (e.g., glucosamine, N-acetyl-glucosamine, glucose, and the like), an amino acid (e.g., lysine), an alkylene, an alkenylene, an arylene, and the like. Non-limiting examples of polymers include a polysaccharide (e.g., chitosan, chitin, and the like), a polypeptide (e.g., poly(lysine)), a vinyl polymer, and the like.

Further non-limiting examples of polyamine include poly(lysine) (e.g., poly(L-lysine), poly(D-lysine), or poly(LD-lysine)), poly(ethyleneimine), poly(propyleneimine), poly(vinylamine), poly(N-methylvinylamine), poly(allylamine), poly(N-isopropyl acrylamide), poly(4-aminostyrene), chitosan, spermidine, spermine, norspermine, putrescine, cadaverine, tetraethylenepentamine (TEPA), triethylenetetramine (TETA), an ethylene amine/oligomeric mix (e.g., Amix 1000 having CAS No. 68910-05-4), diethylenetriamine (DETA), 2-(2-aminoethylamino) ethanol, ethylenediamine, piperazine, 2-piperazin-1-ylethylamine, 2-piperazin-1-ylethanol, pentaethylenehexamine, tetramethylethylenediamine, as well as salts thereof and/or copolymers thereof and/or mixtures thereof. In some embodiments, the polyamine includes spermidine, spermine, norspermine, putrescine, cadaverine, tetraethylenepentamine (TEPA), triethylenetetramine (TETA), ethanolamine, diethylenetriamine (DETA), piperazine, 2-piperazin-1-ylethylamine, 2-piperazin-1-ylethanol, pentaethylenehexamine, tetramethylethylenediamine, as well as polymeric forms thereof. In some embodiments, the ethylene amine/oligomeric mix includes one or more of the following: 2-(2-aminoethylamino)ethanol, trientine or TETA, 2,2′-iminodi(ethylamine) or DETA, 2-aminoethanol, ethylenediamine, piperazine, 2-piperazin-1-ylethylamine, and 2-piperazin-1-ylethanol.

In some embodiments, the polyamine includes H₂N[CH₂CH₂NH]ₙH, in which n is an integer of 1 or more (e.g., 1, 2, 3, 4, 5, 6, 7, 8, 9, 10, or more). In some embodiments, the polyamine includes H₂N[-L-NH-]ₙH or N[-L-NH₂]₃, in which each L is independently a linker (e.g., any described herein, such as optionally substituted alkylene) and n is an integer of 1 or more. In some embodiments, the polyamine includes H₂N[CH₂CH₂CH₂NH]ₙH, in which n is an integer of 1 or more (e.g., 1, 2, 3, 4, 5, 6, 7, 8, 9, 10, or more).

In some embodiments, the polyamine includes oligomeric or polymeric forms of ethyleneimine. In some embodiments, the polyamine includes —[CH₂CH₂NH]ₙ—, in which n is an integer of 1 or more (e.g., 1, 2, 3, 4, 5, 6, 7, 8, 9, 10, or more). In some embodiments, the polyamine includes —[CH₂CH₂NR^{A}]ₙ—, in which R^{A} is an amine moiety (e.g., any described herein) and n is an integer of 1 or more (e.g., 1, 2, 3, 4, 5, 6, 7, 8, 9, 10, or more). In some non-limiting embodiments, R^{A} is -Ak-NR^{N1}R^{N2} or -Ak-N(-Ak-NR^{N1}R^{N2})₂ or -Ak-NR^{N1}-Ak-NR^{N2}R^{N3}, in which Ak is optionally substituted alkylene and each of R^{N1}, R^{N2}, and R^{N3} can be any described herein.

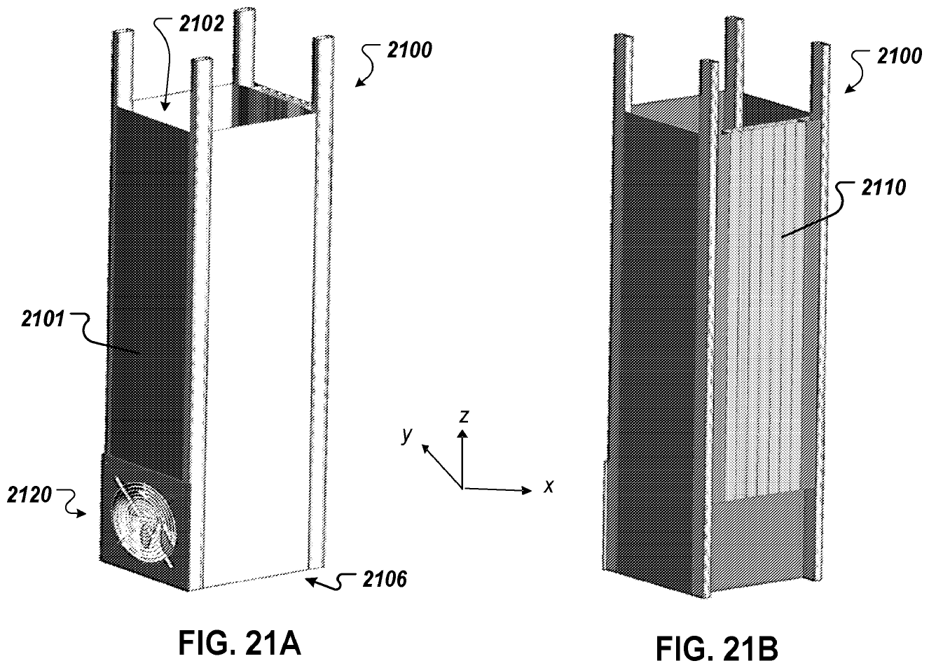

FIGS. 2H-2K provide non-limiting, general examples of polyamine chains which can provide a polyamine. The polyamines of FIGS. 2H and 21 include repeating units composed of amine groups (e.g., —NH—, —NR^{N1}—, —NH₂, or —NR^{N1}R^{N2}) and linkers. In some examples, the linker can be a carbon aliphatic —(CH₂)ₙ— spacer groups, in which n is an integer greater than one (e.g., an integer from 1 to 20, 1 to 10, 1 to 12, 1 to 6, etc.). FIG. 2H shows an n-propylene (—CH₂CH₂CH₂₋) (C₃H₆) spacer group. FIG. 2I shows an ethylene (—CH₂CH₂₋) (C₂H₄) spacer group. The polyamine has a repeating chain portion (bracketed) having a length of n active groups in the chain portion of the polymer (e.g., if n=2, there are two repeating groups in the chain portion). Other linkers can be used, such as any described herein (e.g., optionally substituted alkylene, as described herein), as well as linkers having peptidic bonds (e.g., —C(O)NH—) or glycosidic linkages. Linkers can include peptides, polysaccharides, and the like. Furthermore, the polyamine can include linear or branched structures, such as those present in linear polymers, branched polymers, block polymers, or dendrimers.

FIGS. 2H-2I depict a polyamine having a length of n active groups in the repeating chain portion. FIGS. 2H-2I also depict the repeating chain portion including two non-limiting amine groups (—N(X)—), separated by either C₃ (FIG. 2H) or C₂ (FIG. 2I) spacer groups. In NX, X can be any side group, reactive group, leaving group, or other group described herein. For example, X can be H, optionally substituted aliphatic, heteroaliphatic, aromatic, and the like. Furthermore, X can include further amine groups. Thus, in some non-limiting embodiments, X can include any R^{A} group described herein (e.g., an aminoalkyl group, an alkylaminoalkyl group, and the like). FIG. 2I depicts the amine groups extending in different orientations from the carbon chain, whereas FIG. 2H depicts the amine groups extending in similar orientations.

The polyamine can be derived from natural polymers having amine moieties. For example, FIG. 2J is an example of a poly(lysine), and FIG. 2K is an example of a natural chitosan.

The amine moieties present in a polyamine can interact with other moieties, groups, or compounds present in proximity to a surface of a substrate. In some embodiments, amine moieties of a polyamine can interact with silane moieties (e.g., silanol groups or other groups) present in an aminosilane. In other embodiments, amine moieties of a polyamine can interact with moieties of other polyamines, aminosilanes, or other groups present in proximity to the surface. Such interactions can include covalent or non-covalent interactions (e.g., hydrogen bonding, ionic interactions, and/or others described herein) to form a network over the surface of the substrate.

In some examples, the polyamine can be a polymeric/oligomeric amine or a mixture including polymeric/oligomeric amine, such as poly(ethyleneimine) (PEI), poly(propyleneimine) (PPI), or a multiple amine mixture (e.g., a mixture including a plurality of amines (e.g., polyamines and/or monoamines), such as Amix 1000, CAS No. 68910-05-4, as produced by BASF SE, Ludwigshafen, Germany). In some examples, the polyamine is a small molecule including amine moieties (e.g., small molecule amines), an oligomer including amine moieties (e.g., an oligomeric amine), or an oligomeric including ethylene amine moieties (e.g., an oligomeric ethylene amine), such as tetraethylenepentamine (TEPA), triethylenetetramine (TETA), diethylenetriamine (DETA), ethylenediamine, polymers or oligomers of monoethanolamine, polymers or oligomers of diethanolamine, polymers or oligomers of triethanolamine, 2-(2-aminoethylamino)ethanol, piperazine, 2-piperazin-1-ylethylamine, 2-piperazin-1-ylethanol, pentaethylenehexamine, tetramethylethylenediamine, or others described herein.

In some embodiments, the polyamine is a small molecule polyamine. In some embodiments, the small molecule polyamine is characterized by a boiling point being sufficiently high that the compounds are not lost due to a high volatility. In some embodiments, the small molecule polyamine has a boiling point of at least 170° C. In some examples, these compounds have reduced compound cost compared to alternatives.

In some embodiments, a mixture of one or more amines described herein (e.g., an aminosilane, a polyamine such as a high molecular weight polyamine or a small molecule polyamine, and/or a monoamine) is employed, in which the presence of such amines provides a polymer or an oligomer. In some embodiments, the mixture can further include an alcohol (e.g., ROH, in which R is optionally substituted aliphatic, alkyl, hydroxyalkyl, heteroaliphatic, heteroalkyl, aromatic, or aryl).

d. Monoamines

As described herein, the functional portion can be provided by any useful compound or combination of compounds. In some embodiments, the compound is a monoamine. A monoamine can include any compound or moiety having one amine group (e.g., —NR^{N1}R^{N2}, in which R^{N1} and R^{N2} can be any described herein). The amine group may be attached to a linker (e.g., any described herein).

In certain embodiments, a monoamine may be provided to a substrate to act as an interaction moiety or an adsorbing moiety.

In some embodiments, a monoamine can include an aminosilane having one amine group. Other examples of monoamine compounds include an alkanolamine (e.g., HO-Ak-NR^{N1}R^{N2}, in which Ak is optionally substituted alkylene and each of R^{N1} and R^{N2} can be any described herein, such as monoethanolamine) or an alkylamine (e.g., Ak-NR^{N1}R^{N2}, in which Ak is optionally substituted alkyl and each of R^{N1} and R^{N2} can be any described herein, such as ethylamine or hexylamine), and the like. In some embodiments, the monoamine is a compound having a structure of formula R^{C1}N^{R1}R^{N2}, in which each of R^{N1} and R^{N2} can be any described herein and R^{C1} is optionally substituted aliphatic, heteroaliphatic, alkyl, aromatic, heteroaromatic, or aryl, wherein the optional substituent is not amino, as defined herein, or wherein R^{C1} does not comprise amino, as defined herein.

Iii. Interaction of Moieties, Groups, or Compounds

Any combination of moieties, groups, or compounds can be used to provide a functional portion. In some embodiments, the functional portion is provided as a coating or a surface modification layer, which in turn can be formed from a complex network of interactions between one or more silanes, aminosilanes, polymeric/oligomeric amines, monoamines, and/or surfaces of the substrate (e.g., a silica substrate).

In some embodiments, interactions can form between a surface of a substrate and a silane moiety (e.g., present in any silane, aminosilane, polymeric silane, or polymeric aminosilane described herein). In instances when the silane moiety is provided by a (poly)aminosilane, the silanol moieties on a silica surface may react with the silane moiety to form siloxane linkages, which are non-limiting examples of covalent bonds. Such silanol moieties can be acidic and may be deprotonated by basic amine moieties of the (poly)aminosilane to form an acid-base pair, which is a non-limiting example of an ionic interaction. Silanol moieties (on silica) and silanol and amine moieties (on (poly)aminosilanes) may form a variety of hydrogen bonding interactions (e.g., by way of hydrogen bonding). In the case of large polymeric silanes, the sum of these interactions may be significant. Silica and (poly)silanes can be polar and may possess weak dipole-dipole interactions. In the case of large polymeric silanes, the sum of these interactions may be significant.

In some embodiments, interactions can form between a surface of a substrate and an amine moiety (e.g., present in any aminosilane, polyamine, or a monoamine described herein). In instances when the amine moiety is provided by a polyamine, silanol moieties on a silica surface can be acidic and may be deprotonated by the basic amine moieties of the polyamine to form acid-base pairs, which are non-limiting examples of ionic interactions. Silanol moieties (on silica) and amine moieties (on polyamines) may form a variety of hydrogen bonding interactions. Silica and polyamines can be polar and may possess weak dipole-dipole interactions. Due to the large branching shape of some non-limiting polyamines, the sum of these weak interactions can be significant when the polyamine adheres to or otherwise interacts with the silica surface.

In some embodiments, interactions can form between surfaces of a substrate (e.g., a first surface and a second surface of a silica substrate). In instances when the substrate comprises silica, silica-silica interactions can contribute to the formation and strength of the silica substrate. In some embodiments, silica substrates can be composed of a single polymeric silica-dioxide molecule. In the case of precipitated silica, the silica substrate can be composed of a great number of small nucleites that are entangled into larger aggregates and finally agglomerated into the full particle and held together by physical interactions. Silicon dioxide can form siloxane (—Si—O—Si—) linkages between individual silicon atoms, in which such siloxane linkages are non-limiting examples of covalent bonds. Silica nucleites and aggregates may be physically entangled and agglomerated to form substrate particles, in which such entanglement and agglomeration interactions are non-limiting examples of physical interactions. The surface of silica nucleites and aggregates can include silanol moieties that may form many hydrogen bonding interactions that promote cohesion. Silica nucleites and aggregates can be polar and may form cohesive dipole-dipole interactions.

In some embodiments, interactions can form between silane moieties (e.g., present in any silane, aminosilane, or polymeric aminosilane described herein). In instances when the silane moieties are provided by alkoxysilane groups or silanol groups, the silane moieties may react with each other to form siloxane condensation bonds. Both a silica surface and silanes can include silanol moieties that can condense to form siloxane bonds. This process may be repeated many times to form branching polysilane networks having covalent bonds. Silanols or polysilanes can include acidic silanol moieties that can be deprotonated by basic amine moieties (e.g., present in aminosilane) to form acid-base interactions, which are non-limiting examples of ionic interactions. Silanols or polysilanes can have silanol and amino moieties that can form a variety of hydrogen bonding interactions. Large branching polysilanes can become physically entangled with each other. Silanols and polysilanes can be polar molecules and may possess weak dipole-dipole interactions with each other. In the case of large branching polysilanes, the sum of these weak interactions may be significant.

In some embodiments, interactions can form between amine moieties (e.g., present in any amine, polyamine, aminosilane, or polymeric aminosilane). In instances when the amine moieties are provided by polyamines, polyamines may have a variety of amine moieties that can donate and accept hydrogen bonds. Since polyamines can be polymers, a higher number of these intermolecular interactions are possible (e.g., by way of hydrogen bonding). Large polyamines can become physically entangled with each other. Polyamines can be polar molecules and may possess some weak dipole-dipole interactions with each other. In the case of large branching shapes present in some polyamines, the sum of these interactions can be significant.

In some embodiments, interactions can form between an amino moiety (e.g., present in any amine, polyamine, aminosilane, or polymeric aminosilane). and a silane moiety (e.g., present in any silane, polymeric silane, aminosilane, or polymeric aminosilane). In instances when the amine moieties are provided by polyamines, polyamines can have a plurality of basic amine moieties, which can deprotonate acidic silanol moieties (in (poly)silane) to form acid-base interactions. In the case of large polyamines interacting with large polysilanes, the sum of these interactions can be even more significant (e.g., by way of ionic interactions). polyamines may have many amine moieties, which can form a variety of hydrogen bonding interactions with silanol moieties (in (poly)silane) and amine moieties. In the case of large polyamines interacting with large polysilanes, the sum of these interactions can be even more significant (hydrogen bonding). Polyamines and (poly)silanes can be polar molecules and can possess some weak dipole-dipole interactions with each other. In the case of large polyamines interacting with large polysilanes, the sum of these interactions can be significant.

iv. Additives

Additives can be included. In some implementations, additives can be included in the functionalization mixtures to extend the operational lifetime of the functionalized material. For example, the addition of bis[3-(trimethoxysilyl) propyl]amine (BTMSPA) to the mixture can increase the operational lifetime of the functionalized material. BTMSPA is an aminosilane having two ends, in which each end has a trimethoxysilyl reactive group. The BTMSPA bonds on the substrate with six binding points, as contrasted with the three binding points for an aminosilane with a single reactive group, such as would be present in a compound having a methoxydialkylsilyl reactive group. The increased number of binding points increases binding stability with the silica substrate. The BTMSPA can form a network with other aminosilanes and polyamines on the surface which increases binding stability of the overall network.

Other examples of additives can include a polyamine (e.g., any described herein). Yet other examples of additives include 1,2-bis(triethoxysilyl)ethane (BTESE), other bisaminosilane compounds (e.g., X¹X²X³Si-L¹-NR^{N}-L²-SiX⁴X⁵X⁶, in which each of X¹, X², X³, X⁴, X⁵, and X⁶ is any described herein for X; each of L¹ and L² is any described herein for L; and R^{N} is any described herein for R^{N1}), or other bissilane compounds (e.g., X¹X²X³Si-L¹-SiX⁴X⁵X⁶, in which each of X¹, X², X³, X⁴, X⁵, and X⁶ is any described herein for X and L¹ is any described herein for L).

In some implementations, the functionalized material includes antioxidant additives. Without wishing to be limited by theory, an additive may prevent the degradation of the amine moieties by atmospheric oxygen and/or may extend the cycling lifetime of the functionalized material. For example, the antioxidant additives can be organic sulfur-containing compounds, such as 2,2-thiodiethanol, 2-hydroxyethyl disulfide, and 3,3′-dithiodipropionic acid. In some embodiments, the organic sulfur-containing compound has a formula of R′SR″ or R′SSR″ or R′S-L-SR″, in which each of R′ and R″ is, independently, aliphatic, alkyl, hydroxyalkyl, carboxyalkyl, aromatic, aryl, hydroxyaryl, or carboxyaryl (e.g., as defined herein), in which each of these may be optionally substituted; and L is a linker (e.g., any described herein).

Another example of antioxidant additives could be a metal catalyst chelator. Without wishing to be limited by theory or mechanism, transition metal impurities (e.g., such as iron or copper) could increase the oxidation rate of amine moieties, which in turn may reduce the lifetime of the sorbent. In some embodiments, a catalyst chelator can include, e.g., a phosphate or phosphonate alkali salt (e.g., a phosphate or phosphonate sodium salt), an aminopolycarboxylic acid or a salt thereof (e.g., ethylenediaminetetraacetic acid tetrasodium salt dihydrate or diethylenetriaminepentaacetic acid), a phosphonic acid or a salt thereof (e.g., 1-hydroxyethane 1,1-diphosphonic acid monohydrate or ethylenediamine tetramethylene phosphonic acid), a mercapto acid (e.g., meso-2,3-dimercaptosuccinic acid, and the like. In some embodiments, one or more catalyst chelators can be used to reduce the oxidation rate and improve sorbent lifetime.

In general, the amount of antioxidant additives in the functionalized material is 5% (wt/wt) to the substrate (e.g., 3%, 4%, 6%, or 8% (wt/wt)). The antioxidant additives may be added during any useful step (e.g., during formation of the suspension mixture or the functionalization mixture) of the following synthesis procedure or afterward (e.g., through dissolving in a solvent, such as an alcohol like methanol, and then soaking the functionalized material in the additive/solvent mixture for 1 hour).

In some implementations, the functionalized material can include, or be functionalized with, other hydrophobic compounds including hydrophobic silanes or hydrophobic polymer coatings. In some embodiments, the hydrophobic silane can include one, two, or three alkyl chains. In particular embodiments, the hydrophobic silane can include R¹R²R³SiX¹ or [R¹]ₐSi[X¹]₄₋ₐ, in which each of R¹, R², and R³ is independently an optionally substituted aliphatic, alkyl, aromatic, or aryl; X¹ is a side group, a reactive group, or a leaving group (e.g., any described herein for X); and a is 1, 2, or 3. Without wishing to be limited by theory, alkyl chains on the silane molecule can increase the hydrophobicity of the silane molecule. When the silane molecule is bonded to the substrate, it can increase the hydrophobicity of the functionalized material as well. Thus, the water adsorption capacity of the functionalized material could be reduced, which may be beneficial for some cases such as when using the sorbent in high humidity conditions. For the same purpose of increasing the hydrophobicity of the functionalized material, additional hydrophobic polymer coatings can be used. Polydimethylsiloxane (PDMS), silicone oil, polyethylene, polypropylene, poly(tetrafluorethylene), and polyurethane are possible hydrophobic polymers that could be used to coat the outer surface of the functionalized silica to reduce water adsorption for high humidity applications.

v. Characteristics

The functionalized material may be used as a sorbent, which in turn can have any useful characteristics (e.g., any described herein).

In some embodiments, the functionalized material adsorbs CO₂ at low concentrations enabling increased capture at levels present in atmospheric conditions. Capturing CO₂ from atmospheric conditions can facilitate employing the functionalized material in a large number of applications.

In some embodiments, CO₂ is desorbed from the functionalized material at laboratory temperatures. This can reduce the energy required to remove captured CO₂, increase the applicability of the functionalized material to more industries and environments, and/or increase the speed at which the CO₂ is desorbed.

In some embodiments, the functionalized material can achieve high adsorption/desorption counts, which can reduce operational costs in carbon capture systems. The functionalized material can enable repeated use of the substrate.

In some embodiments, the functionalized material can be produced using industrially available components, reducing the cost of and increasing the scalability of production.

In some embodiments, the functionalized material includes polymeric, oligomeric, or molecular sources with high densities of amine functionality that can increase uptake of CO₂ per weight of dry sorbent.

In some embodiments, functionalizing the substrate with an aminosilane compound increases the binding stability of the polymeric, oligomeric, or high density amine source, thereby increasing the useful lifespan of the functionalized material.

In some embodiments, functionalizing the substrate with a polyamine (e.g., a high molecular weight polyamine) increases the binding stability, as compared to short chain amine functionalization (e.g., employing an oligomeric amine or a small molecular weight amine having at least two amine moieties and having a molecular weight from 100 to 800 g/mol).

In some embodiments, functionalizing the substrate with a small molecule polyamine (e.g., an oligomeric amine, an oligomeric ethylene amine, or an ethylene amine/oligomer mixture compound) decreases the cost of the functionalized substrate and facilitates large-scale functionalization of the substrate.

In some embodiments, polyamine sources have an increased amine density and are commercially available which increases cost effectiveness of the use of polyamine functionalized materials as sorbents.

In some embodiments, the functionalized material is produced in a single-pot reaction in short time scales to reduce the cost of production, reduce reliance on industrial solvents, and/or reduce the environmental impact of the product.

In some embodiments, the functionalized material is produced in a single-pot reaction in short time scales and using only water as a solvent to reduce the cost of production, reduce reliance on industrial solvents, and/or reduce the environmental impact of the product.

In some embodiments, the functionalized material is produced in a water-based, single-pot reaction at ambient pressures and temperatures in short time scales (e.g., using a dip-coating process) to reduce the cost of production, reduce reliance on industrial solvents, and/or reduce the environmental impact of the product.

In some embodiments, the composition can adsorb atmospheric CO₂ (e.g., to an adsorbing moiety, such as an amine moiety) in a first temperature range and can desorb previously adsorbed CO₂ (e.g., from an adsorbing moiety, such as an amine moiety) in a second temperature range higher than the first temperature range. The second temperature range can be in a range from 65° C. to 90° C.

In some embodiments, the composition can adsorb atmospheric CO₂ (e.g., to an adsorbing moiety, such as an amine moiety) at a first gas pressure for CO₂ and can desorb previously adsorbed CO₂ (e.g., from an adsorbing moiety, such as an amine moiety) at a second gas pressure for CO₂ that is lower than the first gas pressure. In some embodiments, the second gas pressure can be below 1.5 psi (e.g., for functionalized silica or other functionalized material described herein). In some embodiments, the second gas pressure can be below 0.3 psi (e.g., for functionalized MOF or other functionalized material described herein). The first and second gas pressure relate to the pressure for CO₂. Thus, when other gases are present in proximity of the sorbent, the first gas pressure and the second gas pressure relate to the partial pressure for CO₂.

In some embodiments, the composition can adsorb atmospheric CO₂ (e.g., to an adsorbing moiety, such as an amine moiety) at a first CO₂ concentration and can desorb previously adsorbed CO₂ (e.g., from an adsorbing moiety, such as an amine moiety) at a second CO₂ concentration lower than the first CO₂ concentration. The first CO₂ concentration can be below 420 ppm or below 400 ppm.

In some embodiments, the composition can comprise or consist essentially of porous silica particles as a substrate. The porous silica particles can include a plurality of pores. The plurality of pores can have a dimension (e.g., a diameter) in a range from 60 to 400 Å or from 20 to 1000 Å. The pores can have a size in a range from 100 to 150 Å. The plurality of pores can have a volume greater than 0.5 mL/g. The porous silica particles can have a total surface area greater than 100 m² per dry gram. The porous silica particles can have an average diameter in a range from 25 μm to 3 mm or from 25 μm to 4 mm.

In some embodiments, the porous silica particles have a greatest dimension in a range from 70 to 80 μm. The porous silica particles can include a plurality of pores, and the plurality of pores have volume greater than 0.8 mL/g and a size of at least 90 Å.

In some embodiments, the composition can comprise or consist essentially of MOF particles as a substrate. The MOF particles can include a plurality of pores. The plurality of pores can have a dimension (e.g., a diameter) in a range from 30 to 400 Å. The plurality of pores can have a volume greater than 0.5 mL/g. The MOF particles can have a total surface area greater than 100 m² per dry gram. The MOF particles can have an average diameter in a range from 10 μm to 1 mm or from 50 to 100 μm.

In some embodiments, the composition can comprise or consist essentially of resin as a substrate. The resin can include a plurality of pores. The plurality of pores can have a dimension (e.g., a diameter) in a range from 1 to 200 nm. The plurality of pores can have a volume greater than 0.5 mL/g. The resin can have a total surface area greater than 100 m² per dry gram. The resin can have an average diameter in a range from 25 μm to 4 mm.

In some embodiments, the composition can adsorb between 0.5 to 2.5 mol of CO₂ per dry kilogram (mol CO₂/kg), 0.5 to 2 mol CO₂/kg, or 1 to 2 mol CO₂/kg. The composition can adsorb CO₂ at a relative humidity in a range from 0% to 100% relative humidity (RH), 5% to 95% RH, or 5% to 90% RH (e.g., for functionalized silica or other functionalized material described herein) or from 0% to 100% RH or 5% to 60% RH (e.g., for functionalized MOF, functionalized resin, or other functionalized material described herein).

In some embodiments, the sorbent can be reused through the desorption process. For example, the sorbent can be reused 100 times or more (e.g., 1000 times or more, 10000 times or more). For the desorption process, the sample can be heated to 70° C. under vacuum for 30 minutes or another duration (e.g., the duration may change based on temperature and/or vacuum level). This can facilitate the CO₂ captured during the adsorption process to be released, in which released CO₂ can be collected for further sequestration, described with reference to the systems for direct air capture herein. A non-limiting aspect of the desorption process can include maintaining the sorbent to be heated under a water vapor filled vacuum environment (e.g., >10% RH). In some non-limiting embodiments, this can reduce sorbent degradation.

When exposed to a gaseous mixture including CO₂, the amine moiety (or other adsorbing moiety) reacts with the CO₂ to bond the CO₂ to the functional portion. This thereby functionally adsorbs the CO₂ to the substrate, in which the interaction moiety bonds the adsorbing moiety to the surface of the substrate by way of covalent or non-covalent bonding interactions. Without wishing to be bound by theory, the total surface area, volume of the pores, and number of adsorbing moieties can determine the adsorption capacity of the functionalized material. The adsorption capacity (e.g., uptake) of the functionalized material can be in a range from 0.1 to 2.5 mol CO₂/kg of functionalized material (e.g., from 0.1 to 2 mol CO₂/kg, 0.1 to 1.8 mol CO₂/kg, 0.1 to 1.5 mol CO₂/kg, 0.1 to 1.2 mol CO₂/kg, 0.1 to 1.0 mol CO₂/kg, 0.1 to 0.5 mol CO₂/kg, 0.2 to 2 mol CO₂/kg, 0.2 to 1.0 mol CO₂/kg, 0.2 to 0.8 mol CO₂/kg, 0.5 to 2.5 mol CO₂/kg, 0.5 to 2.2 mol CO₂/kg, 0.5 to 2 mol CO₂/kg, 0.5 to 1.8 mol CO₂/kg, 0.5 to 1.5 mol CO₂/kg, 0.5 to 0.8 mol CO₂/kg, 0.8 to 2.5 mol CO₂/kg, 0.8 to 2.2 mol CO₂/kg, 0.8 to 2 mol CO₂/kg, 0.8 to 1.8 mol CO₂/kg, 0.8 to 1.5 mol CO₂/kg, 1 to 2 mol CO₂/kg, 1 to 1.4 mol CO₂/kg, 1 to 1.5 mol CO₂/kg, 1.2 to 2.0 mol CO₂/kg, 1.2 to 1.8 mol CO₂/kg, 1.5 to 2.5 mol CO₂/kg, 1.5 to 2 mol CO₂/kg, or 2 to 2.5 mol CO₂/kg). In some embodiments, the range is greater than 0.5, 1, 1.5, 2, or 2.5 mol CO₂/kg. In some implementations, the functionalized material achieves CO₂ adsorption capacity up to 1 mol CO₂/kg or up to 2 mol CO₂/kg at 420 ppm CO₂ in ambient air conditions.

In some implementations, the functionalized material (e.g., functionalized substrate including polyamine) achieves CO₂ adsorption capacity in a range from 0.8 to 2.5 mol CO₂/kg or 0.5 to 2.2 mol CO₂/kg (e.g., from 1 to 2 mol CO₂/kg, 1 to 1.5 mol CO₂/kg, 1.5 to 2 mol CO₂/kg, 1.5 to 2.5 mol CO₂/kg, or 2 to 2.5 mol CO₂/kg). In some implementations, the functionalized substrate achieves CO₂ adsorption capacity up to 2 mol CO₂/kg at 420 ppm CO₂ in ambient air conditions.

In some implementations, the functionalized material (e.g., functionalized substrate including ethylene amine, oligomeric ethylene amine, or mixtures thereof) achieves CO₂ adsorption capacity in a range from 0.5 to 1.8 mol CO₂/kg or 0.5 to 2 mol CO₂/kg (e.g., from 1.5 to 2 mol CO₂/kg, 1.5 to 1.8 mol CO₂/kg, 1 to 1.5 mol CO₂/kg, or 1.2 to 1.8 mol CO₂/kg). In some implementations, the functionalized substrate achieves CO₂ adsorption capacity up to 2 mol CO₂/kg at 420 ppm CO₂ in ambient air conditions.

In some implementations, the functionalized material (e.g., functionalized substrate prepared by way of a dip-coating process) achieves CO₂ adsorption capacity in a range from 1 to 2 mol CO₂/kg. In some implementations, the functionalized substrate achieves CO₂ adsorption capacity up to 2 mol CO₂/kg at 420 ppm CO₂ in ambient air conditions.

In some implementations, the functionalized material (e.g., functionalized MOF) achieves CO₂ adsorption capacity in a range from 0.8 to 2.5 mol CO₂/kg or 0.1 to 1 mol CO₂/kg (e.g., from 0.2 to 0.8 mol CO₂/kg). In some implementations, the functionalized MOF substrate achieves CO₂ adsorption capacity up to 2 mol CO₂/kg at 420 ppm CO₂ in ambient air conditions.

In some implementations, the functionalized material (e.g., functionalized resin) achieves CO₂ adsorption capacity in a range from 0.8 to 2.5 mol CO₂/kg, 0.8 to 3 mol CO₂/kg, or 0.1 to 2.0 mol CO₂/kg (e.g., from 0.1 to 1.8 mol CO₂/kg, 0.1 to 1.5 mol CO₂/kg, 0.1 to 1.2 mol CO₂/kg, 0.1 to 1.0 mol CO₂/kg, 0.1 to 0.5 mol CO₂/kg, 0.2 to 1.0 mol CO₂/kg, 0.2 to 0.8 mol CO₂/kg, 0.5 to 2.0 mol CO₂/kg, 0.5 to 1.5 mol CO₂/kg, 0.5 to 0.8 mol CO₂/kg, 1.2 to 2.0 mol CO₂/kg, 1.2 to 1.8 mol CO₂/kg, or any ranges described herein). In some implementations, the functionalized resin achieves CO₂ adsorption capacity up to 2 mol CO₂/kg at 420 ppm CO₂ in ambient air conditions.

In environmental conditions, the atmosphere can include a concentration of water vapor (e.g., humidity). The functionalized material can be used to capture CO₂ from atmospheric conditions in a range of RH levels. For example, the functionalized material can capture CO₂ from atmospheric conditions in a range from 0% to 100% RH, such as for example 5% to 95% RH (e.g., 15% to 50% RH, 25% to 40% RH, 10% to 60% RH, 5% to 90% RH, 10% to 90% RH, or 20% to 80% RH). In some implementations, the functionalized material captures CO₂ from atmospheric conditions having greater than 60% RH, greater than 75% RH, greater than 90% RH, or greater than 95% RH.

vi. Chemical Definitions

Unless otherwise specified, the term “material” can be used to encompass compounds, molecules, structures (e.g., substrates or particles), or combinations thereof (e.g., a functionalized substrate).

As used herein, the term “moiety” is used to describe characteristic parts of organic molecules, compounds, or materials. For example, an amine moiety is a molecule, compound, or portion of a compound containing an amine group (e.g., —NR^{N1}R^{N2}, as described herein), whereas a silane moiety is a molecule, compound, or portion of a compound containing a silane group (e.g., —SiR^{S1}R^{S2}R^{S3}, as described herein). In one non-limiting instance, an amine moiety can include an aminoalkyl group (e.g., -Ak-NR^{N1}R^{N2}, as described herein), as may be present in an aminosilane compound or a polyamine compound. In another non-limiting instance, an amine moiety can include an amino group alone (e.g., —NR^{N1}R^{N2}, as described herein). The term moiety is used to describe both larger molecules containing the group, or may be used to describe the group itself.

As used herein, “interact” is used to describe covalent or non-covalent interactions between chemicals, such as by way of physical adsorption or ionic interactions.

By “acyl” or “alkanoyl,” as used interchangeably herein, is meant an aliphatic or alkyl group, as defined herein, attached to the parent molecular group through a carbonyl group. In particular embodiments, the alkanoyl is —C(O)-Ak, in which Ak is an aliphatic or alkyl group, as defined herein. In some embodiments, an unsubstituted alkanoyl is a C₂₋₇ alkanoyl group. Non-limiting examples of alkanoyl groups include acetyl.

By “acyloxy” or “alkanoyloxy,” as used interchangeably herein, is meant an acyl or alkanoyl group, as defined herein, attached to the parent molecular group through an oxy group. In particular embodiments, the alkanoyloxy is —O—C(O)-Ak, in which Ak is an aliphatic or alkyl group, as defined herein. In some embodiments, an unsubstituted alkanoyloxy is a C₂₋₇ alkanoyloxy group. Non-limiting examples of alkanoyloxy groups include acetoxy.

By “acyl halide” is meant —C(O)X, where X is a halogen, such as Br, F, I, or Cl.

By “aliphatic” is meant a hydrocarbon group having at least one carbon atom to 50 carbon atoms (C₁₋₅₀), such as one to 25 carbon atoms (C₁₋₂₅), or one to ten carbon atoms (C₁₋₁₀), and which includes alkanes (or alkyl, e.g., as described herein), alkenes (or alkenyl), alkynes (or alkynyl), including cyclic versions thereof, and further including straight- and branched-chain arrangements, and all stereo and position isomers as well. Such a hydrocarbon can be unsubstituted or substituted with one or more groups, such as groups described herein for an alkyl group.

By “aliphatic-aryl” is meant an aryl group that is or can be coupled to a compound disclosed herein, where the aryl group is or becomes coupled through an aliphatic group, as defined herein. In some embodiments, the aliphatic-aryl group is -L-R, in which L is an aliphatic group, as defined herein, and R is an aryl group, as defined herein.

By “aliphatic-heteroaryl” is meant a heteroaryl group that is or can be coupled to a compound disclosed herein, wherein the heteroaryl group is or becomes coupled through an aliphatic group, as defined herein. In some embodiments, the aliphatic-heteroaryl group is -L-R, in which L is an aliphatic group, as defined herein, and R is a heteroaryl group, as defined herein.

By “alkenyl” is meant an optionally substituted C₂₋₂₄ alkyl group having one or more double bonds. The alkenyl group can be cyclic (e.g., C₃₋₂₄ cycloalkenyl) or acyclic. The alkenyl group can also be substituted or unsubstituted. For example, the alkenyl group can be substituted with one or more substitution groups, as described herein for alkyl. Non-limiting unsubstituted alkenyl groups include allyl and vinyl. In some embodiments, the unsubstituted alkenyl group is a C₂₋₆, C₂₋₈, C₂₋₁₀, C₂₋₁₂, C₂₋₁₆, C₂₋₁₈, C₂₋₂₀, C₂₋₂₄, C₃₋₈, C₃₋₁₀, C₃₋₁₂, C₃₋₁₆, C₃₋₁₈, C₃₋₂₀, or C₃₋₂₄ alkenyl group. Non-limiting examples of alkenyl groups include vinyl or ethenyl (—CH═CH₂), 1-propenyl (—CH═CHCH₃), allyl or 2-propenyl (—CH₂—CH═CH₂), 1-butenyl (—CH═CHCH₂CH₃), 2-butenyl (—CH₂CH═CHCH₃), 3-butenyl (—CH₂CH₂CH═CH₂), 2-butenylidene (═CH—CH═CHCH₃), and the like.

By “alkenylene” is meant a multivalent (e.g., bivalent) form of an alkenyl group, which is an optionally substituted C₂₋₂₄ alkyl group having one or more double bonds. The alkenylene group can be cyclic (e.g., C₃₋₂₄ cycloalkenyl) or acyclic. The alkenylene group can be substituted or unsubstituted. For example, the alkenylene group can be substituted with one or more substitution groups, as described herein for alkyl. Non-limiting examples of alkenylene include —CH═CH— or —CH═CHCH₂—.

By “alkoxy” is meant —OR, where R is an optionally substituted aliphatic or alkyl group, as described herein. Non-limiting examples of alkoxy groups include methoxy, ethoxy, n-propoxy, isopropoxy, n-butoxy, t-butoxy, sec-butoxy, n-pentoxy, trihaloalkoxy, such as trifluoromethoxy, etc. The alkoxy group can be substituted or unsubstituted. For example, the alkoxy group can be substituted with one or more substitution groups, as described herein for alkyl. Non-limiting examples of unsubstituted alkoxy include C₁₋₃, C₁₋₆, C₁₋₁₂, C₁₋₁₆, C₁₋₁₈, C₁₋₂₀, or C₁₋₂₄ alkoxy groups.

By “alkoxyalkyl” is meant an alkyl group, as defined herein, which is substituted with an alkoxy group, as defined herein. Non-limiting examples of unsubstituted alkoxyalkyl groups include between 2 to 12 carbons (C₂₋₁₂ alkoxyalkyl), as well as those having an alkyl group with 1 to 6 carbons and an alkoxy group with 1 to 6 carbons (i.e., C₁₋₆ alkoxy-C₁₋₆ alkyl). In some embodiments, the alkoxyalkyl group is -L-O—R, in which L is an alkylene group, as defined herein, and R is an alkyl group, as defined herein.

By “alkyl” and the prefix “alk” is meant a branched or unbranched saturated hydrocarbon group of 1 to 24 carbon atoms, such as methyl (Me), ethyl (Et), n-propyl (n-Pr), isopropyl (i-Pr), cyclopropyl, n-butyl (n-Bu), isobutyl (i-Bu), s-butyl (s-Bu), t-butyl (t-Bu), cyclobutyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic (e.g., C₃₋₂₄ cycloalkyl) or acyclic. The alkyl group can be branched or unbranched. The alkyl group can also be substituted or unsubstituted. For example, the alkyl group can be substituted with one or more alkenyl, alkoxy, alkynyl, amino, aryl, carboxyaldehyde (e.g., —C(O)H), carboxyl (e.g., —CO₂H), cyano (e.g., —CN), halo, nitro (e.g., —NO₂), oxo (e.g., ═O), and the like. In another example, the alkyl group can be substituted with one, two, three or, in the case of alkyl groups of two carbons or more, four substituents independently selected from the group consisting of: (1) C₁₋₆ alkoxy (e.g., —O—R, in which R is C₁₋₆ alkyl); (2) C₁₋₆ alkylsulfinyl (e.g., —S(O)—R, in which R is C₁₋₆ alkyl); (3) C₁₋₆ alkylsulfonyl (e.g., —SO₂—R, in which R is C₁₋₆ alkyl); (4) amine (e.g., —C(O)NR¹R² or —NHCOR¹, where each of R¹ and R² is, independently, selected from hydrogen, aliphatic, heteroaliphatic, haloaliphatic, haloheteroaliphatic, aromatic, as defined herein, or any combination thereof, or R¹ and R², taken together with the nitrogen atom to which each are attached, can form a heterocyclyl group, as defined herein); (5) aryl (e.g., C₄₋₁₈ aryl); (6) arylalkoxy (e.g., —O-L-R, in which L is C₁₋₆ alkylene and R is C₄₋₁₈ aryl); (7) aryloyl (e.g., —C(O)—R, in which R is C₄₋₁₈ aryl); (8) azido (e.g., —N₃); (9) cyano (e.g., —CN); (10) aldehyde (e.g., —C(O)H); (11) C3-B cycloalkyl; (12) halo; (13) heterocyclyl (e.g., as defined herein, such as a 5-, 6- or 7-membered ring containing one, two, three, or four non-carbon heteroatoms); (14) heterocyclyloxy (e.g., —O—R, in which R is heterocyclyl, as defined herein); (15) heterocyclyloyl (e.g., —C(O)—R, in which R is heterocyclyl, as defined herein); (16) hydroxy (e.g., —OH); (17) N-protected amino; (18) nitro (e.g., —NO₂); (19) oxo (e.g., ═O); (20) C₁₋₆ thioalkoxy (e.g., —S—R, in which R is alkyl); (21) thiol (e.g., —SH); (22) —CO₂R¹, where R¹ is selected from the group consisting of (a) hydrogen, (b) C₁₋₆ alkyl, (c) C₄₋₁₃ aryl, and (d) C₁₋₆ alkyl-C₄₋₁₈ aryl (e.g., -L-R, in which L is C₁₋₆ alkylene and R is C₄₋₁₈ aryl); (23) —C(O)NR¹R², where each of R¹ and R² is, independently, selected from the group consisting of (a) hydrogen, (b) C₁₋₆ alkyl, (c) C₄₋₁₈ aryl, and (d) C₁₋₆ alkyl-C₄₋₁₈ aryl (e.g., -L-R, in which L is C₁₋₆ alkylene and R is C₄₋₁₈ aryl); (24) —SO₂R¹, where R¹ is selected from the group consisting of (a) C₁₋₆ alkyl, (b) C₄₋₁₈ aryl, and (c) C₁₋₆ alkyl-C₄₋₁₈ aryl (e.g., -L-R, in which L is C₁₋₆ alkylene and R is C₄₋₁₈ aryl); (25) —SO₂NR¹R², where each of R¹ and R² is, independently, selected from the group consisting of (a) hydrogen, (b) C₁₋₆ alkyl, (c) C₄₋₁₈ aryl, and (d) C₁₋₆ alkyl-C₄₋₁₈ aryl (e.g., -L-R, in which L is C₁₋₆ alkylene and R is C₄₋₁₈ aryl); and (26) —NR¹R², where each of R¹ and R² is, independently, selected from the group consisting of (a) hydrogen, (b) an N-protecting group, (c) C₁₋₆ alkyl, (d) C₂₋₆ alkenyl, (e) C₂₋₆ alkynyl, (f) C₄₋₁₈ aryl, (g) C₁₋₆ alkyl-C₄₋₁₈ aryl (e.g., -L-R, in which L is C₁₋₆ alkylene and R is C₄₋₁₈ aryl), (h) C₃₋₈ cycloalkyl, and (i) C₁₋₆ alkyl-C₃₋₈ cycloalkyl (e.g., -L-R, in which L is C₁₋₆ alkylene and R is C₃₋₈ cycloalkyl), wherein in one embodiment no two groups are bound to the nitrogen atom through a carbonyl group or a sulfonyl group. The alkyl group can be a primary, secondary, or tertiary alkyl group substituted with one or more substituents (e.g., one or more halo or alkoxy). In some embodiments, the unsubstituted alkyl group is a C₁₋₃, C₁₋₄, C₁₋₆, C₁₋₈, C₁₋₁₀, C₁₋₁₂, C₁₋₁₆, C₁₋₁₈, C₁₋₂₀, C₁₋₂₄, C₂₋₆, C₂₋₈, C₂₋₁₀, C₂₋₁₂, C₂₋₁₆, C₂₋₁₈, C₂₋₂₀, C₂₋₂₄, C₃₋₈, C₃₋₁₀, C₃₋₁₂, C₃₋₁₆, C₃₋₁₈, C₃₋₂₀, or C₃₋₂₄ alkyl group.

By “alkylene” is meant a multivalent (e.g., bivalent) form of an aliphatic or alkyl group, as described herein. Non-limiting examples of alkylene groups include methylene, ethylene, propylene, butylene, etc. In some embodiments, the alkylene group is a C₁₋₃, C₁₋₄, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. The alkylene group can be branched or unbranched. The alkylene group can also be substituted or unsubstituted. For example, the alkylene group can be substituted with one or more substitution groups, as described herein for alkyl.

The term “alkylsilyl,” as used herein, refers to —SiR¹R²R³ group, wherein R¹ is an optionally substituted alkyl, and wherein each of R² and R³ is independently selected from H and an optionally substituted alkyl. Alkylsilyls include mono, bis, and tris alkylsilyls. Examples of alkylsilyls include trimethylsilyl, dimethylsilyl, methylsilyl, triethylsilyl, diethylsilyl, ethylsilyl, and the like.

By “alkylsulfinyl” is meant an alkyl group, as defined herein, attached to the parent molecular group through an —S(O)— group. In some embodiments, the unsubstituted alkylsulfinyl group is a C₁₋₆ or C₁₋₁₂ alkylsulfinyl group. In other embodiments, the alkylsulfinyl group is —S(O)—R, in which R is an alkyl group, as defined herein.

By “alkylsulfinylalkyl” is meant an alkyl group, as defined herein, substituted by an alkylsulfinyl group. In some embodiments, the unsubstituted alkylsulfinylalkyl group is a C₂₋₁₂ or C₂₋₂₄ alkylsulfinylalkyl group (e.g., C₁₋₆ alkylsulfinyl-C₁₋₆ alkyl or C₁₋₁₂ alkylsulfinyl-C₁₋₁₂ alkyl). In other embodiments, the alkylsulfinylalkyl group is -L-S(O)—R, in which L is alkylene, as defined herein, and R is an alkyl group, as defined herein.

By “alkylsulfonyl” is meant an alkyl group, as defined herein, attached to the parent molecular group through an —SO₂— group. In some embodiments, the unsubstituted alkylsulfonyl group is a C₁₋₆ or C₁₋₁₂ alkylsulfonyl group. In other embodiments, the alkylsulfonyl group is —SO₂—R, where R is an optionally substituted alkyl (e.g., as described herein, including optionally substituted C₁₋₁₂ alkyl, haloalkyl, or perfluoroalkyl).

By “alkylsulfonylalkyl” is meant an alkyl group, as defined herein, substituted by an alkylsulfonyl group. In some embodiments, the unsubstituted alkylsulfonylalkyl group is a C₂₋₁₂ or C₂₋₂₄ alkylsulfonylalkyl group (e.g., C₁₋₆ alkylsulfonyl-C₁₋₆ alkyl or C₁₋₁₂ alkylsulfonyl-C₁₋₁₂ alkyl). In other embodiments, the alkylsulfonylalkyl group is -L-SO₂—R, in which L is alkylene, as defined herein, and R is an alkyl group, as defined herein.

By “alkynyl” is meant an optionally substituted C₂₋₂₄ alkyl group having one or more triple bonds. The alkynyl group can be cyclic or acyclic and is exemplified by ethynyl, 1-propynyl, and the like. The alkynyl group can also be substituted or unsubstituted. For example, the alkynyl group can be substituted with one or more substitution groups, as described herein for alkyl. Non-limiting unsubstituted alkynyl groups include C₂₋₈ alkynyl, C₂₋₆ alkynyl, C₂₋₅ alkynyl, C₂₋₄ alkynyl, or C₂₋₃ alkynyl. Non-limiting examples of alkynyl groups include ethynyl (—C≡CH), 1-propynyl (—C≡CCH₃), 2-propynyl or propargyl (—CH₂C≡CH), 1-butynyl (—C≡CCH₂CH₃), 2-butynyl (—CH₂C≡CCH₃), 3-butynyl (—CH₂CH₂C≡CH), and the like. In some embodiments, the unsubstituted alkynyl group is a C₂₋₆, C₂₋₈, C₂₋₁₀, C₂₋₁₂, C₂₋₁₆, C₂₋₁₈, C₂₋₂₀, C₂₋₂₄, C₃₋₈, C₃₋₁₀, C₃₋₁₂, C₃₋₁₆, C₃₋₁₈, C₃₋₂₀, or C₃₋₂₄ alkynyl group.

By “alkynylene” is meant a multivalent (e.g., bivalent) form of an alkynyl group, which is an optionally substituted C₂₋₂₄ alkyl group having one or more triple bonds. The alkynylene group can be cyclic or acyclic. The alkynylene group can be substituted or unsubstituted. For example, the alkynylene group can be substituted with one or more substitution groups, as described herein for alkyl. Non-limiting examples of alkynylene groups include —C≡C— or —C≡CCH₂—.

By “amido” is meant —C(O)NR¹R² or —NHCOR¹, where each of R¹ and R² is, independently, selected from hydrogen, aliphatic, heteroaliphatic, haloaliphatic, haloheteroaliphatic, aromatic, as defined herein, or any combination thereof, or where R¹ and R², taken together with the nitrogen atom to which each are attached, can form a heterocyclyl group, as defined herein.

By “amine” or “amino” is meant a —NR^{N1}R^{N2} group, a —NR^{N1}— group, or a compound having such a group, where each of R^{N1} and R^{N2} is, independently, H, optionally substituted aliphatic, alkyl, hydroxyalkyl, heteroaliphatic, heteroalkyl, aromatic, or aryl; or where R^{N1} and R^{N2}, taken together with the nitrogen atom to which each are attached, form a heterocyclyl group, as defined herein.

By “aminoalkyl” is meant an aliphatic or alkyl group, as described herein, substituted with one, two, three, or more amine groups. The aminoalkyl can include internal amine groups or terminal amine groups. The aminoalkyl group can be further substituted. For example, the aminoalkyl group can be substituted with one or more substitution groups, as described herein for alkyl. Non-limiting examples of unsubstituted aminoalkyl groups include C₁₋₃, C₁₋₆, C₁₋₁₂, C₁₋₁₆, C₁₋₁₈, C₁₋₂₀, or C₁₋₂₄ aminoalkyl groups. In some embodiments, the aminoalkyl group is -L-NR¹R², in which L is an aliphatic or alkylene group, as defined herein, and each of R¹ and R² is, independently, selected from hydrogen, aliphatic, heteroaliphatic, haloaliphatic, haloheteroaliphatic, aromatic, as defined herein, or any combination thereof; or R¹ and R², taken together with the nitrogen atom to which each are attached, can form a heterocyclyl group, as defined herein. In other embodiments, the aminoalkyl group is -L-C(NR¹R²)(R³)—R⁴, in which L is a covalent bond, an aliphatic group, or an alkylene group, as defined herein; each of R¹ and R² is, independently, selected from hydrogen, aliphatic, heteroaliphatic, haloaliphatic, haloheteroaliphatic, aromatic, as defined herein, or any combination thereof; or R¹ and R², taken together with the nitrogen atom to which each are attached, can form a heterocyclyl group, as defined herein; and each of R³ and R⁴ is, independently, H or alkyl, as defined herein.

By “aminoaryl” is meant an aromatic or aryl group, as defined herein, substituted by an amino group, as defined herein.

By “aromatic” is meant a cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized π-electron system. Typically, the number of out of plane π-electrons corresponds to the Huckel rule (4n+2). The point of attachment to the parent structure typically is through an aromatic portion of the condensed ring system.

By “aryl” is meant an aromatic carbocyclic group comprising at least five carbon atoms to 15 carbon atoms (C₅₋₁₅), such as five to ten carbon atoms (C₅₋₁₀), having a single ring or multiple condensed rings, which condensed rings can or may not be aromatic provided that the point of attachment to a remaining position of the compounds disclosed herein is through an atom of the aromatic carbocyclic group. Aryl groups may be substituted with one or more groups other than hydrogen, such as alkyl, as well as any substitution groups described herein for alkyl. Non-limiting examples of aryl groups include, but are not limited to, benzyl, naphthalene, phenyl, biphenyl, phenoxybenzene, and the like. The term aryl also includes heteroaryl, which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be substituted with one, two, three, four, or five substituents provided herein for alkyl. In particular embodiments, an unsubstituted aryl group is a C₄₋₁₆, C₄₋₁₄, C₄₋₁₂, C₄₋₁₀, C₆₋₁₈, C₆₋₁₄, C₆₋₁₂, or C₆₋₁₀ aryl group.

By “arylene” is meant a multivalent (e.g., bivalent) form of an aromatic or aryl group, as described herein. Non-limiting examples of arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. The arylene group can be branched or unbranched. The arylene group can also be substituted or unsubstituted. For example, the arylene group can be substituted with one or more substitution groups, as described herein for alkyl or aryl.

By “aryloxy” is meant —OR, where R is an optionally substituted aromatic or aryl group, as described herein. In some embodiments, an unsubstituted aryloxy group is a C₄₋₁₈ or C₆₋₁₈ aryloxy group.

By “arylalkoxy” is meant an alkyl-aryl group, as defined herein, attached to the parent molecular group through an oxygen atom. In some embodiments, the arylalkoxy group is —O-L-R, in which L is an alkylene group, as defined herein, and R is an aryl group, as defined herein.

By “aryloxycarbonyl” is meant an aryloxy group, as defined herein, that is attached to the parent molecular group through a carbonyl group. In some embodiments, an unsubstituted aryloxycarbonyl group is a C₅₋₁₉ aryloxycarbonyl group. In other embodiments, the aryloxycarbonyl group is —C(O)O—R, in which R is an aryl group, as defined herein.

By “aryloyl” is meant an aryl group that is attached to the parent molecular group through a carbonyl group. In some embodiments, an unsubstituted aryloyl group is a C₇₋₁₁ aryloyl or C₅₋₁₉ aryloyl group. In other embodiments, the aryloyl group is —C(O)—R, in which R is an aryl group, as defined herein.

By “(aryl)(alkyl)ene” is meant a bivalent form including an arylene group, as described herein, attached to an alkylene or a heteroalkylene group, as described herein. In some embodiments, the (aryl)(alkyl)ene group is -L-Ar— or -L-Ar-L- or —Ar-L-, in which Ar is an aromatic or arylene group and each L is, independently, an optionally substituted aliphatic, alkylene group, heteroaliphatic, or heteroalkylene group.

By “borono” is meant a —B(OH)₂ group.

By “carbonyl” is meant a —C(O)— group, which can also be represented as >C═O, or a —CO— group.

By “carboxyl” or “carboxylic acid” is meant a —CO₂H group or a compound including such a group, including deprotonated and protonated forms thereof.

By “carboxyalkyl” is meant an alkyl group, as defined herein, substituted by one or more carboxyl groups, as defined herein.

By “carboxyaryl” is meant an aryl group, as defined herein, substituted by one or more carboxyl groups, as defined herein.

By “cycloaliphatic” is meant an aliphatic group, as defined herein, that is cyclic.

By “cycloalkoxy” is meant a cycloalkyl group, as defined herein, attached to the parent molecular group through an oxygen atom. In some embodiments, the cycloalkoxy group is —O—R, in which R is a cycloalkyl group, as defined herein.

By “cycloalkylalkoxy” is meant an alkyl-cycloalkyl group, as defined herein, attached to the parent molecular group through an oxygen atom. In some embodiments, the cycloalkylalkoxy group is —O-L-R, in which L is an alkylene group, as defined herein, and R is a cycloalkyl group, as defined herein.

By “cycloalkyl” is meant a monovalent saturated or unsaturated non-aromatic cyclic hydrocarbon group of from three to eight carbons, unless otherwise specified, and is exemplified by cyclopropyl, cyclobutyl, cyclopentyl, cyclohexyl, cycloheptyl, bicyclo[2.2.1.heptyl], and the like. The cycloalkyl group can also be substituted or unsubstituted. For example, the cycloalkyl group can be substituted with one or more groups including those described herein for alkyl.

By “cycloheteroaliphatic” is meant a heteroaliphatic group, as defined herein, that is cyclic.

By “disulfide” is meant —SSR, where R is selected from hydrogen, aliphatic, heteroaliphatic, haloaliphatic, haloheteroaliphatic, aromatic, as defined herein, or any combination thereof.

By “halo” is meant F, Cl, Br, or I.

By “haloaliphatic” is meant an aliphatic group, as defined herein, substituted with one or more halo.

By “haloalkyl” is meant an alkyl group, as defined herein, substituted with one or more halo.

By “haloalkenyl” is meant an alkenyl group, as defined herein, substituted with one or more halo.

By “haloalkynyl” is meant an alkynyl group, as defined herein, substituted with one or more halo.

By “haloalkylene” is meant an alkylene group, as defined herein, substituted with one or more halo.

By “haloheteroaliphatic” is meant a heteroaliphatic, as defined herein, in which one or more hydrogen atoms, such as one to 10 hydrogen atoms, independently is replaced with a halogen atom, such as fluoro, bromo, chloro, or iodo.

By “heteroaliphatic” is meant an aliphatic group, as defined herein, including at least one heteroatom to 20 heteroatoms, such as one to 15 heteroatoms, or one to 5 heteroatoms, which can be selected from, but not limited to boron, halo, nitrogen, oxygen, phosphorus, selenium, silicon, sulfur, and, if applicable, oxidized forms thereof within the group.

By “heteroalkyl,” “heteroalkenyl,” and “heteroalkynyl” is meant an alkyl, alkenyl, or alkynyl group (which can be branched, straight-chain, or cyclic), respectively, as defined herein, including at least one heteroatom to 20 heteroatoms, such as one to 15 heteroatoms, or one to 5 heteroatoms, which can be selected from, but not limited to, boron, halo, nitrogen (e.g., as present in imino), oxygen, phosphorus, selenium, silicon, sulfur, and, if applicable, oxidized forms thereof within the group.

By “heteroalkylene” is meant a multivalent (e.g., bivalent) form of a heteroaliphatic or heteroalkyl group, as described herein. The heteroalkylene group can be substituted or unsubstituted. For example, the heteroalkylene group can be substituted with one or more substitution groups, as described herein for alkyl.

By “heteroalkenylene” is meant a multivalent (e.g., bivalent) form of a heteroalkenyl group, which is an optionally substituted heteroalkyl group having one or more double bonds. The heteroalkenylene group can be cyclic or acyclic. The heteroalkenylene group can be substituted or unsubstituted. For example, the heteroalkenylene group can be substituted with one or more substitution groups, as described herein for alkyl.

By “heteroalkynylene” is meant a multivalent (e.g., bivalent) form of a heteroalkynyl group, which is an optionally substituted heteroalkyl group having one or more triple bonds. The heteroalkynylene group can be cyclic or acyclic. The heteroalkynylene group can be substituted or unsubstituted. For example, the heteroalkynylene group can be substituted with one or more substitution groups, as described herein for alkyl.

By “heteroaromatic” is meant an aromatic group, as defined herein, including at least one heteroatom to 20 heteroatoms, such as one to 15 heteroatoms, or one to 5 heteroatoms, which can be selected from, but not limited to boron, nitrogen, oxygen, phosphorus, selenium, silicon, sulfur, and oxidized forms thereof within the group.

By “heteroaryl” is meant an aryl group including at least one heteroatom to six heteroatoms, such as one to four heteroatoms, which can be selected from, but not limited to, boron, nitrogen, oxygen, phosphorus, selenium, silicon, sulfur, and oxidized forms thereof within the ring. Such heteroaryl groups can have a single ring or multiple condensed rings, where the condensed rings may or may not be aromatic or may contain a heteroatom, provided that the point of attachment is through an atom of the aromatic heteroaryl group. Heteroaryl groups may be substituted with one or more groups other than hydrogen, such as alkyl, as well as any substitution groups described herein for alkyl. A non-limiting example of heteroaryl includes a subset of heterocyclyl groups, as defined herein, which are aromatic, i.e., they contain 4n+2 pi electrons within the mono- or multicyclic ring system.

By “heteroarylene” is meant a multivalent (e.g., bivalent) form of a heteroaromatic or heteroaryl group, as described herein. Non-limiting examples of heteroarylene groups include pyridinylene and the like. In some embodiments, the heteroarylene group is a C₄₋₁₈, C₄₋₁₄, C₄₋₁₂, C₄₋₁₀, C₆₋₁₈, C₆₋₁₄, C₆₋₁₂, or C₆₋₁₀ heteroarylene group. The heteroarylene group can be branched or unbranched. The heteroarylene group can also be substituted or unsubstituted. For example, the heteroarylene group can be substituted with one or more substitution groups, as described herein for alkyl or aryl.

By “heterocyclyl” is meant a 3-, 4-, 5-, 6- or 7-membered ring (e.g., a 5-, 6- or 7-membered ring), unless otherwise specified, containing one, two, three, or four non-carbon heteroatoms (e.g., independently selected from the group consisting of nitrogen, oxygen, phosphorus, selenium, silicon, or sulfur). The 3-membered ring has zero to one double bonds, the 4- and 5-membered ring has zero to two double bonds, and the 6- and 7-membered rings have zero to three double bonds. The term “heterocyclyl” also includes bicyclic, tricyclic, tetracyclic, or other multicyclic groups. Heterocyclics include acridinyl, adenyl, alloxazinyl, azaadamantanyl, azabenzimidazolyl, azabicyclononyl, azacycloheptyl, azacyclooctyl, azacyclononyl, azahypoxanthinyl, azaindazolyl, azaindolyl, azecinyl, azepanyl, azepinyl, azetidinyl, azetyl, aziridinyl, azirinyl, azocanyl, azocinyl, azonanyl, benzimidazolyl, benzisothiazolyl, benzisoxazolyl, benzodiazepinyl, benzodiazocinyl, benzodihydrofuryl, benzodioxepinyl, benzodioxinyl, benzodioxanyl, benzodioxocinyl, benzodioxolyl, benzodithiepinyl, benzodithiinyl, benzodioxocinyl, benzofuranyl, benzophenazinyl, benzopyranonyl, benzopyranyl, benzopyrenyl, benzopyronyl, benzoquinolinyl, benzoquinolizinyl, benzothiadiazepinyl, benzothiadiazolyl, benzothiazepinyl, benzothiazocinyl, benzothiazolyl, benzothienyl, benzothiophenyl, benzothiazinonyl, benzothiazinyl, benzothiopyranyl, benzothiopyronyl, benzotriazepinyl, benzotriazinonyl, benzotriazinyl, benzotriazolyl, benzoxathiinyl, benzotrioxepinyl, benzoxadiazepinyl, benzoxathiazepinyl, benzoxathiepinyl, benzoxathiocinyl, benzoxazepinyl, benzoxazinyl, benzoxazocinyl, benzoxazolinonyl, benzoxazolinyl, benzoxazolyl, benzylsultamyl, benzylsultimyl, bipyrazinyl, bipyridinyl, carbazolyl (e.g., 4H-carbazolyl), carbolinyl (e.g., P-carbolinyl), chromanonyl, chromanyl, chromenyl, cinnolinyl, coumarinyl, cytdinyl, cytosinyl, decahydroisoquinolinyl, decahydroquinolinyl, diazabicyclooctyl, diazetyl, diaziridinethionyl, diaziridinonyl, diaziridinyl, diazirinyl, dibenzisoquinolinyl, dibenzoacridinyl, dibenzocarbazolyl, dibenzofuranyl, dibenzophenazinyl, dibenzopyranonyl, dibenzopyronyl (xanthonyl), dibenzoquinoxalinyl, dibenzothiazepinyl, dibenzothiepinyl, dibenzothiophenyl, dibenzoxepinyl, dihydroazepinyl, dihydroazetyl, dihydrofuranyl, dihydrofuryl, dihydroisoquinolinyl, dihydropyranyl, dihydropyridinyl, dihydroypyridyl, dihydroquinolinyl, dihydrothienyl, dihydroindolyl, dioxanyl, dioxazinyl, dioxindolyl, dioxiranyl, dioxenyl, dioxinyl, dioxobenzofuranyl, dioxolyl, dioxotetrahydrofuranyl, dioxothiomorpholinyl, dithianyl, dithiazolyl, dithienyl, dithiinyl, furanyl, furazanyl, furoyl, furyl, guaninyl, homopiperazinyl, homopiperidinyl, hypoxanthinyl, hydantoinyl, imidazolidinyl, imidazolinyl, imidazolyl, indazolyl (e.g., 1H-indazolyl), indolenyl, indolinyl, indolizinyl, indolyl (e.g., 1H-indolyl or 3H-indolyl), isatinyl, isatyl, isobenzofuranyl, isochromanyl, isochromenyl, isoindazoyl, isoindolinyl, isoindolyl, isopyrazolonyl, isopyrazolyl, isoxazolidiniyl, isoxazolyl, isoquinolinyl, isoquinolinyl, isothiazolidinyl, isothiazolyl, morpholinyl, naphthindazolyl, naphthindolyl, naphthiridinyl, naphthopyranyl, naphthothiazolyl, naphthothioxolyl, naphthotriazolyl, naphthoxindolyl, naphthyridinyl, octahydroisoquinolinyl, oxabicycloheptyl, oxauracil, oxadiazolyl, oxazinyl, oxaziridinyl, oxazolidinyl, oxazolidonyl, oxazolinyl, oxazolonyl, oxazolyl, oxepanyl, oxetanonyl, oxetanyl, oxetyl, oxtenayl, oxindolyl, oxiranyl, oxobenzoisothiazolyl, oxochromenyl, oxoisoquinolinyl, oxoquinolinyl, oxothiolanyl, phenanthridinyl, phenanthrolinyl, phenazinyl, phenothiazinyl, phenothienyl (benzothiofuranyl), phenoxathiinyl, phenoxazinyl, phthalazinyl, phthalazonyl, phthalidyl, phthalimidinyl, piperazinyl, piperidinyl, piperidonyl (e.g., 4-piperidonyl), pteridinyl, purinyl, pyranyl, pyrazinyl, pyrazolidinyl, pyrazolinyl, pyrazolopyrimidinyl, pyrazolyl, pyridazinyl, pyridinyl, pyridopyrazinyl, pyridopyrimidinyl, pyridyl, pyrimidinyl, pyrimidyl, pyronyl, pyrrolidinyl, pyrrolidonyl (e.g., 2-pyrrolidonyl), pyrrolinyl, pyrrolizidinyl, pyrrolyl (e.g., 2H-pyrrolyl), pyrylium, quinazolinyl, quinolinyl, quinolizinyl (e.g., 4H-quinolizinyl), quinoxalinyl, quinuclidinyl, selenazinyl, selenazolyl, selenophenyl, succinimidyl, sulfolanyl, tetrahydrofuranyl, tetrahydrofuryl, tetrahydroisoquinolinyl, tetrahydroisoquinolyl, tetrahydropyridinyl, tetrahydropyridyl (piperidyl), tetrahydropyranyl, tetrahydropyronyl, tetrahydroquinolinyl, tetrahydroquinolyl, tetrahydrothienyl, tetrahydrothiophenyl, tetrazinyl, tetrazolyl, thiadiazinyl (e.g., 6H-1,2,5-thiadiazinyl or 2H,6H-1,5,2-dithiazinyl), thiadiazolyl, thianthrenyl, thianyl, thianaphthenyl, thiazepinyl, thiazinyl, thiazolidinedionyl, thiazolidinyl, thiazolyl, thienyl, thiepanyl, thiepinyl, thietanyl, thietyl, thiiranyl, thiocanyl, thiochromanonyl, thiochromanyl, thiochromenyl, thiodiazinyl, thiodiazolyl, thioindoxyl, thiomorpholinyl, thiophenyl, thiopyranyl, thiopyronyl, thiotriazolyl, thiourazolyl, thioxanyl, thioxolyl, thymidinyl, thyminyl, triazinyl, triazolyl, trithianyl, urazinyl, urazolyl, uretidinyl, uretinyl, uricyl, uridinyl, xanthenyl, xanthinyl, xanthionyl, and the like, as well as modified forms thereof (e.g., including one or more oxo and/or amino) and salts thereof. The heterocyclyl group can be substituted or unsubstituted. For example, the heterocyclyl group can be substituted with one or more substitution groups, as described herein for alkyl.

By “heterocyclyloxy” is meant a heterocyclyl group, as defined herein, attached to the parent molecular group through an oxygen atom. In some embodiments, the heterocyclyloxy group is —O—R, in which R is a heterocyclyl group, as defined herein.

By “heterocyclyloyl” is meant a heterocyclyl group, as defined herein, attached to the parent molecular group through a carbonyl group. In some embodiments, the heterocyclyloyl group is —C(O)—R, in which R is a heterocyclyl group, as defined herein.

By “hydroxy” is meant —OH.

By “hydroxyalkyl” is meant an alkyl group, as defined herein, substituted by one to three hydroxy groups, with the proviso that no more than one hydroxy group may be attached to a single carbon atom of the alkyl group and is exemplified by hydroxymethyl, dihydroxypropyl, and the like.

By “hydroxyaryl” is meant an aryl group, as defined herein, substituted by one to three hydroxy groups, with the proviso that no more than one hydroxy group may be attached to a single carbon atom of the aryl group and is exemplified by hydroxyphenyl, dihydroxyphenyl, and the like.

By “imido” is meant a ═NR group, where R is selected from H, aliphatic, alkyl, heteroaliphatic, heteroalkyl, aromatic, or aryl, as defined herein, or any combination thereof.

By “imino” is meant —NR—, in which R can be H, optionally substituted aliphatic, alkyl, heteroaliphatic, heteroalkyl, aromatic, or aryl.

By “nitro” is meant an —NO₂ group.

By “nitroalkyl” is meant an alkyl group, as defined herein, substituted by one to three nitro groups. In some embodiments, the nitroalkyl group is -L-NO, in which L is an alkylene group, as defined herein. In other embodiments, the nitroalkyl group is -L-C(NO)(R¹)—R², in which L is a covalent bond or an alkylene group, as defined herein, and each of R¹ and R² is, independently, H or alkyl, as defined herein.

By “oxo” or “oxide” is meant an ═O group.

By “oxy” is meant —O—.

By “phosphono” or “phosphonic acid” is meant a —P(O)(OH)₂ group or a compound including such a group, including deprotonated and protonated forms thereof.

By “perfluoroalkyl” is meant an alkyl group, as defined herein, having each hydrogen atom substituted with a fluorine atom. Non-limiting examples of perfluoroalkyl groups include trifluoromethyl, pentafluoroethyl, etc. In some embodiments, the perfluoroalkyl group is —(CF₂)ₙCF₃, in which n is an integer from 0 to 20, 1 to 20, 1 to 18, 1 to 16, 1 to 14, 1 to 12, 1 to 10, 1 to 8, 2 to 20, 2 to 18, 2 to 16, 2 to 14, 2 to 12, 2 to 10, 2 to 8, and ranges therebetween.

By “perfluoroalkoxy” is meant an alkoxy group, as defined herein, having each hydrogen atom substituted with a fluorine atom. In some embodiments, the perfluoroalkoxy group is —O—R, in which R is a perfluoroalkyl group, as defined herein.

By “salt” is meant an ionic form of a compound or structure (e.g., any formulas, compounds, or compositions described herein), which includes a cation or anion compound to form an electrically neutral compound or structure. Salts are well known in the art. For example, non-toxic salts are described in Berge S. M. et al., “Pharmaceutical salts,” J. Pharm. Sci. 1977 January; 66(1):1-19; and in “Handbook of Pharmaceutical Salts: Properties, Selection, and Use,” Wiley-VCH, April 2011 (2nd rev. ed., eds. P. H. Stahl and C. G. Wermuth. The salts can be prepared in situ during the final isolation and purification of the compounds of the invention or separately by reacting the free base group with a suitable organic acid (thereby producing an anionic salt) or by reacting the acid group with a suitable metal or organic salt (thereby producing a cationic salt). Representative anionic salts include acetate, adipate, alginate, ascorbate, aspartate, benzenesulfonate, benzoate, bicarbonate, bisulfate, bitartrate, borate, bromide, butyrate, camphorate, camphorsulfonate, chloride, citrate, cyclopentanepropionate, digluconate, dihydrochloride, diphosphate, dodecylsulfate, edetate, ethanesulfonate, fumarate, glucoheptonate, gluconate, glutamate, glycerophosphate, hemisulfate, heptonate, hexanoate, hydrobromide, hydrochloride, hydroiodide, hydroxyethanesulfonate, hydroxynaphthoate, iodide, lactate, lactobionate, laurate, lauryl sulfate, malate, maleate, malonate, mandelate, mesylate, methanesulfonate, methylbromide, methylnitrate, methylsulfate, mucate, 2-naphthalenesulfonate, nicotinate, nitrate, oleate, oxalate, palmitate, pamoate, pectinate, persulfate, 3-phenylpropionate, phosphate, picrate, pivalate, polygalacturonate, propionate, salicylate, stearate, subacetate, succinate, sulfate, tannate, tartrate, theophyllinate, thiocyanate, triethiodide, toluenesulfonate, undecanoate, valerate salts, and the like. Representative cationic salts include metal salts, such as alkali or alkaline earth salts, e.g., barium, calcium (e.g., calcium edetate), lithium, magnesium, potassium, sodium, and the like; other metal salts, such as aluminum, bismuth, iron, and zinc; as well as nontoxic ammonium, quaternary ammonium, and amine cations, including, but not limited to ammonium, tetramethylammonium, tetraethylammonium, methylamine, dimethylamine, trimethylamine, triethylamine, ethylamine, pyridinium, and the like. Other cationic salts include organic salts, such as chloroprocaine, choline, dibenzylethylenediamine, diethanolamine, ethylenediamine, methylglucamine, and procaine. Yet other salts include ammonium, sulfonium, sulfoxonium, phosphonium, iminium, imidazolium, benzimidazolium, amidinium, guanidinium, phosphazinium, phosphazenium, pyridinium, etc., as well as other cationic groups described herein (e.g., optionally substituted isoxazolium, optionally substituted oxazolium, optionally substituted thiazolium, optionally substituted pyrrolium, optionally substituted furanium, optionally substituted thiophenium, optionally substituted imidazolium, optionally substituted pyrazolium, optionally substituted isothiazolium, optionally substituted triazolium, optionally substituted tetrazolium, optionally substituted furazanium, optionally substituted pyridinium, optionally substituted pyrimidinium, optionally substituted pyrazinium, optionally substituted triazinium, optionally substituted tetrazinium, optionally substituted pyridazinium, optionally substituted oxazinium, optionally substituted pyrrolidinium, optionally substituted pyrazolidinium, optionally substituted imidazolinium, optionally substituted isoxazolidinium, optionally substituted oxazolidinium, optionally substituted piperazinium, optionally substituted piperidinium, optionally substituted morpholinium, optionally substituted azepanium, optionally substituted azepinium, optionally substituted indolium, optionally substituted isoindolium, optionally substituted indolizinium, optionally substituted indazolium, optionally substituted benzimidazolium, optionally substituted isoquinolinum, optionally substituted quinolizinium, optionally substituted dehydroquinolizinium, optionally substituted quinolinium, optionally substituted isoindolinium, optionally substituted benzimidazolinium, and optionally substituted purinium).

By “silane” is meant —SiR^{S1}R^{S2}R^{S3}, —SiR^{S1}R^{S2}—, or a compound having such groups, where each of R^{S1}, R^{S2}, and R^{S3} is, independently, H, optionally substituted aliphatic, alkyl, heteroaliphatic, heteroalkyl, aromatic, aryl, amine, or others described herein; or R^{S1} and R^{S2}, taken together with the silicon atom to which each are attached, form a heterocyclyl group.

By “silyl ether” is meant a functional group including a silicon atom covalently bound to an alkoxy group, as defined herein. In some embodiments, the silyl ether is —Si—O—R or Si—O—R, in which R is an alkyl group, as defined herein.

By “sulfinyl” is meant an —S(O)— group.

By “sulfo” or “sulfonic acid” is meant an —S(O)₂OH group or a compound including such a group, including deprotonated and protonated forms thereof.

By “sulfonyl” or “sulfonate” is meant an —S(O)₂— group or a —SO₂R, where R is selected from hydrogen, aliphatic, alkyl, heteroaliphatic, heteroalkyl, haloaliphatic, haloheteroaliphatic, aromatic, aryl, as defined herein, or any combination thereof.

By “thio” is meant —S—.

By “thiol” is meant an —SH group.

By “thioalkoxy” is meant an alkyl group, as defined herein, attached to the parent molecular group through a sulfur atom. Non-limiting examples of unsubstituted thioalkoxy groups include C₁₋₆ thioalkoxy. In some embodiments, the thioalkoxy group is —S—R, in which R is an aliphatic or alkyl group, as defined herein.

By “thioalkoxyalkyl” is meant an alkyl group, as defined herein, which is substituted with a thioalkoxy group, as defined herein. Non-limiting examples of unsubstituted thioalkoxyalkyl groups include between 2 to 12 carbons (C₂₋₁₂ thioalkoxyalkyl), as well as those having an alkyl group with 1 to 6 carbons and a thioalkoxy group with 1 to 6 carbons (i.e., C₁₋₆ thioalkoxy-C₁₋₆ alkyl). In some embodiments, the thioalkoxyalkyl group is -L-S—R, in which L is alkylene, as defined herein, and R is an alkyl group, as defined herein.

### II. Methods of Forming a Functionalized Material

A functionalized material can be prepared in any useful manner. In some embodiments, a functionalization mixture is prepared, in which this mixture includes the substrate, a solvent, and one or more compounds to provide a functional portion. In some embodiments, at least one of the compounds includes an amine moiety, and at least one of the compounds includes a silane moiety. In particular embodiments, at least one compound includes both an amine moiety and a silane moiety.

The functionalization mixture can be prepared in any useful manner. In one non-limiting example, a suspension mixture is prepared including the substrate and a solvent. To this suspension mixture, a compound (to provide a functional portion) can be added to provide a functionalization mixture. Non-limiting examples of compounds include a silane coupling material, an aminosilane, a polyamine, or a combination of any of these compounds. In some embodiments, functionalization is conducted using solution-based reaction conditions.

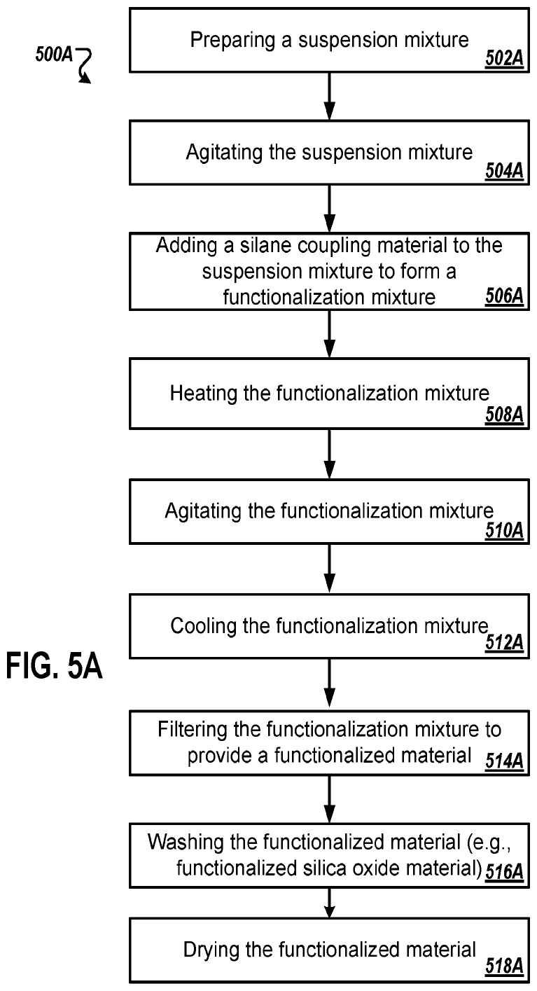

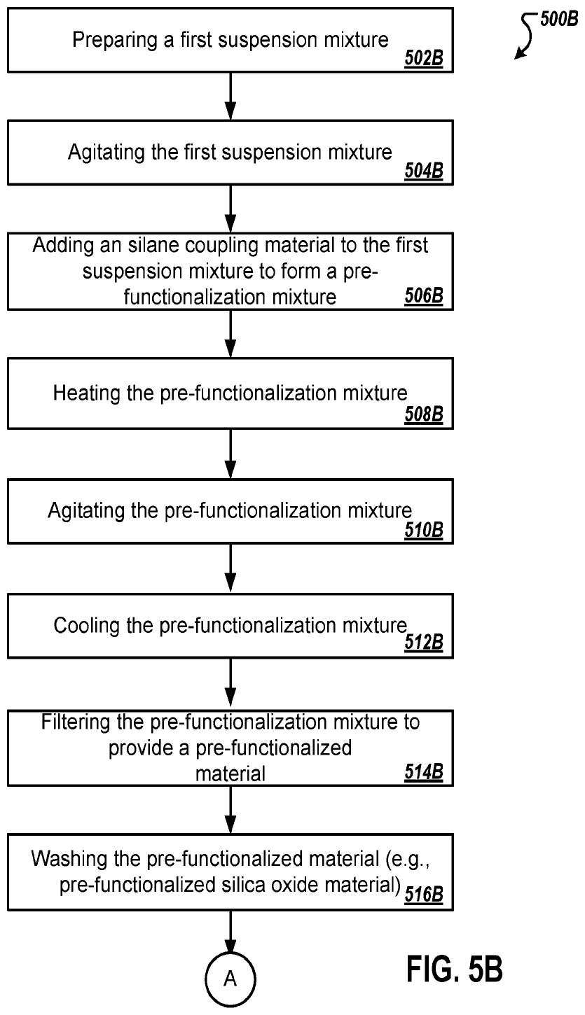

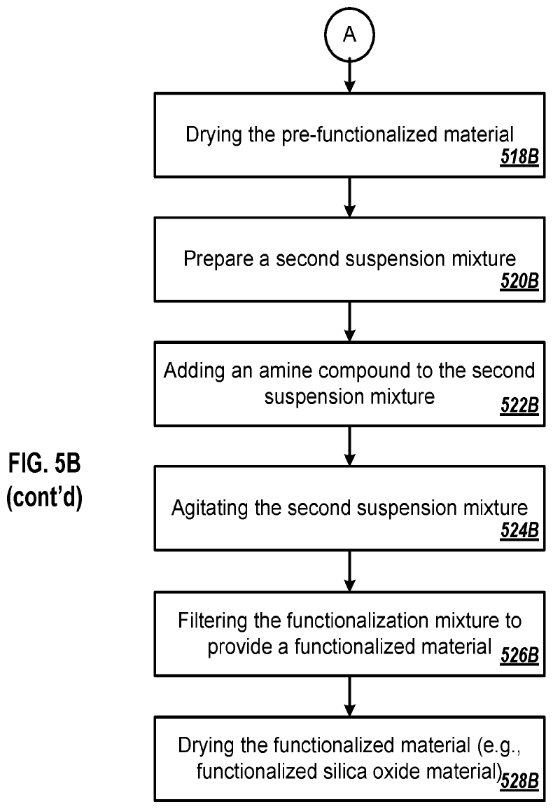

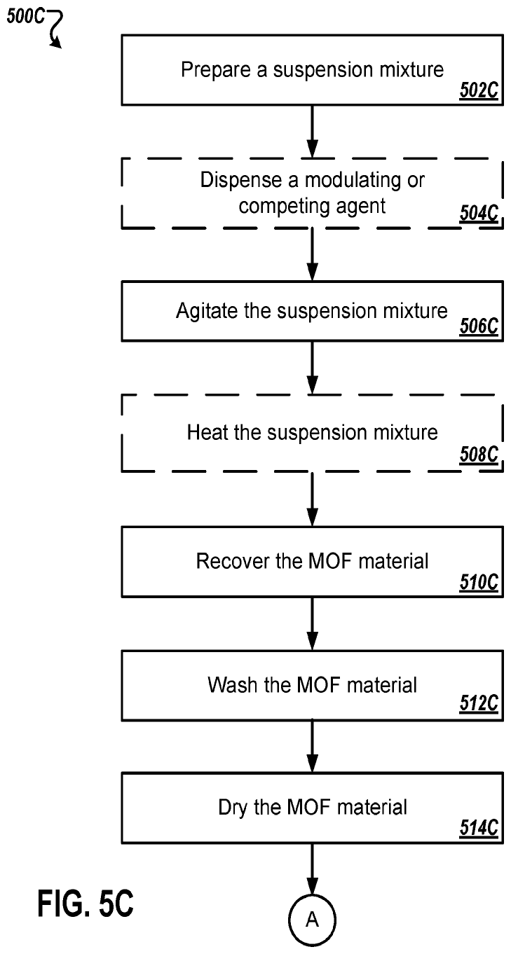

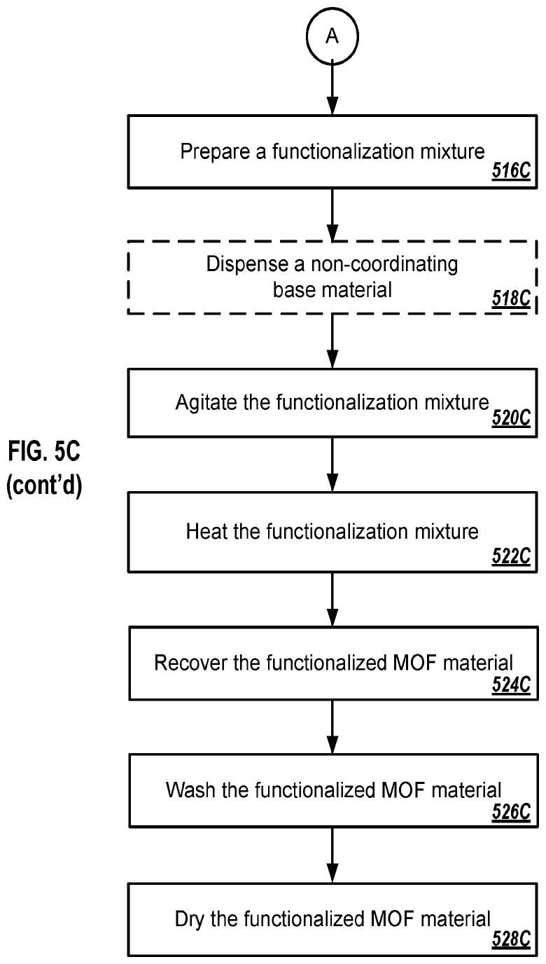

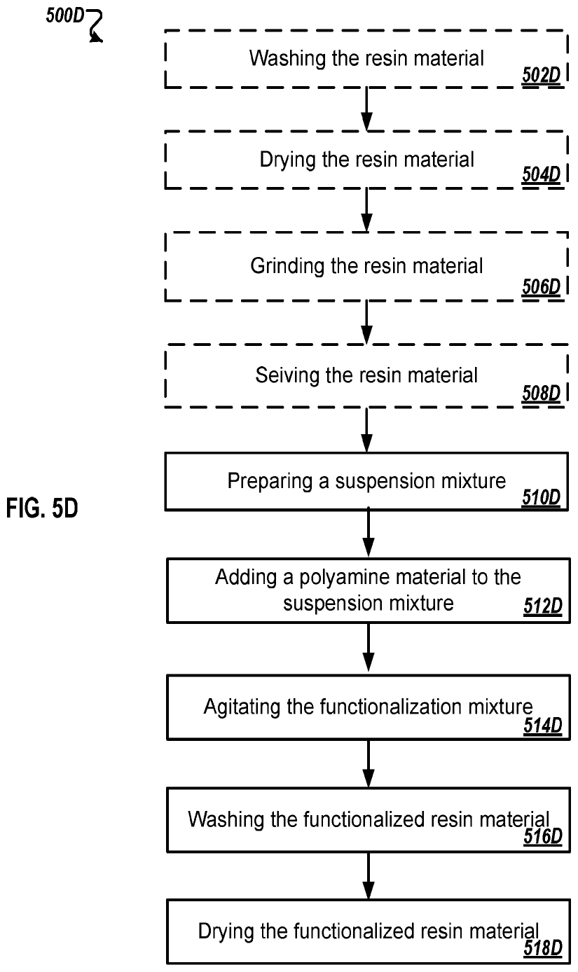

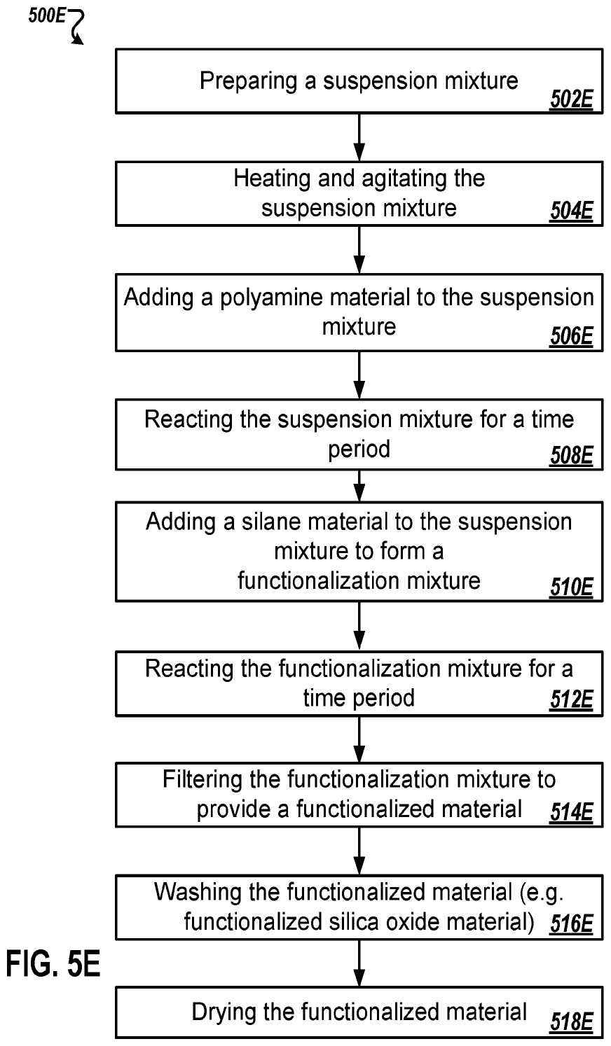

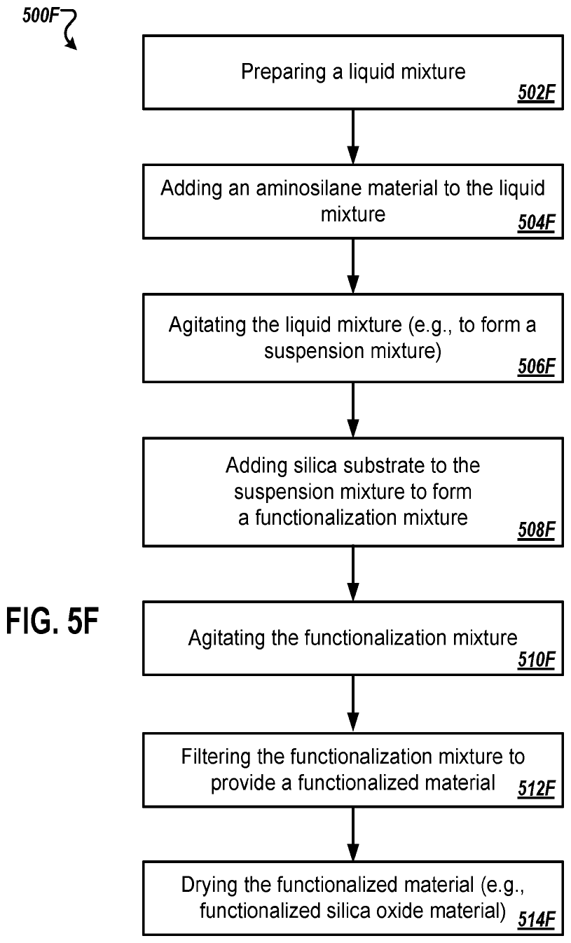

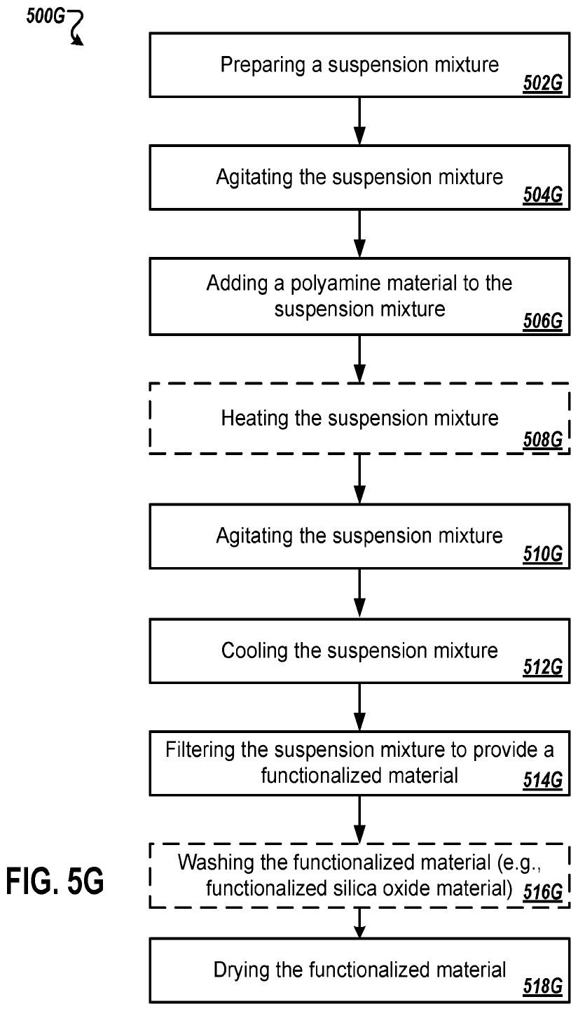

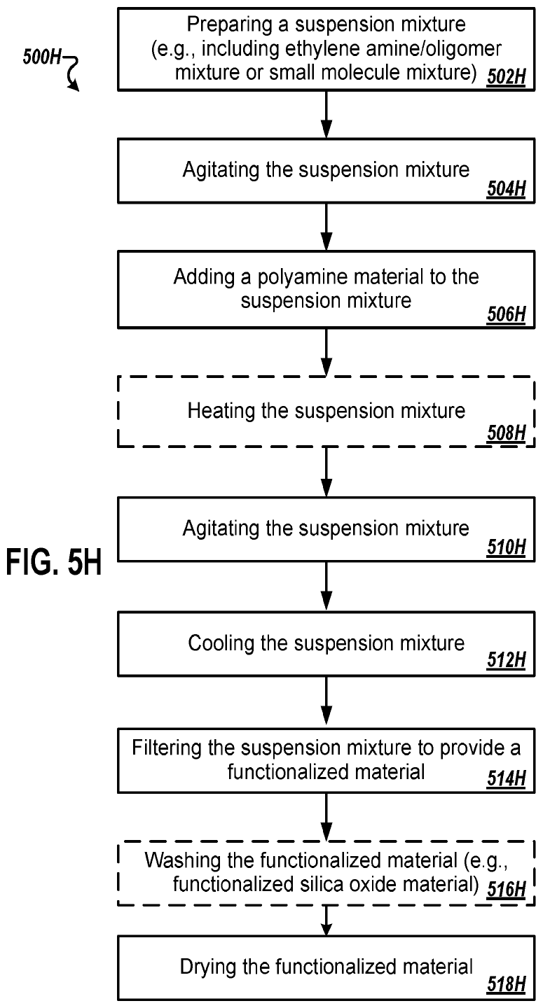

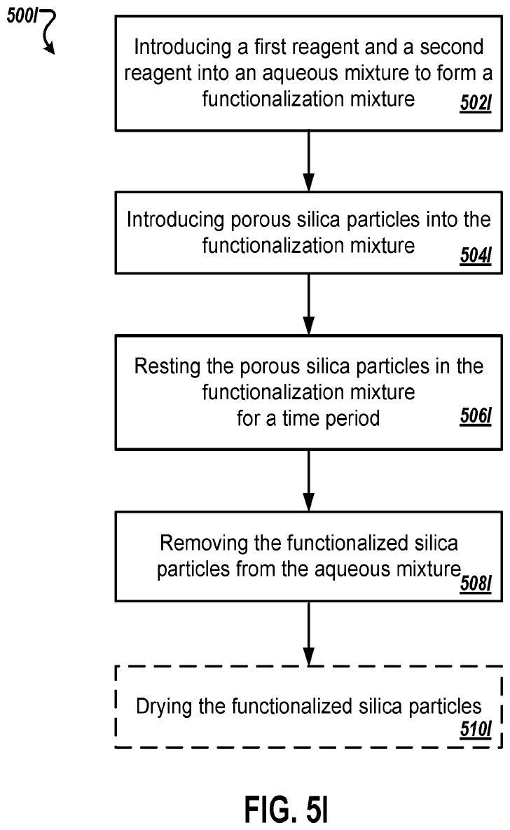

Various methods can be employed to provide the functionalized materials described herein. In some embodiments, a functionalized material (e.g., a functionalized porous silica) can be produced using solution-based reaction methods in which an aminosilane compound (e.g., a compound with an amine moiety and a silane moiety) is solvated and a substrate added. The silane moiety binds to the surface, and the amine moieties extend from the silane moiety. The functionalized substrate can be filtered from the solvent, washed, and dried. Such methods (e.g., such as the process in FIGS. 5A, 5B, and 5E) can provide any functionalized material described herein (e.g., a functionalized material 100A-100C in FIGS. 1A-1C).

In some embodiments, a pre-functionalized material (e.g., a functionalized porous silica) can be produced using solution-based reaction methods in which a silane-containing compound (e.g., an aminosilane compound with an amine moiety and a silane moiety) is solvated and a substrate added. The silane moiety (e.g., an alkoxysilane moiety) binds to the surface, and the amine moieties extend from the silane moiety. The pre-functionalized substrate can be filtered from the solvent, washed, and dried. The polymeric/oligomeric amine compound can be solvated, and the pre-functionalized substrate can be added. The mixture can be stirred and then dried, thereby functionalizing the substrate with both the silane-containing compound and the polymeric/oligomeric amine. Such methods (e.g., such as the process in FIGS. 5B and 5E) can provide any functionalized material described herein (e.g., a functionalized material 100A-100C in FIGS. 1A-IC).

In some embodiments, a functionalized material (e.g., a functionalized porous silica) can be produced using water-based reaction methods in which a polyamine (e.g., a compound with a plurality of amine moieties) and an aminosilane compound (e.g., a compound with an amine moiety and a silane moiety) is solvated in water and a substrate added. The polyamine and aminosilane compounds react to form a complex network, which in turn is bonded to a surface of the substrate. The resulting material can be filtered from water, optionally washed, and dried. Such methods (e.g., such as the process in FIG. 5F) can provide any functionalized material described herein (e.g., a functionalized material 100A-100C in FIGS. 1A-1C).

In some embodiments, a functionalized material (e.g., a functionalized porous silica) can be produced using solvent-based reaction methods in which a polyamine (e.g., a compound with a plurality of amine moieties) is solvated and a substrate added. In some embodiments, the polyamine has an increased number of amine moieties for increased carbon capture (e.g., >2 mol/kg) in the functionalized material. The resulting material can be stirred, optionally filtered, optionally washed, and dried. Such methods (e.g., such as the process in FIG. 5G) can provide any functionalized material described herein (e.g., a functionalized material 100A-100C in FIGS. 1A-1C).

In some embodiments, a functionalized material (e.g., a functionalized porous silica) can be produced using solvent-based reaction methods in which an oligomeric ethylene amine compound (e.g., a compound with a plurality of ethylene groups and amine moieties, as well as mixtures of such compounds, including any described herein) is solvated and a substrate added. In some embodiments, the oligomeric ethylene amine compound or a mixture thereof has an increased number of amine moieties for increased carbon capture (e.g., >1 mol/kg) in the functionalized material. The resulting material can be stirred, optionally filtered, optionally washed, and dried. Such methods (e.g., such as the process in FIG. 5H) can provide any functionalized material described herein (e.g., a functionalized material 100A-100C in FIGS. 1A-1C).

In some embodiments, a functionalized material (e.g., a functionalized MOF) can be produced using reactor-based solvo-thermal (e.g., hydrothermal) synthesis methods in which a metal source, a ligand, and a competing agent are reacted together to form the substrate, and then an aminosilane is solvated in a solvent medium and provided to the substrate. The silane moiety reacts with hydroxy groups on the surface of the MOF, and amine moieties extend from the silane moiety. The powder can be filtered from the solvent, washed, and dried. Such methods (e.g., such as the process in FIG. 5C) can provide any functionalized material described herein (e.g., a functionalized material 100A-100C in FIGS. 1A-1C).

In some embodiments, a functionalized material (e.g., a functionalized resin) can be produced using solution based reaction conditions in which an amine (e.g., a compound with one, two, or more amine moieties, which can include a polyamine) is solvated and a resin added. The amine moiety interacts with reactive sites (e.g., binds to acidic reactive sites) present on the surface of the resin, thereby providing a functionalized resin having adsorbing moieties (e.g., amine moieties). The functionalized resin can be purified, dried, and optionally activated. Such methods (e.g., such as the process in FIG. 5D) can provide any functionalized material described herein (e.g., a functionalized material 100A-100C in FIGS. 1A-1C).

For any substrate herein and in some non-limiting embodiments, aminosilane compounds with longer carbon chain lengths and high amino group density may be used to increase carbon capture potential, and additional silane moieties may increase the binding strength of the silane-amine compound to the surface of the substrate. This can produce a functionalized material capable of high carbon dioxide capture capacity even at low CO₂ concentration, such as direct air capture.

Desorption can be performed at laboratory temperatures (e.g., >70° C.) and below 0.3 psi, thereby enabling the functionalized material to be re-introduced to gaseous mixtures including carbon dioxide for repeated recapture. In some implementations, high adsorption/desorption cycle counts are achieved (e.g., >100 cycles or >1000 cycles).

In other embodiments, a functionalized material can be produced by using at least two compounds. For example and without limitation, a first layer of covalently bonded silane can allow for further surface modification of the substrate to bond a polymeric/oligomeric amine compound with increased stability. In some embodiments, the first compound is a silane or an aminosilane, and the second compound can be a polymeric/oligomeric amine, such as polyethylenimine (PEI), having an increased number of amine moieties for increased carbon capture (e.g., >2 mol CO₂/kg). The functionalized porous material can be produced using solution-based reaction methods in which the silane-containing compound is solvated and a substrate (e.g., silica powder) can be added. The silane moiety covalently binds to the surface of the substrate from which the amine moiety extends. The pre-functionalized powder can be filtered from the solvent, washed, and dried.

Then, a polymeric/oligomeric amine compound can be solvated, and the pre-functionalized powder can be added to form a functionalization mixture. The mixture can be stirred, and then dried, functionalizing the substrate with both the silane-containing compound and the polymeric/oligomeric amine. Desorption can be performed at laboratory temperatures (e.g., >70° C.), thereby enabling the functionalized porous material to be re-introduced to carbon dioxide for recapture. High adsorption/desorption cycle counts can be achieved (e.g., >100 cycles). In some embodiments, the sorbent achieves CO₂ uptake up to 1.5-1.8 mol CO₂/kg or 0.5-1.8 mol CO₂/kg in ambient air conditions of 420 ppm CO₂. Such methods (e.g., such as the process in FIG. 5B, 5E, or 5H) can provide any functionalized material described herein (e.g., a functionalized material 100A in FIG. 1A or functionalized material 100C in FIG. 1C).

After functionalization, the obtained material can be further purified, dried, and/or activated. Activation can include any process to remove residual solvent within the functionalized material. Activation can include use of heat, heated air, vacuum heating, and the like (e.g., to a temperature of about 70° C.).

i. Functionalization

Methods herein can include forming a suspension mixture including the substrate and a solvent medium. The solvent medium can include one or more solvents. In turn, a compound (to provide a functional portion) can be included in the suspension mixtures, thereby forming a functionalization material.

Any useful reagents or compounds can be employed to provide a functional portion to the substrate. Non-limiting reagents and compounds include a silane coupling material (e.g., an aminosilane), a plurality of silane coupling material (e.g., a plurality of aminosilanes), a polyamine, a plurality of polyamines, a monoamine, a plurality of monoamines, a silane coupling material (e.g., an aminosilane) in combination with an amine compound (e.g., a polyamine or a monoamine), a polyamine in combination with a monoamine, and the like. Such reagents and compounds can be provided in a single solution (e.g., a single suspension mixture) or in separate solutions (e.g., separate suspension mixtures).

In some embodiments, the suspension mixture can include reagents that can react to form the substrate. For example and without limitation, methods herein can include forming a suspension mixture including one or more reagents to provide a substrate and a solvent medium. The solvent medium can include one or more solvents. In turn, a compound (to provide a functional portion) can be included in the suspension mixtures, thereby forming a functionalization material.

In some embodiments, methods herein can include forming a functionalization mixture including a solvent medium and at least one compound to provide a functional portion. In some embodiments, the functionalization mixture can include further components (e.g., substrate) that can then provide a functionalized material.

In other embodiments, methods herein can include forming a pre-functionalization mixture including a first solvent medium, and a first compound to provide a portion of a functional portion (e.g., thereby providing a pre-functionalized material); and then forming a functionalization mixture including one or more components from the pre-functionalization mixture and a second solvent medium. In some embodiments, the pre-functionalization mixture can include further components (e.g., substrate) that can then provide a pre-functionalized material; and the functionalization mixture can include further components (e.g., substrate or pre-functionalized substrate) that can then provide a functionalized material. In any embodiment herein, the pre-functionalization mixture can provide a pre-functionalized material (e.g., which can be optionally further reacted), and the functionalization mixture can provide a functionalized material.

Optionally, the suspension mixture, pre-functionalization mixture, and/or functionalization mixture can be formed with agitation methodologies that minimize changes to particle size or distribution or minimize particle degradation. Non-limiting agitation methodologies can include overhead stirring.

Any useful solvent can be employed within mixtures (e.g., suspension mixtures, pre-functionalization mixtures, or functionalization mixtures). In some embodiments, the solvent is an organic solvent that dissolves the compounds for providing the functional portion. In some embodiments, the solvent does not hydrolyze siloxane bonds. In some examples, the solvent medium is a neutral aprotic organic solvent (e.g., such as toluene, hexane, cyclohexane, or tetrahydrofuran (THF)) or a solvent mixture thereof. In some embodiments, the solvent medium can include methanol, cyclohexane, ethanol, water, or a solvent mixture thereof. In some embodiments, the liquid can include cyclohexane and ethanol at a mixture ratio in a range from 1:1 to 5:1 by volume.

In some embodiments, one or more solvents with boiling points in a range from 50° to 100° C. may be desirable.

In some embodiments, the amount of solvent medium (e.g., in the suspension mixture, in the pre-functionalization mixture, or in the functionalization mixture) can be minimized. For example and without limitation, the solvent medium can be dispensed to entirely cover the substrate within the vessel, for example, by dispensing more than 0.5 mL/g of solvent medium to substrate (e.g., 1 mL/g, 2 mL/g, 5 mL/g, 8 mL/g, 10 mL/g, or 15 mL/g, or in a range from 0.5 to 10 mL/g, 0.5 to 5 mL/g, 1 to 5 mL/g, or 1 to 3 mL/g).

The mixtures (e.g., suspension mixtures, pre-functionalization mixtures, or functionalization mixtures) can be further treated in any useful manner. For example and without limitation, the mixture can be heated (e.g., to provide desired dissolution, adsorption, or reaction conditions). In some embodiments, the mixture is heated to a temperature from about 20° to 90° C. Other treatment methodologies can include agitation, cooling, and the like.

In some embodiments, a pre-functionalization mixture can be processed to separate the pre-functionalized material from the solvent. The pre-functionalized material may, in some instances, be used to prepare a functionalized mixture. In some embodiments, the functionalization mixture (e.g., prepared with or without employing a pre-functionalization mixture) can be processed to separate the functionalized material from the solvent. Such processes can include filtration, washing, and the like. Filtering can be performed using methods known in the art for separating a solid phase from a liquid phase. This can include, but is not limited to, vacuum filtration, centrifugation, vacuum evaporation, or a combination of these or other methods.

Washing can be performed in the presence of one or more solvents to remove any unreacted compounds. Any solvent may be employed (e.g., any neutral aprotic solvent as a wash solvent). In some embodiments, a single wash step can include immersing the functionalized material in a wash volume of fresh solvent medium such that the functionalized material is entirely immersed in the fresh solvent medium. In some implementations, one or more wash steps can be performed (e.g., two washes, three washes, four washes, or more). The volume of solvent medium separated from the functionalized material or used to wash the functionalized material can be discarded, stored, or recycled.

The functionalized material can be dried prior to use. Drying the functionalized silica material can include increasing the temperature, reducing the atmospheric pressure, passing an inert dry gas over the sample, or a combination of these.

In some non-limiting embodiments, the functionalized material is dried (e.g., in a vacuum oven) at a temperature from about 30° to 80° C. for a period of 6 to 12 hours for a lab-scale process (e.g., less than 500 g). Further conditions may be optimized for larger scale processing, in which a drying process can depend on the mass of the functionalized material, temperature, pressure, and other conditions as understood by a skilled artisan. Any conditions may be employed to provide a sample having a weight loss of about 15% (e.g., weight lost to solvent removal) or having minimal weight loss (e.g., a weight loss of less than about 5% over a period of about 2 hours at 100° C.) with an inert gas flow (e.g., 50 mL/min of N₂ flow) through the sample (e.g., as measured on thermogravimetric analysis (TGA)).

ii. Preparation of Functionalized Silica

As described herein, the methods herein can include preparing a suspension mixture, which in turn includes silica and reagents to functionalize the surface of the silica. Such suspension mixtures can then be used in combination with at least one compound to provide a functional portion, thereby forming a pre-functionalization mixture (e.g., having components to provide a part of the functional portion) or a functionalization mixture (e.g., having components to provide a fully assembled functional portion).

Any useful reagents or compounds can be employed to provide a functional portion to silica. Non-limiting reagents and compounds include a silane coupling material (e.g., an aminosilane), a plurality of silane coupling material (e.g., a plurality of aminosilanes), a polyamine, a plurality of polyamines, a monoamine, a plurality of monoamines, a silane coupling material (e.g., an aminosilane) in combination with an amine compound (e.g., a polyamine or a monoamine), a polyamine in combination with a monoamine, and the like. Such reagents and compounds can be provided in a single solution (e.g., a single suspension mixture) or in separate solutions (e.g., separate suspension mixtures).

In some embodiments, a method includes: introducing a first reagent including a first compound comprising a silane moiety and an amine moiety into a liquid mixture under conditions sufficient to cause the silane moiety of the first compound to chemically bond to a surface of a substrate (e.g., porous silica particles) to form a functionalized material (e.g., functionalized silica particles), wherein the liquid mixture includes a liquid and the substrate; and removing the functionalized material from the liquid.

In some embodiments, a method includes: introducing a first reagent including a first compound comprising a silane moiety and an amine moiety into a first liquid mixture under conditions sufficient to cause the silane moiety of the first compound to chemically bond to a surface of a substrate (e.g., porous silica particles) to form a functionalized material (e.g., functionalized silica particles), wherein the first liquid mixture includes a liquid and the substrate; removing the functionalized material from the liquid; drying the functionalized material (e.g., in a vacuum oven) until a hydration threshold is reached; introducing a second reagent including a second compound comprising a polyamine into a second liquid mixture under conditions sufficient to cause the second compound to interact with the first compound to form a complex network or a surface functionalization layer, wherein the second liquid mixture includes a second liquid and the functionalized material; and removing the further functionalized material from the second liquid. In some embodiments, the further functionalized material comprises functionalized silica oxide particles.

The first reagent can include a silane moiety. In some embodiments, the silane moiety comprises an alkoxysilane moiety. Non-limiting examples of an alkoxysilane moiety include methoxysilane (e.g., —Si(OMe)_{d}(X)_{3-d}, in which each X is, independently, a side group, a reactive group, or a leaving group, as any described herein; and d is an integer of 1, 2, or 3) or ethoxysilane (e.g., —Si(OEt)_{d}(X)_{3-d}, in which each X is, independently, a side group, a reactive group, or a leaving group, as any described herein; and d is an integer of 1, 2, or 3). A compound to provide an alkoxysilane moiety can include R^{A}Si(OMe)_{d}(X)_{3-d} or R^{A}Si(OEt)_{d}(X)_{3-d}, in which each R^{A} is, independently, an amine moiety; each X is, independently, a side group, a reactive group, or a leaving group, as any described herein; and d is an integer of 1, 2, or 3). Non-limiting examples of compounds include (3-aminopropyl) trimethoxysilane, (3-aminopropyl)triethoxysilane, [3-(2-aminoethylamino) propyl]trimethoxysilane, N1-(3-trimethoxysilylpropyl)diethylenetriamine, or an amino silane oligomer (e.g., VPS SIVO 280, a modified organofunctional polysiloxane from Evonik Industries AG, Essen, Germany). In some embodiments, the amino silane oligomer is an oligomer of an aminosilane (e.g., an oligomer of any aminosilane herein, such as an oligomer of R^{A}Si[OMe]_{d}[X]_{3-d} or an oligomer of R^{A}Si[OEt]_{d}[X]_{3-d}, in which each R^{A} is, independently, an amine moiety; each X is, independently, a side group, a reactive group, or a leaving group, as any described herein; and d is an integer of 1, 2, or 3). In some embodiments, the amino silane oligomer comprises a structure of formula [—SiR^{S1}R^{S2}-L-NR^{N1}-]ₙ or [—SiR^{S1}R^{S2}—NR^{N1}-L-NR^{N2}—]ₙ, in which each of R^{S1} and R^{S2} is independently a leaving group, a reactive group, hydrogen (H), optionally substituted aliphatic, heteroaliphatic, aromatic, or heteroaromatic (e.g., such as any described herein); each L is a linker (e.g., any described herein); each of R^{N1} and R^{N2} is, independently, any described herein; and n is an integer of 1 or more.

In some embodiments, the silane moiety comprises a hydroxysilane moiety. Non-limiting examples of a hydroxysilane moiety include silanol, silanediol, or silanetriol. In some embodiments, the hydroxysilane moiety includes —Si(OH)R^{S1}R^{S2}, —Si(OH)₂R^{S1}, or —Si(OH)₃, in which each of R^{S1} and R^{S2} is independently a leaving group, a reactive group, hydrogen (H), optionally substituted aliphatic, heteroaliphatic, aromatic, or heteroaromatic. In some embodiments, a compound including the hydroxysilane moiety comprises a structure of formula R^{A}Si[OH]_{d}[R^{S1}]_{3-d}, in which R^{A} is an amine moiety (e.g., any described herein); R^{S1} is a leaving group, a reactive group, hydrogen (H), optionally substituted aliphatic, heteroaliphatic, aromatic, or heteroaromatic; and d is an integer of 1, 2, or 3. Non-limiting examples of compounds include 3-aminopropylsilanetriol or N-(2-aminoethyl)-3-aminopropylsilanetriol.

In some embodiments, the silane moiety comprises a halosilane moiety. Non-limiting examples of a halosilane moiety include chlorosilane, fluorosilane, bromosilane, or iodosilane. In some embodiments, a compound including the halosilane moiety comprises a structure of formula [R^{A}]_{d}Si[X]_{3-d}, in which R^{A} is an amine moiety (e.g., any described herein); X is halo; and d is an integer of 1, 2, or 3. Non-limiting examples of compounds include tris(ethylmethylamino)chlorosilane or tris(dimethylamino)chlorosilane.

The first reagent can include a silane moiety and an amine moiety (e.g., as in an aminosilane, such as any described herein). The second reagent can include two or more amine moieties. In some embodiments, the second reagent is a polyamine (e.g., any described herein). Non-limiting examples of second compounds include a linear or a branched polyamine, polyethylenimine (PEI), polypropylenimine, tetraethylenepentamine (TEPA), triethylenetetramine (TETA), diethanolamine (or a polymeric form of diethanolamine), a large molecule weight amine mixture (BASF Amix 1000), or other polyamines described herein.

In some embodiments, the method includes: introducing a first reagent including a first compound including an alkoxysilane moiety and an amine moiety into a first liquid mixture including a liquid and a substrate (e.g., porous silica particles) under conditions sufficient to cause the alkoxysilane moiety of the first compound to chemically bond to a surface of the substrate to form a pre-functionalized material (e.g., pre-functionalized or modified silica particles); removing the pre-functionalized material from the liquid; drying the pre-functionalized material (e.g., in a vacuum oven) until a hydration threshold can be reached; introducing a second reagent including a second compound including a polyamine into a second liquid mixture including a second liquid and the pre-functionalized material under conditions sufficient to cause an amine moiety of the second compound to chemically bond to the amine moiety of the first compound to form a functionalized material (e.g., functionalized silica particles); and removing the functionalized material (e.g., functionalized silica particles or functionalized silica oxide particles) from the second liquid.

In non-limiting implementations, water-based reactions may be employed. In some embodiments, functionalized material is produced using water-based reaction methods in which the polyamine and the aminosilane are dissolved into water to form a solution. The aminosilane hydrolyzes and forms aminosilane oligomers. The polyamine and aminosilane are reacted in the water at room temperature forming a complex network through bonding interactions (e.g., non-covalent bonding interactions, such as ionic and/or hydrogen bonding). The substrate can be added to the solution and allowed to react with the bonded polyamine and silane. The aminosilanes can condense on the surface of the substrate (e.g., in which siloxane bonds can be formed with a silica substrate). Without wishing to be limited by mechanism, bonded aminosilanes can interact with the polyamine through polymer entanglement, ionic interactions, and/or hydrogen bonding, thereby bonding the network to the substrate and creating the functionalized material.

In some embodiments, the method includes: introducing a first reagent including a polyamine, a second reagent including a silane moiety and an amine moiety, and a substrate (e.g., porous silica particles) into a volume of water under conditions sufficient to cause: an amine moiety of the polyamine to interact with a surface of the substrate (e.g., by way of ionic interactions, hydrogen bonding interactions, and the like) and the silane moiety of the second reagent to chemically bond to the surface of the substrate, thereby forming a functionalized material (e.g., functionalized silica particles); and removal of the functionalized material from the water. In some embodiments, the method can further include: drying the functionalized material in a vacuum oven at 80° C. until a hydration threshold is reached (e.g., less than 5% (wt/wt) of water to functionalized material).

In some embodiments, the method includes: introducing a first reagent including polyethylenimine and a second reagent including a silane moiety and an amine moiety into a volume of water to create a suspension; agitating the suspension for a first duration in a range from 5 to 10 minutes; introducing a substrate (e.g., porous silica particles) into the suspension to create a functionalization mixture; agitating the functionalization mixture for a second duration in a range from 5 to 20 minutes to create a functionalized material; recovering the functionalized material by filtration or evaporation; and drying the functionalized material at 120° C. for 20 minutes or less. Without wishing to be limited by mechanism or theory, drying can be conducted under conditions to minimize oxidation of the functionalized material (e.g., conditions such as heating without vacuum at a sufficiently high temperature for drying within a time period of less than 20 minutes until dry, as measured by TGA or other methodologies herein).

Any useful concentration can be employed. In some embodiments, the substrate includes porous silica particles, which can be added into the volume of water at a ratio of 150% to 300% (wt/wt) or 2 to 2.5 mL/g of water to the porous silica particles (e.g., from 150% to 250% (wt/wt), 200% to 300% (wt/wt), or 200% to 250% (wt/wt) of water to porous silica particles). The solvent to silica ratio can be adapted based on the coating method that is employed. For example and without limitation, for a silica substrate with a pore volume about 2.2 mL/g and a density of about 0.25 g/mL, 1 g of silica can employ 2 to 2.5 mL of solution to completely wet the silica (e.g., fill the porosity). Lower ratios of solvent to silica could result in incomplete wetting, and larger ratios of solvent to silica could result in excess solvent on the surface of the silica and between the particles. Variations based on solvent type and interaction of silica with solvent can be observed. For the given non-limiting example of silica, a solution ratio of 2 to 2.5 mL/g could be employed for a wetting or spray coating process. In this case, the solution could be mixed or sprayed onto silica substrate and would be entirely absorbed. For the given non-limiting example of silica, a larger solution ratio of >2.5 ml/g could be employed for a dip coating or submersion/slurry process, in which excess solution can be filtered off. For the given non-limiting example of silica, a very low solvent ratio of <1.5 mL/g could be utilized for a process in which only the surface of the silica to some depth would be coated with amine. This could be conducted by way of spray coating to achieve a uniform surface coating. Other ratios and processes may be employed.

The first reagent can be added to the water at a ratio of 5% to 25% (wt/wt) of the first reagent to the porous silica particles. Without wishing to be limited by mechanism and theory, higher ratios can provide higher CO₂ uptake to an extent. For example and without limitation, higher ratios (e.g., of a large MW polyamine or a polymeric polyamine) can become more sticky, which can be problematic for handling, etc. In some embodiments, the maximum ratio can be limited by pore blocking by the first reagent. If the pores are completely filled or blocked by overloading, then CO₂ may not efficiently enter or exit the pore, such that kinetics and performance may be affected. In some embodiments, increasing polyamine ratios can provide diminishing returns in performance after a point. In some embodiments, the presence of polyamines can be synergistic with aminosilane to an extent.

The second reagent can be added to the water at a ratio of 20% to 80% (wt/wt) of the second reagent to the porous silica particles. Without wishing to be limited by mechanism and theory, higher ratios give higher CO₂ uptake to an extent. For example and without limitation, higher ratios (e.g., of an aminosilane) may not significantly contribute to stickiness but may contribute to pore filling or blocking. In some embodiments, the presence of aminosilanes is synergistic with polyamines to an extent. In some embodiments, aminosilanes may improve the stability of polyamines to an extent. In some embodiments, increasing aminosilane ratios can provide diminishing returns in performance after a point.

The first reagent can include two or more amine moieties. In some embodiments, the first reagent is a polyamine (e.g., any described herein). The second reagent can include a silane moiety and an amine moiety (e.g., as in an aminosilane, such as any described herein) or can include a polyamine (e.g., any described herein). Non-limiting examples of second reagents include an alkoxysilane, a methoxysilane, a silanetriol, an alkoxysilanol, a chlorosilane, a hydrosilane, an ethoxysilane, a polyamine (e.g., a linear or branched polyamine) or others described herein (e.g., (3-aminopropyl)trimethoxysilane, (3-aminopropyl) triethoxysilane, [3-(2-aminoethylamino)propyl]trimethoxysilane, N1-(3-trimethoxysilylpropyl)diethylenetriamine, 3-aminopropylsilanetriol, N-(2-aminoethyl)-3-aminopropylsilanetriol, tris(ethylmethylamino)chlorosilane, tris(dimethylamino) chlorosilane, an amino silane oligomers (e.g., such as VPS SIVO 280 from Evonik), polyethylenimine (PEI), polypropylenimine, tetraethylenepentamine (TEPA), triethylenetetramine (TETA), or a large molecule weight amine mixture (e.g., BASF Amix 1000).

In some embodiments, the method includes: introducing a first reagent including a first compound including a plurality of amine moieties into a liquid mixture including a liquid and a substrate (e.g., porous silica particles) under conditions sufficient to cause the pluralities of amine moieties to chemically bond to a surface of the substrate to form a functionalized material (e.g., functionalized or modified silica particles); removing the functionalized material from the liquid; and drying the functionalized material (e.g., in a vacuum oven) until a hydration threshold is reached.

In some embodiments, the first compound can be a small molecule polyamine, an oligomeric amine, an oligomeric ethylene amine, an ethylene amine/oligomer mixture, a small molecule mixture, or a combination of any of these. The first compound can include Amix 1000, tetraethylenepentamine (TEPA), or triethylenetetramine (TETA).

In some embodiments, the method can further include: introducing a second reagent including a second compound including a sulfur-containing compound (e.g., an antioxidant) into a second liquid mixture including a second liquid and the functionalized particles (e.g., functionalized silica oxide particles); removing the functionalized material from the second liquid; and drying the functionalized material (e.g., in a vacuum oven) until a hydration threshold is reached. The second compound can be included in the second liquid mixture within a range from 0.5% to 10% (wt/wt) of the second compound to the substrate (e.g., silica oxide material).

In some embodiments, a method can include: introducing a first reagent including a polyethylenimine compound including a plurality of amine moieties into a liquid mixture including a methanol or ethanol and a substrate (e.g., porous silica particles) under conditions sufficient to cause the plurality of amine moieties of the polyethylenimine compound to interact with a surface of the substrate (e.g., by way of van der Waals interactions, hydrogen bonding interactions, or ionic bonding interactions with silanol groups on the surface of the substrate) to form a functionalized material (e.g., functionalized or modified silica particles); removing the functionalized material from the liquid by evaporating the liquid from the functionalized material; and drying the functionalized material (e.g., in a vacuum oven) until a hydration threshold of 5% (wt/wt) of the first liquid to the functionalized material is reached.

In some embodiments, a method can include: introducing a first reagent including an ethylene amine mixture compound including a plurality of amine moieties into a liquid mixture including a methanol or ethanol and a substrate (e.g., porous silica particles) under conditions sufficient to cause the plurality of amine moieties of the ethylene amine mixture compound to chemically interact with a surface of the substrate to form a functionalized material (e.g., functionalized or modified silica particles); removing the functionalized material from the liquid by evaporating the liquid from the functionalized material; and drying the functionalized material (e.g., in a vacuum oven) until a hydration threshold of 5% (wt/wt) of the first liquid to the functionalized material can be reached.

Further non-limiting methods of preparing functionalized silica can include any described herein (e.g., in FIGS. 5A, 5B, and 5E-51).

iii. Preparation of Functionalized MOFs

As described herein, the methods herein can include preparing a suspension mixture, which in turn includes reagents to provide a MOF. Such suspension mixtures can then be used in combination with at least one compound to provide a functional portion, thereby forming a pre-functionalization mixture or a functionalization mixture (e.g., as described herein).

In some embodiments, a method can include preparing a suspension to form a MOF substrate (e.g., MOF particles) and then preparing a functionalization mixture including the MOF substrate and a compound to provide a functional portion.

A suspension can be prepared in any useful manner. In some embodiments, the method includes: introducing a first reagent including a metal source and a second reagent including an organic ligand into a solvent medium (or a liquid) under conditions sufficient to cause a reaction between the first reagent and second reagent to create a MOF substrate (e.g., MOF particles). In some embodiments, MOF substrates with adsorbing moieties (e.g., functionalized with one or more amine-containing moieties that can be bonded to hydroxyl functional side groups of the MOF structure) can achieve reversible capture of carbon dioxide from gaseous mixtures (e.g., the atmosphere). In some embodiments, the organic ligand can include at least one hydroxy group. Examples of metal sources and organic ligands, as well as compounds for providing such metal sources and organic ligands, can include any described herein.

In some embodiments, the hydroxy functional side group can react with interaction moieties and/or adsorbing moieties. In some embodiments, the hydroxy functional side group can be used to form a covalent bond between the MOF substrate and adsorbing moiety (e.g., wherein the hydroxy group reacts with the interaction moiety, thereby forming the covalent bond that is present between the MOF surface and the adsorbing moiety).

The suspension (including the MOF substrate) can be further prepared to provide a functionalization mixture. In some embodiments, the method can further include: introducing a third reagent including an adsorbing moiety (e.g., an amine moiety) to the suspension. In some embodiments, the third reagent can be any aminosilane described herein. Non-limiting aminosilane compounds include, e.g., tris(ethylmethylamino)chlorosilane, tris(dimethylamino) chlorosilane, bis(3-(methylamino)propyl)trimethoxysilane, N-[3-(trimethoxysilyl)propyl]aniline, (N,N-dimethylaminopropyl)trimethoxysilane, 3-aminopropyl(diethoxy)methylsilane, bis[3-(trimethoxysilyl)propyl]amine, (3-aminopropyl)triethoxysilane, (3-aminopropyl) trimethoxysilane, N-[3-(trimethoxysilyl) propyl]ethylenediamine, N₁-(3-trimethoxysilylpropyl)diethylenetriamine, or [3-(2-aminoethylamino) propyl]trimethoxysilane.

In some embodiments, said introducing the third reagent can be conducted under conditions sufficient to cause the third reagent to chemically bond to the second reagent to form a modified MOF substrate (e.g., modified MOF particles). In some embodiments, the third reagent is an aminosilane compound (e.g., any described herein), in which the silane moiety interacts with the organic ligand (e.g., a hydroxy group or other reactive group present on the organic ligand). The amine moiety of the aminosilane compound can be disposed on the surface of the MOF substrate. Within the functionalization mixture, a functionalized material including a functionalized MOF (e.g., functionalized MOF particles) can be formed.

Optionally, the method can include providing a second solvent medium or a second liquid. In some embodiments, the method can further include: before introducing the third reagent, removing the MOF substrate from the liquid, introducing a second liquid to the MOF substrate for a duration; and removing the MOF substrate from the second liquid. The second liquid can include a second volume of a solvent medium (e.g., any described herein).

The functionalization mixture may be further processed. In some embodiments, the method can include: removing the functionalized MOF substrate (e.g., modified MOF particles) from the solvent medium or liquid present in the functionalization mixture. The liquid can be any useful solvent (e.g., a polar solvent). Non-limiting examples of solvents include water, N,N-dimethylacetamide (DMAc), N,N-dimethylformamide (DMF), N,N-diethylformamide (DEF), methanol, ethanol, acetonitrile, dimethylsulfoxide (DMSO), as well as combinations thereof.

The presence of competing agents or additives can affect the coordination of ligands, morphology and size of crystals, nucleation and crystal growth, and the like. Non-limiting modulating or competing agents and additives include an inorganic acid (e.g., hydrochloric acid or hydrofluoric acid), a carboxylic acid (e.g., benzoic acid, formic acid, acetic acid, trifluoroacetic acid, dodecanoic acid, or lauric acid), and the like.

In some embodiments, the method can further include: introducing a fourth reagent including a competing agent with the first reagent and the second reagent. The fourth reagent can include a non-coordinating base. The non-coordinating base can be 2,6-lutidine, N,N-diisopropylethylamine, triethylamine, 2-tert-butylimino-2-diethylamino-1,3-dimethylperhydro-1,3,2-diazaphosphorine, or 1,8-diazabicyclo[5.4.0]undec-7-ene. In some embodiments, the non-coordinating base can include a compound for deprotonating one or more hydroxy side groups present on a surface of the MOF substrate. In turn, the deprotonated side group can react with a silane moiety to provide a coating or a surface functionalization layer.

The method can further include drying the functionalized MOF substrate (e.g., modified MOF particles) until a hydration threshold (e.g., any described herein) can be reached.

Any useful MOF material and functionalized MOFs can be prepared. In some embodiments, the method include: introducing a first reagent including a metal salt (e.g., a zinc salt, such as Zn(NO₃)₂·6H₂O) and a second reagent into a polar solvent liquid under conditions sufficient to cause a reaction between the first reagent and second reagent to create a MOF substrate (e.g., MOF particles). In some embodiments, the second reagent comprises an organic ligand (e.g., TPDC²⁻ or a derivative thereof, such as (X)₂-TPDC²⁻ or (X)₄-TPDC²⁻) or a compound providing the organic ligand (e.g., a compound such as H₂TPDC, H₂(X)₂-TPDC, or H₂(X)₄-TPDC).

In some embodiments, the method can further include: removing the MOF substrate from the liquid; introducing a second polar solvent liquid to the MOF substrate for a duration; removing the metal oxide framework particles from the second liquid; introducing a third polar solvent liquid to the MOF substrate for a duration; introducing a third reagent (e.g., including an aminosilane, such as tris(ethylmethylamino)chlorosilane or any described herein) to the third liquid under conditions sufficient to cause the third reagent to chemically bond to the second reagent to form functionalized MOF (e.g., modified or functionalized MOF particles); and removing the functionalized MOF from the liquid. Non-limiting methods of preparing functionalized MOF can include any described herein (e.g., in FIG. 5C).

iv. Preparation of Functionalized Resin

As described herein, the methods herein can include preparing a suspension mixture, which in turn includes resin material.

A suspension can be prepared in any useful manner. In some embodiments, the suspension can include a first agent (e.g., comprising a resin substrate) and a second reagent (e.g., comprising an adsorbing moiety). The second reagent can include any reactive amine(s), which can be introduced into the porous structure of the resin. Non-limiting examples of liquid amines include liquid amine-based polymers (e.g., polyethylenimines (PEIs)), liquid molecular mono, di-, tri-, tetra-, penta-, and larger ethylamines, liquid amine-functionalized hydrocarbons, silylamines (or aminosilanes), or any combination of these.

In some embodiments, the method includes: introducing a first reagent and a second reagent by spraying the second reagent onto the resin substrate. In some embodiments, the method includes: introducing the first reagent and the second reagent by forming a solution including the first reagent and the second reagent and recovering the functionalized resin from the solution.

In some embodiments, the method includes: combining a first reagent including porous resin particles and a second reagent including an amine moiety under conditions sufficient to cause a reaction between the first reagent and second reagent to create functionalized resin (e.g., functionalized porous resin particles). In some embodiments, the method can further include: introducing a liquid to the functionalized resin for a duration; and recovering the functionalized resin from the liquid. The method can further include drying the functionalized resin until a hydration threshold is reached. The liquid or the second liquid can be ethanol, methanol, or any solvent described herein.

In some embodiments, the method includes: combining a first reagent including porous resin particles and a second reagent including an amine moiety under conditions sufficient to cause a reaction between the first reagent and second reagent to create a functionalized resin; recovering the functionalized resin from the solution; and drying the functionalized resin until a hydration threshold is reached.

In some embodiments, a polyamine is provided to the surface of the resin. In some embodiments, the polyamine comprises two or more amine moieties. In some embodiments, the polyamine is ethylenediamine (H₂NCH₂CH₂NH₂), diethylenetetramine (DETA, H₂N[CH₂CH₂NH]2H), triethylenetetramine (TETA, H₂N[CH₂CH₂NH]₃H), branched triethylenetetramine (N[CH₂CH₂NH]₃), tetraethylenepentamine (H₂N[CH₂CH₂NH]₄H), or pentaethylenehexamine (H₂N[CH₂CH₂NH]₅H). In some implementations, the polyamine is polyethylenimine (PEI) (e.g., linear, branched, or dendrimer forms of PEI). In some implementations, the polyamine is an amine-based polymer. In some embodiments, a first amine moiety is configured to react with a reactive site of the resin (e.g., an acidic reactive site) to functionalize the resin, and remaining amine moieties serve as reaction sites for CO₂ adsorption.

In some embodiments, a monoamine is provided to the surface of the resin. Non-limiting examples of monoamines can include amine-functionalized hydrocarbons can include ethanolamine, hexylamine, and the like.

In some embodiments, an amine-functionalized hydrocarbon is provided to the surface of the resin. The amine-functionalized hydrocarbon can include one, two, three, or more amine moieties (e.g., one, two, three, or more amine groups). Non-limiting examples of amine-functionalized hydrocarbon include ethanolamine, hexylamine, or 1,6-hexanediamine.

In some embodiments, a molecular ethylamine is provided to the surface of the resin. Non-limiting examples of molecular ethylamines include mono, di-, tri-, tetra-, penta-, and/or larger ethylamines, as well as tetraethylenepentamine (TEPA), triethylenetetramine (TETA), or pentaethylenehexamine (PEHA).

In some embodiments, a silylamine (or aminosilane) is provided to the surface of the resin. Non-limiting examples of silylamines can include (3-aminopropyl)trimethoxysilane, [3-(2-aminoethylamino)propyl]trimethoxysilane, N1-(3-trimethoxysilylpropyl)diethylenetriamine, 3-aminopropylsilanetriol, N-(2-aminoethyl)3-aminopropylsilanetriol, as well as any aminosilane described herein.

In some embodiments, an amine-based polymer is provided to surface of the resin. Non-limiting examples of polymers include polypropylenimine, natural chitosan, polylysine, a small molecule polyamine, or an ethylene amine/oligomeric mix (BASF Amix 1000).

In some embodiments, a compound provided to the surface of the resin can include amine-based polymers, polyethylenimines (PEIs), molecular ethylamines, amine-functionalized hydrocarbons, silylamines (or aminosilanes), or any combination thereof.

Non-limiting methods of preparing functionalized resin can include any described herein (e.g., in FIG. 5D).

v. Non-Limiting Examples of Processes for Forming a Functionalized Material

FIGS. 5A-5H are non-limiting flow chart diagrams showing examples of steps for producing a functionalized material. These diagrams are further described below.

In any of these diagrams, the process can be used to make a functionalized material for use in a reversible sorbent material, e.g., synthesizing a reversible CO₂ sorbent, such as functionalized silica. In some implementations, the process can be performed at large scale, e.g., producing 1 kilogram or more of functionalized material in a single process. To maintain the original particle size distribution, agitation methods in which the substrate is not contacted are preferred, such as overhead stirring.

While the processes herein may refer to a silane coupling material as the compound configured to provide an adsorbing moiety, other compounds may be employed. For example and without limitation, the silane coupling material may be replaced with any compound including an adsorbing moiety and/or an interaction moiety (e.g., any compound described herein).

As seen in FIG. 5A, the process 500A can include preparing a suspension mixture including a solvent medium and a substrate (step 502A). In a vessel suitable for the total volume of the solvent medium and the substrate, such as a three-necked round bottom flask, the solvent medium and the substrate (e.g., a silica material or a silicon oxide material) are dispensed. The substrate can be any suitable substrate (e.g., a silica substrate or any others described herein). The solvent medium may be dispensed to entirely cover the substrate within the vessel, for example, by dispensing from 1 to 15 mL/g of the solvent medium to the substrate (e.g., 1 mL/g, 5 mL/g, 8 mL/g, 15 mL/g, 2 to 2 mL/g, 2 to 2.5 mL/g, or other ranges herein). The solvent medium can be any described herein (e.g., a neutral aprotic organic solvent, such as toluene, hexane, cyclohexane, or tetrahydrofuran (THF), as well as combinations of any of these).

The process 500A can include agitating the substrate in the solvent medium for a first time period (step 504A). The suspension mixture can be agitated (e.g., stirred) within the vessel, e.g., with a magnetic stir bar and stir plate or other suitable method known to a person skilled in the art, while the substrate is soaking in the solvent medium. Agitation can increase the diffusion rate to ensure a homogeneous mixture. The first time period should be sufficient to ensure that the substrate has absorbed the solvent medium to maximum capacity. For example, the first time period can be in a range from 10 minutes to 3 hours (e.g., 2 hours).

While agitating, a silane coupling material can be added to the suspension mixture to form a functionalization mixture (step 506A). The silane coupling material can include any compound having a silane moiety, such as any aminosilane compound described herein. The silane coupling material may be dispensed in a range from 20% to 80% (wt/wt) of a loading silane to the substrate.

While agitating, the functionalization mixture can be heated to a heating temperature above ambient temperature and below 90° C. (step 508A) (e.g., greater than 25° C. and below 90° C.). The heating temperature to which the functionalization mixture is heated can depend on the solvent medium selected for the process 500A. As an example, in implementations in which toluene is selected as a solvent medium, the heating temperature can be 70° or 90° C. The temperature can be preferably below the temperature at which oxidation of the amine occurs (e.g., a temperature that is between 70° and 80° C. or that is less than 90° C.).

The process 500A can include agitating the functionalization mixture at the heating temperature for a second time period (step 510A). The second time period can be sufficient to allow maximum functionalization (e.g., binding) of the silane coupling material to the surface of the substrate. In general and without wishing to be bound by theory, the second time period can be longer than 6 hours and depends on the solvent medium, heating temperature, and silane coupling material. In some implementations, the second time period can be longer than 8 hours (e.g., longer than 10 hours, longer than 12 hours, longer than 18 hours, longer than 20 hours, or longer than 24 hours).

After the second time period, the process 500A can include cooling the functionalization mixture (step 512A). In some implementations, the cooling occurs passively (e.g., radiant cooling). For example, the vessel can be allowed to cool at ambient air temperature until the functionalization mixture cools to a target temperature. In some implementations, the target cooling temperature is ambient temperature (e.g., room temperature). In alternative implementations, the cooling occurs actively (e.g., heat exchange), such as with a water bath for the vessel.

The process 500A can further include filtering the functionalized material from the functionalization mixture (step 514A). Filtering can be performed using methods known in the art for separating a solid phase from a liquid phase. This can include, but is not limited to, vacuum filtration, centrifugation, vacuum evaporation, or a combination of these or other methods. The volume of solvent medium separated from the functionalized material can be discarded, stored, or recycled.

The process 500A can further include washing the functionalized material in at least one wash volume of fresh (e.g., a new volume) solvent medium (step 516A). In some embodiments, similar ratios of fresh solvent medium to functionalized material as in step 502A (e.g., 10 mL/g of fresh solvent medium to amine-functionalized substrate) can be used. For example, the functionalized material can be immersed in a wash volume of fresh solvent medium (e.g., 40 mL of solvent for 4 g of functionalized material), in which a single wash or a plurality of washes can be performed. In some embodiments, the wash solvent dissolves the silane moiety to remove moieties coated on the surface of functionalized substrate but not reacted.

The process 500A can further include drying the functionalized material (step 518A). Drying the functionalized material can include increasing the temperature, reducing the atmospheric pressure, passing an inert dry gas over the sample, or a combination of these. The functionalized material can be dried to remove substantially all of the wash volume of the solvent medium entrained in the functionalized material. For example, in some implementations, the functionalized material is dried in a vacuum oven at 50° C. for 12 hours, e.g., overnight. As non-limiting examples, the drying threshold is a weight lost by the sample of 15% (e.g., weight lost to solvent removal) or having minimal weight loss (e.g., a weight loss of less than about 5% over a period of about 2 hours at 100° C.) with an inert gas flow (e.g., 50 mL/min of N₂ flow) through the sample (e.g., as measured on TGA)). In some implementations, the functionalized material is dried until a hydration threshold is reached, e.g., such as <5% (wt/wt) solvent to functionalized material remains. The functionalized material can then be prepared for use as a reversible sorbent material.

As seen in FIG. 5B, the process 500B can include preparing a suspension mixture including a solvent medium and a substrate (step 502B) and agitating the substrate in the solvent medium for a first time period (step 504B). Additional details can include any described herein (e.g., for steps 502A or 504A).

While agitating, a silane coupling material can be added to the suspension mixture to form a pre-functionalization mixture (step 506B). The silane coupling material can include any compound having a silane moiety, such as any aminosilane compound or silane compound described herein. The silane coupling material may be dispensed in a range from 20% to 80% (wt/wt) of a loading silane to the substrate.

While agitating, the pre-functionalized mixture can be heated to a heating temperature above ambient temperature and below 90° C. (step 508B) (e.g., greater than 25° C. and below 90° C.). The heating temperature to which the functionalization mixture is heated can depend on the solvent medium selected for the process 500B. As an example, in implementations in which toluene is selected as a solvent medium, the heating temperature can be 90° C. As another example, in implementations in which hexane is selected as a solvent medium, the heating temperature is 65° C. The temperature is preferably below the temperature at which oxidation of the amine occurs (e.g., a temperature that is between 70° and 80° C. or that is less than 90° C.).

The process 500B can include agitating the pre-functionalization mixture at the heating temperature for a second time period (step 510B). The second time period can be sufficient to allow maximum functionalization (e.g., binding) of the silane coupling material to the surfaces of the substrate. After the second time period, the process 500B can include cooling the pre-functionalization mixture (step 512B), filtering a pre-functionalized material from the pre-functionalization mixture (step 514B), washing the pre-functionalized material in at least one wash volume of fresh (e.g., a new volume) solvent medium (step 516B), and drying the pre-functionalized material (step 518B). In some embodiments, similar ratios of fresh solvent medium to pre-functionalized material as in step 512A (e.g., 10 mL/g of fresh solvent medium to pre-functionalized material) can be used. Additional details can include any described herein (e.g., for steps 510A, 512A, 514A, 516A, and 518A).

The process 500B can further include preparing a second suspension mixture including a second solvent medium and the pre-functionalized material (step 520B). For example, in a vessel suitable for the total volume of the second solvent medium and the pre-functionalized material, such as a three-necked round bottom flask, dispense the pre-functionalized substrate (e.g., an amine-grafted silica material) and the second solvent medium. In some examples, the second solvent medium is methanol. In some examples, the second solvent medium is a solvent mixture, such as a 2:1 mixture of ethanol and cyclohexane. The solvent mixture selection for the second solvent medium can affect sorbent uptake.

In one example, a solvent medium such as methanol or water used in step 520B, may cause hydrolysis of the first adsorbing moiety (e.g., provided by way of the silane coupling material and deposited as a silane layer). In some embodiments, the solvent mixture is characterized in that it does not readily hydrolyze and solvate the silane layer from the surface of the substrate. The second solvent medium may be dispensed to entirely cover the pre-functionalized substrate within the vessel, for example, by dispensing 2 to 2.5 mL/g or 6 mL/g of solvent medium to pre-functionalized substrate (e.g., 1 mL/g, 2 mL/g, 3 mL/g, or 5 mL/g).

The process 500B may further include adding an amine compound into the second solvent medium (step 522B). The amine compound can be any described herein including one or more amine moieties. In some embodiments, the amine compound is a polyamine or a small molecule amine, such as any described herein. The amine compound can be dispensed into the second solvent medium at a 30% (wt/wt) or 5% to 25% (w/w) ratio to the pre-functionalized substrate in the second solvent medium. In some implementations, the amine compound is dispensed into the second solvent medium at up to 50% (wt/wt) ratio or 20% (wt/wt) ratio (e.g., in a range from 20% to 50% (wt/wt) or 2% to 20% (wt/wt)).

The process 500B may include agitating the amine compound and pre-functionalized material in the second solvent medium for a time period (step 524B). The suspension can be agitated (e.g., stirred) within the vessel, as described herein, while the substrate of the pre-functionalized material is soaking in the second solvent medium. The first time period may be sufficient to ensure that the pre-functionalized material has absorbed the second solvent medium to maximum capacity and/or undergone interacting with the amine compound to form a functionalized material. For example and without limitation, the time period can be in a range from 1 hour to 3 hours (e.g., greater than 1 hour, e.g., 2 hours).

The process 500B may include filtering the functionalized material from the functionalization mixture (step 526B) and drying the functionalized material (step 528B). Additional details can include any described herein (e.g., for steps 514A and 518A).

In some alternative implementations, the silane coupling material and the amine compound are added to the first solvent medium at step 506B. Such implementations can reduce the time and solvent volumes used to produce the functionalized mixture. Non-limiting examples of solvents for the first solvent medium can include water, methanol, ethanol, or mixtures of these (e.g., as well as any others described herein).

As seen in FIG. 5C, the process 5000 can include preparing a suspension mixture including a solvent medium, a metal source (e.g., a metal ion source), and an organic ligand compound (step 502C). In a vessel suitable for the total volume of the solvent medium, the metal source, and organic ligand compound, such as a sealable reactor, dispense the metal source, organic ligand, and the solvent medium.

The metal source can be any suitable source described herein (e.g., ZnNO₃, ZrCl₄, or alternative salts thereof). The organic ligand can be any suitable source described herein (e.g., 2-hydroxyterephthalic acid). The ratio of organic ligand material to metal source material can vary according to the specific interaction of the organic ligand to the metal atom. In general, the ratio can be 1:1, or in a non-limiting range from about 1:5 to 5:1 of the moles of the organic ligand to moles of the metal. The synthesis of the functionalized MOF can be conducted under any useful condition, such as under solvothermal reactor-based reaction conditions or hydrothermal reactor-based reaction conditions.

The solvent medium may be dispensed to entirely cover the metal source and organic ligand compound within the vessel, for example, by dispensing 50 mL/g solvent medium to metal source (e.g., 10 mL/g, 15 mL/g, 20 mL/g, or 30 mL/g). In general and without wishing to be bound by theory, inert high boiling point aprotic solvents can be preferred when the MOF is synthesized in acidic conditions (e.g., which can exist in the presence of metal chlorides reacting with carboxylic acid-containing ligands). In some non-limiting examples, protic solvents such as methanol, ethanol, or even water can be used when the MOF is synthesized in basic conditions or with nitrogen-based ligands (e.g., such as imidazole ligands). Non-limiting examples of solvent media include polar solvents, such as water, dimethylacetamide (DMAc), N,N-dimethylformamide (DMF), diethylformamide (DEF), methanol, ethanol, dimethyl sulfoxide (DMSO), or combinations of any of these.

Optionally, the process 500C can include dispensing a modulating or competing agent to the suspension mixture (step 504C). Such agents can alter the crystallization reaction kinetics occurring between the metal ion source and the organic ligand material. For example and without limitation, modulating or competing agents can be added to a MOF synthesis reaction mixture (e.g., the suspension mixture) and can increase the reproducibility and crystallinity of the final MOF substrate. Modulating agents and competing agents can be selected based on the metal ion source and organic ligand materials, and such can include a carboxylic acid, such as benzoic acid. In some embodiments, the modulating agent or the competing agent includes an agent that competes with the organic ligand to coordinate to the metal centers in the MOF structure. Without wishing to be limited by mechanism or theory, the presence of such agents can allow the MOF to “regrow” or error correct, thereby reducing defects.

The process 5000 can include agitating the suspension mixture (step 506C). The suspension mixture can be agitated (e.g., stirred) within the reaction chamber, e.g., with a magnetic stir bar and stir plate or other suitable method known to a person skilled in the art, while the metal ion source and organic ligand is soaking in the solvent medium. The suspension mixture can be agitated until the metal ion source and organic ligand, and the modulating/competing agent if added, are fully dissolved.

Optionally, the process 5000 can include heating the suspension mixture for a time period (step 508C). The temperature of the suspension mixture can be increased to facilitate the crystallization reaction. The target temperature of the reaction is selected based on the metal source and the organic ligand. In some examples, the suspension mixture is heated above ambient temperature, e.g., heated to 30° C. or more, 45° C. or more, 60° C. or more, 80° C. or more, 100° C. or more, or 120° C. or more. The time period during which the suspension mixture remains at the target temperature can depend on the composition of the suspension mixture, e.g., the metal source, the organic ligand material, and the optional modulating/competing agent. In some examples, the time period is in a range from 12 to 72 hours (e.g., 12 to 24 hours, 24 to 48 hours, or 24 to 36 hours, e.g., 24 hours, or 48 hours).

The process 5000 can include recovering the pre-functionalized MOF material from the suspension mixture (step 510C). Recovery can be performed using methods known in the art for separating a solid phase from a liquid phase. This can include, but is not limited to, vacuum filtration, centrifugation, vacuum evaporation, or a combination of these or other methods. The volume of solvent medium separated from the pre-functionalized MOF can be discarded, stored, or recycled.

The process 5000 can include washing the pre-functionalized MOF material in at least one wash volume of fresh (e.g., a new volume) solvent medium (step 512C). Additionally or alternatively, a polar aprotic solvent can serve as the wash solvent. A single wash step can include immersing the functionalized MOF material in a wash volume of fresh solvent medium such that the functionalized MOF material is entirely immersed in the fresh solvent medium. In some embodiments, similar ratios of fresh solvent medium to pre-functionalized MOF material as in step 502C (e.g., 50 mL/g of fresh solvent medium to pre-functionalized MOF substrate) can be used. For example, 0.2 g of pre-functionalized MOF material can be immersed in a wash volume of 10 mL of fresh solvent medium, in which a single wash or a plurality of washes can be performed. In some embodiments, the wash step can remove unreacted metal source material, organic ligand material, and the optional modulating/competing agent.

The process 5000 can further include drying the pre-functionalized MOF material (step 514C). Drying the pre-functionalized MOF material can include increasing the temperature, reducing the atmospheric pressure, passing an inert dry gas over the sample, or a combination of these. The pre-functionalized MOF material can be dried to remove substantially all of the wash volume of the solvent medium entrained in the MOF material. For example, in some implementations, the pre-functionalized MOF material is dried in a vacuum oven at 60° C. for 12 hours.

The process 5000 can further include preparing a functionalization mixture including a second solvent medium, the pre-functionalized MOF material, and an aminosilane (step 516C). In a vessel suitable for the total volume of the second solvent medium, the pre-functionalized MOF material, and the aminosilane, such as a sealable reactor, dispense the volume of the second solvent medium, the pre-functionalized MOF material, and the aminosilane.

The second solvent medium can be a neutral aprotic solvent, e.g., such as tetrahydrofuran (THF), dichloromethane (DCM), 1,2-dichloroethane (DCE), DMF, or acetonitrile (MeCN). The second solvent medium can be dispensed at a ratio of 1:20 w/v of pre-functionalized MOF material to second solvent medium (e.g., in a range from 1:10 w/v to 1:30 w/v of the MOF material to second solvent medium).

The aminosilane can be dispensed into the functionalization mixture at a ratio in excess (e.g., in molar excess) of the available hydroxyl groups in the pre-functionalized MOF materials. Non-limiting examples of aminosilanes include chlorosilylamines (e.g., [R^{A}]ₐSi[Cl]₄₋ₐ, wherein each R^{A} is, independently, an amine moiety comprising at least one amine group (e.g., any described herein) and a is an integer from 1 to 4) and alkoxysilylamines (e.g., [R^{A}]ₐSi[OAk]₄₋ₐ, wherein each R^{A} is, independently, an amine moiety comprising at least one amine group (e.g., any described herein), each Ak is, independently, an optionally substituted alkyl, and a is an integer from 1 to 4), as well as others described herein. Examples of chlorosilylamines include tris(ethylmethylamino)chlorosilane, and tris(dimethylamino) chlorosilane. Examples of alkoxysilylamines include bis(3-(methylamino)propyl) trimethoxysilane, N-[3-(trimethoxysilyl)propyl]aniline, (N,N-dimethylaminopropyl) trimethoxysilane, 3-aminopropyl(diethoxy)methylsilane, bis[3-(trimethoxysilyl) propyl]amine, (3-aminopropyl)triethoxysilane, (3-aminopropyl)trimethoxysilane, N-[3-(trimethoxysilyl)propyl]ethylenediamine, N1-(3-trimethoxysilylpropyl) diethylenetriamine, and [3-(2-aminoethylamino)propyl]trimethoxysilane. In some examples, the aminosilane material is dispensed at a molar ratio in a range from 0.1:1 to 1:1 of aminosilane material to organic ligand material.

Optionally, the process 5000 can include dispensing a non-coordinating base material, such as any described herein, to the functionalization mixture (step 518C). The non-coordinating base materials can be dispensed in excess of the hydroxy groups on the MOF ligands based on stoichiometry. This can serve to deprotonate the hydroxy group (e.g., of the organic ligand) and facilitate the reaction with an aminosilane material. Additionally, the base can react with any acid that may be formed during the reaction. The base can be used in 2 to 20 times molar equivalents to the organic ligand, for example. In some embodiments, the non-coordinating base material is a base that does not significantly coordinate to metal centers within the MOF structure. In some embodiments, the non-coordinating base material is a base that does not significantly coordinate to metal centers within the MOF structure. Non-limiting examples of non-coordinating base materials include 2,6-lutidine, N,N-diisopropylethylamine, triethylamine, 2-tert-butylimino-2-diethylamino-1,3-dimethylperhydro-1,3,2-diazaphosphorine, or 1,8-diazabicyclo [5.4.0]undec-7-ene. In some examples, the non-coordinating base material is a combination of non-coordinating base materials.

The process 5000 can further include agitating the functionalization mixture (step 520C). The functionalization mixture can be agitated (e.g., stirred) within the reaction chamber, e.g., with a suitable method known to a person skilled in the art, while the pre-functionalized MOF material, aminosilane, and optional non-coordinating base material are in the second solvent medium. The suspension mixture can be agitated while the functionalization mixture is heated.

The process 5000 can include heating the suspension mixture for a second time period (step 522C). The temperature of the functionalization mixture can be increased to facilitate binding of the silane moiety and/or functionalizing the surface with amine moieties. The target temperature of the reaction can be selected based on the selected aminosilane and second solvent medium. In some examples, the suspension mixture is heated above ambient temperature, e.g., heated to 30° C. or more, 40° C. or more, or 60° C. or more. The second time period during which the functionalization mixture remains at the target temperature can depend on the composition of the functionalization mixture, e.g., the pre-functionalized MOF material, the aminosilane, and the optional non-coordinating base material, and is generally sufficient to ensure maximal silylation/silanization of the pre-functionalized MOF material and creating the functionalized MOF material. In some examples, the time period is in a range from 2 to 24 hours (e.g., 2 to 12 hours, 12 to 24 hours, or 6 to 16 hours, e.g., 12 hours, or 24 hours).

The process 5000 can further include recovering the functionalized MOF material from the functionalization mixture (step 524C). Recovery can be performed using methods known in the art for separating a solid phase from a liquid phase (e.g., as described herein, such as for step 510C). The volume of the second solvent medium separated from the functionalized MOF material can be discarded, stored, or recycled.

The process 5000 can include washing the functionalized MOF material in at least one wash volume of fresh (e.g., a new volume) of a solvent medium (step 526C). In some embodiments, similar ratios of fresh solvent medium to functionalized MOF material as in step 516C (e.g., 20 mL/g of fresh solvent medium to functionalized MOF substrate) can be used. In some implementations, more than one wash step is performed (e.g., two washes, three washes, four washes, or more). In some embodiments, the wash step can remove unreacted aminosilane and optional non-coordinating base material from the functionalized MOF material.

The process 5000 can further include drying the functionalized MOF material (step 528C). Drying the functionalized MOF material can include any described herein (e.g., for step 514C). The functionalized MOF material can be dried to remove substantially all of the wash volume of the wash solvent entrained in the MOF material. For example, in some implementations, the functionalized MOF material is dried in a vacuum oven at 50 mbar and at 50° C. for 12 hours.

As seen in FIG. 5D, a process 500D can provide a functionalized resin. Optionally, the process can include washing a resin material in at least one wash volume of a solvent medium (step 502D). The resin material can be any ion-exchange resin as described herein. In some implementations, the resin material is a base-functionalized resin, an acid-functionalized resin, or a neutral resin comprising no chemical functionalization. The solvent medium can be chosen based on the type of resin selected. In an example of an acid-functionalized resin, the solvent medium can be an organic solvent, such as methanol, acetone, or a combination of both. The wash step can be employed to prepare the resin material for functionalization by removing entrained water and/or by facilitating drying with less gel shrinking. In some examples, replacing entrained water with an organic solvent can assist in this process. For example, washing can include dispensing a solvent medium at 20 mL/g of solvent medium to resin material.

If the optional wash step 502D is performed, then the process 500D can include drying the resin material (step 504D). The washed resin material can be dried to remove liquid solvent from the resin before functionalization. Drying the resin material can include increasing the temperature, reducing the atmospheric pressure, passing an inert dry gas over the sample, or a combination of these.

Optionally, the process 500D can include grinding the resin material (step 506D). Ion-exchange resin materials purchased from industrial sources can come in several morphologies, including beads, granules, membranes, and/or fibers. Grinding the resin material, e.g., grinding beads or granules into a powder form, can increase the overall surface area of the resin material and can facilitate enhanced functionalization in subsequent steps to provide a functional portion. In some embodiments, grinding the resin material can increase the kinetics of CO₂ adsorption by reducing average resin material size. The grinding process can depend on the quantity of resin to be functionalized. For example and without limitation, small quantities (e.g., <100 g) can be ground with a mortar and pestle, while larger quantities can be ground in a mechanical mill.

Optionally, the process 500D can include sieving the resin material (step 508D). Sieving the ground resin materials can increase uniformity of the recovered ground resin, which in turn can increase uniformity in CO₂ uptake and resin packing density in direct air capture methods. In some implementations, ground resin is passed through a non-reactive mesh having pores of uniform size, for example and without limitation, a stainless steel mesh having 250 micron pores (e.g., 500 micron, 300 micron, or 200 micron pores).

The process 500D can include preparing a suspension mixture including a solvent medium and the resin material (step 510D). In a vessel suitable for the total volume of the solvent medium and the resin material, such as a three-necked round bottom flask or glass vial, dispense the resin material and the solvent medium. The solvent medium can be an organic solvent (e.g., any described herein) or a mixture of organic solvents. The solvent medium can be the same organic solvent as above in step 502D (if step 502D is conducted) or a different organic solvent. The solvent medium can be dispensed to entirely cover the resin material within the vessel. For example, by dispensing 20 mL/g of solvent medium to resin material (e.g., 5 mL/g, 8 mL/g, 10 mL/g, or 15 mL/g).

The process 500D can include adding a polyamine material into the suspension mixture to form a functionalization mixture (step 512D). The polyamine material can include a polyamine, e.g., PEI, ethylamine, silylamine, or small molecule amines, such as those described herein. In some embodiments, the polyamine material is a combination of materials, e.g., a high molecular weight polyamine with a low molecular weight polyamine, such as PEI with pentaethylenehexamine. In some embodiments, the polyamine material can be adapted to provide from 10% to 60% (wt/wt) of the polyamine to the resin. In some embodiments, the polyamine material can be dispensed into the solvent medium at a 50% (wt/wt) ratio or from 0% to 30% (wt/wt) ratio to the resin. In some implementations, the polyamine material is dispensed into the solvent medium in a range from 10% to 60% (wt/wt) or 30% to 100% (wt/wt) of polyamine to the solvent medium.

The process 500D can further include agitating the functionalization mixture for a time period (step 514D). The functionalization mixture can be agitated (e.g., stirred) within the vessel, e.g., with a magnetic stir bar and stir plate, a rotation device, or other suitable method known to a person skilled in the art, while the resin material is soaking in the solvent medium. Agitation can increase the rate of functionalizing the resin material. The first time period should be sufficient to ensure that the resin material has adsorbed the polyamine material to maximum capacity to form functionalized resin material. For example, the first time period can be in a range from 10 hours to 24 hours (e.g., 12 hours). In some embodiments, the solvent medium can be decanted following agitation.

The process 500D can include washing the functionalized resin material in at least one wash volume of a second solvent medium (step 516D). The second solvent medium can be chosen based on the type of resin and polyamine material selected. In one example, the second solvent medium is a solvent, such as water, methanol, cyclohexane, or a combination of organic solvents (e.g., any described herein).

The process 500D can include drying the functionalized resin material (step 518D). Drying the functionalized resin material can include increasing the temperature, reducing the atmospheric pressure, passing an inert dry gas over the sample, or a combination of these. The functionalized resin material can be dried to remove substantially all of the wash volume of the second solvent medium entrained in the functionalized resin material. For example, in some implementations, the functionalized resin material is dried in a vacuum oven at 50° C. at 50 mbar for 12 hours. As non-limiting examples, the drying threshold is a weight lost by the sample of 15% (e.g., weight lost to solvent removal) or having minimal weight loss (e.g., a weight loss of less than about 5% over a period of about 2 hours at 100° C.) with an inert gas flow (e.g., 50 mL/min of N₂ flow) through the sample (e.g., as measured on TGA)).

As seen in FIG. 5E, the process 500E can include preparing a suspension mixture including a solvent medium and a substrate (step 502E). Additional details can include any described herein (e.g., for step 502A).

The process can further include heating and agitating the suspension mixture under reflux conditions to a heating temperature above ambient temperature and below 90° C. (step 504E) (e.g., greater than 25° C. and below 90° C.). For example, using hexane as a solvent medium, the suspension mixture can be heated to between 65° and 70° C., though in general, the heating temperature to which the suspension mixture is heated can depend on the solvent medium selected for the process 500E. As a second example, in implementations in which toluene is selected as a solvent medium, the heating temperature can be 90° C. The suspension mixture is agitated (e.g., stirred) within the vessel, e.g., with a magnetic stir bar and stir plate or other suitable method known to a person skilled in the art, while the substrate is soaking in the solvent medium. In some embodiments, agitation can increase the substrate absorption rate.

The process 500E can include adding a polymeric/oligomeric amine material to the suspension mixture to form a pre-functionalization mixture (step 506E). The polyamine material can include any described herein. A second polar solvent (e.g., such as water, methanol, or ethanol) may be added at a 5% volume/volume (vol/vol) ratio to the first solvent to increase dispersion of polymeric/oligomeric amine. In some examples, the ratio of the neutral aprotic organic solvent to polar solvent is 20:1 vol/vol. The polymeric/oligomeric amine material can be dispensed to a weight ratio in a range from 5% to 25% (wt/wt) of polyamine material to the substrate.

The process 500E can include reacting the substrate and polyamine material in the solvent medium for a first time period (step 508E). The first time period can be sufficient to ensure that the polyamine material has reacted to maximum capacity with the substrate. For example, the first time period can be in a range from 4 to 24 hours (e.g., 6 to 18 hours).

The process 500E can include adding a silane coupling material to the suspension mixture to form a functionalization mixture (step 510E). Additional details can include any described herein (e.g., for step 506A). In some embodiments, the silane coupling material may be dispensed in a range from 20% to 80% (wt/wt) of a loading silane to the substrate.

The process 500E can include reacting the substrate, silane coupling material, and polyamine material in a solvent medium for a second time period (step 512E). The second time period can be sufficient to allow maximum functionalization (e.g., binding) of the silane coupling material to the surfaces of the polyamine-treated substrate. In general and without wishing to be bound by theory, the second time period can be longer than 12 hours and can depend on the solvent medium, heating temperature, and silane coupling material. In some implementations, the second time period is longer than 12 hours (e.g., longer than 18 hours, longer than 20 hours, or longer than 24 hours). For example and without limitation, the second time period can be in a range from 12 to 24 hours (e.g., 16 to 18 hours).

The process 500E can include filtering the functionalized material from the functionalization mixture (step 514E), wash the functionalized material in a wash volume of fresh (e.g., a new volume) of the solvent medium (step 516E), and drying the functionalized material (step 518E). Additional details can include any described herein (e.g., for steps 514A, 516A, 518A, and 528B).

As seen in FIG. 5F, the process 500F can include a water-based reaction. In particular embodiments, the process 500F can include preparing a liquid mixture including a volume of water and a polyamine material (step 502F). In a vessel suitable for the total volume of the water and the polyamine material, such as a three-necked round bottom flask or a beaker, dispense the polyamine material (e.g., PEI) and the volume of water. The polyamine material can be any polyamine material (e.g., as described herein). The water can be dispensed to fully suspend the polyamine material within the vessel, for example, by dispensing 20 mL/g water to polyamine material (e.g., 10 mL/g, 15 mL/g, or 25 mL/g). The polyamine material can be added to the water in a range between 5% to 25% (wt/wt) of the silica substrate to be added in step 508F.

Optionally, the liquid mixture can be stirred until the polyamine material is fully suspended in the water. In some examples, mechanical stirring with a propeller, a magnetic stirrer, or sonication disperses the polyamine material in time in a range from 5 to 60 minutes (e.g., from 10 to 30 minutes, 5 to 30 minutes, or 10 to 45 minutes).

While agitating, the process 500F can further include adding a silane coupling material (e.g., an aminosilane) to the liquid mixture (step 504F). The silane coupling material can be dispensed in a range between 20% to 80% (wt/wt) or 40% to 80% (wt/wt) of the substrate to be added in step 508F (e.g., 20%, 30%, 40%, 45%, 50%, 60%, or 70% (wt/wt)).

The process 500F can further include agitating the liquid mixture for a first time period to form a suspension mixture (step 506F). The first time period can be sufficient to allow for hydrolysis of and dissolution of the silane coupling material. In general, the first time period is in a range between 1 to 10 minutes (e.g., 5 minutes).

The process 500F can further include adding a substrate to the suspension mixture to form a functionalization mixture (step 508F). The substrate (e.g., a silica material or a silicon oxide material) can be any suitable substrate, e.g., any described herein. The substrate can be added to achieve the quantity of functionalized material resulting from the process, the quantity depending on the scale of the process.

The process 500F can include agitating the functionalization mixture for a second time period (step 510F). The second time period can be sufficient to allow maximum absorption of the polyamine material and the silane coupling material to the substrate, e.g., for functionalization or binding to the surface of the substrate. In general and without wishing to be bound by theory, the second time period can be less than 60 minutes and can depend on the quantities and concentrations of polyamine material and silane coupling material in the functionalization mixture. For example, the second time period can be in a range from 5 to 60 minutes, e.g., 10 minutes, 20 minutes, 30 minutes, or 45 minutes. In some non-limiting embodiments, agitation times greater than 30 minutes can reduce the absorption capacity of the functionalized silica.

The process 500F can include filtering the functionalized material from the functionalization mixture (step 512F) and drying the functionalized material (step 514F). Additional details can include any described herein (e.g., for steps 514A, 518A, and 528B). In some embodiments, the functionalized material is removed from the solution through filtration or evaporation, and retained water removed from the material through heating. In some embodiments, preparation of the functionalized material in a batch format using water as a solvent can reduce the cost and environmental impact of the process.

In some implementations, the functionalized material is dried in an oven at 120° C. for between 5 and 20 minutes. Drying times longer than 30 minutes may reduce the absorption capacity of the final product. Alternatively, the functionalized material can dried in an oven (e.g., at 80° C.) until a hydration threshold is reached. As non-limiting examples, the hydration threshold can be a weight lost by the sample of 15% (e.g., weight lost to water removal) or having minimal weight loss (e.g., a weight loss of less than about 5% over a period of about 2 hours at 100° C.) with an inert gas flow (e.g., 50 mL/min of N₂ flow) through the sample (e.g., as measured on TGA)). Alternatively, the functionalized material is dried in the oven until the water content in the material is less than 5% (wt/wt).

As seen in FIG. 5G, the process 500G can include preparing a suspension mixture including a solvent medium and a substrate (step 502G). In a vessel suitable for the total volume of the solvent medium and the substrate, such as a three-necked round bottom flask, dispense the substrate (e.g., a silica or silicon oxide material) and the solvent medium. The substrate can be any suitable substrate, e.g., any described herein. The solvent medium can be dispensed to entirely cover the substrate within the vessel, for example, by dispensing 1 to 10 mL/g of solvent medium to silica substrate (e.g., 1 mL/g, 5 mL/g, 8 mL/g, 15 mL/g, or from 2 to 3 mL/g or 2 to 2.5 mL/g). In one example, the solvent medium is methanol. In some examples, the solvent medium is a solvent mixture, such as a 2:1 mixture of ethanol and cyclohexane. The solvent mixture for the solvent medium can be selected to provide optimal uptake of the polyamine by the substrate.

The process 500G can further include agitating the substrate in the solvent medium (step 504G). The suspension mixture can be agitated (e.g., stirred) within the vessel, e.g., with a magnetic stir bar and stir plate or other suitable method known to a person skilled in the art, while the substrate is soaking in the solvent medium.

While agitating, a polyamine material can be added to the suspension mixture (step 506G). The polyamine material can be a polyamine, e.g., any described herein. The polyamine material can be dispensed into the solvent medium at 10% to 60% (wt/wt) or a 30% (wt/wt) ratio to the substrate in the solvent medium. In some implementations, the polyamine material is dispensed into the solvent medium at up to 20% (wt/wt), 50% (wt/wt), or 60% (wt/wt) ratio (e.g., in a range from 10% to 60% (wt/wt), 10% to 50% (wt/wt), 15% to 60% (wt/wt), 15% to 50% (wt/wt, or 20% to 60% (wt/wt)).

Optionally, the suspension mixture can be heated to a heating temperature above ambient temperature and below 90° C. (step 508G) (e.g., greater than 25° C. and below 90° C.). The heating temperature to which the suspension mixture is heated can depend on the solvent medium selected for the process 500G.

The process 500G can include agitating the suspension mixture at the heating temperature for a time period (step 510G). The time period can be sufficient to allow maximum functionalization (e.g., binding) of the polyamine material to the surface of the substrate. In general and without wishing to be bound by theory, the time period can be in a range from 10 minutes to 6 hours and can depend on the solvent medium, heating temperature, concentration of the polyamine material, and characteristics of the polyamine material. In some implementations, the time period is in a range from 10 minutes to 1 hours, 10 minutes to 2 hours, 10 minutes to 4 hours, 1 to 6 hours, 2 to 6 hours, or 3 to 6 hours.

After the time period, the process 500G can include cooling the suspension mixture (step 512G). In some implementations, the cooling occurs passively (e.g., by way of radiant cooling). For example, the vessel can be allowed to cool at ambient air temperature until the suspension mixture cools to a target temperature. In some implementations, the target cooling temperature is ambient temperature (e.g., room temperature). In alternative implementations, the cooling occurs actively (e.g., by way of heat exchange), such as with a water bath for the vessel.

The process 500G can include filtering the functionalized material from the suspension mixture (step 514G), optionally washing the functionalized material in at least one wash volume of fresh (e.g., a new volume) solvent medium (step 516G), and drying the functionalized material (step 518G). Additional details can include any described herein (e.g., for steps 514A, 516A, 518A, and 528B).

Additionally or alternatively, any neutral aprotic solvent can serve as the wash solvent. A single wash step can include immersing the functionalized material in a wash volume of fresh solvent medium such that the functionalized silica material is entirely immersed in the fresh solvent medium. Similar ratios of fresh solvent medium to substrate as in step 502G (e.g., 10 mL/g of fresh solvent medium to functionalized substrate) can be used. For example, the functionalized material can be immersed in a wash volume of 40 mL of fresh solvent medium as a single wash or as a plurality of washes performed (e.g., two washes, three washes, four washes, or more).

As seen in FIG. 5H, the process 500H can include preparing a suspension mixture including a solvent medium and a substrate (step 502H). In a vessel suitable for the total volume of the solvent medium and the substrate, such as a three-necked round bottom flask, dispense the substrate (e.g., a silica or silicon oxide material) and the solvent medium. Additional details can include any described herein (e.g., for step 502G).

In some examples, the ethylene amine/oligomer material is received suspended in a suspension medium from a commercial source. In such examples, steps 502G and 504H may be omitted, or the solvent medium can be added to the suspension medium to form a mixture.

The process can further include agitating the substrate in the solvent medium (step 504H). The suspension mixture can be agitated (e.g., stirred) within the vessel, e.g., with a magnetic stir bar and stir plate or other suitable method known to a person skilled in the art, while the substrate is soaking in the solvent medium.

While agitating, a polyamine material can be added to the suspension mixture (step 506H). The polyamine material can include a polyamine having a MW of about 100 to 800 g/mol (e.g., a small molecular polyamine), an oligomeric amine, an oligomeric ethylene amine, and/or an ethylene amine/oligomer, such as any described herein. In some embodiments, the polyamine material can be a small molecule polyamine material. The small molecule polyamine material can be dispensed into the solvent medium at a 10% to 60% (wt/wt) ratio to the substrate in the solvent medium. In some implementations, the small molecule polyamine material is dispensed into the solvent medium at up to 50% (wt/wt) ratio or up to 60% (wt/wt) ratio (e.g., in a range from 10% to 60% (wt/wt), 10% to 50% (wt/wt), 20% to 60% (wt/wt), or 20% to 50% (wt/wt)). Without wishing to be limited by mechanism or theory, the small molecule polyamine can bind to the substrate through van der Waals interactions creating a functionalization layer of polymeric/oligomeric amines.

Optionally, the process 500H can include heating the suspension mixture to a heating temperature above ambient temperature and below 90° C. (step 508H) (e.g., greater than 25° C. and below 90° C.). The heating temperature to which the suspension mixture is heated can depend on the solvent medium selected for the process 500H.

The process 500H can include agitating the suspension mixture at the heating temperature for a time period (step 510H). The time period can be sufficient to allow maximum functionalization (e.g., binding) of the small molecule polyamine material to the surface of the substrate. In general and without wishing to be bound by theory, the time period can be longer than 6 hours and can depend on the solvent medium, heating temperature, concentration of the small molecule polyamine material, and characteristics of the small molecule polyamine material. In some implementations, the time period is in a range from 10 minutes to 6 hours (e.g., from 10 minutes to 5 hours, 10 minutes to 4 hours, 10 minutes to 3 hours, 10 minutes to 2 hours, from 10 mins to 1 hours, 30 minutes to 5 hours, 1 to 5 hours, 2 to 5 hours, 3 to 5 hours, 1 to 3 hours, or from 30 minutes to 2 hours).

After the time period, the process 500H can include cooling the suspension mixture (step 512H), filtering the functionalized material from the suspension mixture (step 514H), optionally washing the functionalized material in at least one wash volume of fresh (e.g., a new volume) solvent medium (step 516H), and drying the functionalized material (step 518H). Additional details can include any described herein (e.g., for steps 512G, 514A, 516A, 518A, and 528B).

In some embodiments, the process can include that described in FIG. 5I, as discussed below.

vi. Dip-Coating Processes

The present disclosure also relates to a method of making a functionalized material at a commercial scale (e.g., batches of 25 kg or more), and compounds produced therefrom. In some embodiments, the substrate (e.g., porous silica particles) are functionalized with a polyamine, such as polyethylenimine (PEI), and an aminosilane compound containing at least one silane moiety and at least one amine moiety, such as an aminoalkyl-substituted trialkyoxysilane (e.g., N-(2-aminoethyl)-3-aminopropyltrimethoxysilane)). In some embodiments, the combination of a polyamine and an aminosilane increases the number of amine moieties bound to the silica substrate for increased carbon capture (e.g., >2 mol/kg). The first polyamine layer forms a network with the aminosilane. The polymer layer is stabilized by the aminosilane compound during binding to the porous silica. The functionalized material can be produced using solution-based reaction methods (e.g., dip-coating) in which the aminosilane compound and the polyamine compound are solvated in a water-based solution. The substrate is dispensed into the mixture, stirred, and removed. This functionalizes the substrate with both the silane-containing compound and the polyamine concurrently.

In some embodiments, the dip-coating process facilitates scaled-up sorbent manufacturing and recycling of some process ingredients which reduces long-term production costs. The dip-coating method can reduce energy and time for drying the volumes of sorbent. The dip-coating method can be more gentle than stirred production methods and reduces damage to the dip-coated substrate (e.g., dip-coated silica particles).

In some embodiments, a method can include: introducing a first reagent including a polyamine and a second reagent including a silane moiety and an amine functional group into a volume of water to form a functionalization mixture; introducing a substrate (e.g., porous silica particles) into the functionalization mixture; resting the substrate in the functionalization mixture for a time period and under conditions sufficient to interact the first reagent and the second reagent with a surface of the substrate to form a functionalized substrate (e.g., functionalized silica particles); and removing the functionalized material from the volume of water.

In some embodiments, the conditions to form functionalized material may include ambient pressure and a temperature in a range from 20° C. to 70° C. The second reagent may include (3-aminopropyl)trimethoxysilane, (3-aminopropyl) triethoxysilane, [3-(2-aminoethylamino)propyl]trimethoxysilane, n-(2-aminoethyl)-3-aminopropyl silanetriol, n1-(3-trimethoxysilylpropyl)diethylenetriamine, 3-aminopropylsilanetriol, n-(2-aminoethyl)-3-aminopropylsilanetriol, tris(ethylmethylamino)chlorosilane, or tris(dimethylamino)chlorosilane.

In some embodiments, the method may further include: drying the functionalized material at 50° C. or higher until a hydration threshold can be reached, or under a flow of nitrogen in an oven at 50° C. or higher. The drying can be performed in a double cone vacuum dryer, a conveyor belt dryer, a Blet dryer, or a Nutsche filter dryer.

In some embodiments, the substrate may include a quantity of at least 25 kilograms (e.g., at least 25 kilograms of porous silica particles). The quantity can be in a range from 100 kilograms to 10,000 kilograms.

The first reagent can be included in the volume of water at a range from 5% to 20% (wt/wt) of the first reagent to the substrate (e.g., a silica oxide material). The second reagent can be included in the volume of water at a range from 20% to 70% (wt/wt) of the second reagent to the substrate (e.g., silica oxide material.

Introducing may include consecutively introducing a plurality of quantities of substrate (e.g., a plurality of quantities of porous silica particles) into the functionalization mixture to form a plurality of quantities of functionalized material (e.g., a plurality of quantities of functionalized silica particles), and removing may include consecutively removing the plurality of quantities of functionalized material (e.g., a plurality of quantities of functionalized silica particles).

In some embodiments, the method may include: introducing a third reagent may include an antioxidant compound to the volume of water. The antioxidant compound can be an organic sulfur-containing compound (e.g., any described herein). In some embodiments, the substrate can be maintained in the functionalization mixture for 3 to 72 hours.

FIG. 5I provides a non-limiting dip-coating process 500I for producing functionalized material. In some implementations, the dip-coating process 500I is performed at large scale, e.g., producing 1 kilogram or more of functionalized material in a single process. In some implementations, the process 500I produces 100 kilograms or more of functionalized material, e.g., up to 10,000 kg. To maintain the original size distribution, agitation methods in which the substrate is subjected to comparatively low friction or stirring forces are preferred, such as overhead stirring, gentle tumbling, slow and periodic stirring, or vibration.

As seen in FIG. 5I, the process 500I includes introducing a first reagent including a polyamine and a second reagent comprising a silane moiety and an amine functional group into a volume of water to form a functionalization mixture (step 502I), e.g., introducing the polyamines and the aminosilanes into the volume of water. The solvent can also be organic solvent for some cases. As used herein, a reagent and a compound can be used interchangeably. Depending on use, a reagent may optionally include one or more solvents, salts, or other compounds.

In a vessel suitable for the total volume of the reagents, such as a three-necked round bottom flask, beaker, drum, or mixer, dispense the first reagent, the second reagent, and the volume of water. The first reagent is a polyamine material, such as the polyamine compounds described herein. The water should be dispensed to fully suspend the polyamine material within the vessel, for example, by dispensing 20 mL/g water to polyamine material (e.g., 10 mL/g, 15 mL/g, or 25 mL/g). The polyamine material is added to the water in a range between 5% to 20% (wt/wt) of the substrate to be added in step 304 (e.g., 6% (wt/wt), 8% (wt/wt), 10% (wt/wt), 12% (wt/wt), 14% (wt/wt), 16% (wt/wt), or 18% (wt/wt)).

The second reagent can be a silane coupling material, which includes the examples of silane compounds described herein. The silane coupling material can be dispensed in a range between 20% to 80% (wt/wt) of the substrate to be added in step 504I (e.g., 25% (wt/wt), 30% (wt/wt), 35% (wt/wt), 45% (wt/wt), 50% (wt/wt), or 60% (wt/wt)).

The liquid mixture can be stirred until the polyamine material and the silane coupling material are fully suspended in the water. In some examples, mechanical stirring with a propeller, a magnetic stirrer, or sonication disperses the polyamine material in time in a range from 5 to 60 minutes (e.g., from 10 to 30 minutes, 5 to 30 minutes, 10 to 45 minutes).

Optionally, the functionalization mixture can be agitated for a duration to allow hydrolysis of and fully dissolve the silane coupling material and polyamine materials. In general, the first time period is in a range between 1 to 10 minutes (e.g., 5 minutes).

The process 500I can include introducing a substrate (e.g., porous silica particles) to the functionalization mixture (step 504I). The substrate (e.g., a silica or silicon oxide material) can be any suitable substrate, e.g., any described herein. The substrate is added to achieve the quantity of functionalized material resulting from the process, the quantity depending on the scale of the process.

The process 500I can include resting the substrate in the functionalization mixture for a time period (step 506I). The substrate can rest in the functionalization mixture under conditions sufficient to chemically bond the first reagent and the second reagent to a surface of the substrate to form a functionalized material (e.g., functionalized silica particles). The time period is sufficient to allow maximum absorption of the polyamine material and the silane coupling material to the surfaces of the substrate e.g., functionalization. In general and without wishing to be bound by theory, the time period is less than 60 minutes and depends on the quantities and concentrations of polyamine material and silane coupling material in the functionalization mixture. For example, the time period can be in a range from 5 to 60 minutes, e.g., 10 minutes, 20 minutes, 30 minutes, or 45 minutes.

The process 500I can include removing the functionalized material from the functionalization mixture (step 508I). The removal is performed using methods known in the art for separating a solid phase from a liquid phase. This can include, but is not limited to, vacuum filtration, centrifugation, vacuum evaporation, or a combination of these or other methods. The volume of functionalization mixture separated from the functionalized material can be discarded, stored, or recycled. Optionally, the functionalization mixture can be reused in the process 500I more than once if the concentrations of the polyamine material and the silane coupling material remain high enough to functionalize additional amounts of substrate. Reusing the functionalization mixture over multiple processes 300 can save material costs and increase manufacturing efficiency of functionalized material.

Optionally, the process 500I can include drying the functionalized material (step 510I). Drying the functionalized material can include increasing the temperature, reducing the atmospheric pressure, passing an inert dry gas over the sample, passing an heated dry gas over the sample, or a combination of these. The functionalized material can be dried to remove substantially all of the water entrained in the functionalized material.

For example, in some implementations, the functionalized material is dried in an oven at 70° C. for between 5 and 20 minutes. In some embodiments, drying times longer than 60 minutes may reduce the absorption capacity of the final product. However, the drying time can be scale- or condition-dependent. For example, drying under N₂ or vacuum, the drying time can be longer. In examples in which batch drying is performed, even with N₂ or vacuum, drying times may be longer than 60 minutes. Alternatively, the functionalized material can be dried in an oven at 70° C. until a hydration threshold is reached. As non-limiting examples, the hydration threshold can be a weight lost by the sample of 15% (e.g., weight lost to water removal) or no further weight loss at 70° C. with inert (e.g. N₂) flow through (e.g., as measured on TGA)). Alternatively, the functionalized material can be dried (e.g., in the oven) until the water content in the material is less than 5% (wt/wt).

The sorbent can be reused through the desorption process. For example, the sorbent can be reused 100 times or more (e.g., 1000 times or more, 10000 times or more). For the desorption process, the sample can be heated to 70° C. or higher under vacuum for 30 minutes (the duration may change based on temperature and/or vacuum level). Without wishing to be limited by theory, this can facilitate release of CO₂ capture during the adsorption process, in which released CO₂ can be collected for further sequestration, described with reference to the systems for direct air capture herein. A non-limiting aspect of the desorption process can be to maintain the sorbent heated under a water vapor filled vacuum environment (e.g., >10% relative humidity). Without wishing to be limited by mechanism, this can reduce sorbent degradation.

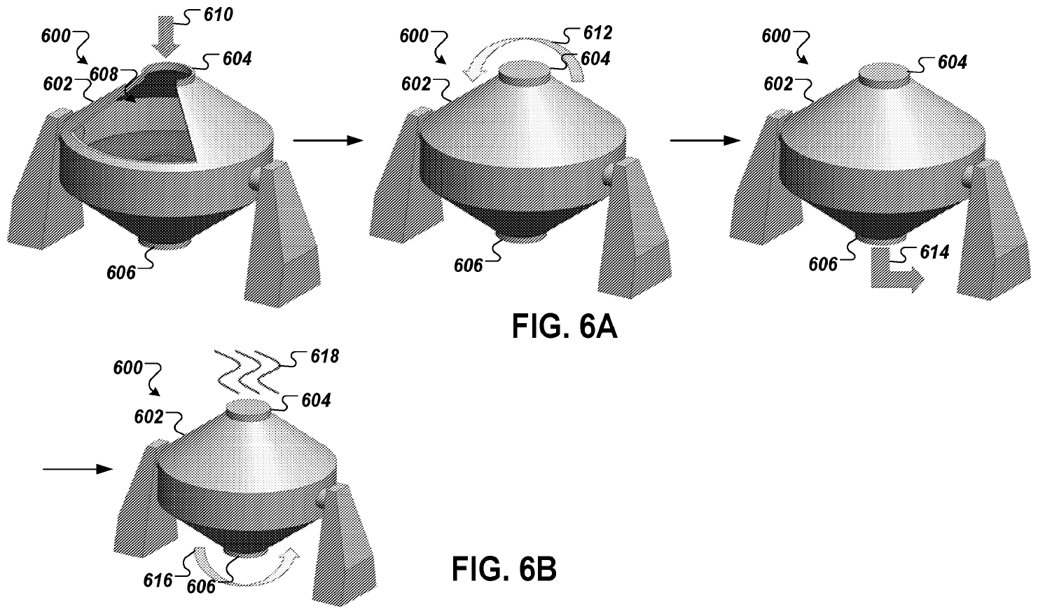

Any useful component can be used to form a functionalized material. In some embodiments, one or more components can be employed in a dip coating system. FIGS. 6-11 are example systems by which a functionalized material can be produced in the dip-coating methods described herein.

FIGS. 6A-6B shows a double cone tumble mixing system 600 which includes a tumbler 602 having an inlet 604, outlet 606, and an inner volume 608. The double cone mixing system 600 results in a high degree of particle mobility during mixing when the substrate is added to the inner volume 608 through the inlet 604. In general, the contents of the tumbler 602 are mixed by rotating the tumbler 602 around a central horizontal axis.

The double cone tumble mixing system 600 is an efficient machine for mixing of dry powders and granules homogeneously. All of the surfaces which contact the contents can be manufactured from non-reactive metal, such as stainless steel, glass, or glass-coated interior, to prevent interaction with the silane compounds, the polyamines, or the substrate (e.g., silica particles). In general and without wishing to be bound by theory, the effective volume for optimum homogeneity is between 35-70% of the inner volume 608 of the tumbler 602. The double cone tumble mixing system 600 is advantageous for use with fragile substrates (e.g., fragile silica particles) as the cone-shapes and smooth inner walls of the tumbler 602 reduce attrition of the substrate during agitation.

In general, the pre-functionalization mixture components and/or functionalization mixture components are poured into the inlet 604 and allowed to form the functionalization mixture. In other words, the aminosilanes, the polyamines, and/or a volume of solvent (e.g., water) water are sprayed into the inner volume 608 of the mixing system 600, shown in the left-most image of FIG. 6A. If necessary, the inlet 604 is sealed and the components agitated within the mixing system 600 to form, or hasten the formation of, the pre-functionalization mixture or the functionalization mixture.

The substrate (e.g., porous silica particles) are added to the functionalization mixture through the inlet 604 and the tumbler 602 is sealed and agitated to form the functionalized material, shown in the central image of FIG. 6A.

The functionalized material can be separated from the functionalization mixture by opening the outlet 606 and decanting the functionalization mixture (the right-most image of FIG. 6A) from the functionalized material through filtration or other means. In some examples, the tumbler 602 does not include an outlet 606, and the inlet 604 is instead used to decant the functionalization mixture and separate the functionalized material.

In some examples, the mixing system 600 is used to both functionalize and dry the silica particles. In FIG. 6B, the mixing system 600 applies heat 618 to the inner volume 608 of the tumbler 602 which causes excess functionalization mixture absorbed by the functionalized material to evaporate. The tumbler 602 is rotated to agitate the functionalized material, which increases the evaporation rate of the absorbed functionalization mixture during heating.

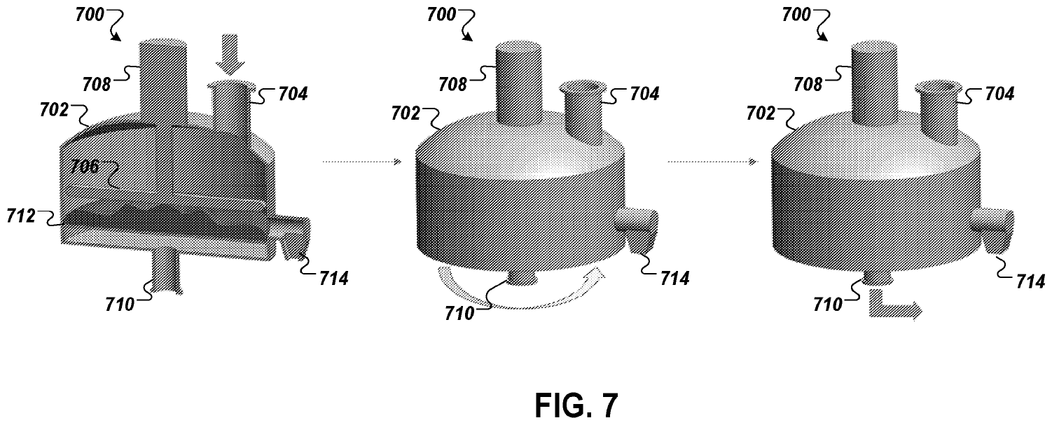

FIG. 7 is three images of an example Nutsche filter mixing system 700 which effectively performs the separation of solid matter from a liquid under pressure or vacuum in a closed system. The left-most image of FIG. 7 shows a cut-away view of the mixing system 700. The mixing system 700 includes a vessel 702 having an inlet 704, filter discharge 710, and outlet 714. Some examples of the vessel 702 are jacketed for temperature control. An agitator 706 is rotatable within the vessel 702 by a drive motor 708 around the drive motor 708 shaft. The inlet 704 receives the pre-functionalization mixture components or functionalization mixture components including the silane compounds, polyamines, volume of solvent (e.g., water), and/or substrate (e.g., silica substrates).

The drive motor 708 rotates the agitator 706 such that the mixture is stirred and the substrate is mobilized within the functionalization mixture. The vessel 702 includes a filter 712 sized to separate the solid substrate and the liquid functionalization mixture during agitation. When the discharge 710 and outlet 714 are open, the liquids are removed from the vessel 702 and discarded while the filter 712 separates the functionalized material. The solid substrate exits through the outlet 714 and the liquid functionalization mixture exits through the discharge 710. The filter 712 can be wire mesh, a cloth layer, or a perforated metal layer.

Some examples of the mixing system 700 include a heating mechanism integrated into the filter 712 such that, following decanting of the liquid in the right-most image of FIG. 7, the separated functionalized material can be dried within the vessel 702.

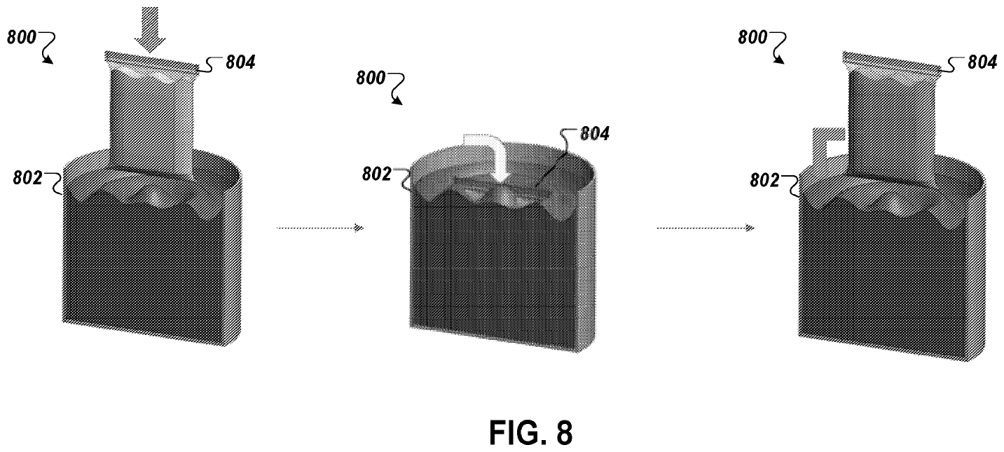

FIG. 8 is three images of a filtration bag dip-coating method used to produce a functionalized material. An open-topped container 802, e.g., a vat, is filled with the liquid components of the functionalization mixture and allowed to produce a homogeneous mixture. In some examples, the liquid components are agitated to produce the homogeneous mixture. In the left-most image, a mesh filtration bag 804 is filled with the substrate (e.g., silica particles) to be functionalized. The mesh of the filtration bag 804 is sufficiently small to permit liquid ingress while withholding the substrate (e.g., particulates of the silica particles). In some cases, the mesh is large enough to permit fine dust to be separated from the substrate when the filtration bag 804 is submerged.

In the central image of FIG. 8, the filtration bag 804 is submerged within the liquid components and rested for a duration. The filtration bag 804 can be moved within the container 802 to facilitate uniform contact between the functionalization mixture and the substrate contained within the filtration bag 804. The uniform contact produces homogenous functionalized material when the filtration bag 804 is withdrawn and the functionalized material is dried.

In the right-most image of FIG. 8, the filtration bag 804 is withdrawn from the container 802 and the excess functionalization mixture decanted, e.g., drained, such that the functionalized material is maintained in the filtration bag 804. The functionalized material (e.g., functionalized silica particles) can then be removed from the filtration bag 804 and dried to complete the functionalization process.

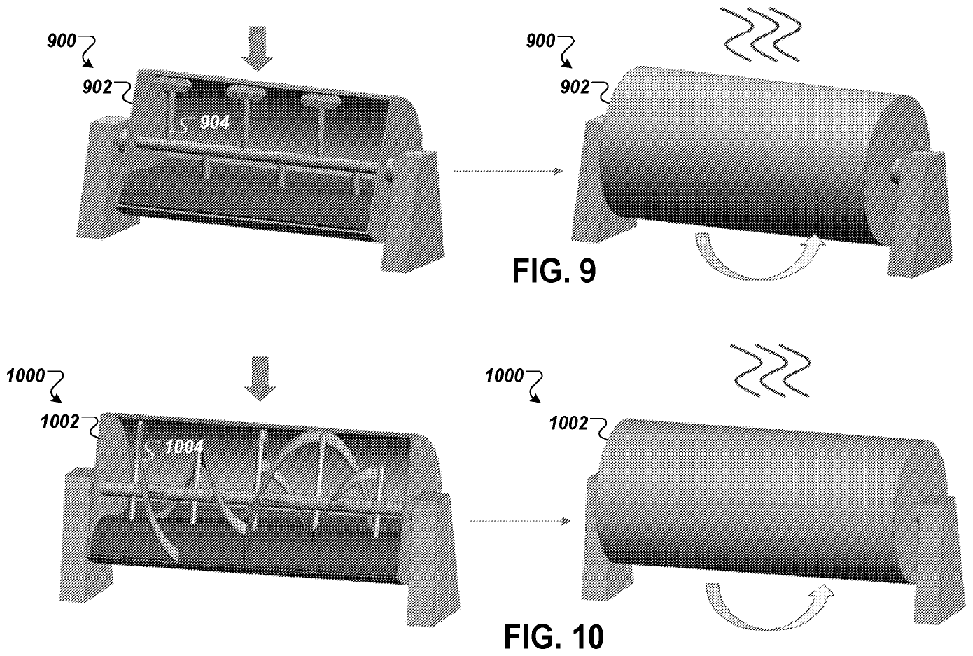

FIGS. 9 and 10 show two different examples of drum mixers which can be used for mixing the functionalization mixtures and drying of the functionalized material (e.g., functionalized silica particles). In the left image of FIG. 9, a paddle mixer 900 includes a cylindrical drum 902 in which the functionalization mixture is mixed. A paddle agitator 904 rotates independently of the drum 902 to mix the functionalization mixture. The substrate is dispensed into the drum 902, and the paddle agitator 904 rotates to agitate the substrate (e.g., silica particles) in the functionalization mixture.

In the left image of FIG. 10, a ribbon mixer 1000 includes cylindrical drum 1002 in which the functionalization mixture is mixed by a ribbon agitator 1004, which rotates independently of the drum 1002 to mix the functionalization mixture. The substrate is dispensed into the drum 1002, and the ribbon agitator 1004 rotates to agitate the substrate (e.g., silica particles) in the functionalization mixture.

Examples of the paddle mixer 900 and ribbon mixer 1000 can include heating mechanisms, such as jacketed drums 902 and 1002, or forced gas venting to flow heated gas over the functionalized material after separating the solid substrate from the liquid functionalization mixture. In some examples, the heated gas can be air, or an inert gas (e.g., nitrogen, N₂). If a heat carrier is flown through a jacket of the paddle mixer 900 or ribbon mixer 1000, the heat carrier can be heated oil, steam, or hot water. If the heat carrier is flown inside the vessel (e.g., forced gas venting), an inert gas such as N₂ can be used. However, in examples of forced gas venting air should be avoided to prevent oxidation. In this way, the paddle mixer 900 and ribbon mixer 1000 can be used to both functionalize and dry the silica particles. The mixers 900 and 1000 apply heat to the inner volume of the mixers, which causes excess functionalization mixture absorbed by the functionalized material to evaporate. As the agitators 904 and 1004 are rotated to agitate the functionalized material, the evaporation rate of the absorbed functionalization mixture increases during heating.

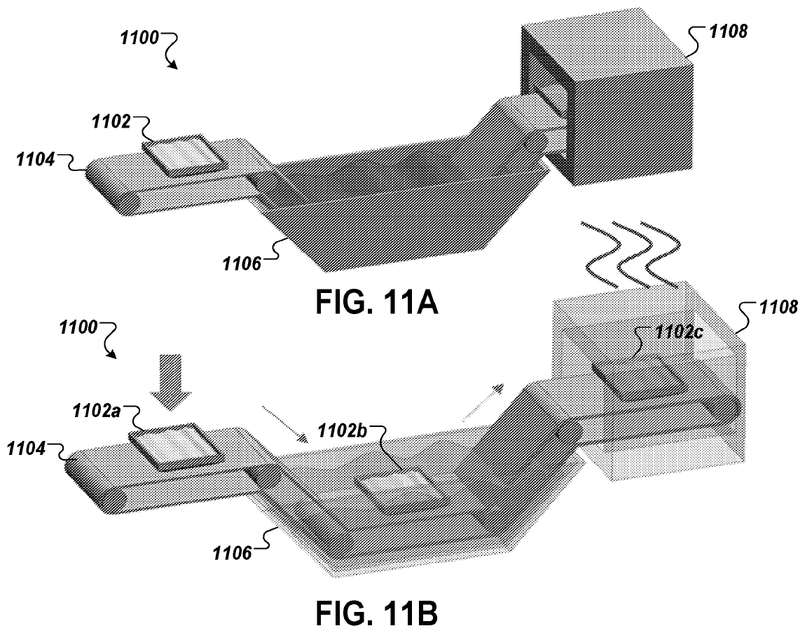

FIGS. 11A-11B illustrate an example dip-coating conveyor system 1100 in which silica particles to be functionalized are placed in a container 1102 and conveyed through the dip-coating process by a conveyor 1104. The container 1102 shown is an open-top vessel, though in other examples a mesh bag containing the substrate is functional with the conveyor system 1100. The container 1102 can be solid or perforated to facilitate rapid and complete absorption of the functionalization mixture by the substrate.

FIG. 11A illustrates the container 1102 arranged on the conveyor 1104. The conveyor is operated by a controller, which causes the container 1102 to enter a dip tank 1106. The dip tank 1106 contains the functionalization mixture including the aminosilanes and/or polyamines to functionalize the substrate (e.g., silica particles). Some examples of the dip tank 1106 include agitation elements, such as mixing or stirring blades, or pumps.

The conveyor 1104 transports the container 1102 into the dip tank 1106. The conveyor 1104 operates continuously, or intermittently, so the container 1102 spends sufficient time within the functionalization mixture to functionalize the substrate. The conveyor 1104 operates to remove the container 1102 from the functionalization mixture.

The conveyor system 1100 includes a dryer 1108 after the dip tank 1106 for removing excess functionalization mixture from the functionalized material (e.g., functionalized silica particles). The dryer 1108 can raise the temperature of the substrate by blowing heated gas, through passive heating elements, or both.

FIG. 11B illustrates the conveyor system 1100 operating in a continuous mode in which multiple containers 1102 are transported by the conveyor 1104 concurrently. FIG. 11B illustrates containers 1102a, 1102b, and 1102c each at different stages of the dip-coating process. In this manner, the conveyor system 1100 can be operated efficiently to dip-coat and dry batches of the silica particles sequentially.

### III. Methods of Using or Testing a Functionalized Material

The functionalized material may be used as a sorbent. Described herein are methods and systems to test such materials.

i. Methods of Using a Functionalized Material

The present disclosure encompasses methods of using a functionalized material to remove atmospheric CO₂ from air by direct air capture. In addition to air, the functionalized material can be used to remove CO₂ from a fluid.

Methods of use can include providing a functionalized material for capturing (e.g., reversibly capturing) CO₂. In general, the functionalized material is a layer of conventional or uniform beads, granules, pellets, fibers, membranes, or powders over which gaseous mixtures including CO₂ are flowed. Gas exiting the layer of functionalized material has a lower concentration of CO₂ than the entering gas.

Capture of CO₂ can be achieved by using a reactor or a sample holder, e.g., such as any described herein. Accordingly, methods of use can include: providing air to a reactor (e.g., any described herein) or a sample holder (e.g., any described herein) comprising a sorbent, wherein the sorbent can include a functionalized material (e.g., any described herein); and exposing the sorbent to conditions to adsorb CO₂ from the air to form CO₂-reduced air. In some embodiments, the sorbent is provided as a fluidized bed.

Methods of use can further include: releasing adsorbed CO₂ under certain conditions to desorb CO₂ from the sorbent to form CO₂-enriched air. Non-limiting conditions can include, e.g., a temperature swing adsorption process, a pressure swing adsorption, a vacuum swing adsorption process, or a combination of any of these.

In some embodiments, the method includes: providing ambient air comprising CO₂ to a reactor (e.g., any described herein) comprising one or more air chambers; blowing the ambient air so that it travels from the one or more air chambers into a reaction chamber; delivering a powdered sorbent material to the reaction chamber through an inlet; creating a fluidized bed of the powdered sorbent material and the air under conditions in which the powdered sorbent material adsorbs the CO₂ from the air to form CO₂-reduced air and used powdered sorbent material; continuously removing used powdered sorbent material from the reaction chamber; and continuously removing CO₂-reduced air from the reaction chamber through one or more exhaust ports.

ii. Sample Holder

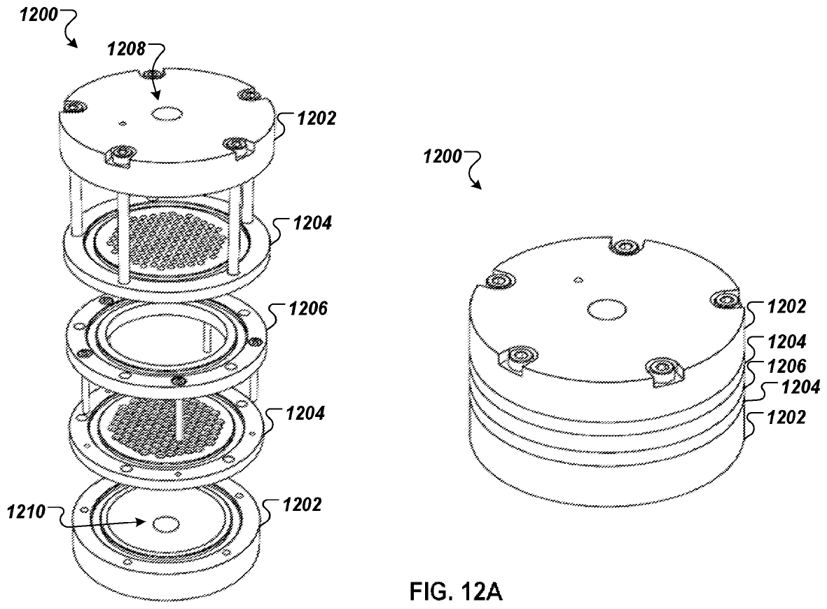

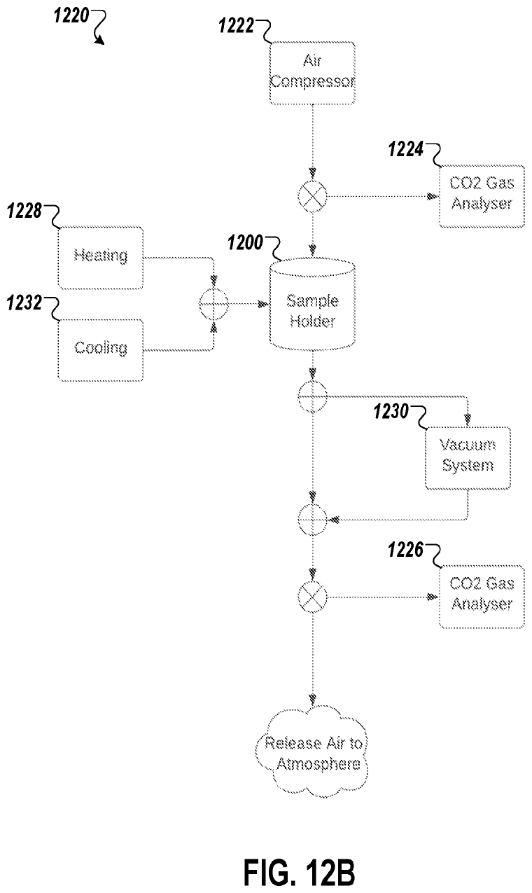

The functionalized material can be provided in a sample holder for testing and/or during use as a sorbent. FIG. 12A schematically illustrates an exploded view (left) and an assembled view (right) of a non-limiting sample holder 1200 for the sorbent. Functionalized material can be placed in a sample space 1206 arranged between two layers of filter 1204 (e.g., such as glass wool) in a sample holder 1200. The sealing ends 1202 of the sample holder 1200 can include an inlet 1208 and an outlet 1210 permissive to gas flow. The sealing ends 1202 can include reversible screw connections to assemble the sample holder 1200. When assembled (right), the sample holder 1200 was otherwise sealed against gaseous inflow.

In FIG. 12B, a schematic diagram of the experimental setup 1220 is shown. Referring now to FIGS. 12A and 12B, a gas source, e.g., air compressor 1222, provided compressed environmental air to the inlet 1208 of the testing sample holder 1200. The air passes through the filters 1204, thereby exposing the functionalized material to the environmental air. Air can be exhausted from the outlet 1210. The concentration of CO₂ in the compressed environmental air can be measured by a gas analyzer, e.g., CO₂ gas analyzers 1224 and 1226, prior to entering the inlet 1208 and subsequent to exiting the outlet 1210.

The samples of functionalized material were treated with an activation process before data collection. Samples were heated in a vacuum drier (e.g., vacuum heater 1228) to 70° C. for 30 minutes under vacuum (e.g., at 0.3 psi) to activate the sorbent, e.g., as the activation process. Alternatively, and as shown in FIG. 12B, the heating element 1228 and the vacuum system 1230 are separate elements of the setup 1220 and work in concert to heat and apply vacuum to the sample holder 1200. In some implementations, a cooling element 1232 is included in the setup 1220 to further control the temperature of the environment in the sample holder 1200. Both the heating element 1228 and the cooling element 1232 are integrated into the sample holder 1200 in the experimental setup 1220 to apply temperature control directly to the sorbent sample. The activation process can facilitate removal, e.g., evaporation, of residual solvent medium in the pores of the functionalized silica and desorbs CO₂ molecules bonded during the synthesis process (e.g., processes 500A-500I) for venting to the atmosphere.

For a non-limiting adsorption procedure, samples of functionalized silica in a range between 0.5 g and 10 g were placed in between two layers of glass fiber filters 1204 in the testing sample holder 1200. Compressed environmental air (e.g., input air) from a gas source 1222 can be continuously fed through the testing sample holder 1200 at a rate in a range from 1 to 10 standard liters per minute (slpm), thereby exposing the activated functionalized material. The activated functionalized material was exposed for time periods in a range from 30 to 60 minutes. The humidity of the input air can be controlled to be in a range between 15% to 50% relative humidity (RH) at 21° C. As the activated functionalized material adsorbs CO₂, the concentration of CO₂ is measured both before the sample holder with CO₂ gas analyzer 1224 and after the sample holder with CO₂ gas analyzer 1226. The same sample holder can then be brought to vacuum by a vacuum system 1230 and heated by a heating element 1228 to extract the carbon dioxide from the sample. The amount of carbon dioxide extracted was also measured by gas analyzer 1226.

The humidity can be controlled through blending of “dry air” and “wet air” with a flow meter (not shown). As an example, to produce input air having 50% RH at a flow rate of 5 slpm, dry air (e.g., <10% RH) at 2.5 slpm and wet air (e.g., >95% RH or 100% RH) can be blended at 2.5 slpm each. The dry air and wet air flow control can be accomplished using a closed loop controller.

The compressed environmental air including CO₂ concentration can be monitored by gas analyzers 1224 and 1226 at the input and output of the testing sample holder 1200 during the experimental time period in units of mol CO₂/kg of sorbent.

### IV. Systems Employing a Functionalized Material

Disclosed herein are systems for employing a functionalized material. In some embodiments, the functionalized material is used as a sorbent in a fluidized bed reactor for use in direct air capture (DAC).

### I. Direct Air Capture Systems

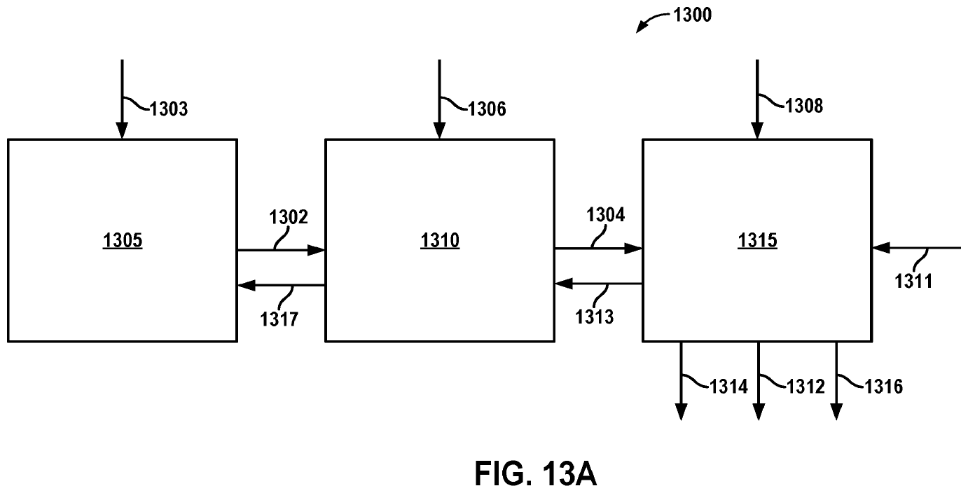

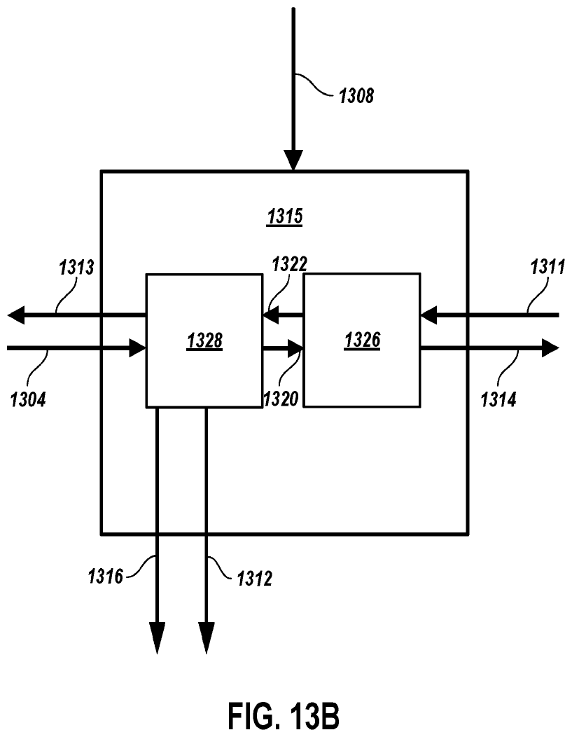

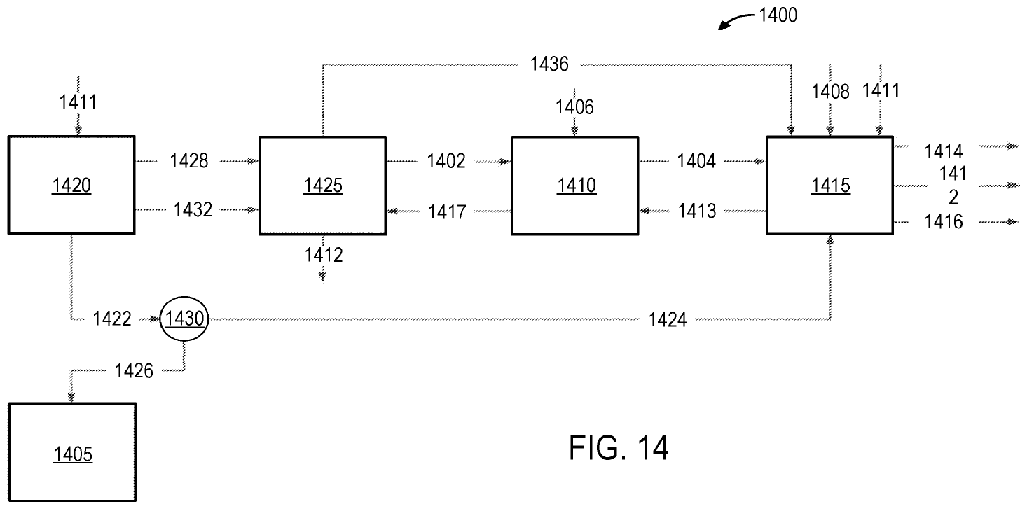

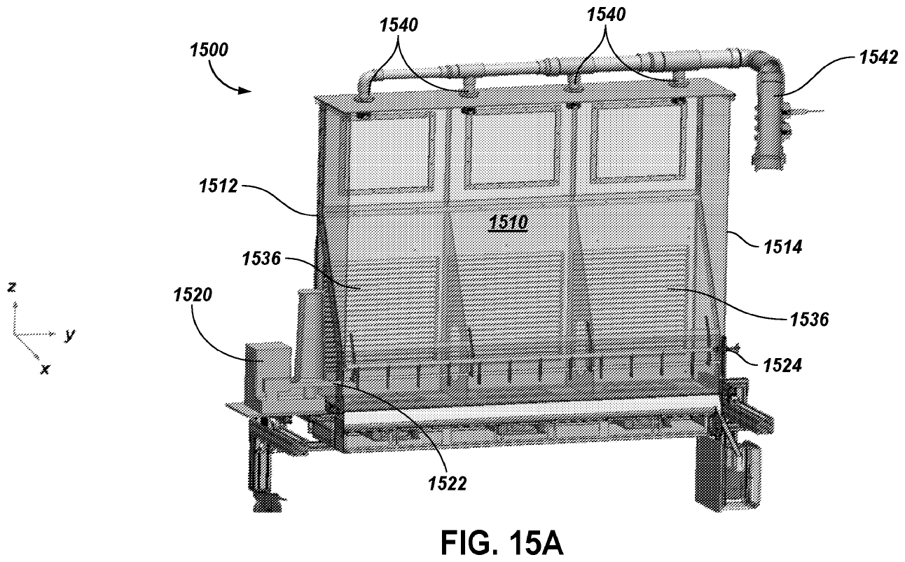

Examples of systems for direct air capture (DAC) of CO₂ using the sorbent of the present disclosure are described with reference to FIGS. 13A-13B and FIG. 14, examples of which are described in U.S. Pat. Pub. No. 2021/0300765 or Int. Pub. No. WO 2021/202499, the disclosure of which are hereby incorporated by reference in their entirety.

FIG. 13A is a schematic illustration of an example implementation of a carbon dioxide extraction system 1300 that uses waste heat to provide energy for a carbon dioxide direct air capture (DAC) system 1315. As illustrated, the carbon dioxide extraction system 1300 includes an industrial process 1305 that generates waste heat 1302. In some implementations, the industrial process utilizes a power input 1303. The waste heat 1302 is supplied, in this example, to a thermal heat-reuse system 1310 that also utilizes a power input 1306.

The thermal heat-reuse system 1310 provides a heated fluid 1304 to a carbon dioxide DAC system 1315. The carbon dioxide DAC system 1315 also receives a power input 1308 and an ambient airflow input 1311. The carbon dioxide DAC system 1315 outputs a carbon dioxide supply stream 1312, a carbon dioxide-reduced airflow output stream 1314, and demineralized water 1316. As will be discussed in greater detail herein, DAC system 1315 includes a adsorber system (e.g., that may optionally comprise a fluidized bed reactor or a silo adsorber) and a desorber system (e.g., that may optionally comprise a gravity fed desorption system).

Generally, the carbon dioxide extraction system 1300 operates to utilize the heated fluid 1304 as thermal energy that is generated from the waste heat 1302 by the thermal heat-reuse system 1310. The thermal energy in the heated fluid 1304 is used by the carbon dioxide DAC system 1315 to separate carbon dioxide captured from the ambient airflow input 1311 and supply the separated carbon dioxide as the carbon dioxide supply stream 1312. The heated fluid 1304 is then returned via heated fluid return 1313 to the thermal heat-reuse system 1310, and the waste heat 1302 is returned to the industrial process 1305 via waste heat return 1317. In some aspects, the carbon dioxide supply stream 1312 can be provided as an injectant into a subterranean formation during hydrocarbon production operations. In some aspects, the injected carbon dioxide may be sequestered in the subterranean formation (with or without assisting in the hydrocarbon production operations).

The industrial process 1305 may be any process that generates, as an output, thermal energy in the form of waste heat, i.e., energy that, unless captured, would otherwise be lost to, e.g., the ambient environment. As an example, the industrial process 1305 may be a computer data center that, generally, houses computer systems and associated components, such as telecommunications and storage systems. In some aspects, a data center includes tens, hundreds, thousands, or even more server devices that generate heat, such as hardware processors, voltage regulators, memory modules, switches, and other devices that operate to provide a particular amount of information technology (IT) power. Such devices, typically, utilize electrical power to operate and output heat during operation. In order for such devices to operate correctly, the output heat must be captured in a cooling fluid flow (e.g., air, water, refrigerant) and expelled from the data center. For instance, air handling system (e.g., fans, cooling coils) may operate to capture the output heat in an airflow circulated over the heat-generating components. The output heat now within the airflow is transferred to a cooling liquid, e.g., within a cooling coil. The heat transferred to the cooling liquid is then typically rejected to the ambient environment as waste heat, such as through evaporative cooling systems, chiller/cooling tower systems, or otherwise. In this example, this waste heat takes the form of waste heat 1302.

The example thermal heat-reuse system 1310 utilizes the waste heat 1302 and power input 1308 to provide the heated fluid 1304. The thermal heat reuse system 1310 comprises a bank of heat pumps and a bank of heat exchangers to provide the heated fluid 1304. By balancing the use of passive and active heating, power can be saved to provide the carbon dioxide DAC system 1315 with the required temperatures of heated fluid 1304. Generally, the thermal heat-reuse system 1310 includes one or more vapor-compression cycles (“heat pumps”) to add thermal energy in the form of heat of compression to the waste heat 1302 and transfer the sum of such energy to a fluid to generate the heated fluid 1304 (e.g., a heated liquid). Generally, each heat pump and heat exchanger within the thermal heat-reuse system 1310 operates to transfer thermal energy from a heat sink to a heat source, i.e., in an opposite direction of spontaneous heat transfer. The one or more heat pumps of the thermal heat-reuse system 1310 use the power input 1306 to accomplish the work of transferring energy from the heat source to the heat sink. Each heat pump in the thermal heat-reuse system 1310 includes the primary components of two heat exchangers (one acting as an evaporator, one acting as a condenser), an expansion device (e.g., valve or fixed orifice), and a compressor (e.g., centrifugal, screw, reciprocating, scroll, or otherwise). Each of these components is fluidly coupled within a closed-loop refrigerant circuit in the heat pump.

As is generally known, in a vapor-compression heat pump cycle, a refrigerant exits a first heat exchanger in which heat from the refrigerant is released to a first medium. The refrigerant then enters a compressor in which it is compressed and a heat of compression is added thereto. The refrigerant then enters a second heat exchanger in which heat from a second medium is added. The refrigerant then enters an expansion device and undergoes an isenthalpic pressure drop. The refrigerant completes the cycle by entering the evaporator to release the heat of compression and the heat from the second medium to the first medium.

Although the present disclosure describes a vapor-compression heat pump cycle as a heat transfer system between a source of waste heat and a carbon dioxide DAC system, other thermodynamic cycles may also be used in place of (or along with) the described vapor-compression heat pump cycle. For example, one or more vapor-adsorption cycles may be used in place of (or along with) the described vapor-compression heat pump cycle. A vapor-adsorption cycle, for example, consists of a cycle of desorption-condensation-expansion-evaporation, followed by adsorption.

The carbon dioxide DAC system 1315, generally, operates to pass the ambient airflow input 1311 (which includes low concentrations of gaseous carbon dioxide) over or through one or more media (e.g., “filters”). In some aspects, one or more fans (not shown) utilize the power input 1308 to circulate the ambient airflow input 1311. The media or filter, in some aspects, includes a solid sorbent to which the atmospheric carbon dioxide in the airflow input 1311 bonds. The sorbent that is saturated with carbon dioxide may be referred to as “rich sorbent.”

In the case of a solid sorbent, such as the sorbent described in the present disclosure, as the airflow input 1311 passes over the solid media or filter, atmospheric carbon dioxide within the airflow input 1311 bonds to the media or filter. When the media or filter is saturated with carbon dioxide, it can be heated (e.g., to 600-620° C. or to 60-100° C.) to release the carbon dioxide for collection (as described herein).

Using thermal energy from the heated fluid 1304, heat is applied to the solid or liquid sorbent, which breaks the bonds between the carbon dioxide and the sorbent. The separated carbon dioxide is provided as the carbon dioxide supply stream 1312 from the carbon dioxide DAC system 1315. The now-“lean sorbent” that is carbon dioxide free (i.e., the solid or liquid) is recycled back to capture more carbon dioxide from the ambient airflow input 1311. The airflow output 1314, typically, contains little to no carbon dioxide.

FIG. 13B shows an example carbon dioxide DAC system 1315. The carbon dioxide DAC system 1315 includes an adsorber system 1326 and a desorber system 1328.

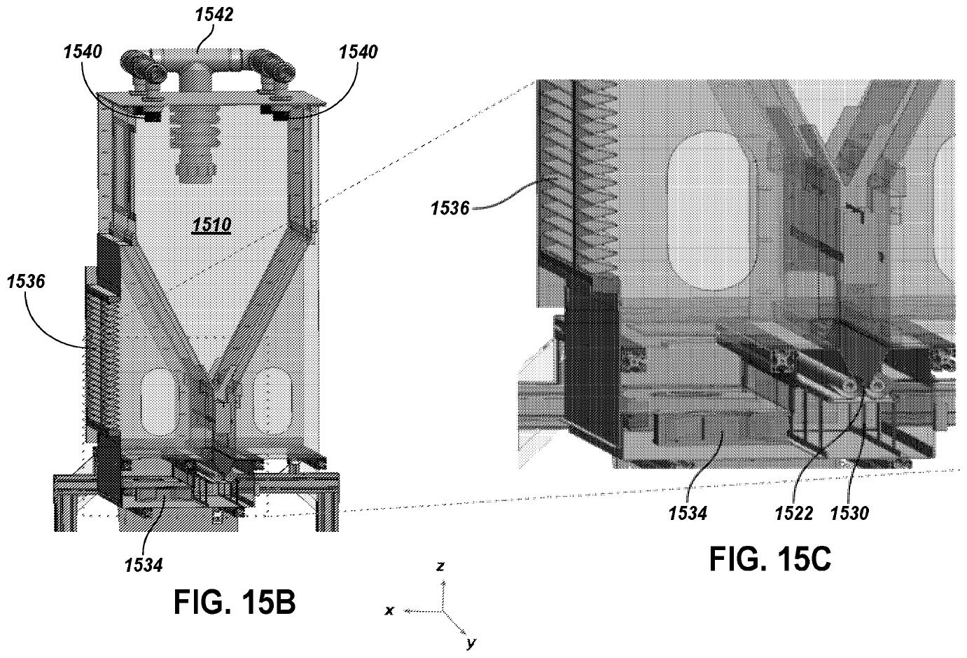

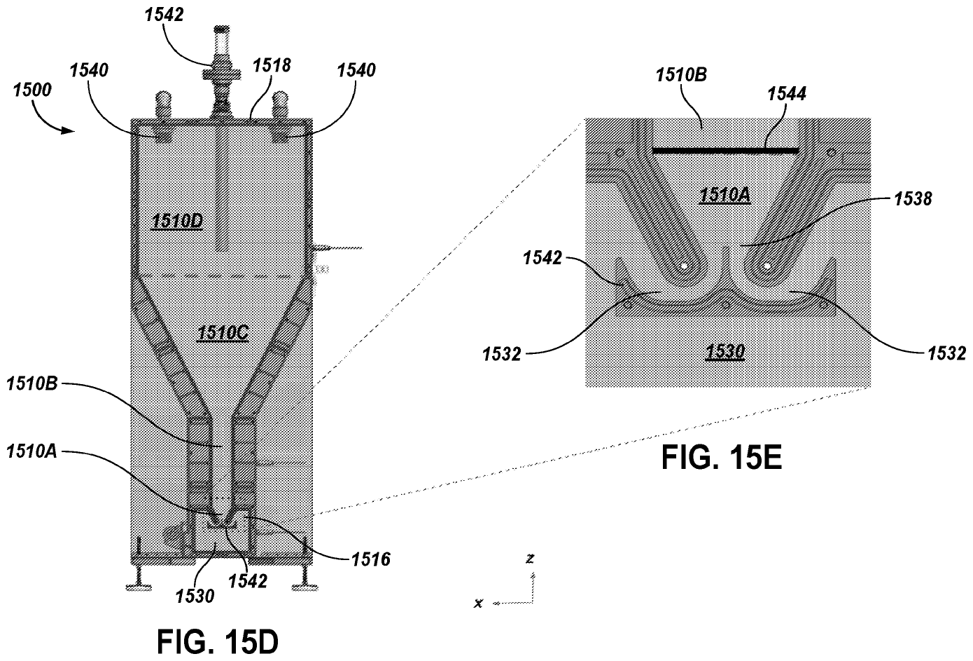

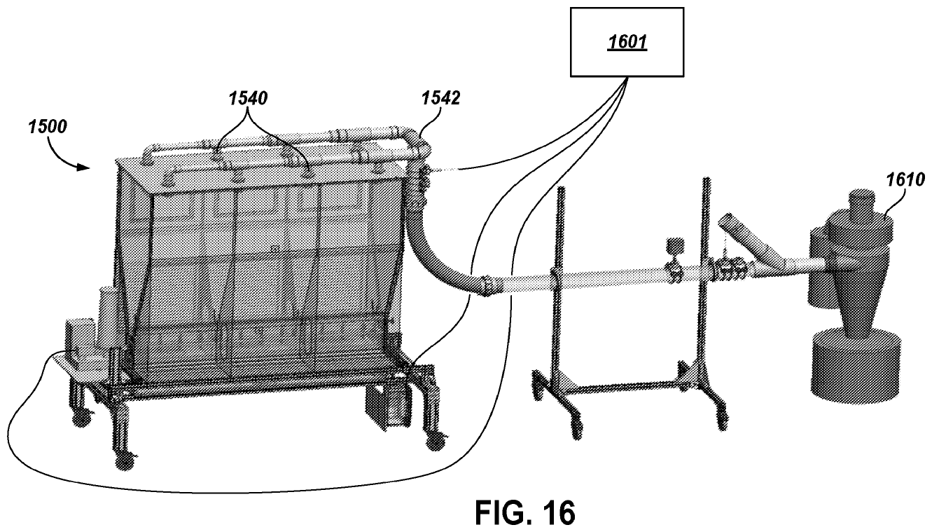

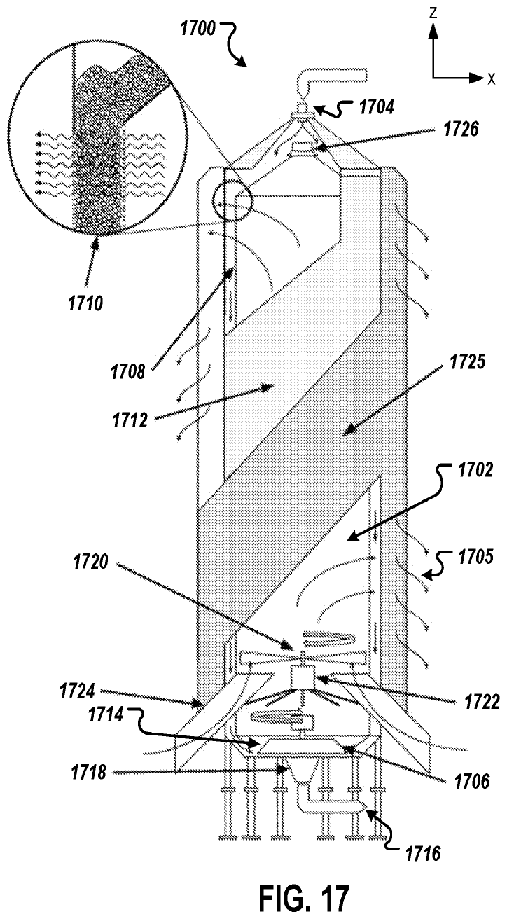

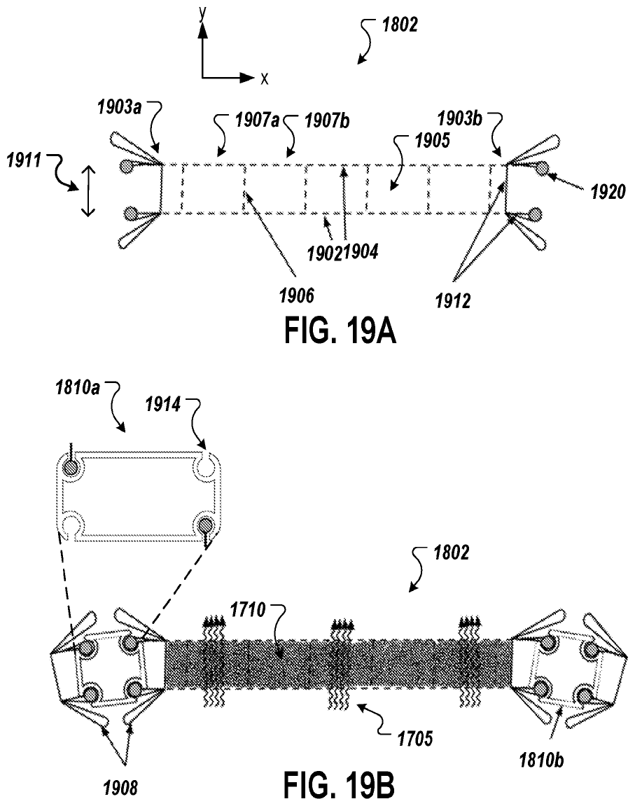

The adsorber system 1326 generally operates to pass the ambient airflow input 1311 (which includes gaseous carbon dioxide) over or through one or more sorbents (e.g., in media or filters) under conditions at which the sorbent adsorbs CO₂ from the air. In some embodiments, the sorbent is provided within a fluidized bed reactor, where air flows through the air inlet 1538 into the reaction chamber 1510 and will diffuse through the distribution plate 1542 to make contact with the sorbent (e.g., reactor 1500 in any of FIG. 15A-15E or FIG. 16). In some embodiments, the adsorber system can include, for example, the adsorber in any of FIG. 17, 18, 19A-19B, 20, 21A-21B, 22A-22B, or 23A-23C. In other embodiments, referring to FIG. 17 and FIG. 19B, air 1705 flows through the filter panels 1802 of the silo adsorber 1700.

The desorber system 1328 generally operates to remove adsorbed carbon dioxide from sorbent material. The desorber system can include, for example, the desorption system of any of FIG. 25, 26, or 27A-27B.

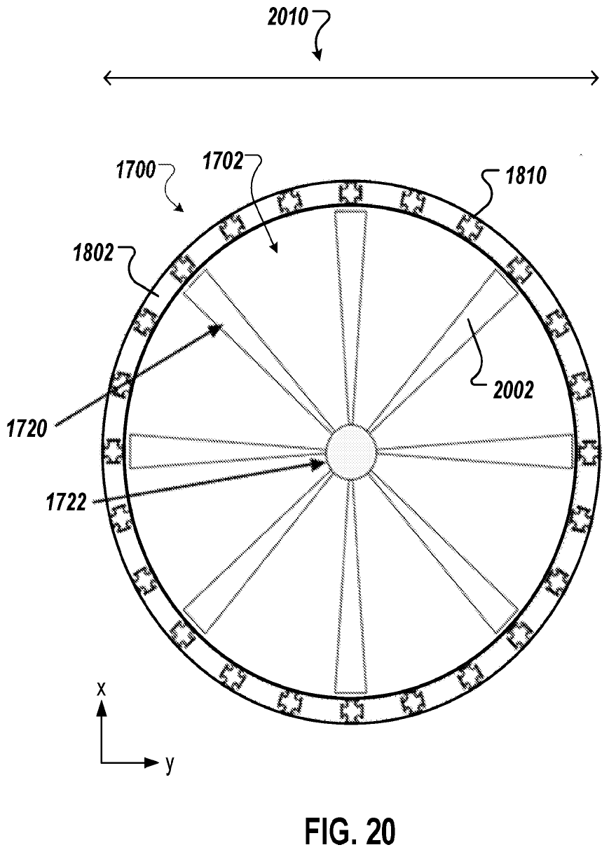

In some aspects, one or more fans (not shown) utilize the power input 1308 to circulate the ambient airflow input 1311. For example, referring to FIG. 17 and FIG. 20, the blower 1720 can use the power input 1308 to circulate airflow input to the chamber 1702 of the silo adsorber 1700.

The media, filter, or sorbent, in some aspects, includes a solid sorbent to which the atmospheric carbon dioxide in the airflow input 1311 bonds. For example, the solid sorbent can be in a pelletized or powdered form. Alternatively, a liquid sorbent may be also passed over the media or filter to which the atmospheric carbon dioxide in the airflow input 1311 bonds. The sorbent that is saturated with carbon dioxide may be referred to as “rich sorbent.” Rich sorbent 1322 exits the adsorber system 1326 and enters the desorber system 1328. Carbon dioxide-reduced air exits the adsorber system 1326 through the airflow output 1314.

As the airflow input 1311 passes over the sorbent (e.g., as a solid media and/or with a filter), atmospheric carbon dioxide within the airflow input 1311 bonds to the sorbent. The airflow output 1314 exits the system as carbon dioxide-reduced air and is released into the atmosphere. The airflow output 1314, typically, contains little to no carbon dioxide. When the sorbent is saturated with carbon dioxide, it can be heated (e.g., to 70-120° C.) to release the carbon dioxide for collection.

In some aspects, a powdered sorbent material can be used. For example, silica-based sorbent powders are possible, e.g., porous silica functionalized with an amine compound. In some cases, metal oxide framework (MOF) powders can also be used. The degree of coarseness (granularity) of the powder can vary depending on the application. In some cases, particles with an average grain size in a range from 50 to 1,700 μm or from 50 to 3,000 μm can be used. In some examples, the sorbent powder is pelletized.

In some aspects, for example, if liquid sorbent is used, such liquid has a high affinity for carbon dioxide and is circulated over a non-reactive metal (or other material) filter. Once saturated with carbon dioxide, the liquid can be heated (e.g., to 800° C.) to release the carbon dioxide (as described herein). The liquid can then be reused to capture more carbon dioxide in a continual cycle.

The desorber system 1328 uses thermal energy from the heated fluid 1304 to apply heat to the solid or liquid rich sorbent 1322. The heat dissolves the bonds between the carbon dioxide and the rich sorbent 1322. The heated fluid return 1313 exits the desorber system 1328 in order to collect more heat from a process outside of the carbon dioxide DAC system. The separated carbon dioxide is provided as the carbon dioxide supply stream 1312 from the carbon dioxide DAC system 1315. The heat also dissolves bonds between water molecules and the rich sorbent 1322, which exits the system as demineralized water output 1316. The sorbent exiting the desorber system 1328 may be referred to as “lean sorbent,” e.g., sorbent that is carbon dioxide free and, optionally, moisture free. Lean sorbent 1320 (e.g., as a solid or liquid) exits the desorber system 1328 and is recycled back to the adsorber system 1326. The lean sorbent 1320, in the filters of the adsorber system 1326, captures more atmospheric carbon dioxide from the ambient airflow input 1311. The demineralized water output 1316, typically, contains little to no carbon dioxide.

FIG. 14 is a schematic illustration of an example implementation of an integrated power and carbon dioxide DAC system (“integrated system”) 1400. As illustrated, the integrated system 1400 includes a natural gas plant 1420 attached to a CCS flue gas carbon dioxide scrubber 1425 that generates waste heat 1402. The waste heat 1402 is supplied, in this example, to a thermal heat-reuse system 1410 that also utilizes a power input 1406. The thermal heat-reuse system 1410 provides a heated fluid 1404 to a carbon dioxide direct air capture (DAC) system 1415.

A natural gas plant 1420 generates flue gas containing carbon dioxide and electrical power 1428 that is sent to the CCS flue gas carbon dioxide scrubber system 1425. The scrubber system 1425 separates out the carbon dioxide from the flue gas. The scrubber system 1425 provides waste heat 1402 to a carbon dioxide direct air capture (DAC) system 1415. The carbon dioxide DAC system 1415 also receives a power input 1408 and an ambient airflow input 1411. The carbon dioxide DAC system 1415 outputs a carbon dioxide supply stream 1412 and a carbon dioxide-reduced airflow output stream 1414.

Generally, the integrated system 1400 operates to capture the waste heat 1402, generate the heated fluid 1404 that has a thermal energy that includes the waste heat 1402, as well as heat of compression from the thermal heat-reuse system 1410, and utilize such thermal energy in the heated fluid 1404 to separate carbon dioxide captured from the ambient airflow input 1411 to supply the separated carbon dioxide as the carbon dioxide supply stream 1412. In some aspects, the carbon dioxide supply stream 1412 can be provided as an injectant into a subterranean formation during hydrocarbon production operations. In some aspects, the injected carbon dioxide may be sequestered in the subterranean formation (with or without assisting in the hydrocarbon production operations).

In this implementation, the industrial process 1405 is powered by the natural gas plant 1420 rather than the electrical power grid since the electrical power 1426 would be considered carbon negative electricity.

The example thermal heat-reuse system 1410 utilizes the waste heat 1402 from the CCS Flue Gas CO₂ Scrubber 1425 and power input 1406 to provide the heated fluid 1404. Generally, the thermal heat-reuse system 1410 includes one or more vapor-compression cycles (“heat pumps”) to add thermal energy in the form of heat of compression to the waste heat 1402 and transfer the sum of such energy to a fluid to generate the heated fluid 1404 (e.g., a heated liquid). Generally, each heat pump within the thermal heat-reuse system 1410 operates to transfer thermal energy from a heat sink to a heat source, i.e., in an opposite direction of spontaneous heat transfer. The one or more heat pumps of the thermal heat-reuse system 1410 use the power input 1406 to accomplish the work of transferring energy from the heat source to the heat sink. Each heat pump in the thermal heat-reuse system 1410 includes the primary components of two heat exchangers (one acting as an evaporator, one acting as a condenser), an expansion device (e.g., valve or fixed orifice), and a compressor (e.g., centrifugal, screw, reciprocating, scroll, or otherwise). Each of these components are fluidly coupled within a closed-loop refrigerant circuit in the heat pump.

The carbon dioxide DAC system 1415, generally, operates to pass the ambient airflow input 1411 (which includes gaseous carbon dioxide) over or through one or more media (e.g., “filters”). In some aspects, one or more fans (not shown) utilize the power input 1408 to circulate the ambient airflow input 1411. The media or filter, in some aspects, includes a solid sorbent to which the atmospheric carbon dioxide in the airflow input 1411 bonds. The sorbent that is saturated with carbon dioxide may be referred to as “rich sorbent.”

In the case of a solid sorbent, such as the sorbent described in the present disclosure, as the airflow input 1411 passes over the solid media or filter, atmospheric carbon dioxide within the input 1411 bonds to the media or filter. When the media or filter is saturated with carbon dioxide, it can be heated (e.g., to 100-120° C., to 60-100° C.) to release the carbon dioxide for collection (as described herein).

Using thermal energy from the heated fluid 1404, heat is applied to the solid sorbent, which breaks the bonds between the carbon dioxide and the sorbent. The separated carbon dioxide is provided as the carbon dioxide output stream 1412 from the carbon dioxide DAC system 1415. The now-“lean sorbent” that is carbon dioxide free (i.e., the solid or liquid) is recycled back to capture more carbon dioxide from the ambient airflow input 1411. The airflow output 1414, typically, contains little to no carbon dioxide. The carbon dioxide DAC system 1415 outputs carbon dioxide 1412 and demineralized water 1416.

As further shown in the example embodiment of FIG. 14, the integrated system 1400 includes a power plant 1420 (e.g., a natural gas power plant 1420) and a scrubbing system 1425 (e.g., a CCS Flue Gas CO₂ scrubbing system 1425). As shown in this example, the power plant 1420 may provide waste heat 1402 (e.g., as generated through the generation of electrical power by the power plant 1420) to the DAC system 1415. In this example, the power plant 1420 also generates electrical power 1422 and 1428. In some aspects, as shown, the electrical power 1422 goes through one or more switches 1430 (shown here as one, but more are possible) to provide electrical power 1424 to the DAC system 1415 and backup electrical power 1426 to the industrial process 1405.

As shown in this example, the power output of the power plant 1420 may be sized to provide a sum of the electrical power 1424 to the DAC system 1415 and the electrical power 1428 to the scrubbing system 1425 for normal operation, as well as the backup electrical power 1426 to the industrial process 1405 when needed (i.e., when the industrial process 1405 loses or cannot use grid electrical power 1417). Thus, in some aspects, when the industrial process 1405 needs the backup electrical power 1426, electrical power 1428 and electrical power 1424 are still provided to their respective users. Alternatively, in some aspects, the power output of the power plant 1420 may be sized to provide a sum of the electrical power 1424 to the DAC system 1415 and the electrical power 1428 to the scrubbing system 1425 for normal operation, as well as the backup electrical power 1426 to the industrial process 1405 when needed (i.e., when the industrial process 1405 loses or cannot use grid electrical power 1417), as well as one or both of power inputs 1406 or 1408.

Alternatively, in some aspects, the power output of the power plant 1420 may be sized only to provide the backup electrical power 1426 to the industrial process 1405 when needed (i.e., when the industrial process 1405 loses or cannot use grid electrical power 1417). Thus, during operational periods when the industrial process 1405 does not need backup electrical power 1426, the electrical power 1428 and/or the electrical power 1424 (as well as other power inputs) may be provided by the power plant 1420. During operational periods when the industrial process 1405 does need backup electrical power 1426, the electrical power 1428 and/or the electrical power 1424 (as well as other power inputs) may not be provided by the power plant 1420. For example, electrical power 1422 may be routed, in such operational periods, through the switch 1430 as backup electrical power 1426.

In some aspects, the electrical power 1426 supplied from the power plant 1420 to the industrial process 1405 may not be “backup” power but instead may be a primary power source for the industrial process 1405. For example, in some aspects, the power plant 1420 may be sized to provide primary electrical power 1426 to the industrial process 1405, as well as, in some aspects, one or more other components shown in the integrated system 1400.

As further shown in FIG. 14, in some aspects, waste heat 1402 that is generated from the scrubber system 1425 may be used by the thermal heat-reuse plant 1410 to provide heated fluid to the DAC system 1415. In some implementations, the heated fluid 1404 is then returned via heated fluid return 1413 to the thermal heat-reuse system 1410 and the waste heat 1402 is returned to the industrial process 1405 via waste heat return 1417.

As shown in this example implementation, the scrubbing system 1425 also receives an exhaust fluid 1432 (e.g., the flue gas with 100% CO₂) from the power plant 1420. For example, in some aspects, the power plant 1420 may be a natural gas power plant in which natural gas is combusted to drive electrical power generation equipment that operates to generate the electrical power shown in FIG. 14. In other aspects, the power plant 1420 may use other carbon-based fuel rather than natural gas. In still other aspects, the power plant 1420 may use non-carbon based fuels to generate electrical power (e.g., geothermal, solar, and other). For a natural gas power plant 1420, although not shown specifically here, such equipment may include, for example, a compressor rotatably coupled to a gas turbine that drives the compressor. The gas turbine receives combustion products fluid from a combustion chamber that receives compressed natural gas from the compressor. The combustion products fluid drives the gas turbine, which in turn is coupled to and drives a generator to produce electrical power.

Output from such a gas turbine (at a lower pressure than the combustion products fluid) is exhaust fluid 1432 (e.g., as a flue gas). A difference in pressure between the combustion products fluid and the exhaust fluid 1432 drives the gas turbine to produce electrical power from the generator. As shown in this example, the exhaust fluid 1432 is separated by the scrubbing system 1425 into multiple output streams. For example, the flue gas with 100% CO₂ 1432 is separated into a carbon dioxide supply stream 1412 and a flue gas stream 1436 with 5% CO₂. The flue gas stream 1436 with 5% CO₂ is sent to the DAC system 1415 to remove the remaining carbon dioxide from the output airflow 1436 of the natural gas plant 1420. This makes the resulting power generated from the natural gas plant carbon negative power. For example, similar to the DAC system 1415, outputs of a carbon dioxide supply stream 1412 and a carbon dioxide-reduced airflow output stream 1414 may be output from the scrubbing system 1425.

In some aspects, the carbon dioxide supply streams 1412 may be sold (e.g., for CO₂-EOR, sequestration, and/or other processes). For example, the carbon dioxide supply streams 1412 may generate revenue through emissions credits and federal tax credits. In some aspects, such revenue may offset capital and/or operations costs of the DAC system 1415, the power plant 1420, both, or other components of the system 1400.

The integrated system 1400 may advantageously utilize the power plant 1420, which may normally be sitting idle, to produce a saleable product in the carbon dioxide fluid streams 1412, which also provide environmental benefits. Additionally, in the event of a power outage at the industrial process 1405, the power plant 1420 would already be running, meaning the delay between the outage and providing the process 1405 with power would be reduced. Further, by using the thermal energy 1402 from the waste heat 1402 from the scrubber 1425, operating costs of the DAC system 1415 may be significantly reduced, allowing for the carbon dioxide captured to finance the construction of the DAC system 1415 as well as help subsidize the cost of the industrial process's backup power. In addition, the integrated system 1400 may produce water from ambient humidity as the DAC system 1415 pulls carbon dioxide from the air. The water can be sold or used, e.g., at the industrial process 1405.

In some embodiments, a DAC system comprises: a fluidized bed adsorption reactor (e.g., any described herein) configured to adsorb CO₂ from ambient air using a sorbent material (e.g., any described herein); a desorption reactor configured to receive the sorbent material from the fluidized bed adsorption reactor and to desorb CO₂ from the sorbent material; and an industrial process facility which produces waste heat that is provided to the desorption reactor to heat the sorbent material.

In some embodiments, a DAC system comprises: a fluidized bed reactor or a silo adsorber (e.g., any described herein) configured to adsorb CO₂ from ambient air using a sorbent material (e.g., any described herein). In some embodiments, the system further comprises a desorption system (e.g., a reactor, a desorber, a gravity fed desorption system, or others described herein) configured to receive the sorbent material from the fluidized bed reactor or the silo adsorber and to desorb CO₂ from the sorbent material.

In some embodiments, a DAC system comprises: a gravity fed desorption system (e.g., any described herein) configured to desorb CO₂— from a sorbent material (e.g., any described herein). In some embodiments, the system further comprises an adsorption system (e.g., a reactor, an adsorber, a silo adsorber, or others described herein) configured to adsorb CO₂ from ambient air using the sorbent material and configured to provide the sorbent material to the gravity fed desorption system.

Embodiments of the subject matter and the operations described in this specification (e.g., for any system herein, such as a DAC system, a fluidized bed reactor, a silo adsorber, a gravity fed desorption system, as well as combinations and subcombinations thereof) can be implemented, in part, by digital electronic circuitry, or in computer software, firmware, or hardware, including the structures disclosed in this specification and their structural equivalents, or in combinations of one or more of them, in additional to the structures described herein.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing.

The separation of various system modules and components in the embodiments described herein (e.g., for any system herein) should not be understood as requiring such separation in all embodiments, and it should be understood that the described program components and systems can generally be integrated together in a single software product or packaged into multiple software products. In certain circumstances, multitasking and parallel processing may be advantageous.

ii. Fluidized Bed Reactors

Fluidized bed reactors are a type of chemical reactor in which a solid particle reagent behaves like a fluid. Such reactors typically involve pumping a fluid, e.g., a gas, through a bed of solid particles. At high enough fluid velocities, this causes the solid material, which rests at the bottom of the reactor when not in operation, to become suspended. This makes the reactor a fluidized bed, in contrast to a packed bed where the solid material is not entrained in the fluid. Fluidized beds may be operated in a continuous state, making them appropriate for applications with effectively infinite input fluid. They tend to be larger than packed bed reactors to accommodate the volume increase in the solid material when it attains fluidization. Due to the large fluid velocity in this type of reactor, the solid material tends to get entrained in the fluid. Often, the captured solid material exits the reactor with a portion of the fluid to later be separated.

The present disclosure also relates to a reactor for adsorption of atmospheric carbon dioxide (CO₂) for direct air capture (DAC) of CO₂, as well as uses for the system and its byproducts. The reactor is a fluidized bed adsorber, where the design and operating conditions facilitate the adsorption of CO₂ at atmospheric concentrations, e.g., about 350 to 550 ppm. The reaction chamber includes one or more hollow compartments through which a powdered sorbent material flows. A cross-section perpendicular to the direction of flow of each hollow compartment reveals a broad top, which tapers to a narrow base. Each hollow compartment is in fluidic communication with a corresponding air chamber via a channel at the base of the corresponding hollow compartment. A distribution plate sits beneath each narrow base of each hollow compartment, with a fan located proximate to each distribution plate. Additionally, louvers extend along the first direction from one end of the chamber to the opposite end, forming part of the side walls of the chamber. The louvers draw ambient air into an air chamber located next to the narrow base.

Among other advantages, the reactors described herein can effectively remove CO₂ from ambient air with relatively low concentrations, e.g., 400 ppm or from 350 to 550 ppm, atmospheric concentrations. The scale of the reactor can accommodate huge air flow rates, which is appropriate for the problem of decreasing the atmospheric levels of CO₂. As a result of the reactor's efficiency, the ratio of volume of air in the reactor to mass of the powdered sorbent material can be relatively high, e.g., about 50 L/g, compared to other fluidized bed reactors. Additionally, in certain embodiments the powdered sorbent material can be recycled back into the reaction chamber after it has undergone the adsorption and desorption process. Both of these factors can reduce the initial investment and maintenance costs associated with running the reactor.

The reactor can reach high levels of energy efficiency due to its design. The shape of the reactor being larger on top and narrower below encourages the circulation of the air (e.g., vertical circulation in the cross section of the reactor) and powdered sorbent material, diminishing the need for a large pressure differential between the top and bottom of the reactor to keep the powder entrained. The design of the distribution plate can also increase levels of circulation, while requiring relatively little input electrical energy. Further, in some embodiments the adsorption reaction can proceed with little to no input heating to facilitate the reaction.

As noted above, adsorber system 1316 can include a fluidized bed reactor for reacting air with lean sorbent. Referring to FIGS. 15A-15D, an example fluidized bed reactor suitable for DAC system 1315 includes a reaction chamber 1510 that extends in a direction of sorbent flow between two chamber walls 1512 and 1514. With reference to the Cartesian coordinate system provided in these figures for reference, this direction is the y-direction. The reaction chamber 1510 is composed of a hollow compartment that extends between chamber walls 1512 and 1514 and has a substantially uniform cross-section along its length. Vertically, i.e., in the z-direction, reaction chamber 1510 extends from a base portion 1516 to a ceiling 1518. The chamber's width (i.e., dimension in the x-direction) is narrowest at the base portion 1516 and broadens out to up to the ceiling 1518.

Chamber wall 1512 includes a sorbent inlet 1522 providing access for delivery of the powdered or pelletized sorbent material into the reaction chamber 1510. A sorbent dispenser 1520 is connected to the sorbent inlet 1522 and delivers the sorbent material to the chamber 1510 via sorbent inlet 1522. At the opposite wall 1514, a sorbent outlet port 1524 provides an egress for removal of the sorbent material from the reaction chamber 1510.

Reactor 1500 also includes multiple air chambers 1530 that are each in fluid communication with the hollow compartment of the reaction chamber 1510 via a channel 1532 at the base portion 1516 of the reaction chamber 1510. Multiple blowers 1534, each associated with a corresponding one of the chambers 1530, are arranged to receive ambient air and blow air at pressure into the corresponding air chamber 1530 during operation of the reactor while compartment 1510 is partially filled with sorbent.

The outer side walls of reactor 1500 include inlets that allow the passage of ambient air from the environment into the reactor 1500. The air is drawn in through louvers 1536 by a low pressure generated by blowers 1534 which force the air into chambers 1530.

Reactor 1500 includes multiple exhaust ports 1540 in the ceiling 1518. The exhaust ports 1540 are provided for removal of air from the reaction chamber 1510 after the air is mixed with the sorbent during operation of the reactor 1510. The exhaust ports 1540 are connected to an exhaust manifold 1542, which provides a conduit to remove the air from the reaction chamber. The exhaust manifold 1542 is designed with gradually increasing pipe sizes to normalize the flow of air across the vertical length of the reactor.

Referring specifically to FIGS. 15D-15E, which shows reactor 1500 in cross section in the x-z plane, reaction chamber 1510 has a varying width (in the x-direction) through its depth. Specifically, the reaction chamber has a first tapered portion 1510A at base portion 1516 where the width of the reaction chamber increases from a minimum width at an air inlet 1538 where the chamber receives air from chamber 1530 to a first constant width portion 1510B. Portion 1510B extends a height in the z-direction providing a trench of constant width in the reaction chamber. The main volume of the reaction chamber 1510 is composed of a second tapered portion 1510C and a top compartment 1510D which is the widest section of the reaction chamber. The dimensions of the reaction chamber, including the width and depth of each portion (1510A-1510D) and the angles at which portions 1510A and 1510C are tapered are selected based on, among other parameters, the air pressure at air inlet 1538 and the nature of the sorbent powder so that the air pressure in the reaction chamber is sufficient to fluidize the powder and facilitate the reaction between the air and the sorbent. Air pressure will be highest at air inlet 1538 and will drop as the width of the reaction chamber increases.

It is believed that the difference in pressure facilitates fluidization of the powdered sorbent and encourages the powdered sorbent and ambient air to circulate. The pressure drop from the bottom to top of the reaction chamber 1510 can be managed (e.g., by the shape of the chamber, air pressure, and nature of the sorbent), so that the sorbent sits below in a fluidized bed away from the air exhaust ports 1540 to reduce inadvertently purging sorbent from the chamber via air exhaust ports 1540.

A distribution plate 1542 is located directly below the air inlet 1538 from chamber 1530 into the reaction chamber 1510. The distribution plate 1542 resides above chamber 1530 which acts as an air plenum proximate to a corresponding blower. The distribution plate 1542 forms two distribution channels 1532 which control flow of air from chamber 1530 into the reaction chamber 1510. The distribution plate also serves as a stop preventing sorbent powder from leaking from the reaction chamber 1510 into the air chamber 1530 and damaging the blowers 1534.

Distribution plate 1542 has a W-shaped in cross-section, being formed by a curved, metal sheet with a central ridge extending into inlet 1538 and splitting the inlet into two channels which draw air from opposite sides of the chamber 1530.

It is believed that the W-shape allows for a smaller pressure drop between the top and bottom of the reaction chamber while achieving a comparable amount of powder circulation. It is further believed that smaller pressure drops can slow down the powdered sorbent material and ambient air flow rate, which can increase the level of entrainment, thereby facilitating the adsorption reaction.

In general, the shape of the distribution plate can impact the degree of circulation of the mixture of the powdered sorbent material and ambient air, as well as the efficiency of the adsorption reaction. Accordingly, other shapes for the distribution plate are possible. For example, a flat plate can be used. In some cases, an inverted V-shaped plate is used, e.g., where the apex of the V sits in the center of the air inlet 1538.

In some non-limiting implementations, a W-shaped distribution plate alone may provide sufficient mixing between air and sorbent. For example, as the blowers 1534 blow air through the air chambers 1530, the air finds the path of least resistance and channels through it. In some implementations, the path of least resistance determined by the W-shaped distribution plate causes limited contact between air and adsorbent. Accordingly, a secondary distribution plate 1544, located between reaction chamber 1510A and 1510B, can complement a primary distribution plate (e.g., a W-shaped distribution plate). For example, in FIG. 15E, a secondary distribution plate 1544 divides reaction chambers 1510A and 1510B from each other. When the secondary distribution plate 1544 is present, from the cross-sectional view in FIG. 15E, the distribution plate 1544 appears as a flat rectangle. The distribution plate 1544 can have any useful dimension, e.g., 80 mm wide by 1800 mm long. Depending on the cross-sectional dimension of the reaction chambers 1510A and 1510B, the secondary distribution plate can be appropriately sized to be placed therebetween. In some non-limiting embodiments, a primary distribution plate can be used alone or in combination with a secondary distribution plate. In other non-embodiments, a secondary distribution plate can be used alone or in combination with a primary distribution plate.

The secondary distribution plate can include a plate (e.g., a perforated stainless steel sheet metal plate), or a mesh (e.g., a mesh stainless steel wire cloth), or some combination of the two where the mesh is on top of the plate. In some implementations, the perforated plate has staggered holes (e.g., 0.065 inch in diameter or smaller), and the mesh has openings (e.g., micron-sized openings, such as 700 micron in size or lower). When the perforated plate is 30% open and the mesh is 70% open, the parameters of the perforated plate can determine the air pressure drop between the top and bottom of the reactor. In some implementations, the mesh acts to prevent the adsorber powder from leaking into the air inlet 1538 and the air chambers 1530. The secondary distribution plate 1544 can be used to create a pressure zone in the air chambers 1530 which promotes even air flow across the length of the reactor. In some embodiments, the combination of the primary and secondary distribution plates can allow for even mixing between the sorbent and air.

Generally, the length of the reaction chamber and its cross-sectional shape are designed to move the sorbent through and out of the chamber as quickly as possible while exposing the sorbent to a sufficient amount of air so that the sorbent is fully or close to fully saturated with CO₂ when it exits the reaction chamber 1510 through the sorbent outlet port 1524.

The various dimensions of components of the reactor and other elements in the DAC system should allow the system to meet the objective of removing CO₂ from the atmosphere. In some examples, the reaction chamber has a length (y-dimension) in a range from 3 meters to 20 meters and a height (z-dimension) in a range from 1 meter to 4 meters. The maximum width (i.e., x-dimension in portion 1510D) can be in a range from 50 cm to 2 meters and the minimum width (i.e., x-dimension at air inlet 1538) can be in a range from 1 cm to 20 cm.

Creating an efficient DAC system directed towards ambient air can be challenging due to the relatively low concentration of CO₂ in ambient air compared to flue gas, for example. One approach is to provide high air flow rates which can lead to using a larger reaction chamber relative to the amount of sorbent than is typical of such reactor design. The size of the reaction chamber and air chambers should consequently be large enough to accommodate the large air flow rates necessary to efficiently adsorb CO₂ within gas sources with relatively low concentrations, e.g., about 400 ppm or from about 350 to 550 ppm.

In addition to providing sufficient pressure to fluidize the powdered sorbent, the airflow rate through the reaction chamber 1510 should be appropriate so that the powdered sorbent material is used efficiently. For example, if the powdered sorbent material travels through the reaction chamber too quickly, the powdered sorbent material may exit the chamber before being close to or fully saturated with CO₂. If the sorbent flow rate is too low and/or the reaction chamber is too long, however, the powdered sorbent material may be fully saturated well before exiting the reaction chamber and remain in the reaction chamber when it is no longer participating in the adsorption reaction, which uses unnecessary energy. In both instances, the efficiency of the adsorption reactor is less than ideal. In some embodiments, the powdered sorbent material travels the length of the reactor by about the time it is fully saturated with CO₂.

Generally, depending on the sorbent, the ratio of the volume of air to mass of powdered sorbent material can be 10 liters/gram or more (e.g., 20 liters/gram or more, 30 liters/gram or more, 40 liters/gram or more, 50 liters/gram or more, 60 liters/gram or more, 80 liters/gram or more, 100 liters/gram or more, such as 200 liters/gram or less).

Referring to FIG. 16, in general, a system 1600 utilizing fluidized bed reactor 1500 includes an electronic control module 1601 to monitor and control various functions of the reactor. For instance, electronic control module 1601 (e.g., by way of a controller) can be in communication with one or more sensors measuring various operating conditions of the reactor, including, by way of example, a flow rate of sorbent powder entering the reaction chamber, a flow rate of sorbent powder exiting the reaction chamber, air pressure at one or more points in the reactor, air pressure exhausted from the reactor. Electronic control module 1601 can regulate the flow of sorbent powder through the reactor, e.g., by controlling input and/or output flow rates, and/or can regulate air pressure through the reactor, e.g., by controlling the force of the blowers 1534.

In some examples, system 1600 can include one or more sensors monitoring environmental conditions such as temperature, air pressure, humidity, and/or the chemical composition of ambient air surrounding the reactor, which can all affect the efficiency of CO₂ uptake by the powdered sorbent material. Control module 1601 can regulate operation of the reactor in response to changes to one or more of such monitored environmental parameters.

Furthermore, as shown in FIG. 16, the air exhaust ports 1540 on top of the reactor 1500 feed air exhausted from the reaction chamber 1510 to a cyclone separator 1610 via ducts that include exhaust manifold 1542. Cyclone separator 1610 removes any entrained sorbent (e.g., less than 25 microns) from the air exhausted from reaction chamber 1510. Alternatively, or additionally, other devices suitable for filtering sorbent powder from exhaust air may be used to ensure the exhausted air is substantially free of the powder before being exhausted to the ambient atmosphere.

Although FIGS. 15A-15E show a specific example of a fluidized bed reactor 1500, the disclosure is not so limited and a variety of variants are possible. For example, while the dispenser 1520 is attached to the bottom of the reaction chamber 1510, it may be attached at any height along the exterior of the reactor. Furthermore, in some implementations, the powdered sorbent material may be delivered through a different conveyance system. For example, in certain examples, the dispenser can be a feed that delivers recycled sorbent from the system's desorber. Generally, any suitable powder conveying mechanisms can be used to deliver the sorbent to the reaction chamber. For example, the dispenser 1520 can be attached to the reactor 1500 with twin worm gears.

iii. Silo Adsorber for Carbon Capture

The present disclosure also relates to a gravity-fed system for adsorption of atmospheric carbon dioxide (CO₂). An example system includes a silo or tower structure. The system includes a chamber bordered by one or more panels. Each panel extends in a vertical plane and is suspended between a pair of vertical beams. Each panel includes a porous inner sheet, a porous outer sheet, and a cavity between the inner sheet and the outer sheet. Each cavity extends from the top of the panel to the bottom of the panel. During operation, sorbent material flows downward through the cavities of the panels, adsorbing carbon dioxide from air flowing through the panels.

The beams can be, for example, aluminum beams that support the structure. The beams can include attachment mechanisms, such as keder rails, for attaching to side edges of the inner sheet and the outer sheet. The inner sheet and the outer sheet can each include attachment components, such as keder ends, configured to fit into the attachment mechanisms of the beams.

The inner sheet and the outer sheet can each be formed from a porous, or permeable, fabric material. In some examples, the cavity between the inner sheet and the outer sheet is divided into multiple channels. Each channel can extend vertically from the top of the panel to the bottom of the panel. The channels can be separated by fabric ribs connecting the inner sheet and the outer sheet at horizontal intervals between the side edges of the panel. In some examples, each channel has an approximately square cross section in a horizontal plane.

An inlet provides access for delivery of a sorbent material to the cavities at the tops of the panels. An outlet provides an egress for removal of the sorbent material from the bottom of the cavities of the panels. The sorbent material can have a powdered or pelletized form. In some examples, the sorbent material includes silica-based pellets.

During operation, sorbent material enters the cavities through the inlet at the top of the panels. The sorbent material passes through the cavities in a downward direction due to gravity. The sorbent material exits the cavity at the bottom end of the panel, passing through an outlet to an egress channel. In some examples, a meter is positioned at the outlet to control a rate of flow of the sorbent material to the egress channel. In an example embodiment, a time duration between a pellet entering the top of a cavity and exiting the bottom of the cavity is approximately one hour.

One or more blowers are arranged to direct air into the chamber. In some examples, a blower is positioned at or near the bottom of the chamber, and the blower directs air in an axial direction, e.g., vertically upward into the chamber. In some examples, a blower is positioned near the vertical center of the chamber, or near the top of the chamber. In some examples, the one or more blowers direct air horizontally towards one or more of the panels. During operation, the one or more blowers cause the air to pass through the panels. The sorbent material within the cavities of the panels performs a filtering function, capturing, or removing, carbon dioxide from the air. The sorbent material can later undergo a desorption process to remove the carbon dioxide from the sorbent material. The sorbent material can then be transported back to the top of the chamber and reused.

In general, innovative aspects of the subject matter described herein can be embodied in a structure including: a chamber bordered by a plurality of panels, each panel being suspended between a pair of beams extending in a first direction from a base of the structure, a height of each panel extending in the first direction from a bottom of the panel to a top of the panel, each panel including: a porous inner sheet; a porous outer sheet; and a cavity between the inner sheet and the outer sheet, the cavity extending from the top of the panel to the bottom of the panel; an inlet providing access for delivery of a sorbent material to the cavities at the tops of the plurality of panels; an outlet providing an egress for removal of the sorbent material from the bottom of the cavities of the plurality of panels; and a blower arranged to direct a fluid into the chamber.

These and other embodiments can include the following features, alone or in any combination. In some implementations, the sorbent material in the cavities of the panels forms a vertical falling moving bed adsorber.

In some implementations, the cavity between the inner sheet and the outer sheet is divided into multiple channels separated by fabric ribs connecting the inner sheet and the outer sheet at intervals between side edges of the panel.

In some implementations, each channel of the multiple channels has a substantially square cross section in a plane perpendicular to the first direction.

In some implementations, the cavity has a thickness between the inner sheet and the outer sheet, the thickness being twenty centimeters or less.

In some implementations, the chamber has a substantially cylindrical shape, with a cylindrical axis extending in the first direction. In some implementations, the chamber has a substantially rectangular prismic shape having four walls. In some implementations, at least one wall of the four walls includes a panel of the plurality of panels.

In some implementations, the structure includes a metering device configured to control a flow of sorbent material from the cavities to the outlet.

In some implementations, the inner sheet and the outer sheet include a fabric material.

In some implementations, the sorbent material has a pelletized form. In some implementations, the sorbent material is configured to adsorb carbon dioxide from the fluid.

In some implementations, the blower is positioned in the chamber. In some implementations, the blower is positioned in a lower third portion of the chamber in the first direction, the lower third portion being the portion that is nearest to the base of the structure.

In some implementations, the blower is positioned in a center third portion of the chamber in the first direction. In some implementations, the blower is configured to direct the fluid in the first direction.

In some implementations, the fluid includes a gas. In some implementations, the fluid includes air.

In general, innovative aspects of the subject matter described in this specification can be embodied in a method including: feeding sorbent material at an inlet of a structure, the structure including a chamber bordered by a plurality of panels, each panel being suspended between a pair of beams each panel including: a porous inner sheet; a porous outer sheet; and a cavity between the inner sheet and the outer sheet, the cavity extending from a top of the panel to a bottom of the panel. The inlet provides access for delivery of the sorbent material to the cavities at the tops of the plurality of panels. The method includes extracting sorbent material from an outlet of the structure. The outlet provides an egress for removal of the sorbent material from the bottom of the cavities of the plurality of panels. Extracting sorbent material from the outlet causes sorbent material in the cavities to fall due to gravity. The method includes directing a fluid through the plurality of panels in a direction from the inner sheet towards the outer sheet.

These and other embodiments can include the following features, alone or in any combination. In some implementations, the method includes controlling a rate of extracting the sorbent material from the outlet to control a volumetric flow rate of the sorbent material through the cavities due to gravity.

In some implementations, the method includes controlling a rate of feeding the sorbent material at the inlet of the structure based on the rate of extracting the sorbent material from the outlet.

In some implementations, the method includes controlling the rate of extracting the sorbent material from the outlet to control an exposure time of the sorbent material to the fluid.

In some implementations, the method includes controlling the exposure time of the sorbent material to the fluid to be thirty minutes or more. In some implementations, the method includes controlling the exposure time of the sorbent material to the fluid to be ninety minutes or less.

In general, innovative aspects of the subject matter described in this specification can be embodied in a structure including: a first beam extending in a first direction from a base of the structure toward a top of the structure; a second beam spaced apart from the first beam and extending parallel to the first beam; a panel coupled at a first edge to the first beam and at a second edge to the second beam, a width of the panel extending from the first edge to the second edge in a direction orthogonal to the first direction; a height of the panel extending in the first direction from a bottom of the panel to a top of the panel, the panel including: a porous inner sheet; a porous outer sheet; and a cavity between the inner sheet and the outer sheet, the cavity extending from the top of the panel to the bottom of the panel; an inlet providing access for delivery of a sorbent material to the cavity at the top of the panel; an outlet providing an egress for removal of the sorbent material from the bottom of the cavity; and a blower arranged to direct fluid through the panel in a direction from the inner sheet towards the outer sheet.

FIG. 17 is a cross-sectional view of an example silo adsorber 1700. The silo adsorber 1700 includes a chamber 1702 bordered by panels. The chamber 1702 has an approximately cylindrical shape. A cylindrical axis of the chamber 1702 extends in the vertical direction with respect to the direction of gravity, e.g., the z-direction.

Each panel includes a porous inner sheet, a porous outer sheet, and a cavity between the inner sheet and the outer sheet. The cavity extends from the top of the panel to the bottom of the panel in a vertical direction, e.g., the z-direction. The inner sheets of the panels form an inner screen 1708. The outer sheets of the panels form an outer screen 1712.

A sorbent inlet 1704 provides access for delivery of a sorbent material 1710 to the cavities at the tops of the panels. A sorbent outlet 1714 provides an egress for removal of the sorbent material 1710 from the bottom of the cavities of the panels. The sorbent material 1710 can have a powdered or pelletized form. In some examples, the sorbent material 1710 includes silica-based pellets. In some embodiments, the sorbent material 1710 includes a functionalized material (e.g., any described herein).

During operation, sorbent material 1710 enters the cavities through the inlet 1704. The sorbent material 1710 passes over the top 1726 of the chamber 1702 and into the cavities. The sorbent material 1710 flows through the cavities in a downward direction due to gravity. In some examples, sorbent material flow through the cavities is assisted, e.g., by a vibration device configured to vibrate the panels, or by compressed air pneumatically conveying sorbent material 1710 through the cavities.

In some examples, the sorbent material 1710 within the cavities of the panels forms a gravity-fed packed bed. The sorbent material in the cavities of the panel can thus form a vertical falling moving bed absorber. In some examples, sorbent material 1710 is introduced to the cavities at a rate such that the cavities remain full or nearly full of sorbent material 1710. For example, the sorbent material can occupy the full height of the cavities.

The sorbent material 1710 within the cavities of the panels form a filter. A fluid, such as air 1705, can flow through the filters, e.g., in a radial direction from the inner screen 1708 towards the outer screen 1712. A weather shield 1725 protects the filters from weather elements such as rain. As the fluid flows through the filters, the sorbent material 1710 removes carbon dioxide from the fluid by adsorbing carbon dioxide from the fluid.

The chamber 1702 is a hollow space for air flow. One or more blowers, e.g., fans, can be arranged to direct air into the chamber 1702. In the example of FIG. 17, a blower 1720 is positioned at or near the bottom of the chamber 1702, and the blower directs air in an axial direction, e.g., vertically upward into the chamber. For example, the blower 1720 can be positioned in the lower third of the chamber as measured in the z-direction. In some examples, the blower 1720 can be positioned in a center third of the chamber as measured in the z-direction. In some examples, the blower 1720 can be positioned in a top third of the chamber. The blower 1720 includes a motor 1722 to drive rotation of the blower 1720. One or more blower inlets 1724 guide air to the blower.

During operation, the blower 1720 pushes air into the chamber 1702 and forces the air to pass through the panels of the silo adsorber. The sorbent material 1710 within the cavities of the panels performs a filtering function, removing carbon dioxide from the air.

In some examples, sorbent material 1710 is provided to the inlet 1704 continuously or near continuously. For example, a conveying system may provide a consistent feed of sorbent material 1710 to the inlet 1704. In some examples, the sorbent material 1710 is provided to the sorbent inlet 1704 in batches. In some examples, the sorbent material 1710 is provided to the inlet 1704 at a volumetric flow rate that approximately matches the rate of egress of the sorbent material 110 through the sorbent outlet 1714.

The sorbent material 1710 exits the cavity at the bottom end of the panel, passing through the outlet 1714 to an egress channel 1716. In some examples, a meter 1706 is positioned at the outlet 1714 to control a rate of flow of the sorbent material to the egress channel 1716. In some examples, a loader 1718 collects sorbent material exiting the cavities, and funnels the sorbent material to the outlet 1714.

In an example embodiment, a time duration between a pellet, a granule, or sorbent material 1710 entering the top of a cavity and exiting the bottom of the cavity is approximately one hour (e.g., two hours or less, ninety minutes or less, thirty minutes or more). The meter 1706 can control the rate of egress of the sorbent material 1710 to control the volumetric flow rate of the sorbent material through the cavities, and to control the exposure time of the sorbent material to air.

In some examples, sorbent material 1710 exits through the outlet 1714 continuously or near-continuously. In some examples, sorbent material 1710 exits through the outlet in batches. For example, the meter 1706 can permit an amount of sorbent material 1710 to flow to the loader 1718 before stopping flow of sorbent material 1710 to the loader 1718, e.g., by shutting a valve, such that a first batch of sorbent material is collected in the loader 1718. The first batch of sorbent material 1710 in the loader 1718 can then egress through the outlet 1714. The meter 1706 can then permit another amount of sorbent material 1710 to flow to the loader 1718, such that a second batch of sorbent material is collected in the loader 1718.

In some examples, after exiting through the outlet 1714, the sorbent material 1710 later undergoes a desorption process to remove the carbon dioxide from the sorbent material. The sorbent material 1710 can then be transported, e.g., conveyed, back to the top of the chamber 1702 and provided into the chamber 1702 through the inlet 1704.

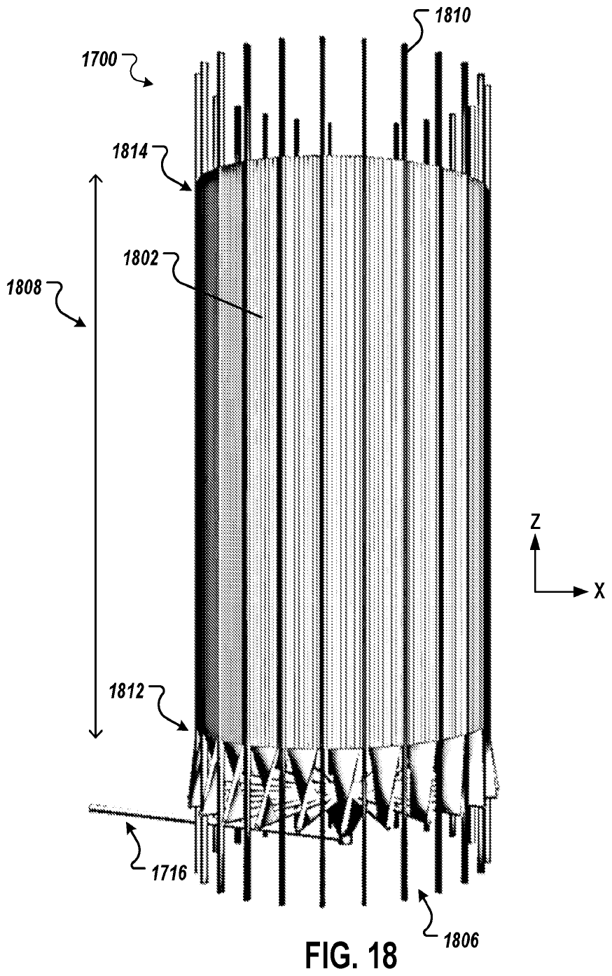

FIG. 18 is a side view of the example silo adsorber 1700. The silo adsorber 1700 includes a chamber bordered by panels 1802. Each panel 1802 extends in a vertical plane, e.g., a plane parallel or near-parallel the z-direction. Each panel 1802 is suspended between a pair of beams 1810 extending in a vertical direction from a base 1806 of the structure. A height 1808 of each panel extends in the vertical direction from a bottom 1812 of the panel to a top 1814 of the panel.

In some examples, the panels 1802 can be removable from the beams 1810. For example, each panel 1802 can be detachable from the suspending beams 1810. Each panel 1802 can therefore be removed for repair or replacement. Additional panels 1802 can also be added to the silo adsorber 1700 to increase the surface area of sorbent material 1710 in contact with air and therefore increase the CO₂ uptake.

FIGS. 19A-19B show top views of an example panel 1802 of a silo adsorber. Referring to FIG. 19A, the panel 1802 includes an inner sheet 1902 and an outer sheet 1904. The panel 1802 includes a cavity 1905 between the inner sheet 1902 and the outer sheet 1904. The panel 1802 can have a thickness 1911 of twenty centimeters or less (e.g., 180 mm or less, 150 mm or less, 120 mm or less).

The inner sheet 1902 and the outer sheet 1904 can each be formed from a porous, or permeable, fabric material. For example, the fabric material can be permeable to fluids, e.g., air. The panel 1802, including the inner sheet 1902, the outer sheet 1904, and sorbent material flowing between the inner sheet 1902 and the outer sheet 1904, form a permeable filter panel. In some examples, the inner sheet 1902, the outer sheet 1904, or both can be formed from a metallic, plastic, mesh, or composite material.

In some examples, the cavity between the inner sheet and the outer sheet is divided into multiple channels, e.g., channels 1907a, 1907b. Each channel can extend in the vertical direction from a bottom 1812 of the panel to a top 1814 of the panel. The channels 1907a, 1907b can be separated by fabric drop-stitching, or ribs 1906. The number of ribs can be selected in order to control sorbent material flow through the channels. For example, a greater number of ribs reduces a size of the channels, and can reduce a flow rate of sorbent material through the channels. A fewer number of ribs increases a size of the channels, and can increase a flow rate of sorbent material through the channels.

The fabric ribs 1906 can connect the inner sheet 1902 and the outer sheet 1904 at horizontal intervals, e.g., in the x-direction, between side edges 1903a, 1903b of the panel 1802. In some examples, each channel has an approximately square cross section in a horizontal plane, e.g., the x-y plane. In some examples, the side edges 1903a, 1903b of the panel 1802 are formed from non-permeable fabric material 1912, or a non-permeable metallic, plastic, or composite material.

In some examples, the inner sheet 1902 and the outer sheet 1904 each include attachment components such as keder ends 1920. Referring to FIG. 19B, the keder ends 1820 are configured to fit into keder rails of the beams, e.g., beams 1810a, 1810b. The panel 1802 can also include tensioning loops 1908 for adjusting tension when the panel 1802 is suspended between the beams 1810a, 1810b. The tension can be applied in the horizontal direction, e.g., the x-direction. Tension of the panel 1802 can be adjusted to control a flow rate of sorbent material 1710 through the channels 1907a, 1907b. For example, a lesser tension can increase a thickness 1911 of the panel 1802 and increase a flow rate of sorbent material 1710 through the channels 1907a, 1907b. A greater tension can decrease a thickness 1911 of the panel 1802 and decrease a flow rate of sorbent material 1710 through the channels 1907a, 1907b.

The beams 1810a, 1810b can be, for example, aluminum beams that support the structure. The beams 1810 can include attachment mechanisms, such as keder rails 1914, for attaching to the side edges 1903a, 1903b, of the panel 1802. For example, the attachment components of the inner sheet 1902 and the outer sheet 1904 can slide into and out of the attachment mechanisms of the beams 1810a, 1810b. Thus, the panel 1802 is removably coupled to the beams 1810a, 1810b. The panel 1802 can be removed and reinstalled, or removed and replaced, without moving the beams or any other panels.

During operation, sorbent material 1710 flows through the channels 1907a, 1907b. Air 1705 flows through the panel 1802 in a direction from the inner sheet 1902 to the outer sheet 1904.

FIG. 20 is a top cross-sectional view of an example silo adsorber 1700. The silo adsorber 1700 includes a blower 1720. The blower 1720 includes a motor 1722 and blades 2002. The motor 1722 drives rotation of the blower 1720. A diameter 2010 of the blower 1720 can be approximately eight meters or less (e.g., ten meters or less, nine meters or less, seven meters or less). The silo adsorber 1700 includes beams 1810. Panels 1802 are suspended between the beams 1810. The panels 1802 enclose the chamber 1702. The chamber 1702 has an approximately circular shape from the top cross-sectional view.

FIGS. 21A-21B are perspective view of an example adsorber structure 2100. The structure 2100 includes four walls 2101. The four walls 2101 enclose a chamber 2102. The chamber 2102 has a substantially rectangular prismic shape.

At least one wall of the four walls 2101 includes a filter panel 2110. Similar to the panels 1802, the filter panel 2110 can be formed from a porous fabric material and can include multiple channels. FIGS. 21A-21B show an example in which one of the four walls includes a filter panel 2110. In some examples, additional walls can include a filter panel 2110, e.g., two, three, or four walls.

The adsorber structure 2100 includes a blower 2120. The blower 2120 is integrated with a wall 2101 of the structure. The blower 2120 is positioned near a base 2106 of the structure 2100. For example, the blower 2120 can be integrated into a bottom portion of the wall 2101, e.g., a portion of the wall 2101 nearest to the base 2106. The bottom portion of the wall can be, for example, a lower third or lower quarter of the wall, as measured in the z-direction.

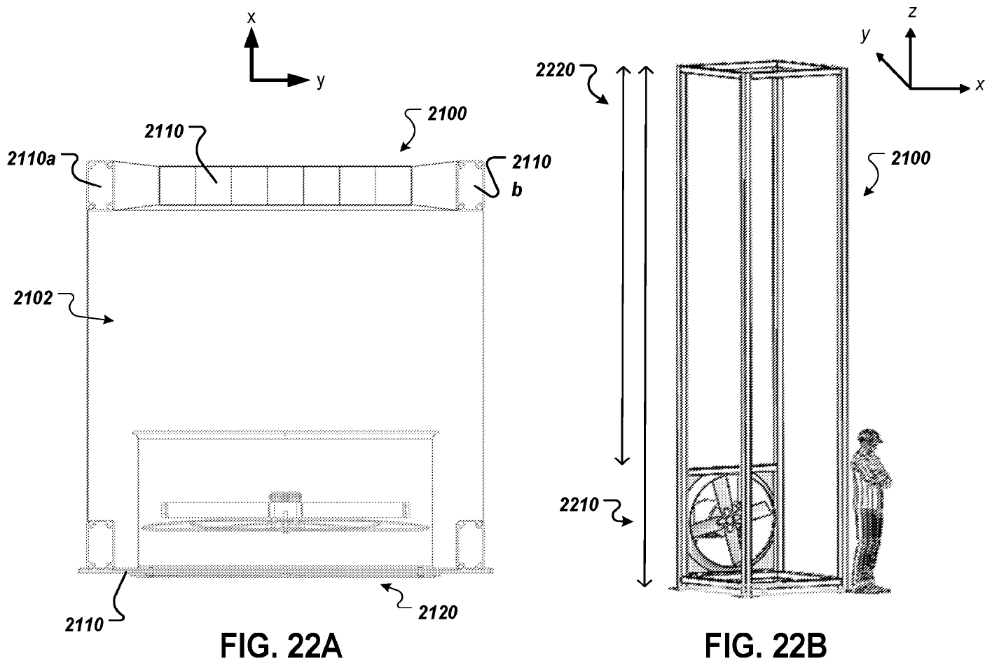

FIG. 22A is a top cross-sectional view of an example adsorber structure 2100. The adsorber structure 2100 includes a filter panel 2110 suspended between beams 2110a, 2110b. Four walls enclose a chamber 2102. A blower 2120 is integrated with one of the walls 2101. The blower 2120 directs air into the chamber 2102.

FIG. 22B is a perspective view showing a scale of an example adsorber structure 2100. In some examples, the adsorber structure has a height 2210 of approximately twenty meters (e.g., seventy feet or less, sixty-five feet or less, sixty feet or less). In some examples, the filter panel has a height that is less than the height of the structure. For example, the filter panel can have a height 2220 of approximately ten meters (e.g., forty feet or less, thirty-five feet or less, thirty feet or less).

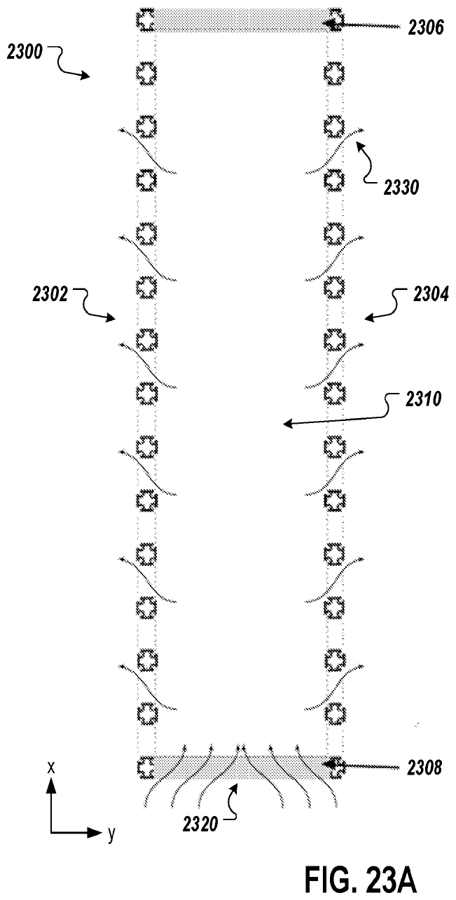

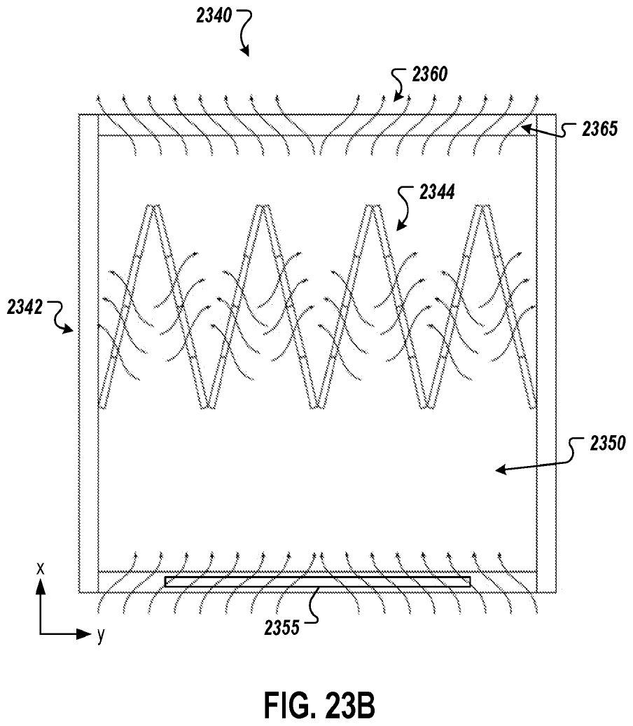

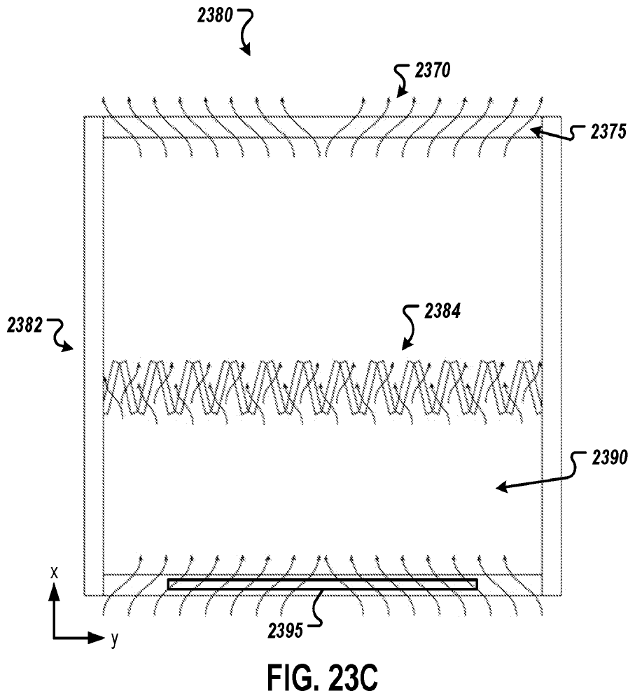

FIG. 23A is a top cross-sectional view of an example adsorber structure 2300 with two filter panels 2302, 2304 and two end walls 2306, 2308. The structure 2300 includes filter panels 2302, 2304 that each extend in the x-z plane and are parallel to each other. The filter panels 2302, 2304 and the end walls 2306, 2308 enclose a chamber 2310. The chamber 2310 has a substantially rectangular prismic shape. A blower 2320 directs air horizontally, e.g., in the x-direction, into the chamber 2310. The air 2330 then flows out of the chamber 2310 through the filter panels 2302, 2304. The filter panels 2302, 2304 can be formed from a porous fabric material and can include multiple channels.

FIGS. 23B-23C are top cross-sectional views of example adsorber structures 2340, 2380 with filter panels arranged in a sawtooth configuration. Referring to FIG. 23B, the structure 2340 includes eight filter panels 2344 arranged in a sawtooth configuration. Each filter panel 2344 can be formed from a porous fabric material and can include multiple channels. The structure 2340 includes walls 2342 that enclose a chamber 2350. The walls 2342 of the chamber 2350 form a substantially rectangular prismic shape. A blower 2355 directs air horizontally, e.g., in the x-direction, into the chamber 2350. The air 2360 then flows out of the chamber 2350 through an outlet 2365. The outlet 2365 can be, for example, a porous wall or a porous section of a wall.

Referring to FIG. 23C, the structure 2340 includes twenty-four filter panels 2384 arranged in a sawtooth configuration. Each filter panel 2384 can be formed from a porous fabric material and can include multiple channels. The structure 2380 includes walls 2382 that enclose a chamber 2390. The chamber 2390 has a substantially rectangular prismic shape. A blower 2395 directs air horizontally, e.g., in the x-direction, into the chamber 2390. The air 2370 then flows out of the chamber 2390 through an outlet 2375. The outlet 2375 can be, for example, a porous wall or a porous section of a wall.

Although shown as having parallel, rectangular, and sawtooth configurations, other configurations of filter panels are possible. For example, filter panels can be arranged in any polygonal shape from a top cross-sectional view. In some examples, multiple filter panels can be arranged in a straight line from a top cross-sectional view. In some examples, filter panels can be curved. In some examples, filter panels can be arranged in a circular, elliptical, oval, or other non-polygonal shape.

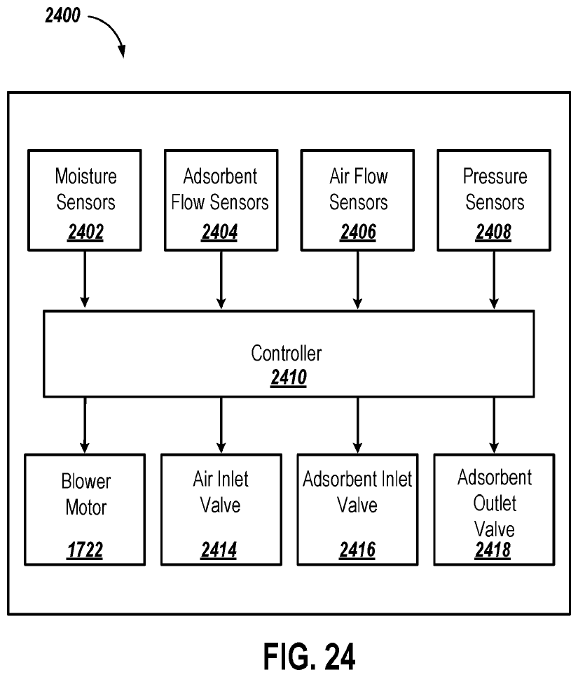

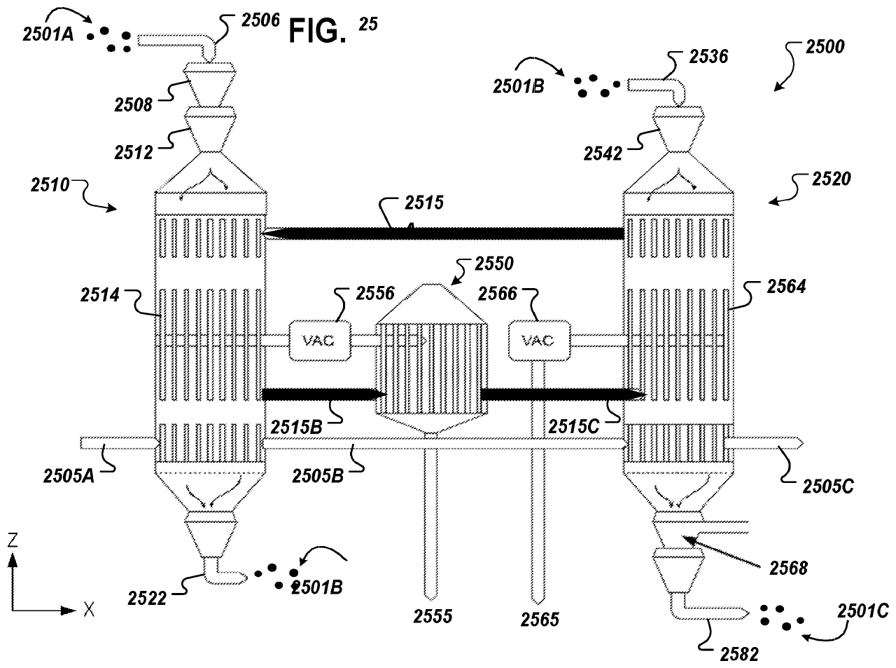

FIG. 24 is a block diagram of an example control system 2400 for the silo adsorber. The control system 2400 for the silo adsorber includes sensors. The sensors can include moisture sensors 2402, sorbent flow sensors 2404, air flow sensors 2406, and pressure sensors 2408. The control system 2400 for the silo adsorber includes a controller 2410.

The sensors output sensor data to the controller 2410. Based on the sensor data, the controller 2410 control components of the control system 2400. The components can include, for example, a blower motor 1722, an air inlet valve 2414, a sorbent inlet valve 2416, and a sorbent outlet valve 2418. Components can also include, for example, a conveyor system for conveying sorbent material to the inlet 1704.

In some examples, the controller 2410 can increase or decrease air flow by controlling a speed of the blower motor 1722. The controller 2410 can increase or decrease air flow by controlling a position of the air inlet valve 2414. The controller 2410 can increase or decrease sorbent flow into the cavities by adjusting a speed of the sorbent inlet valve. The controller 2410 can increase or decrease sorbent flow out of the cavities by adjusting the speed of the sorbent outlet valve 2418.

The controller 2410 can control the components of the control system 2400 in order to control parameters of the system. Parameters can include, for example, a pressure drop across the panels 1802, a flow rate of air into and out of the chamber, moisture content of the sorbent material, carbon dioxide content of the sorbent material, etc.

iv. Gravity-Fed Carbon Desorption System

In general, this disclosure relates to a gravity-fed system for desorption of carbon dioxide. An example system includes a first heat exchanger, or evaporator, configured to evaporate water from a sorbent material. The system includes a second heat exchanger, or desorber, configured to desorb carbon dioxide from the sorbent material. In some implementations, the system includes a third heat exchanger, or cooler, configured to cool the sorbent material. The evaporation and desorption are achieved by transferring heat between the sorbent material and a working fluid, and between the sorbent material and a heat source fluid.

The working fluid flows in a closed loop from the evaporator, to a condenser, to the desorber, and returning to the evaporator. The heat source fluid can flow in an open loop from a source, to the evaporator, to the desorber, and returning to the source.

The evaporator and the desorber can each be an indirect liquid-to-solid heat exchanger. For example, the evaporator and desorber can each be a shell and tube heat exchanger, a plate heat exchanger, or a combination heat exchanger such as a plate and shell heat exchanger. The sorbent material is a free flowing bulk solid and can have a powdered or pelletized form. In some examples, the sorbent material includes silica-based pellets.

During operation, the sorbent material enters the evaporator through an inlet at the top of the evaporator and flows downward through the evaporator due to gravity. The sorbent material enters the evaporator wet and rich at approximately an ambient temperature of 15° C. to 20° C. As the sorbent material flows through the evaporator, the sorbent material flows over tubes and/or plates through which the working fluid and the heat source fluid flow.

The heat source fluid, which may be from a waste heat source, transfers heat to the sorbent material in the evaporator before exiting the evaporator and flowing to the desorber. The working fluid also transfers heat to the sorbent material in the evaporator. The working fluid heats up the sorbent material to approximately 40° C. to 55° C. The sorbent material releases water vapor into the evaporator under the vacuum conditions due to the increased temperatures.

The water vapor is removed from the evaporator by a first vacuum pump. The first vacuum pump transports the water vapor from the evaporator to a condenser. Working fluid flowing out of the evaporator acts as a coolant for the condenser, extracting heat from the water vapor in the condenser. Thus, the working fluid is reheated in the condenser before flowing to the desorber.

The sorbent material exits the evaporator dry of water and rich in carbon dioxide at approximately the temperature at which water evaporates in the vacuum pressure of the evaporator. The sorbent material is transported from the evaporator through a channel to an inlet of the desorber. In some examples, the outlet of the evaporator is positioned vertically above the inlet of the desorber, and the sorbent material flows from the evaporator to the desorber due to gravity. In some examples, the outlet of the evaporator is positioned vertically below the inlet of the desorber, and a conveyor or lift system transports the sorbent material from the outlet of the evaporator to the inlet of the desorber.

The sorbent material enters the desorber through the inlet at the top of the desorber and flows downward through the desorber due to gravity. The desorber is configured to remove carbon dioxide from the sorbent material by transferring heat from the working fluid to the sorbent material. The working fluid heats up the sorbent material to approximately 65° C. to 80° C. Under vacuum conditions at these temperatures, the sorbent material releases carbon dioxide. The carbon dioxide is removed from the desorber by a second vacuum pump. The carbon dioxide can then be stored or recycled.

Heat source fluid that was cooled in the evaporator flows through the desorber and absorbs heat from the sorbent material, cooling the sorbent material. The sorbent material exits the desorber dry of water and lean in carbon dioxide at a temperature of 40° C. or less to avoid damage to the sorbent material. In some examples, the sorbent material exits the desorber at approximately ambient temperature. Any appropriate cooling fluid can be used to cool the sorbent material before exiting the desorber.

In some examples, the system includes airlocks that seal in the vacuum pressures of the evaporator and the desorber. For example, the system can include an airlock at an inlet of the evaporator, an airlock between the evaporator and the desorber, and an airlock at an outlet of the desorber. In some examples, the system includes an airlock at an inlet to the system and an airlock at an outlet to the system. For example, the system can include an airlock at an inlet to the evaporator, and an airlock at an outlet of the desorber, without including an airlock in between the evaporator and the desorber. In some examples, the system includes an airlock at an inlet to the evaporator, and an airlock at an outlet of the cooler, without including an airlock in between the evaporator and the desorber and without including an airlock in between the desorber and the cooler.

The system can include meters for controlling flow into the evaporator, between the evaporator and the desorber, and/or out of the desorber, between the desorber and the cooler, out of the cooler, or any combination thereof. In some examples, the meters control the mass flow rate of the sorbent material through airlocks in order to control the mass flow rate through the system.

After exiting the system (e.g., after exiting the desorber or the cooler), the sorbent material can undergo an adsorption process to adsorb carbon dioxide from the atmosphere. The sorbent material can then be transported back to the inlet of the evaporator to restart the desorption process.

In general, innovative aspects of the subject matter described in this specification can be embodied in a system for removing carbon dioxide from a sorbent material including a bulk solid. The system includes: a first heat exchanger configured to evaporate water vapor from the sorbent material by transferring heat from a working fluid and from a heat source fluid to the sorbent material; a condenser configured to condense the water vapor by transferring heat from the water vapor to the working fluid; a second heat exchanger configured to desorb carbon dioxide from the sorbent material by transferring heat from the working fluid to the sorbent material; a pump configured to remove the carbon dioxide from the second heat exchanger; a closed loop flow path for circulating the working fluid between the first heat exchanger, the condenser, and the second heat exchanger; an open loop flow path for providing the heat source fluid to the first heat exchanger; and a channel for transporting the sorbent material from the first heat exchanger to the second heat exchanger.

These and other embodiments can include the following features, alone or in any combination. In some implementations, the first heat exchanger includes: a first inlet providing access for delivery of the sorbent material to the first heat exchanger; and a first outlet providing an egress for removal of the sorbent material from the first heat exchanger. During operation, the first inlet has a higher elevation than the first outlet.

In some implementations, the second heat exchanger includes: a second inlet providing access for delivery of the sorbent material to the second heat exchanger; and a second outlet providing an egress for removal of the sorbent material from the second heat exchanger. During operation, the second inlet has a higher elevation than the second outlet.

In some implementations, during operation, the second inlet of the second heat exchanger has a higher elevation than the first outlet of the first heat exchanger. In some implementations, during operation, the second inlet of the second heat exchanger has a lower elevation than the first outlet of the first heat exchanger.

In some implementations, the closed loop flow path and the open loop flow path are fluidly isolated from each other.

In some implementations, the system includes a metering device configured to control a flow of sorbent material into the first heat exchanger.

In some implementations, the sorbent material is a free flowing bulk solid and can have a powdered or pelletized form.

In some implementations, the sorbent material is configured to adsorb carbon dioxide from fluid.

In some implementations, the first heat exchanger and the second heat exchanger are plate heat exchangers. In some implementations, the first heat exchanger and the second heat exchanger are shell and tube heat exchangers.

In some implementations, the first heat exchanger and the second heat exchanger are shell and plate heat exchangers.

In some implementations, the first heat exchanger is an evaporator.

In some implementations, the second heat exchanger is a desorber.

In general, innovative aspects of the subject matter described in this specification can be embodied in a method for removing carbon dioxide from a sorbent material including a bulk solid. The method includes: circulating a working fluid in a closed loop between a first heat exchanger, a condenser, and a second heat exchanger; providing a heat source fluid to the first heat exchanger; evaporating water vapor from the sorbent material by transferring heat from the working fluid and from the heat source fluid to the sorbent material in the first heat exchanger; condensing the water vapor by transferring heat from the water vapor to the working fluid in the condenser; transporting the sorbent material from the first heat exchanger to the second heat exchanger through a channel; desorbing carbon dioxide from the sorbent material by transferring heat from the working fluid to the sorbent material in the second heat exchanger; and removing the carbon dioxide from the second heat exchanger by a pump.

These and other embodiments can include the following features, alone or in any combination. In some implementations, the method includes: feeding the sorbent material at an inlet of the first heat exchanger; and extracting the sorbent material from an outlet of the first heat exchanger. The sorbent material moves from the inlet of the first heat exchanger to the outlet of the first heat exchanger due to gravity.

In some implementations, the method includes: feeding the sorbent material at an inlet of the second heat exchanger; and extracting the sorbent material from an outlet of the second heat exchanger. The sorbent material moves from the inlet of the second heat exchanger to the outlet of the second heat exchanger due to gravity.

In some implementations, the method includes transferring heat from the water vapor evaporated from the sorbent material in the first heat exchanger to the sorbent material in the second heat exchanger through the working fluid.

In some implementations, the method includes: cooling the sorbent material in the second heat exchanger using heat source fluid that was pre-cooled in the first heat exchanger.

In some implementations, the method includes using a pump to establish vacuum pressure in the first heat exchanger and to transport the water vapor from the first heat exchanger to the condenser.

In some implementations, the method includes removing the condensed water vapor from the condenser through a water outlet.

In some implementations, the method includes establishing vacuum pressure in the second heat exchanger using the pump.

In some implementations, the method includes maintaining vacuum pressures in the first heat exchanger and in the second heat exchanger using airlocks.

In general, innovative aspects of the subject matter described in this specification can be embodied in a system for removing carbon dioxide from a sorbent material comprising a bulk solid, the system comprising: a first heat exchanger configured to evaporate water vapor from the sorbent material by transferring heat from a heat source fluid to the sorbent material; a second heat exchanger configured to desorb carbon dioxide from the sorbent material by transferring heat from a working fluid to the sorbent material; a pump configured to remove the carbon dioxide from the second heat exchanger; a third heat exchanger configured to cool the sorbent material by transferring heat from the sorbent material to the cooling fluid; a channel for transporting the sorbent material from the first heat exchanger to the second heat exchanger and to the third heat exchanger.

In some implementations, the system comprises: an inlet providing access for delivery of the sorbent material to the first heat exchanger; and an outlet providing an egress for removal of the sorbent material from the third heat exchanger, wherein, during operation, the inlet has a higher elevation than the outlet.

In some implementations, the first heat exchanger comprises an evaporator; the second heat exchanger comprises a desorber; and the third heat exchanger comprises a cooler, wherein the sorbent material has a pelletized form and is configured to adsorb carbon dioxide from fluid.

In some implementations, the pump is configured to establish vacuum pressure in the first heat exchanger, the second heat exchanger, and the third heat exchanger.

The disclosed systems and methods can result in the following advantages. Removing water from the sorbent material in the first heat exchanger prior to delivering the sorbent material to the second heat exchanger improves the efficiency of desorption of carbon dioxide from the sorbent material in the second heat exchanger. Performing evaporation and desorption at vacuum pressures reduces the temperature at which the processes occur. Energy efficiency is increased by reheating the working fluid in the condenser, using heat from the water vapor. Energy efficiency is increased by cooling the sorbent material in the second heat exchanger using heat source fluid that was pre-cooled in the first heat exchanger. Waste heat can be used as a heat source, improving efficiency. Due to the vertically oriented modular design with few moving parts or no moving parts, maintenance costs can be reduced. Indirect heating by conduction makes it possible to capture and use low-grade heat for heating bulk solid sorbent material.

FIG. 25 illustrates an example desorption system 2500 including an evaporator 2510 and a desorber 2520. The desorption system 2500 is a system for removing carbon dioxide and moisture from a sorbent material.

In FIG. 25, the sorbent material at various stages is labeled as 2501A, 2501B, 2501C. Wet and rich sorbent material, containing water and carbon dioxide, is labeled 2501A. Dry and rich sorbent material, which has released water and contains carbon dioxide, is labeled 2501B. Dry and lean sorbent material, which has released both water and carbon dioxide, is labeled 2501C. Generally, the sorbent material can be referred to as sorbent material 2501. The sorbent material 2501 can be a free flowing bulk solid and can have a powdered or pelletized form. In some examples, the sorbent material 2501 includes silica-based pellets. Prior to being introduced to the desorption system 2500, the sorbent material 2501 can undergo an adsorption process. During the adsorption process, the sorbent material 2501 can adsorb carbon dioxide from a fluid such as an air stream.

The desorption system 2500 includes a first heat exchanger (e.g., an evaporator 2510) and a second heat exchanger (e.g., a desorber 2520). The evaporator 2510 is configured to evaporate water vapor from the sorbent material 2501 by transferring heat from a working fluid and from a heat source fluid to the sorbent material 2501. The desorber 2520 is configured to desorb carbon dioxide from the sorbent material 2501 by transferring heat from the working fluid 2515 to the sorbent material 2501.

In FIG. 25, the working fluid at various stages is labeled as 2515A, 2515B, 2515C. Hot working fluid exiting the desorber 2520 and entering the evaporator 2510 is labeled 2515A. Cooled working fluid, exiting the evaporator 2510, is labeled 2515B. Reheated working fluid, entering the desorber 2520, is labeled 2515C. Generally, the working fluid can be referred to as working fluid 2515. The working fluid 2515 can be a liquid such as water.

The heat source fluid at various stages is labeled as 2505A, 2505B, 2505C. Hot heat source fluid entering the evaporator 2510 is labeled 2505A. Cooled heat source fluid exiting the evaporator 2510 and entering the desorber 2520 is labeled 2505B. Reheated heat source fluid leaving the desorber 2520 is labeled 2505C. Generally, the heat source fluid can be referred to as heat source fluid 2505. The working fluid 2515 can be a liquid such as water.

The evaporator 2510 and the desorber 2520 can be the same type of heat exchanger or can each be a different type of heat exchanger. In some examples, the evaporator 2510, the desorber 2520, or both, are plate heat exchangers. In some examples, the evaporator 2510, the desorber 2520, or both, are shell and tube heat exchangers. In some examples, the evaporator 2510, the desorber 2520, or both, are combination heat exchangers such as shell and plate heat exchangers.

Wet and rich sorbent material 2501A can be delivered to the evaporator 2510 through an evaporator inlet 2506. The sorbent material 2501A entering the evaporator 2510 can have a temperature of, for example, 15° C. to 20° C. At higher pressures, the sorbent material 2501A may have higher temperatures.

The evaporator inlet 2506 provides access for delivery of the wet and rich sorbent material 2501A to the evaporator 2510. In some examples, the inlet 2506 is near or at the top of the evaporator 2510 with respect to the direction of gravity. The sorbent material 2501 enters the evaporator 2510 through the inlet 2506 and flows downward through the evaporator 2510 due to gravity.

In some examples, a loader 2508 collects the sorbent material 2501 prior to entering the evaporator 2510. The loader 2508 can include a metering device for controlling the flow of sorbent material 2501 into the evaporator 2510.

In some examples, the evaporator 2510 includes an airlock 2512. The airlock 2512 can seal in the vacuum pressure of the evaporator 2510. The airlock 2512 can permit entry of the sorbent material 2501 into the evaporator 2510 without disrupting the vacuum pressure inside the evaporator 2510. In some implementations, the airlock 2512 can also be used as a metering device for controlling the flow of sorbent material 2501 into the evaporator 2510. Airlocks can also be located between the outlet of the evaporator 2510 and the inlet of the desorber 2520 (e.g., airlock 2542), and at the outlet of the desorber (e.g., airlock 2568).

In the example of a shell and tube heat exchanger, the evaporator 2510 includes tubes 2514. Fluid, e.g., the working fluid 2515 and the heat source fluid 2505, flows through the tubes 2514. Inside the evaporator 2510, the sorbent material 2501 flows over the tubes, absorbing heat. The absorbed heat causes the sorbent material 2501 to release water vapor into the evaporator 2510.

The working fluid 2515 flows in a closed loop flow path. The flow path circulates the working fluid 2515 between the evaporator 2510, a condenser 2550, and the desorber 2520. The working fluid flows in a closed loop from the evaporator 2510, to the condenser 2550, to the desorber 2520, returning to the evaporator 2510. When entering the evaporator, the working fluid 2515A has a temperature of approximately 70° C. or greater (e.g., 65° C. or greater, 70° C. or greater, 75° C. or greater, 80° C. or greater).

The heat source fluid 2505 flows in an open loop flow path from a heat source, to the evaporator 2510, to the desorber 2520, and returning to the source. The heat source fluid 2505, which may be from a waste heat source, transfers heat to the sorbent material 2501 in the evaporator 2510 before exiting the evaporator 2510 and flowing to the desorber 2520. In some implementations, the closed loop flow path of the working fluid 2515 and the open loop flow path of the heat source fluid 2505 are fluidly isolated from each other. When entering the evaporator, the heat source fluid 2505A has a temperature of approximately 35° C. or greater (e.g., 30° C. or greater, 40° C. or greater, 45° C. or greater).

Inside the evaporator 2510, the working fluid 2515A and the heat source fluid 2505A transfer heat to the wet and rich sorbent material 2501A. The wet and rich sorbent material 2501A releases water vapor into the evaporator 2510 under the vacuum conditions due to the increased temperatures in the evaporator 2510.

working fluid 2515B exiting the evaporator 2510 has a reduced temperature compared to the working fluid 2515A entering the evaporator 2510. For example, the working fluid 2515B exiting the evaporator 2510 can have a temperature of approximately 60° C. or less (e.g., 50° C. or less, 55° C. or less, 65° C. or less).

The heat source fluid 2505B exiting the evaporator 2510 has a reduced temperature compared to the heat source fluid 2505A entering the evaporator 2510. For example, the heat source fluid 2505B exiting the evaporator 2510 can have a temperature of approximately 15° C. or less (e.g., 25° C. or less, 20° C. or less, 10° C. or less). The reduced temperature heat source fluid 2505 flows through piping from the evaporator 2510 to the desorber 2520.

The sorbent material 2501 exits the evaporator 2510 through evaporator outlet 2522. The evaporator outlet 2522 provides an egress for removal of the sorbent material from the evaporator 2510. The evaporator outlet 2522 has a lower elevation than the evaporator inlet 2506, e.g., in the z-direction, such that the sorbent material 2501 can flow from the evaporator inlet 2506 to the evaporator outlet 2522 due to gravity. The dry and rich sorbent material 2501B can be extracted from the evaporator outlet 2522.

The sorbent material 2501B exits the evaporator 2510 dry of water and rich in carbon dioxide at the evaporation temperature of water in the vacuum. In an example evaporator having a pressure of 0.65 pound per square inch absolute (psia), the sorbent material 2501B exits the evaporator 2510 dry of water and rich in carbon dioxide at approximately 30° C. The sorbent material 2501B is transported from the evaporator 2510 through a channel to an inlet 2536 of the desorber 2520. In some examples, the desorber inlet 2536 is at a higher elevation than the evaporator outlet 2522. In some examples, the desorber inlet 2536 is at a same or lower elevation than the evaporator outlet 2522. In some examples, the evaporator outlet 2522 is positioned vertically above the desorber inlet 2536, and the sorbent material 2501B flows from the evaporator 2510 to the desorber 2520 due to gravity. In some examples, the evaporator outlet 2522 is positioned vertically below the desorber inlet 2536, and a conveyor or lift system transports the sorbent material 2501B from the evaporator outlet 2522 to the desorber inlet 2536.

An evaporator pump 2556 removes water vapor from the evaporator 2510. The evaporator pump 2556 establishes vacuum pressure in the evaporator. The vacuum pressure can be, for example, between 0.25 and 2.0 psia. In some examples, the evaporator 2510 and the desorber 2520 operate at a same or similar pressure. In some examples, the evaporator 2510 and the desorber 2520 operate at different pressures.

In some implementations, the evaporator pump 2556 transports the water vapor from the evaporator 2510 to the condenser 2550. In some implementations, water vapor is transported from the evaporator 2510 to the condenser 2550 through other paths, e.g., through a turbo compressor. In some implementations, the evaporator pump 2556 releases the water vapor through the water outlet 2555.

The condenser 2550 condenses the water vapor by transferring heat from the water vapor to the working fluid 2515B. The working fluid 2515B flowing out of the evaporator 2510 acts as a coolant for the condenser 2550, extracting heat from the water vapor in the condenser 2550. Thus, the working fluid 2515B is reheated in the condenser, using exhaust steam from the evaporator pump 2556 as a heat source. Reheated working fluid 2515C flows through piping out of the condenser 2550 and into the desorber 2520. The working fluid 2515C entering the desorber can have a temperature of approximately 85° C. or more (e.g., 75° C. or more, 80° C. or more, 90° C. or more). Thus, heat is transferred from the water vapor evaporated from the sorbent material 2501 in the evaporator 2510 to the sorbent material 2501 in the desorber 2520 through the working fluid 2515. The condensed water vapor in the condenser 2550 is removed as water 2555 through a water outlet. In some implementations, the condenser can be positioned before the vacuum pump, e.g., in implementations in which heat pumps are used as a thermal source.

In some implementations, mechanical vapor recompression can be used to recycle waste heat to improve efficiency. To employ mechanical vapor recompression, turbo-compression equipment can be used to compress vapor from the evaporator 2510 before entering the condenser 2550. In some implementations, recompressed vapor can be used as a working fluid and condensed in the evaporator 2510.

The dry and rich sorbent material 2501B enters the desorber 2520 through desorber inlet 2536. The dry and rich sorbent material 2501B can have a temperature of approximately 30° C. or greater (e.g., 25° C. or greater, 35° C. or greater, 40° C. or greater). The desorber inlet 2536 provides access for delivery of the sorbent material 2501 to the desorber 2520. Airlocks 2542, 2572 and airlock 2568 seal in the vacuum pressure of the desorber 2520.

In the example of a shell and tube heat exchanger, the desorber 2520 includes tubes 2564. In the example of a plate heat exchanger, the desorber 2520 may include plates instead of tubes. Fluid, e.g., the working fluid 2515 and the heat source fluid 2505, flows through the tubes 2564. Inside the desorber 2520, the sorbent material 2501 flows over the tubes, absorbing heat. The absorbed heat causes the sorbent material 2501 to release carbon dioxide into the desorber 2520. The sorbent material 2501 enters the desorber 2520 through the desorber inlet 2536 at the top of the desorber 2520 and flows downward through the desorber 2520 due to gravity. The desorber 2520 removes carbon dioxide from the sorbent material 2501 by transferring heat from the working fluid 2515 to the sorbent material.

As described herein, the working fluid 2515C enters the desorber at approximately 85° C. After transferring heat to the sorbent material 2501, the working fluid 2515A exits the desorber at approximately 70° C. or less (e.g., 75° C. or less, 65° C. or less, 60° C. or less).

Inside the desorber 2520, the sorbent material 2501, heated by the working fluid 2515, rises to a temperature of approximately 65° C. to 80° C. Under vacuum conditions at these temperatures, the sorbent material 2501 releases carbon dioxide into the desorber.

A desorber pump 2566 removes carbon dioxide from the desorber 2520 and establishes vacuum pressure in the desorber 2520. The carbon dioxide 2565 is removed from the desorber 2520 by the desorber pump 2566. The carbon dioxide 2565 can then be stored or recycled.

The heat source fluid 2505B that was cooled in the evaporator 2510 to a temperature of approximately 15° C. or less enters the desorber 2520. The heat source fluid 2505 flows through tubes or plates of the desorber 2520 and absorbs heat from the sorbent material 2501, cooling the sorbent material 2501. The sorbent material 2501C exits the desorber 2520 at a temperature of 50° C. or less. In some examples, the sorbent material 2501C exits the desorber 2520 dry of water and lean in carbon dioxide at approximately ambient temperature (e.g., 15° C., 20° C., 25° C., or ranges therebetween, such as from 15° C. to 25° C.). The heat source fluid 2505C exits the desorber 2520 at a higher temperature than the heat source fluid 2505B that entered the desorber. For example, the heat source fluid 2505C can have a temperature of approximately 19° C. or greater (e.g., 20° C. or greater, 25° C. or greater, 30° C. or greater).

The dry and lean sorbent material 2501C exits the desorber 2520 through a desorber outlet 2582. The desorber outlet 2582 provides an egress for removal of the sorbent material 2501C from the desorber 2520.

After exiting the desorber 2520, the dry and lean sorbent material 2501C can undergo an adsorption process to adsorb carbon dioxide from the atmosphere. The sorbent material can then be transported back to the inlet 2506 of the evaporator to restart the desorption process.

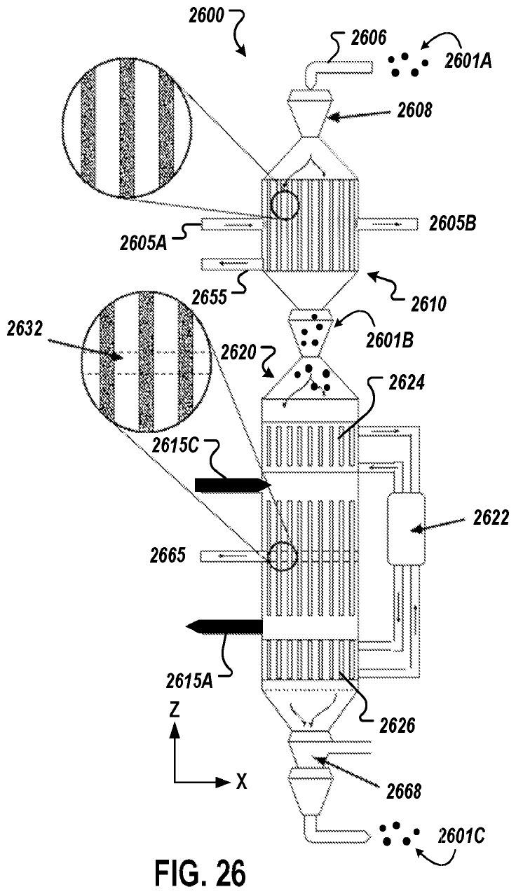

FIG. 26 illustrates an example desorption system 2600 including an evaporator 2610 stacked with a desorber 2620. Wet and rich sorbent material 2601A can be delivered to the evaporator 2610 through an evaporator inlet 2606 and an airlock 2608. The wet and rich sorbent material 2601A enters the evaporator 2610 through the inlet 2606 and flows downward through the evaporator 2610 due to gravity.

Heat source fluid 2605 flows in an open loop flow path from a heat source, to the evaporator 2610, and returning to the source. The heat source fluid 2605, which may be from a waste heat source, transfers heat to the sorbent material 2601 in the evaporator 2610 before exiting the evaporator 2610.

The heat source fluid 2605A enters the evaporator 2610 at approximately 35° C. or greater (e.g., 30° C. or greater, 40° C. or greater, 45° C. or greater). Inside the evaporator 2610, the heat source fluid 2605A transfers heat to the wet and rich sorbent material 2601A and raises it to a temperature of approximately 40° C. to 55° C. The wet and rich sorbent material 2601A releases water vapor into the evaporator 2610 under the vacuum conditions due to the increased temperatures in the evaporator 2610. A vacuum pump (not shown) removes water vapor 2655 from the evaporator 2610 and establishes vacuum pressure in the evaporator 2610.

The heat source fluid 2605B exits the evaporator at approximately 15° C. or less (e.g., 25° C. or less, 20° C. or less, 10° C. or less). Dry and rich sorbent material 2601B exits the evaporator 2610 at approximately ambient temperature, and is transported from the evaporator 2610 through a channel to the desorber 2620.

The working fluid 2615C enters the desorber 2620 at a high temperature. The high temperature can be approximately 85° C. or greater (e.g., 80° C. or greater, 90° C. or greater, 95° C. or greater). Inside the desorber 2620, the sorbent material 2601, heated by the working fluid 2615, rises to a temperature of approximately 65° C. to 80° C. Under vacuum conditions at these temperatures, the sorbent material 2601 releases carbon dioxide into the desorber 2620.

The working fluid 2615A exits the desorber 2620 at a lower temperature, compared to the inlet temperature, of approximately 70° C. or less (e.g., 75° C. or less, 65° C. or less, 60° C. or less). A pump (not shown) removes carbon dioxide from the desorber 2620 through a vacuum inlet 2632. The pump also establishes vacuum pressure in the desorber 2620.

The desorption system 2600 includes a heat pump 2622. The heat pump 2622 circulates coolant to remove heat from sorbent material near the bottom 2626 of the desorber 2620 and provide heat to sorbent material near the top 2624 of the desorber 2620. Thus, the sorbent material 2601 is cooled by coolant circulated by the heat pump 2622 prior to exiting the desorber 2620. Dry and lean sorbent material 2601C exits the desorber 2620 through an airlock 2668. The airlock preserves the vacuum pressure in the desorber 2620. The dry and lean sorbent material 2601C has a temperature of approximately 25° C. or less to ensure the sorbent material 2601C is not damaged when it exits the desorption system 2600 (e.g., a temperature of 30° C. or less, 20° C. or less, 15° C. or less).

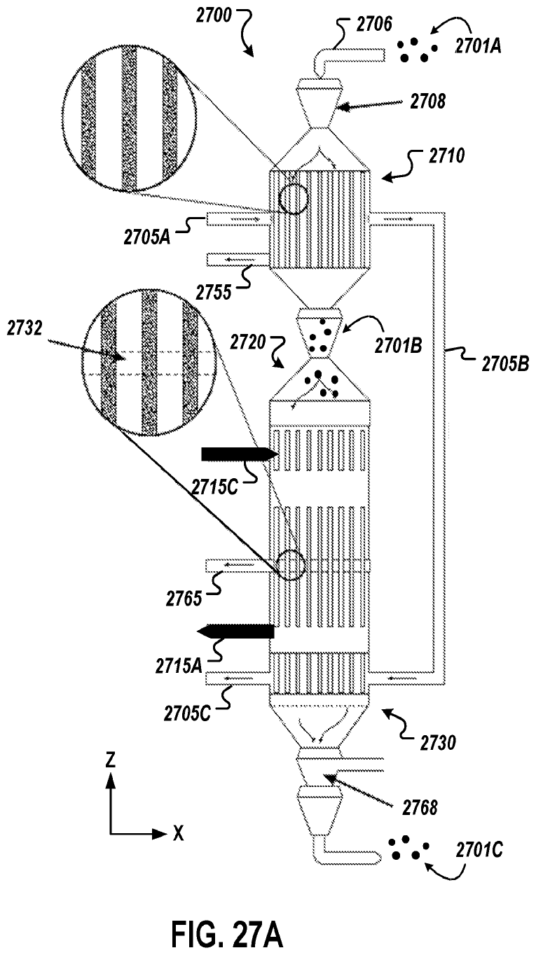

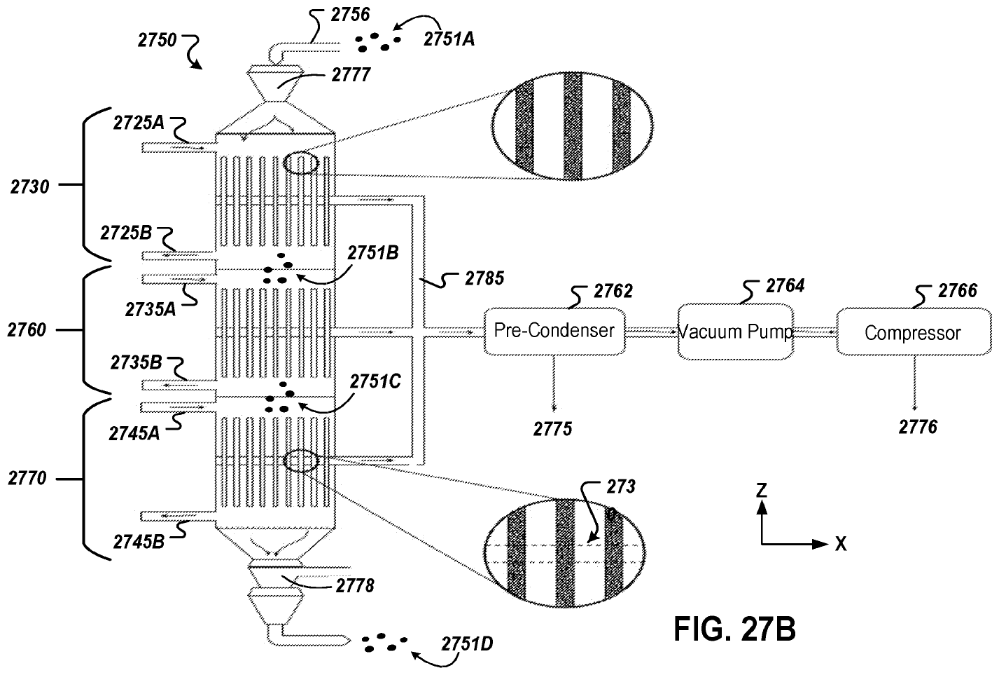

FIG. 27A illustrates an example desorption system 2700 including an evaporator 2710 stacked with a desorber 2720 including heat source fluid recirculation. Wet and rich sorbent material 2701A can be delivered to the evaporator 2710 through an evaporator inlet 2706 and an airlock 2708. The wet and rich sorbent material 2701A enters the evaporator 2710 through the inlet 2706 and flows downward through the evaporator 2710 due to gravity.

Heat source fluid 2705 flows in an open loop flow path from a heat source, to the evaporator 2710, to the desorber 2620, and returning to the source. The heat source fluid 2705, which may be from a waste heat source, transfers heat to the sorbent material 2701 in the evaporator 2710 before exiting the evaporator 2710.

The heat source fluid 2705A enters the evaporator 2710 at approximately 35° C. or greater (e.g., 30° C. or greater, 40° C. or greater, 45° C. or greater). Inside the evaporator 2710, the heat source fluid 2705A transfers heat to the wet and rich sorbent material 2701A and raises it to a temperature of approximately 40° C. to 55° C. The wet and rich sorbent material 2701A releases water vapor into the evaporator 2710 under the vacuum conditions due to the increased temperatures in the evaporator 2710. A vacuum pump (not shown) removes water vapor 2755 from the evaporator 2710 and establishes vacuum pressure in the evaporator 2710.

The heat source fluid 2705B exits the evaporator at approximately 15° C. or less (e.g., 25° C. or less, 20° C. or less, 10° C. or less). The heat source fluid 2705B flows through recirculation piping to the desorber 2720. Dry and rich sorbent material 2701B exits the evaporator 2710 at approximately ambient temperature, and is transported from the evaporator 2710 through a channel to the desorber 2720.

The working fluid 2715C enters the desorber 2720 at a high temperature. The high temperature can be approximately 85° C. or greater (e.g., 80° C. or greater, 90° C. or greater, 95° C. or greater). Inside the desorber 2720, the sorbent material 2701, heated by the working fluid 2715, rises to a temperature of approximately 65° C. to 80° C. Under vacuum conditions at these temperatures, the sorbent material 2701 releases carbon dioxide into the desorber 2720.

The working fluid 2715A exits the desorber 2720 at a lower temperature, compared to the inlet temperature, of approximately 70° C. or less (e.g., 75° C. or less, 65° C. or less, 60° C. or less). A pump (not shown) removes carbon dioxide 2765 from the desorber 2720 through a vacuum inlet 2732. The pump also establishes vacuum pressure in the desorber 2720.

The heat source fluid 2705B, cooled in the evaporator 2710, enters the desorber 2720 through the recirculation piping. The heat source fluid 2705B cools the dry and lean sorbent material 2701C before the dry and lean sorbent material 2701 exits the desorber 2720 to ensure that the sorbent material is not damaged when it is not under vacuum.

The dry and lean sorbent material 2701C exits the desorber 2720 through an airlock 2768. The airlock preserves the vacuum pressure in the desorber 2720. The dry and lean sorbent material 2701C has a temperature of approximately 25° C. or less (e.g., 30° C. or less, 20° C. or less, 15° C. or less).

FIG. 27B illustrates an example desorption system 2750 including an evaporator 2730, a desorber 2760, and a cooler 2770 in a single vacuum sealed system. Moisture and carbon dioxide rich sorbent material 2751A can be delivered to the evaporator 2730 through an evaporator inlet 2756 and an upper airlock 2777. The moisture and carbon dioxide rich sorbent material 2751A enters the evaporator 2730 through the inlet 2756 and flows downward through the evaporator 2730 due to gravity.

The entire desorption system 2750 between the upper airlock 2777 and lower airlock 2778 are held under constant vacuum with a vacuum pump 2764. The vacuum level is at approximately 2 psia or less (e.g., 1.5 psia or less, 1.0 psia or less, 0.5 psia or less). The vacuum pump 2764 draws the outlet air 2785 from the evaporator 2730, the desorber 2760, and the cooler 2770, through vacuum inlets.

A heat source fluid 2725A, which can be a low heat working fluid, flows in a closed loop flow path from a heat source, to the evaporator 2730, and returning to the source. The heat source fluid 2725A, which may be from a waste heat source or a dedicated heat pump, transfers heat to the sorbent material 2751A before exiting the evaporator 2730.

The heat source fluid 2725A enters the evaporator 2730 at approximately 30° C. or greater (e.g., 35° C. or greater, 40° C. or greater, 45° C. or greater). Inside the evaporator 2730, the heat source fluid 2725A transfers heat to the moisture and carbon dioxide rich sorbent material 2751A. The moisture and carbon dioxide rich sorbent material 2751A releases water vapor into the evaporator 2730 under the vacuum conditions due to the increased temperatures.

A pre-condenser 2762 removes water vapor 2775 from the evaporator 2730 before outlet air 2756 reaches the vacuum pump 2764. The vacuum pump 2764 establishes vacuum pressure in the evaporator 2730.

The heat source fluid 2725B exits the evaporator 2730 at approximately 25° C. or less (e.g., 20° C. or less, 15° C. or less, 10° C. or less). Dry and carbon dioxide rich sorbent material 2751B exits the evaporator 2730 at approximately 25° C. or greater (e.g., 30° C. or greater, 35° C. or greater, 40° C. or greater), and is gravity fed from the evaporator 2730 to the desorber 2760.

A working fluid 2735A, which can be a high heat working fluid, enters the desorber 2760 at a high temperature. The high temperature can be approximately 75° C. or greater (e.g., 80° C. or greater, 85° C. or greater, 90° C. or greater). Inside the desorber 2760, the sorbent material 2751B, heated by the working fluid 2735A, rises to a temperature of approximately 70° C. or greater (e.g., 75° C. or greater, 80° C. or greater, 85° C. or greater). Under vacuum conditions at these temperatures, the sorbent material 2751B releases carbon dioxide into the desorber 2760.

A carbon dioxide compressor 2766 removes carbon dioxide 2776 from the outlet air 2756 after the water vapor 2775 has been removed from the outlet air 2756. The vacuum pump 2764 establishes vacuum pressure in the desorber 2760.

The working fluid 2735B exits the desorber 2760 at a lower temperature, compared to the inlet temperature, of approximately 75° C. or less (e.g., 70° C. or less, 65° C. or less, 60° C. or less). Dry and carbon dioxide lean sorbent material 2751B exits the desorber 2760 at approximately 60° C. or greater (e.g., 65° C. or greater, 70° C. or greater, 75° C. or greater), and is gravity fed from the desorber 2760 to the cooler 2770.

A cooling fluid 2745A enters the cooler 2770 at approximately 25° C. or less (e.g., 20° C. or less, 15° C. or less, 10° C. or less). Inside the cooler 2770, the cooling fluid 2745A cools the dry and carbon dioxide lean sorbent material 2751C to a temperature of approximately 35° C. or less (e.g., 30° C. or less, 25° C. or less, 20° C. or less). The dry and carbon dioxide lean sorbent material 2751C is cooled before the sorbent material is released from the vacuum created by the desorber system 2750 in order to prevent the sorbent from oxidizing. The cooling fluid 2745B exits the cooler 2770 at a higher temperature, compared to the inlet temperature, of approximately 35° C. or less (e.g., 30° C. or less, 25° C. or less, 20° C. or less)

Cooled and cleaned sorbent material 2751D exits the cooler 2770 through an airlock 2778. The airlock preserves the vacuum pressure in the entire desorber system 2750. The cooled and cleaned sorbent material 2751D has a temperature of approximately ambient temperature.

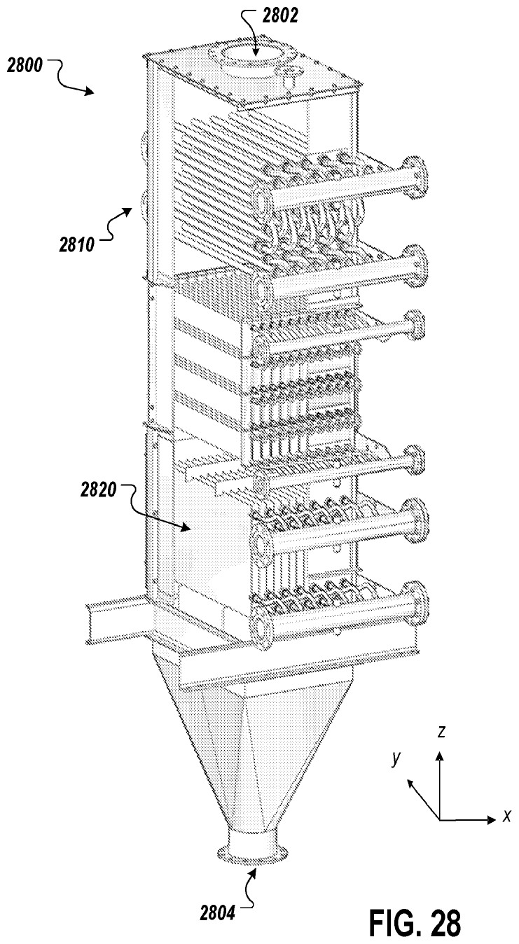

FIG. 28 illustrates an example heat exchanger 2800. The heat exchanger 2800 includes a combination of tubes 2810 and plates 2820. The heat exchanger 2800 can be implemented as an evaporator or as a desorber in accordance with implementations of the present disclosure.

The heat exchanger 2800 includes an inlet 2802 at the top and an outlet 2804 at the bottom. Free-flowing bulk solids, such as sorbent material (e.g., any described herein), can enter the heat exchanger 2800 through the inlet 2802 and exit the heat exchanger 2800 through the outlet 2804. The bulk solids pass slowly downward between a series of vertical hollow heat exchanger plates.

Fluid, such as steam, hot water, thermal oil, or air, flows through the plates to heat the bulk solid material by conduction. A mass flow discharge feeder creates uniform product velocity and regulates product flow rate. The bulk solids pass through the vertical heater by gravity, using an external metering system at the outlet 2804 to regulate the sorbent material flow rate.

Using the heat exchanger 2800, waste heat can be captured and reused, improving efficiency. Due to the vertically oriented modular design with no moving parts, maintenance costs can be reduced, and servicing the equipment can be easy. Indirect heating by conduction makes it possible to capture and use low-grade heat for heating bulk solids.

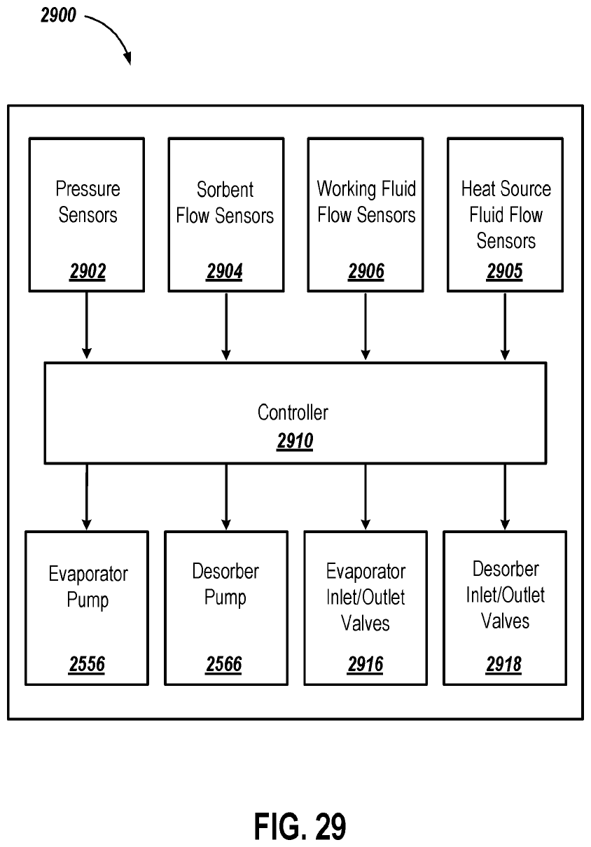

FIG. 29 is a block diagram of an example control system 2900 for the desorption system. The control system 2900 for the desorption system includes sensors. The sensors can include pressure sensors 2902, sorbent flow sensors 2904, air flow sensors 2906, and heat source fluid flow sensors 2905. The control system 2900 for the desorption system includes a controller 2910.

The sensors output sensor data to the controller 2910. Based on the sensor data, the controller 2910 control components of the control system 2900. The components can include, for example, an evaporator pump 2556, a desorber pump 2566, evaporator inlet and outlet valves 2916, and desorber inlet and outlet valves 2918. Components can also include, for example, a conveyor system for conveying sorbent material from the outlet of the evaporator to the inlet of the desorber.

In some examples, the controller 2910 can increase or decrease vacuum pressure in the evaporator and desorber by controlling the evaporator pump 2556 and the desorber pump 2566, respectively. In some examples, gas analyzers can be used to measure the output of water 2555 and carbon dioxide 2565 to quantify the efficiency of the desorption system 2500.

The controller 2910 can increase or decrease a rate of flow of sorbent material through the evaporator by controlling the evaporator inlet and outlet valves 2916. The controller 2910 can increase or decrease a rate of flow of sorbent material through the desorber by controlling the desorber inlet and outlet valves 2918.

The controller 2910 can control the components of the control system 2900 in order to control parameters of the system. Parameters can include, for example, a pressure inside the evaporator, a pressure inside the desorber, a flow rate of sorbent material through the evaporator, a flow rate of sorbent material through the desorber, moisture content of the sorbent material, carbon dioxide content of the sorbent material, etc.

A controller can include one or more memory devices, one or more mass storage devices, and one or more processors having a CPU or computer, analog, and/or digital input/output connections, stepper motor controller boards, etc. The controller can be configured to perform any methods or to control any parameters described herein (e.g., by way of executing system control software or by performing control logic that is hard coded in the controller).

### EXAMPLES

### Example 1: Reversible Amino Silane Functionalized Porous Silica for Carbon Capture

Examples 1.1 to 1.4 generally relate to a functionalized porous silica and more specifically, to a functionalized porous silica for reversibly capturing carbon dioxide.

### Example 1.1—N1-(3-Trimethoxysilylpropyl)diethylenetriamine grafting

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hours (hrs). N1-(3-Trimethoxysilylpropyl)diethylenetriamine was added into the above solution at a molar ratio in a range from 2.3 g to 4.7 g (e.g., 8 mmol to 16 mmol, e.g., a silica particle to polyamine material molar ratio in a range from 5:1 to 10:1). The mixture was heated and stirred at 60° C. or above (e.g., up to 90° C.). The temperature depends on the chosen solvent. The mixture was stirred for 18 hrs (in some cases, the mixing continued for 24 hrs). The mixture was cooled to room temperature. The functionalized silica particles were filtered from the solvent and washed twice while stirring with a 40 mL volume of solvent each time. The functionalized silica particles were dried in a vacuum oven at 50° C. for 12 hrs.

### Example 1.2—[3-(2-Aminoethylamino)propyl]trimethoxysilane grafting

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hrs. [3-(2-Aminoethylamino)propyl]trimethoxysilane was added into the above solution at 2.2 g to 4.5 g (e.g., 8 mmol to 16 mmol, e.g., a silica particle to amine material molar ratio in a range from 5:1 to 10:1). The mixture was heated and stirred at 60° C. or above (e.g., up to 90° C.). The temperature depends on the chosen solvent. The mixture was stirred for 18 hrs. The mixture was cooled to room temperature. The functionalized silica particles were filtered from the solvent and washed twice while stirring with a 40 mL volume of solvent each time. The functionalized silica particles were dried in a vacuum oven at 50° C. for 12 hrs.

### Example 1.3—Bis[3-(trimethoxysilyl)propyl]amine grafting

Using a silane compound having two or more silane moieties (e.g., two trimethoxysilane or triethoxysilane functional groups) in the same molecule, such as for example bis[3-(trimethoxysilyl)propyl]amine, can facilitate a plurality of interactions between silane groups and silica, potentially improving binding stability of the silane bond to the silica surface.

To add bis[3-(trimethoxysilyl)propyl]amine) to the reaction, the same procedure as for [3-(2-aminoethylamino)propyl]trimethoxysilane grafting was followed.

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hrs. [3-(2-Aminoethylamino)propyl]trimethoxysilane was added into the above solution at 2.2 g to 4.5 g (e.g., 8 mmol to 16 mmol, e.g., a silica particle to amine material molar ratio in a range from 5:1 to 10:1). Bis[3-(trimethoxysilyl)propyl]amine) was added into the above solution at 0.68 g (e.g., 2 mmol, a silica particle to bis-amine material ratio of 40:1). The mixture was heated and stirred at 60° C. or above (e.g., up to 90° C.). The temperature depends on the chosen solvent. The mixture was stirred for 18 hrs. The mixture was cooled to room temperature. The functionalized silica particles were filtered from the solvent and washed twice while stirring with a 40 mL volume of solvent each time. The functionalized silica particles were dried in a vacuum oven at 50° C. for 12 hrs.

### Example 1.4—Experimental Results

Functionalized silica produced using the process described herein (e.g., in FIG. 5A or in non-limiting Embodiment A) is characterized by a CO₂ uptake measurement (e.g., using a sample holder as in FIGS. 12A-12B).

FIG. 3 is a line chart depicting the breakthrough adsorption curve for CO₂ adsorbed by a functionalized silica substrate in 48 minutes (mins). The upper curve 302 represents baseline environmental CO₂ concentration in units of ppm. The lower curve 304 represents the outcome CO₂ concentration (in ppm) changing during the adsorption process.

At the beginning of adsorption process (line 304), the sorbent adsorbs CO₂ very quickly, which leads to outcome CO₂ concentration (in ppm) drops very quickly. Then, the CO₂ concentration will increase gradually. The area between the two curves times the flow rate times the adsorption duration (curve integration over time times flow rate) is the total CO₂ adsorbed with the adsorption period (in units of mol). Using the total mol of CO₂ adsorbed divided by the amount of sorbent used in the testing (mass) will provide the value of mol of CO₂ per kg of the sorbent. For the sample shown below, the uptake is 1.5 mol CO₂/kg of sorbent. With proper flow rate against proper amount of sorbent added in the sample hold, CO₂ concentration can be reduced to 0 ppm for large mass, low flow rate case.

### Example 2: Silane and Polymeric Amine Functionalized Porous Silica for Carbon Capture

Examples 2.1 to 2.3 generally relate to a functionalized porous silica and more specifically, to a functionalized porous silica for reversibly capturing carbon dioxide.

### Example 2.1—N1-(3-Trimethoxysilylpropyl)diethylenetriamine and PEI grafting

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hrs. N₁-(3-Trimethoxysilylpropyl)diethylenetriamine was added into the above solution at a molar ratio in a range from 2.3 g to 4.7 g (e.g., 8 mmol to 16 mmol, e.g., a silica particle to amine material molar ratio in a range from 5:1 to 10:1). The mixture was heated and stirred at 60° C. or above (e.g., up to 90° C.). The temperature depends on the chosen solvent. The mixture was stirred for 18 hrs (in some cases, the mixing continued for 24 hrs). The mixture was cooled to room temperature. The functionalized silica particles were filtered from the solvent and washed twice while stirring with a 40 mL volume of solvent each time. The functionalized silica particles were dried in a vacuum oven at 50° C. for 12 hrs. Alternatively, [3-(2-aminoethylamino)propyl]trimethoxysilane may be added to the solution at 2.2 g to 4.5 g (e.g., 8 mmol to 16 mmol, e.g., a silica particle to amine material molar ratio in a range from 5:1 to 10:1).

In a second round bottom flask, 30 mL of methanol or solvent mixture (e.g., cyclohexane:ethanol=2:1), 5 g of silane-treated silica from the above step, and 1.5 g polyethylenimine (PEI) or other second amine (30 wt % to silica) was added. The mixture was stirred for 1 hr. The solvent was dried from the functionalized silica through evaporation, such as on a rotovap, to recover the functionalized silica. The functionalized silica particles were dried in a vacuum oven at 50° C. for 12 hrs. The second step can be performed as a large scale process such as using vacuum drying together with an amine/solvent mixture spraying process.

### Example 2.2—Bis[3-(trimethoxysilyl)propyl]amine grafting

Using a silane compound having two or more silane moieties (e.g., two trimethoxysilane or triethoxysilane functional groups) in the same molecule, such as for example bis[3-(trimethoxysilyl)propyl]amine, can facilitate a plurality of interactions between silane groups and silica, potentially improving binding stability of the silane bond to the silica surface.

To add bis[3-(trimethoxysilyl)propyl]amine) to the reaction, the same procedure as for [3-(2-aminoethylamino)propyl]trimethoxysilane grafting was followed.

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hrs. [3-(2-Aminoethylamino)propyl]trimethoxysilane was added into the above solution at 2.2 g to 4.5 g (e.g., 8 mmol to 16 mmol, e.g., a silica particle to amine material molar ratio in a range from 5:1 to 10:1). Bis[3-(trimethoxysilyl)propyl]amine) was added into the above solution at 0.68 g (e.g., 2 mmol, a silica particle to bis-amine material ratio of 40:1). The mixture was heated and stirred at 60° C. or above (e.g., up to 90° C.). The temperature depends on the chosen solvent. The mixture was stirred for 18 hrs. The mixture was cooled to room temperature. The functionalized silica particles were filtered from the solvent and washed twice while stirring with a 40 mL volume of solvent each time. The functionalized silica particles were dried in a vacuum oven at 50° C. for 12 hrs.

### Example 2.3—Experimental Results

Functionalized silica produced using the process described herein (e.g., in FIG. 5B or in non-limiting Embodiment B) is characterized by a CO₂ uptake measurement (e.g., using a sample holder as in FIGS. 12A-12B).

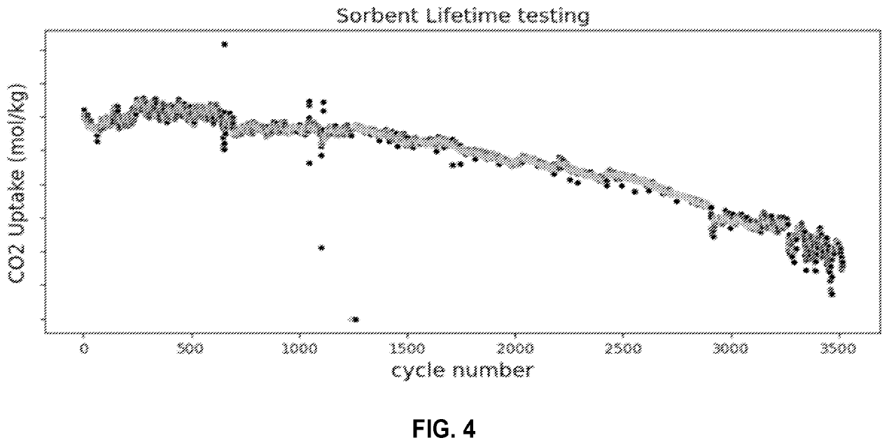

FIG. 4 is a line chart depicting CO₂ uptake in mol CO₂/kg (left y-axis) and CO₂ concentration in parts per million (ppm) of the environmental air (right y-axis) against cycle number, e.g., the number of absorption and desorption cycles, (x-axis). The upper line 402 indicates the total CO₂ uptake of the functionalized silica sample during a single desorption, and the lower line 404 is indicative of the CO₂ concentration as measured by a gas analyzer. The upper line 402 fluctuates around a CO₂ uptake value of about 1.6 mol CO₂/kg.

The CO₂ uptake fluctuates with the CO₂ concentration indicating that increased CO₂ concentration correlates with uptake. The circled data point in the upper line 402 indicates an extended activation time of 2 hrs at 70° C. The extended activation time increased the CO₂ uptake above adjacent data points.

### Example 3: Metal Oxide Framework with Active Hydroxyl Functional Group for Carbon Capture

Examples 3.1 to 3.2 generally relate to a functionalized MOF and more specifically, to a functionalized MOF for reversibly capturing carbon dioxide.

### Example 3.1—MOF Synthesis

In one example, 0.2 g of zirconium tetrachloride (ZrCl₄) can be added to 10 mL of N,N-dimethylformamide (DMF) to create a suspension mixture. 0.16 g of 2-hydroxyterephthalic acid can be added to the suspension mixture. Optionally, 2.4 g of benzoic acid can be added as a modulator. This suspension mixture can be agitated until complete dissolution can be observed.

The suspension mixture can be added to a 20 mL glass vial and placed in a 120° C. oven for 48 hours (hr). The resulting UiO-66-OH MOF crystal powder (having an added hydroxy group) can be cooled and can be washed with fresh DMF and ethanol. The crystal powder can be dried in a 60° C. vacuum oven for 12 hr.

1 g of the obtained UiO-66-OH MOF powder can be suspended in 20 mL of tetrahydrofuran (THF), e.g., at a ratio of 1:20 w/v MOF powder to THF. Optionally, a non-coordinating base such as 2,6-lutidine can be added in excess (3 mL). 0.2 g of tris(dimethylamino)chlorosilane can be added in excess to the available hydroxy groups. The reaction can be heated to 40° C. and maintained for 12 hr to create the silylated MOF. The product can be washed with fresh DMF, followed by a second wash of THF. The silylated MOF can be dried in a 60° C. vacuum oven for 12 hr.

### Example 3.2—Experimental Results

Functionalized MOF produced using the process described herein (e.g., in FIG. 5C or in non-limiting Embodiment C) can be characterized by a CO₂ uptake measurement (e.g., using a sample holder as in FIGS. 12A-12B).

### Example 4: Polymeric Amine Ion-Exchange Resin for Carbon Capture

Examples 4.1 to 4.2 generally relate to a functionalized ion-exchange resin and more specifically, to an ion-exchange resin for reversibly capturing carbon dioxide.

### Example 4.1—Pentaethylenehexamine and PEI Grafting

In a glass vial, a 10 g sample of Purolite© Macronet™ MN502 acidic resin beads (macroporous polystyrene crosslinked with divinylbenzene in the form of spherical beads, commercially available from Purolite©, an Ecolab Inc. company, Saint Paul, MN) functionalized with sulfonic acid groups in a range from 0.7 equivalents per liter (eq/L) to 0.9 eq/L was washed and soaked with 200 mL each of methanol and acetone (e.g., two 200 mL washes, one of methanol and one of acetone).

The resin beads were dried in a 50° C. vacuum oven at 50 mbar for 12 hours. The dried beads were ground with a mortar and pestle and passed through a 250 μm stainless steel mesh sieve.

A solution of 10 mL of methanol, 0.5 g of branched polyethylenimine (weight-average molecular weight (Mw) of 800 daltons, number-average molecular weight (Mn) of 600 daltons), and 0.5 g of pentaethylenehexamine was dispensed into a 20 mL glass vial. 1 g of the sieved powder was dispensed into the glass vial containing the methanol, PEI, and pentaethylenehexamine solution.

The vial was capped and placed on a rotation device (e.g., SCILOGEX SCI-T6-S Analog Tube Roller available from Scilogex, LLC, Rocky Hill, CT) to mix for 12 hr. The functionalized powder was recovered by decanting the liquid solution.

The recovered powder was washed with 15 mL of a 1:1 cyclohexane:MeOH mixture in a centrifuge tube. The washing solution was decanted, and the recovered product was dried in a 50° C. vacuum oven at 50 mbar for 12 hr. Optionally, the washing mixture is centrifuged before the washing solution is decanted.

### Example 4.2—Experimental Results

Functionalized resin produced using the process described herein (e.g., in FIG. 5D or in non-limiting Embodiment D) can be characterized by a CO₂ uptake measurement (e.g., using a sample holder as in FIGS. 12A-12B).

### Example 5: Polymeric Amine Silica Oxide for Carbon Capture

Examples 5.1 to 5.3 generally relate to a functionalized porous silica and more specifically, to a functionalized porous silica for reversibly capturing carbon dioxide.

### Example 5.1—PEI and N-[3-(trimethoxysilyl)propyl]ethylenediamine grafting

In a three-necked round bottom flask, 4.85 g (e.g., 80 mmol) of silica particles was added into 60 mL solvent (e.g., hexane) at ambient temperature. The mixture was heated in reflux conditions (e.g., solvent vapors were trapped by a condenser) to 65° C. (e.g., in a range from 65° C. to 70° C.).

2.3 g of PEI (e.g., 53 mmol) was dissolved in 3 mL of ethanol. The PEI/ethanol mixture was added to the heated silica/solvent mixture. The mixture was stirred for 6 to 18 hours, depending on the PEI molecular weight (in some cases, the mixing continued for 24 hours).

3.6 g (e.g., 16 mmol) of N-[3-(trimethoxysilyl)propyl]ethylenediamine was added to the flask. The mixture was stirred for 16 to 18 hours.

The mixture was cooled to room temperature. The functionalized silica particles were filtered from the solvent and washed while stirring with a 50 mL volume of solvent. Alternatively, the mixture may be centrifuged, and the solvent may be decanted to remove the functionalized silica particles before washing.

### Example 5.2—Bis[3-(trimethoxysilyl)propyl]amine grafting

Using a silane source with two trimethoxysilane or triethoxysilane functional groups on both ends of a molecule, such as for example bis[3-(trimethoxysilyl)propyl]amine, could facilitate two points at which silane groups bond to the silica, potentially improving binding stability of the silane bond to the silica surfaces.

To add bis[3-(trimethoxysilyl)propyl]amine) to the reaction, the same procedure as for n-[3-(trimethoxysilyl)propyl]ethylenediamine grafting was followed.

In a three-necked round bottom flask, 4.85 g (e.g., 80 mmol) of silica particles was added into 60 mL of solvent (e.g., hexane) at ambient temperature. The mixture was heated in reflux conditions (e.g., solvent vapors were trapped by a condenser) to 65° C. (e.g., in a range from 65° C. to 70° C.).

2.3 g of PEI (e.g., 53 mmol) was dissolved in 3 mL of ethanol. The PEI/ethanol mixture was added to the heated silica/solvent mixture. The mixture was stirred for 6 to 18 hours, depending on the PEI molecular weight (in some cases, the mixing continued for 24 hours).

3.6 g (e.g., 16 mmol) of N-[3-(trimethoxysilyl)propyl]ethylenediamine and 0.68 g of bis[3-(trimethoxysilyl)propyl]amine) (e.g., 2 mmol, a silica particle to bis-amine material ratio of 40:1) were added to the flask. The mixture was stirred for 16 to 18 hours.

The mixture was cooled to room temperature. The functionalized silica particles were filtered from the solvent and washed while stirring with a 50 mL volume of solvent. Alternatively, the mixture may be centrifuged, and the solvent can be decanted to remove the functionalized silica particles before washing.

### Example 5.3—Experimental Results

Functionalized silica produced using the process described herein (e.g., in FIG. 5E or in non-limiting Embodiment E) can be characterized by a CO₂ uptake measurement (e.g., using a sample holder as in FIGS. 12A-12B).

### Example 6: Porous Silica Including Polymeric Amine and Silane for Carbon Capture from Water-Based Methods

Examples 6.1 to 6.3 generally relate to a functionalized porous silica and more specifically, to a functionalized porous silica for reversibly capturing carbon dioxide.

### Example 6.1—Coating 50 g Silica with Polymeric Amine and Silane Compound

In a large beaker, 200 mL of water was stirred (e.g., 4:1 weight ratio water to silica). 10 g of PEI was added to the water and stirred (e.g., 20% (wt/wt) of PEI relative to silica). Aminosilane material was added to the PEI/water mixture in a range from 30 g (60% (wt/wt) relative to silica). The mixture was stirred for 5 min to allow hydrolysis.

50 g dry silica oxide material was added to the mixture solution. The sample of silica oxide material had a pore volume of greater than 0.7 mL/g. The mixture was stirred until the silica was distributed in the solution. The solution was stirred at room temperature for 10 minutes such that the liquid mixture was absorbed by silica.

The silica/water was dried on rotoevaporation equipment to remove residual water and recover wet silica solids. The wet silica solid was placed in an oven at 120° C. for between 5 minutes and 20 minutes.

### Example 6.2—Bis[3-(trimethoxysilyl)propyl]amine grafting

Using a silane source with two trimethoxysilane or triethoxysilane functional groups on both ends of a molecule, such as for example bis[3-(trimethoxysilyl)propyl]amine, facilitates two points at which silane groups bond to the silica, potentially improving binding stability of the silane bond to the silica surfaces.

To add Bis[3-(trimethoxysilyl)propyl]amine) to the reaction, the same procedure as for other aminosilane grafting was followed.

In a large beaker, 200 mL of water was stirred (e.g., 4:1 weight ratio water to silica). 10 g of PEI was added to the water and stirred (e.g., 20% (wt/wt) of PEI relative to silica). Aminosilane material was added to the PEI/water mixture in a range from 30 g to 40 g (60%-80% (wt/wt) relative to silica). Bis[3-(trimethoxysilyl)propyl]amine) was added to the PEI/water mixture in a range from 5 g to 10 g (10-20% (wt/wt) relative to silica). The mixture was stirred for 5 min to allow hydrolysis.

50 g dry silica oxide material was added to the mixture solution. The sample of silica oxide material had a pore volume of greater than 0.7 mL/g. The mixture was stirred until the silica was distributed in the solution. The solution was stirred at room temperature for 10 min such that the liquid mixture was absorbed by silica.

The silica/water was dried on rotoevaporation equipment to remove residual water and recover wet silica solids. The wet silica solid was placed in an oven at 120° C. for between 5 and 20 minutes.

### Example 6.3—Experimental Results

Functionalized silica produced using the process described herein (e.g., in FIG. 5F or in non-limiting Embodiment F) can be characterized by a CO₂ uptake measurement (e.g., using a sample holder as in FIGS. 12A-12B).

### Example 7: Polymeric Amine Porous Silica for Carbon Capture

Examples 7.1 to 7.2 generally relate to a functionalized porous silica and more specifically, to a functionalized porous silica for reversibly capturing carbon dioxide.

### Example 7.1—PEI Grafting

In a large beaker, 50 g of silica is dispersed in 100 mL methanol. The whole mixture is stirred gently for 10 minutes. Then, 12.5 g of PEI is added to the above mixture, and the whole mixture is allowed to be absorbed by silica.

The silica/methanol was dried on rotoevaporation equipment to remove residual methanol and recover wet silica solids. The wet silica solid was placed in a vacuum oven at 70° C. overnight.

### Example 7.2—Experimental Results

Functionalized silica produced using the process described herein (e.g., in FIG. 5G or in non-limiting Embodiment G) can be characterized by a CO₂ uptake measurement (e.g., using a sample holder as in FIGS. 12A-12B).

### Example 8: Small Molecule Polyamine Functionalized Porous Silica for Carbon Capture

Examples 8.1 to 8.2 generally relate to a functionalized porous silica and more specifically, to a functionalized porous silica for reversibly capturing carbon dioxide.

### Example 8.1—Amix 1000 Grafting

In a large beaker, 50 g of silica is dispersed in 100 mL methanol. The whole mixture is stirred gently for 10 mins. Then, 12.5 g to 25 g (25 wt % to 50 wt %) of Amix 1000 is added to the above mixture, and the whole mixture is allowed to be absorbed by silica.

The silica/methanol was dried on rotoevaporation equipment to remove residual methanol and recover wet silica solids. The wet silica solid was placed in a vacuum oven at 70° C. overnight.

### Example 8.2—Experimental Results

Functionalized silica produced using the process described herein (e.g., in FIG. 5H or in non-limiting Embodiment H) can be characterized by a CO₂ uptake measurement (e.g., using a sample holder as in FIGS. 12A-12B).

### Example 9: Dip Coating Method of Producing Polymeric Amine and Silane Functionalized Porous Silica

Example 9.1 generally relates to a functionalized porous silica and more specifically, to a functionalized porous silica for reversibly capturing carbon dioxide.

### Example 9.1—Experimental Results

Functionalized silica produced using the process described herein (e.g., in FIG. 5I or in non-limiting Embodiment I) can be characterized by a CO₂ uptake measurement (e.g., using a sample holder as in FIGS. 12A-12B).

### Example 10: Non-Limiting Aqueous Solvent-Based Method

This is a non-limiting example for aqueous solvent-based reactions, in which the first reagent and second reagent are added in one step and then excess solution is removed at the end. In a 1 L beaker, 11.5 g of PEI and 53 g of N-[3-(trimethoxysilyl)propyl]ethylenediamine are added into 260 mL of water. Then, the solution is stirred (e.g., for at least 10 mins) to allow the solution to mix well and to fully dissolve PEI into the water. Then, 100 g of the silica is poured into the solution. In order to avoid breaking down of the silica particles, gentle agitation is applied slowly and/or periodically for at least 10 mins to allow the solution to diffuse into the silica. After that, excess liquid can be decanted, or the functionalized silica particles can be filtered from the solution. Then, the functionalized silica particles can be dried, e.g., in a vacuum oven for 12 hrs at 60° C.

### Example 11: Non-Limiting Aqueous Solvent-Based Method

This is another non-limiting example for aqueous solvent-based reactions, in which the first reagent and second reagent are added in one step without removing the excess solution at the end. In a 1 L beaker, 7.7 g of PEI and 36 g of N-[3-(trimethoxysilyl)propyl]ethylenediamine are added into 160 mL of water. Then, the solution is stirred (e.g., for at least 10 mins) to allow the solution to mix well and to fully dissolve PEI into the water. Then, 100 g of the silica is poured into the solution. In order to avoid breaking down the silica particles, gentle agitation is applied slowly and/or periodically for at least 10 mins to allow the solution to diffuse into the silica. After that, the functionalized silica particles can be directly dried, e.g., in a vacuum oven for 12 hrs at 60° C.

### Non-Limiting Embodiment A

A1. A composition comprising:
porous silica particles, and
a compound comprising a silane moiety and an amine moiety, the silane moiety of the compound being chemically bonded to a surface of each of the porous silica particles.

A2. The composition of embodiment A1, wherein the composition adsorbs atmospheric CO₂ in a first temperature range and desorbs previously adsorbed CO₂ in a second temperature range higher than the first temperature range.

A3. The composition of embodiment A2, wherein the composition adsorbs atmospheric CO₂ at a first gas pressure and desorbs previously adsorbed CO₂ at a second gas pressure lower than the first gas pressure.

A4. The composition of embodiment A2, wherein the composition adsorbs atmospheric CO₂ at a first CO₂ concentration, and desorbs previously adsorbed CO₂ at a second CO₂ concentration lower than the first CO₂ concentration.

A5. The composition of embodiment A1, wherein the composition consists essentially of the porous silica particles and the compound.

A6. The composition of embodiment A1, wherein the porous silica particles comprises a plurality of pores.

A7. The composition of embodiment A6, wherein the plurality of pores have a diameter in a range from 60 to 400 angstroms or from 1 to 200 nm.

A8. The composition of embodiment A6, wherein the plurality of pores have a volume greater than 0.5 mL/g.

A9. The composition of embodiment A1, wherein the porous silica particles have a total surface area greater than 100 m² per dry gram.

A10. The composition of embodiment A1, wherein the composition adsorbs between 0.5 mol to 2 mol of CO₂ per dry kilogram adsorbent.

A11. The composition of embodiment A1, wherein the composition adsorbs CO₂ at a relative humidity in a range from 5% to 95% relative humidity.

A12. The composition of embodiment A2, wherein the second temperature range is in a range from 65° C. to 90° C.

A13. The composition of embodiment A3, wherein the second gas pressure is below 1.5 psi or 2 psi.

A14. The composition of embodiment A1, wherein the first CO₂ concentration is below 420 ppm.

A15. The composition of embodiment A1, wherein the compound comprises one to three silane moieties.

A16. The composition of embodiment A1, wherein the silane moiety comprises methoxysilane, ethoxysilane, alkoxysilane, chlorosilane, alkoxysilanol, a silanetriol, or an amino silane oligomer.

A17. The composition of embodiment A1, wherein the amine moiety is a primary, secondary or tertiary amine group.

A18. The composition of embodiment A1, wherein the compound comprises more than one amine moiety.

A19. The composition of embodiment A1, wherein the compound comprises (3-aminopropyl)trimethoxysilane, (3-aminopropyl)triethoxysilane, [3-(2-aminoethylamino)propyl]trimethoxysilane, N1-(3-trimethoxysilylpropyl) diethylenetriamine, 3-aminopropylsilanetriol, N-(2-aminoethyl)-3-aminopropylsilanetriol, tris(ethylmethylamino)chlorosilane, tris(dimethylamino) chlorosilane, or an amino silane oligomer (e.g., such as VPS SIVO 280 from Evonik).

A20. The composition of embodiment A1, further comprising an antioxidant moiety at a weight ratio of 5% to porous silica particles.

A21. The composition of embodiment A20, wherein the antioxidant moiety is an organic sulfur-containing compound selected from a list comprising 2,2-thiodiethanol, 2-hydroxyethyl disulfide, and 3,3′-dithiodipropionic acid.

A22. A method, comprising:
introducing a first reagent comprising a first compound comprising a silane moiety and an amine moiety into a liquid mixture comprising a liquid and porous silica particles under conditions sufficient to cause the silane moiety of the first compound to chemically bond to a surface of the porous silica particles to form modified silica particles; and
removing the modified silica particles from the liquid.

A23. The method of embodiment A22, wherein the liquid mixture comprises the liquid and the porous silica particles at a ratio of at least 5 mL/g or from 0.5 to 3 mL/g.

A24. The method of embodiment A22, wherein the second reagent is added to the liquid mixture at a molar ratio in a range from 5:1 to 10:1 of porous silica particles to the first reagent or at a 20% to 80% (wt/wt) ratio of the second reagent to porous silica particles.

A25. The method of embodiment A22, wherein the liquid comprises an organic solvent selected from a list comprising toluene, hexane, cyclohexane, or tetrahydrofuran.

A26. The method of embodiment A22, further comprising:
after removing the modified silica particles from the liquid, introducing a second liquid to the modified silica particles for a duration; and
removing the modified silica particles from the second liquid.

A27. The method of embodiment A26, wherein the second liquid comprises a second volume of the liquid.

A28. The method of embodiment A22 or embodiment A26, further comprising: drying the modified silica particles in a vacuum oven at 50° C. until a hydration threshold is reached.

A29. The method of embodiment A22, further comprising, after introducing the first reagent into the liquid mixture, agitating the liquid mixture, and introducing the second reagent occurs during the agitating.

A30. The method of embodiment A22 or embodiment A29, further comprising heating the liquid mixture after introducing the second reagent to a first temperature for a duration longer than 6 hours.

A31. The method of embodiment A30, further comprising, after heating, cooling the liquid mixture.

A32. A composition comprising porous silica particles modified according to the method of embodiment A22.

A33. A method, comprising using the composition of embodiment A1 to remove atmospheric CO₂ from air by direct air capture.

A34. The composition of embodiment A1, wherein the compound further comprises a hydrophobic compound.

A35. The composition of embodiment A34, wherein the hydrophobic compound is a hydrophobic silane compound or a hydrophobic polymer.

A36. The composition of embodiment A35, wherein the hydrophobic silane compound comprises a silane molecule (e.g., a silane moiety) and one, two, or three alkyl chains.

A37. The composition of embodiment A36, wherein the hydrophobic polymer comprises polydimethylsiloxane (PDMS), silicone oil, polyethylene, polytetrafluorethylene, or polyurethane.

A38. The composition of embodiment A1, further comprising BTMSPA.

A39. The composition of embodiment A1, further comprising an antioxidant at a weight ratio of 5% to 10% (wt/wt) to porous silica particles.

A40. The composition of embodiment A39, wherein the antioxidant is an organic sulfur-containing compound selected from a list comprising 2,2-thiodiethanol, 2-hydroxyethyl disulfide, and 3,3′-dithiodipropionic acid; or wherein the antioxidant is a metal catalyst chelator.

### Non-Limiting Embodiment B

B1. A composition comprising:
porous silica particles;
a first compound comprising an silane moiety and at least one amine moiety, wherein the silane moiety is bonded to a surface of the porous silica particles, an amine moiety of the at least one amine moiety is chemically bonded to the silane moiety; and
a second compound comprising at least two amine moieties, wherein the second compound is chemically bonded to the amine moiety of the first compound.

B2. The composition of embodiment B1, wherein the porous silica particles comprise a plurality of pores.

B3. The composition of embodiment 82, wherein the pores have a size in a range from 60 to 400 angstroms or from 1 to 200 nm.

B4. The composition of embodiment B2, wherein the pores have a size in a range from 100 to 150 angstroms or from 1 to 200 nm.

B5. The composition of embodiment B2, wherein the plurality of pores have a volume greater than 0.5 mL/g.

B6. The composition of embodiment B1, wherein the silane moiety is selected from a group comprising an alkoxysilane moiety (e.g., methoxysilane or ethoxysilane), a trihalosilane moiety, a dihalosilane moiety, a monohalosilane moiety, a silanetriol moiety, a dialkoxysilanol moiety, a monoalkoxysilanol moiety, or an aminosilane oligomer.

B7. The composition of embodiment 81, wherein the first compound is selected from a group comprising (3-aminopropyl)trimethoxysilane, (3-aminopropyl) triethoxysilane, [3-(2-aminoethylamino)propyl]trimethoxysilane, N1-(3-trimethoxysilylpropyl)diethylenetriamine, 3-aminopropylsilanetriol, N-(2-aminoethyl)-3-aminopropylsilanetriol, tris(ethylmethylamino)chlorosilane, tris(dimethylamino) chlorosilane, or an amino silane oligomer (e.g., such as VPS SIVO 280 from Evonik).

B8. The composition of embodiment B1, wherein the second compound is a polymeric amine.

B9. The composition of embodiment B8, wherein the second compound is a linear or a branched polymeric amine.

B10. The composition of embodiment B9, wherein the second compound is selected from a group comprising polyethylenimine (PEI), polypropylenimine, tetraethylenepentamine (TEPA), triethylenetetramine (TETA), diethanolamine, a polyamine, or a large molecule weight amine mixture (e.g., BASF Amix 1000).

B11. The composition of embodiment B1, the porous silica particles having an average diameter of in a range from 25 μm to 1 mm or from 25 μm to 4 mm.

B12. The composition of embodiment B1, wherein the amine moiety of the first compound and the amine moiety of the second compound are reactable with carbon dioxide.

B13. The composition of embodiment B1, wherein the composition adsorbs between about 0.5 mol to 2 mol of CO₂ per dry kilogram.

B14. The composition of embodiment B1, wherein the composition desorbs between about 65° C. to 90° C.

B15. The composition of embodiment B1, wherein the composition adsorbs CO₂ at a relative humidity in a range from 5% to 95% relative humidity.

B16. A composition, comprising:
porous silica particles having a greatest dimension in a range from 70 microns to 80 microns, the porous silica particles comprising a plurality of pores, the plurality of pores having a volume greater than 0.8 mL/g and a size of at least 90 angstroms;
a first compound comprising an silane moiety and at least one amine moiety, wherein the silane moiety is bonded to a surface of the porous silica particles, an amine moiety of the at least one amine moiety is chemically bonded to the silane moiety; and
a second compound comprising at least two amine moieties where the second compound is chemically bonded to the amine moiety of the first compound.

B17. A method, comprising:
introducing a first reagent comprising a first compound comprising a silane moiety and an amine moiety into a first liquid mixture comprising a liquid and porous silica particles under conditions sufficient to cause the silane moiety of the first compound to chemically bond to a surface of the porous silica particles to form modified silica particles;
removing the modified silica particles from the liquid;
drying the modified silica particles in a vacuum oven until a hydration threshold is reached;
introducing a second reagent comprising a second compound comprising a polymeric amine into a second liquid mixture comprising a second liquid and the modified silica particles under conditions sufficient to cause an amine moiety of the second compound to chemically bond to the amine moiety of the first compound to form functionalized silica oxide particles; and
removing the functionalized silica oxide particles from the second liquid.

B18. The method of embodiment B17, wherein the functionalized silica oxide particles are for use in the removal of carbon dioxide from a fluid.

B19. The method of embodiment B17, wherein the liquid comprises methanol, cyclohexane, or ethanol or water.

B20. The method of embodiment B19, wherein the liquid comprises cyclohexane and ethanol at a mixture ratio in a range from 1:1 to 5:1 by volume.

B21. The method of embodiment B17, wherein the functionalized silica oxide particles comprises (3-aminopropyl)trimethoxysilane, (3-aminopropyl)triethoxysilane, [3-(2-aminoethylamino)propyl]trimethoxysilane, N1-(3-trimethoxysilylpropyl) diethylenetriamine, 3-aminopropylsilanetriol, N-(2-aminoethyl)-3-aminopropylsilanetriol, tris(ethylmethylamino)chlorosilane, tris(dimethylamino) chlorosilane, or an amino silane oligomer (e.g., such as VPS SIVO 280 from Evonik).

B22. The method of embodiment B17, further comprising: drying the functionalized silica oxide particles in a vacuum oven at 50° C. until a hydration threshold is reached.

B23. The method of embodiment B17, wherein the removing the functionalized silica oxide particles from the second liquid comprises evaporating the second liquid from the functionalized silica oxide particles.

B24. The method of embodiment B17, wherein the second compound is included in the second liquid mixture at a range from 10% to 50% (wt/wt) second compound to silica oxide material.

B25. The method of embodiment B17, wherein the second compound is included in the liquid mixture at about 30% (wt/wt) second compound to silica oxide material.

B26. A composition comprising porous silica particles modified according to the method of embodiment B17.

B27. A method, comprising using the composition of embodiment 81 to remove atmospheric CO₂ from air by direct air capture.

B28. The composition of embodiment B1 or embodiment B16, further comprising an antioxidant at a weight ratio of 5% to porous silica particles.

B29. The composition of embodiment B28, wherein the antioxidant moiety is organic sulfur-containing compound selected from a list comprising 2,2-thiodiethanol, 2-hydroxyethyl disulfide, and 3,3′-dithiodipropionic acid.

B30. The composition of embodiment B1, wherein the compound further comprises a hydrophobic compound.

B31. The composition of embodiment B30, wherein the hydrophobic compound is a hydrophobic silane compound or a hydrophobic polymer.

B32. The composition of embodiment B31, wherein the hydrophobic silane compound comprises a silane molecule and one, two, or three alkyl chains.

B33. The composition of embodiment B32, wherein the hydrophobic polymer comprises polydimethylsiloxane (PDMS), silicone oil, polyethylene, polytetrafluorethylene, or polyurethane.

B34. The composition of embodiment B1, further comprising BTMSPA.

### Non-Limiting Embodiment C

C1. A composition, comprising:
metal oxide framework (MOF) particles comprising a metal source and an organic ligand including at least one hydroxyl group, the organic ligand chemically bonded to the metal source; and
a compound comprising at least one amine moiety, the compound being chemically bonded to the hydroxyl group of each of the metal oxide framework particles,
wherein, when exposed to atmospheric CO₂ while in a first temperature range, the composition adsorbs CO₂ to the at least one amine moiety and, while in a second temperature range, desorbs previously adsorbed CO₂ from the at least one amine moiety, the second temperature range being higher than the first temperature range.

C2. The composition of embodiment C1, wherein the composition is formulated to adsorb CO₂ to the at least one amine moiety at a first gas pressure and desorb previously adsorbed CO₂ from the at least one amine moiety at a second gas pressure lower than the first gas pressure.

C3. The composition of embodiment C2, wherein the second gas pressure is below 0.3 psi.

C4. The composition of embodiment C1, wherein the composition is formulated to adsorb atmospheric CO₂ to the at least one amine moiety at a first CO₂ concentration, and desorb previously adsorbed CO₂ from the at least one amine moiety at a second CO₂ concentration lower than the first CO₂ concentration.

C5. The composition of embodiment C4, wherein the first CO₂ concentration is below 400 ppm or below 500 ppm.

C6. The composition of embodiment C1, wherein the composition consists essentially of the MOF particles and the compound.

C7. The composition of embodiment C1, wherein the MOF particles comprise a plurality of pores.

C8. The composition of embodiment C7, wherein the plurality of pores have a dimension in a range from about 60 to 400 angstroms.

C9. The composition of embodiment C8, wherein the plurality of pores have a volume greater than 0.5 mL/g.

C10. The composition of embodiment C1, wherein the MOF particles have a total surface area greater than 100 m² per dry gram.

C11. The composition of embodiment C1, wherein, for the first temperature range, the composition has a CO₂ adsorbent capacity from 0.5 mol to 2 mol of CO₂ per dry kilogram.

C12. The composition of embodiment C1, wherein the composition is formulated to adsorb CO₂ to the at least one amine moiety when the composition is exposed to an environment having a relative humidity in a range from 5% to 60% relative humidity.

C13. The composition of embodiment C1, wherein the second temperature range is in a range from 65° to 90° C.

C14. The composition of embodiment C1, wherein the organic ligand is 1,4-di-(4-carboxy-2,6-dihydroxyphenyl)benzene and the metal source is Zn(NO₃)₂·6H₂O.

C15. The composition of embodiment C1, wherein the metal source is an iron-based metal source, an aluminum-based metal source, a titanium-based metal source, a zinc-based metal source, or a zirconium-based metal source.

C16. The composition of embodiment C15, wherein the MOF particles are selected from a list comprising MIL-101-Fe, MIL-101-AI, MIL-125-Ti, PCN-250, UIO-66, or UIO-67.

C17. The composition of embodiment C1, wherein the organic ligand is 2-hydroxyterephthalic acid, 2,5-dihydroxyterephthalic acid, 2,3-dihydroxyterephthalic acid, or a 2-boronobenzene-1,4-dicarboxylic acid.

C18. The composition of embodiment C1, wherein the MOF particles are water-stable MOF particles.

C19. The composition of embodiment C1, wherein the compound comprises a methoxysilane moiety or ethoxysilane moiety chemically bonded to at least one amine moiety.

C20. A composition, comprising:
metal oxide framework (MOF) particles comprising Zn(NO₃)₂·6H₂O and an organic ligand comprising 1,4-di-(4-carboxy-2,6-dihydroxyphenyl)benzene comprising at least one hydroxyl group, the organic ligand chemically bonded to the metal source and the hydroxyl group being unbound from the metal source; and
a compound comprising tris(ethylmethylamino)chlorosilane wherein the tris(ethylmethylamino)chlorosilane comprises a silane moiety being chemically bonded to the hydroxyl group of the 1,4-di-(4-carboxy-2,6-dihydroxyphenyl)benzene,
wherein, when exposed to atmospheric CO₂ while in a first temperature range, the composition adsorbs CO₂ to the at least one amine moiety and, while in a second temperature range, desorbs previously adsorbed CO₂ from the at least one amine moiety, the second temperature range being higher than the first temperature range and in a range from 65° C. to 90° C.

C21. A method, comprising:
introducing a first reagent comprising a metal source, and a second reagent comprising a ligand and a functional group into a liquid under conditions sufficient to cause a reaction between the first reagent and second reagent to create metal oxide framework particles;
after creating metal oxide framework particles, introducing a third reagent comprising an amine moiety to the liquid under conditions sufficient to cause the third reagent to chemically bond to the second reagent to form modified metal oxide framework particles; and
removing the modified metal oxide framework particles from the liquid.

C22. The method of embodiment C21, wherein the liquid is a polar solvent.

C23. The method of embodiment C21, wherein the polar solvent is water, DMAc, DMF, DEF, methanol, ethanol, or DMSO.

C24. The method of embodiment C21, further comprising: introducing a fourth reagent comprising a competing agent with the first reagent and the second reagent.

C25. The method of embodiment C24, wherein the fourth reagent comprises a non-coordinating base.

C26. The method of embodiment C25, wherein the non-coordinating base is 2,6-lutidine, N,N-diisopropylethylamine, triethylamine, 2-tert-butylimino-2-diethylamino-1,3-dimethylperhydro-1,3,2-diazaphosphorine, or 1,8-diazabicyclo[5.4.0]undec-7-ene.

C27. The method of embodiment C21, wherein the third reagent comprises a silane compound having at least one amine moiety chemically bonded to the silane compound.

C28. The method of embodiment C27, wherein the silane compound is tris(ethylmethylamino)chlorosilane, tris(dimethylamino)chlorosilane, bis(3-(methylamino)propyl)trimethoxysilane, N-[3-(trimethoxysilyl)propyl]aniline, (N,N-dimethylaminopropyl)trimethoxysilane, 3-aminopropyl(diethoxy)methylsilane, bis[3-(trimethoxysilyl)propyl]amine, (3-aminopropyl)triethoxysilane, (3-aminopropyl) trimethoxysilane, N-[3-(trimethoxysilyl)propyl]ethylenediamine, N1-(3-trimethoxysilyl propyl)diethylenetriamine, or [3-(2-aminoethylamino)propyl]trimethoxysilane.

C29. The method of embodiment C21, further comprising:
before introducing the third reagent, removing the metal oxide framework particles from the liquid, introducing a second liquid to the metal oxide framework particles for a duration, and
removing the metal oxide framework particles from the second liquid.

C30. The method of embodiment C29, wherein the second liquid comprises a second volume of the liquid.

C31. The method of embodiment C21 or embodiment C29, further comprising:
drying the modified metal oxide framework particles until a hydration threshold is reached.

C32. A method, comprising:
introducing a first reagent comprising Zn(NO₃)₂·6H₂O, and a second reagent comprising into a polar solvent liquid under conditions sufficient to cause a reaction between the first reagent and second reagent to create metal oxide framework particles;
removing the metal oxide framework particles from the liquid; introducing a second polar solvent liquid to the metal oxide framework particles for a duration;
removing the metal oxide framework particles from the second liquid; introducing a third polar solvent liquid to the metal oxide framework particles for a duration;
introducing a third reagent comprising tris(ethylmethylamino)chlorosilane to the third liquid under conditions sufficient to cause the third reagent to chemically bond to the second reagent to form modified metal oxide framework particles; and
removing the modified metal oxide framework particles from the liquid.

C33. A composition comprising porous metal oxide framework particles modified according to the method of embodiment C21.

### Non-Limiting Embodiment D

D1. A composition, comprising:
ion-exchange resin particles, wherein the ion-exchange resin particles are sufficiently cross-linked to retain porosity sufficient to facilitate gas diffusion and adsorption when dry; and
a compound comprising at least one amine moiety, the compound being chemically bonded to the ion-exchange resin particles to create functionalized ion-exchange resin particles.

D2. The composition of embodiment D1, wherein the ion-exchange resin particles comprise a base-functionalized resin, an acid-functionalized resin, or a neutral resin comprising no chemical functionalization.

D3. The composition of embodiment D2, wherein the acid-functionalized resin comprises carboxylic and/or sulfonic acid groups.

D4. The composition of embodiment D1, wherein a morphology of the ion-exchange resin particles comprises beads, granules, powders, membranes, and/or fibers.

D5. The composition of embodiment D1, wherein the ion-exchange resin particles are a porous polystyrene, polyacrylamide, or phenol-formaldehyde resin that retains its porosity when dry combined with a molecular alkyl amine.

D6. The composition of embodiment D5, wherein the ion-exchange resin particles are selected from a list comprising Purolite® A110 (Polystyrenic Macroporous, Weak Base Anion Resin, Free Base form), Purolite® A105 (Polystyrenic Macroporous, Weak Base Anion Resin, Free Base form), Purolite® C145H (Polystyrenic Macroporous, Strong Acid Cation Resin, Hydrogen form), Purolite® C160H (Polystyrenic Macroporous, Strong Acid Cation Resin, Hydrogen form), Purolite® Macronet™ MN502 (Hyper-crosslinked Polystyrenic Macroporous, Adsorbent Resin, Strong Acid Functionality, Hydrogen form), Purolite® C104Plus (Polyacrylic Porous, Weak Acid Cation Resin, Hydrogen form), PuroSorb™ PAD900 (Polydivinylbenzene Macroporous, Adsorbent Resin, Non-Ionic form), Amberlite® IRA-402 (strongly basic anion exchanger) Cl⁻ form, or Dowex® 50W-X8 (strongly acidic cation exchanger, H⁺ form).

D7. The composition of embodiment D1, wherein the compound comprises amine-based polymers, polyethylenimines (PEIs), molecular ethylamines, amine-functionalized hydrocarbons, silylamines, or any combination thereof.

D8. The composition of embodiment D7, wherein the silylamines comprise (3-aminopropyl)trimethoxysilane, [3-(2-aminoethylamino)propyl]trimethoxysilane, or N1-(3-trimethoxysilylpropyl)diethylenetriamine.

D9. The composition of embodiment D7, wherein the amine-functionalized hydrocarbons comprise ethanolamine, hexylamine, or 1,6-hexanediamine.

D10. The composition of embodiment D7, wherein the polymers comprise polypropylenimine, natural chitosan, polylysine, or large molecule amine mixture (e.g., BASF Amix 1000).

D11. The composition of embodiment D7, wherein the molecular ethylamines comprise mono, di-, tri-, tetra-, penta-, and/or larger ethylamines.

D12. The composition of embodiment D11, wherein the molecular ethylamines comprise tetraethylenepentamine (TEPA), triethylenetetramine (TETA), or pentaethylenehexamine (PEHA).

D13. The composition of embodiment D1, wherein the composition is formulated to adsorb atmospheric CO₂ at a first gas pressure and desorbs previously adsorbed CO₂ at a second gas pressure lower than the first gas pressure.

D14. The composition of embodiment D1, wherein the composition is formulated to, when exposed to atmospheric CO₂ while in a first temperature range, adsorb CO₂ to the at least one amine moiety and, while in a second temperature range, desorbs previously adsorbed CO₂ from the at least one amine moiety, the second temperature range being higher than the first temperature range.

D15. The composition of embodiment D13, wherein the second gas pressure is below 0.3 psi.

D16. The composition of embodiment D13, wherein the composition is formulated to adsorb atmospheric CO₂ to the at least one amine moiety at a first CO₂ concentration, and desorbs previously adsorbed CO₂ from the at least one amine moiety at a second CO₂ concentration lower than the first CO₂ concentration.

D17. The composition of embodiment D16, wherein the first CO₂ concentration is below 400 ppm.

D18. The composition of embodiment D1, wherein the ion-exchange resin particles are porous ion-exchange resin particles.

D19. The composition of embodiment D18, wherein the porous ion-exchange resin particles each comprise a plurality of pores having a dimension in a range from about 60 to 400 angstroms.

D20. The composition of embodiment D19, wherein the plurality of pores have a volume greater than 0.5 mL/g.

D21. The composition of embodiment D1, wherein the ion-exchange resin particles have a total surface area greater than 100 m² per dry gram.

D22. The composition of embodiment D14, wherein, for the first temperature range, the composition has a CO₂ adsorbent capacity from 0.5 mol to 2 mol of CO₂ per dry kilogram adsorbent.

D23. The composition of embodiment D1, wherein the composition is formulated to adsorb CO₂ to the at least one amine moiety when the composition is exposed to an environment having a relative humidity in a range from 5% to 60% relative humidity.

D24. The composition of embodiment D14, wherein the second temperature range is in a range from 65° to 90° C.

D25. A composition, comprising:
ion-exchange resin particles having a plurality of pores, wherein the ion-exchange resin particles are sufficiently cross-linked to retain porosity sufficient to facilitate gas diffusion and adsorption when dry, and the plurality of pores have a volume greater than 0.5 mL/g and a dimension in a range from 60 angstroms to 400 angstroms; and
a compound comprising at least one amine moiety, the compound being chemically bonded to the ion-exchange resin particles to create functionalized ion-exchange resin particles, wherein the functionalized ion-exchange resin particles are formulated to adsorb CO₂ and have a CO₂ adsorbent capacity of 2 mol of CO₂ per dry kilogram adsorbent.

D26. A method, comprising:
combining a first reagent comprising porous resin particles and a second reagent comprising an amine moiety under conditions sufficient to cause a reaction between the first reagent and second reagent to create functionalized porous resin particles,
wherein, when exposed to atmospheric CO₂ while in a first temperature range, the functionalized porous resin particles adsorb CO₂ and, while in a second temperature range, desorb previously adsorbed CO₂, the second temperature range being higher than the first temperature range.

D27. The method of embodiment D26, wherein introducing the first reagent and the second reagent comprises spraying the second reagent onto the porous resin particles.

D28. The method of embodiment D27, wherein introducing the first reagent and the second reagent comprises exposing the first reagent to the second reagent in a gas phase.

D29. The method of embodiment D27, wherein introducing the first reagent and the second reagent comprises forming a solution comprising the first reagent and the second reagent and recovering the functionalized ion-exchange resin particles from the solution.

D30. The method of embodiment D29, further comprising:
recovering the functionalized porous resin particles;
introducing a liquid to the functionalized porous resin particles for a duration; and
recovering the functionalized porous resin particles from the liquid.

D31. The method of embodiment D29 or embodiment D30, further comprising drying the functionalized porous resin particles until a hydration threshold is reached.

D32. The method of any one of embodiments D27, D31, or D29, wherein the liquid or the second liquid is ethanol or methanol.

D33. A method, comprising:
combining a first reagent comprising porous resin particles and a second reagent comprising an amine moiety under conditions sufficient to cause a reaction between the first reagent and second reagent to create functionalized porous resin particles;
recovering the functionalized ion-exchange resin particles from the solution; and
drying the functionalized porous resin particles until a hydration threshold is reached,
wherein, when exposed to atmospheric CO₂ while in a first temperature range, the functionalized porous resin particles adsorb CO₂ and, while in a second temperature range, desorb previously adsorbed CO₂, the second temperature range being higher than the first temperature range.

D34. A composition comprising porous ion-exchange resin particles modified according to the method of embodiment D26.

D35. A method, comprising using the composition of embodiment D1 to remove atmospheric CO₂ from air by direct air capture.

### Non-Limiting Embodiment E

E1. A composition, comprising:
porous silica particles;
a first compound comprising an alkoxysilane moiety and at least one amine moiety, wherein the alkoxysilane moiety is bonded to a surface of the porous silica particles, an amine moiety of the at least one amine moiety is chemically bonded to the alkoxysilane moiety; and
a second compound comprising at least two amine moieties, wherein the second compound is chemically bonded to the amine moiety of the first compound.

E2. The composition of embodiment E1, wherein the porous silica particles comprise a plurality of pores.

E3. The composition of embodiment E2, wherein the pores have a size in a range from 60 to 400 angstroms or from 1 to 200 nm.

E4. The composition of embodiment E2, wherein the pores have a size in a range from 100 to 150 angstroms or from 1 to 200 nm.

E5. The composition of embodiment E2, wherein the plurality of pores have a volume greater than 0.5 mL/g.

E6. The composition of embodiment E1, wherein the alkoxysilane moiety is selected from a group comprising methoxysilane, silanetriol, or ethoxysilane; or wherein the alkoxysilane moiety comprises a dialkoxysilanol moiety, a monoalkoxysilanol moiety, or an aminosilane oligomer

E7. The composition of embodiment E1, wherein the first compound is selected from a group comprising (3-aminopropyl)trimethoxysilane, (3-aminopropyl) triethoxysilane, [3-(2-aminoethylamino)propyl]trimethoxysilane, N1-(3-trimethoxysilylpropyl)diethylenetriamine, 3-aminopropylsilanetriol, N-(2-aminoethyl)-3-aminopropylsilanetriol, tris(ethylmethylamino)chlorosilane, tris(dimethylamino) chlorosilane, or an amino silane oligomer (e.g., such as VPS SIVO 280 from Evonik).

E8. The composition of embodiment E1, wherein the second compound is a polymeric amine.

E9. The composition of embodiment E8, wherein the second compound is a linear or a branched polymeric amine.

E10. The composition of embodiment E9, wherein the second compound is selected from a group comprising polyethylenimine (PEI), polypropylenimine, tetraethylenepentamine (TEPA), triethylenetetramine (TETA), diethanolamine, or a large molecule weight amine mixture (e.g., BASF Amix 1000).

E11. The composition of embodiment E1, the porous silica oxide particles having an average diameter in a range from 25 μm to 1 mm or from 25 μm to 4 mm.

E12. The composition of embodiment E1, wherein the second amine moiety is reactive to carbon dioxide.

E13. The composition of embodiment E1, wherein the composition adsorbs between about 0.5 mol to 2 mol of CO₂ per dry kilogram.

E14. The composition of embodiment E1, wherein the composition desorbs between about 65° C. to 90° C.

E15. The composition of embodiment E1, wherein the composition adsorbs CO₂ at a relative humidity in a range from 5% to 95% relative humidity.

E16. A method, comprising:
introducing a first reagent comprising a first compound comprising an alkoxysilane moiety and an amine moiety into a first liquid mixture comprising a liquid and porous silica particles under conditions sufficient to cause the alkoxysilane moiety of the first compound to chemically bond to a surface of the porous silica particles to form modified silica particles;
removing the modified silica particles from the liquid;
drying the modified silica particles in a vacuum oven until a hydration threshold is reached;
introducing a second reagent comprising a second compound comprising a polymeric amine into a second liquid mixture comprising a second liquid and the modified silica particles under conditions sufficient to cause an amine moiety of the second compound to chemically bond to the amine moiety of the first compound to form functionalized silica oxide particles; and
removing the functionalized silica oxide particles from the second liquid.

E17. The method of embodiment E16, wherein the functionalized silica oxide particles are for use in the removal of carbon dioxide from a fluid.

E18. The method of embodiment E16, wherein the liquid comprises methanol, cyclohexane, or ethanol or water.

E19. The method of embodiment E18, wherein the liquid comprises cyclohexane and ethanol at a mixture ratio in a range from 1:1 to 5:1 by volume.

E20. The method of embodiment E16, wherein the functionalized silica oxide particles comprises (3-aminopropyl)trimethoxysilane, (3-aminopropyl)triethoxysilane, [3-(2-aminoethylamino)propyl]trimethoxysilane, N1-(3-trimethoxysilylpropyl) diethylenetriamine, 3-aminopropylsilanetriol, N-(2-aminoethyl)-3-aminopropyl silanetriol, tris(ethylmethylamino)chlorosilane, tris(dimethylamino)chlorosilane, or an amino silane oligomer (e.g., such as VPS SIVO 280 from Evonik).

E21. The method of embodiment E16, further comprising: drying the functionalized silica oxide particles in a vacuum oven at 50° C. until a hydration threshold is reached.

E22. The method of embodiment E16, wherein the removing the functionalized silica oxide particles from the second liquid comprises evaporating the second liquid from the functionalized silica oxide particles.

E23. The method of embodiment E16, wherein the second compound is included in the aqueous mixture at a range from 10% to 50% (wt/wt) second compound to silica oxide material.

E24. The method of embodiment E16, wherein the second compound is included in the liquid mixture at about 30% (wt/wt) second compound to silica oxide material.

E25. A composition comprising porous silica particles modified according to the method of embodiment E16.

E26. A method, comprising using the composition of embodiment E1 to remove atmospheric CO₂ from air by direct air capture.

E27. The composition of embodiment E1, further comprising an antioxidant moiety at a weight ratio of 5% to porous silica particles.

E28. The composition of embodiment E27, wherein the antioxidant moiety is organic sulfur-containing compound selected from a list comprising 2,2-thiodiethanol, 2-hydroxyethyl disulfide, and 3,3′-dithiodipropionic acid.

E29. The composition of embodiment E1, wherein the compound further comprises a hydrophobic compound.

E30. The composition of embodiment E29, wherein the hydrophobic compound is a hydrophobic silane compound or a hydrophobic polymer.

E31. The composition of embodiment E30, wherein the hydrophobic silane compound comprises a silane molecule and one, two, or three alkyl chains.

E32. The composition of embodiment E31, wherein the hydrophobic polymer comprises polydimethylsiloxane (PDMS), silicone oil, polyethylene, polytetrafluorethylene, or polyurethanes.

E33. The composition of embodiment E1, further comprising BTMSPA.

### Non-Limiting Embodiment F

F1. A method, comprising:
introducing a first reagent comprising a polymeric amine, a second reagent comprising a silane moiety and an amine moiety, and porous silica particles into a volume of water under conditions sufficient to cause:
   an amine moiety of the polymeric amine to chemically bond to a surface of the porous silica particles to form modified silica particles;
   the silane moiety of the second reagent to chemically bond to the surface of the porous silica particles to form functionalized silica particles; and removing the functionalized silica particles from the water.

F2. The method of embodiment F1, wherein the porous silica particles are added into the volume of water at a ratio of 4:1 (wt/wt) of water to the porous silica particles.

F3. The method of embodiment F1, wherein the first reagent is added to the water at a ratio of 20% (wt/wt) of the first reagent to the porous silica particles.

F4. The method of embodiment F1, wherein the second reagent is added to the water at a ratio of between 40% and 80% (wt/wt) of the second reagent to the porous silica particles.

F5. The method of embodiment F1, wherein the second reagent comprises an alkoxysilane, a methoxysilane, a silanetriol, an alkoxysilanol, a chlorosilane, a hydrosilane, or an ethoxysilane.

F6. The method of embodiment F5, wherein the second reagent comprises (3-aminopropyl)trimethoxysilane, (3-aminopropyl)triethoxysilane, [3-(2-aminoethylamino)propyl]trimethoxysilane, N1-(3-trimethoxysilylpropyl) diethylenetriamine 3-aminopropylsilanetriol, N-(2-aminoethyl)-3-aminopropyl silanetriol, tris(ethylmethylamino)chlorosilane, tris(dimethylamino)chlorosilane, or an amino silane oligomer (e.g., such as VPS SIVO 280 from Evonik).

F7. The method of embodiment F1, wherein the second reagent is a polymeric amine.

F8. The method of embodiment F7, wherein the second reagent is a linear or a branched polymeric amine.

F9. The method of embodiment F8, wherein the second reagent is selected from a group comprising polyethylenimine (PEI), polypropylenimine, tetraethylenepentamine (TEPA), triethylenetetramine (TETA), diethanolamine, or a large molecule weight amine mixture (e.g., BASF Amix 1000).

F10. The method of embodiment F1, further comprising:
drying the functionalized silica particles in a vacuum oven at 80° C. until a hydration threshold of less than 5% (wt/wt) of water to functionalized silica substrate is reached.

F11. A method, comprising:
introducing a first reagent comprising polyethylenimine and a second reagent comprising a silane moiety and an amine moiety into a volume of water to create a functionalization mixture;
agitating the functionalization mixture for a first duration in a range from 5 to 10 minutes;
introducing porous silica particles into the functionalization mixture to create a functionalization suspension;
agitating the functionalization suspension for a second duration in a range from 5 to 20 minutes to create functionalized silica particles;
recovering the functionalized silica particles by filtration or evaporation; and
drying the functionalized silica particles at 120° C. for 20 minutes.

F12. A composition comprising porous silica particles modified according to the method of embodiment F1.

F13. The composition of embodiment F12, wherein the second reagent is reactive to carbon dioxide.

F14. The composition of embodiment F12, wherein the composition adsorbs between about 0.5 mol to 2.5 mol of CO₂ per dry kilogram.

F15. The composition of embodiment F12, wherein the composition desorbs between about 65° C. to 90° C.

F16. The composition of embodiment F12, wherein the composition adsorbs CO₂ at a relative humidity in a range from 5% to 95% relative humidity.

F17. A method, comprising: using the functionalized silica particles of embodiment F1 to remove atmospheric CO₂ from air by direct air capture.

F18. The method of embodiment F1, further comprising: introducing a third reagent comprising an antioxidant at a weight ratio of 5% to porous silica particles.

F19. The method of embodiment F18, wherein the antioxidant moiety is organic sulfur-containing compound selected from a list comprising 2,2-thiodiethanol, 2-hydroxyethyl disulfide, and 3,3′-dithiodipropionic acid.

F20. The composition of embodiment F1, wherein the compound further comprises a hydrophobic compound.

F21. The composition of embodiment F20, wherein the hydrophobic compound is a hydrophobic silane compound or a hydrophobic polymer.

F22. The composition of embodiment F21, wherein the hydrophobic silane compound comprises a silane molecule and one, two, or three alkyl chains.

F23. The composition of embodiment F22, wherein the hydrophobic polymer comprises polydimethylsiloxane (PDMS), silicone oil, polyethylene, polytetrafluorethylene, or polyurethanes.

F124. The composition of embodiment F1, further comprising BTMSPA.

### Non-Limiting Embodiment G

G1. A composition, comprising:
porous silica particles; and
a first compound comprising a plurality of amine moieties, wherein the first compound is bonded to a surface of the porous silica particles and forms a surface modification layer on the surface of the porous silica particles.

G2. The composition of embodiment G1, wherein the porous silica particles comprise a plurality of pores.

G3. The composition of embodiment G2, wherein the pores have a size in a range from 60 to 400 angstroms.

G4. The composition of embodiment G2, wherein the pores have a size in a range from 100 to 150 angstroms.

G5. The composition of embodiment G2, wherein the plurality of pores have a volume greater than 0.5 mL/g.

G6. The composition of embodiment G1, wherein the first compound is a polymeric amine.

G7. The composition of embodiment G6, wherein the first compound is a linear or a branched polymeric amine.

G8. The composition of embodiment G7, wherein the first compound is selected from comprising polyethylenimine (PEI) or polypropylenimine.

G9. The composition of embodiment G1, the porous silica particles having an average diameter within a range from 25 μm to 3 mm or 25 μm to 4 mm.

G10. The composition of embodiment G1, wherein the plurality of amine moieties are reactive to carbon dioxide.

G11. The composition of embodiment G1, wherein the composition adsorbs between about 0.5 mol to 2.2 mol of CO₂ per dry kilogram.

G12. The composition of embodiment G1, wherein the composition desorbs between about 65° to 90° C.

G13. The composition of embodiment G1, wherein the composition adsorbs CO₂ at a relative humidity in a range from 5% to 95% relative humidity.

G14. The composition of embodiment G1, wherein the composition comprises a second compound, and wherein the second compound is an organic sulfur-containing compound.

G15. The composition of embodiment G14, wherein the second compound is 2,2-thiodiethanol, 2-hydroxyethyl disulfide, or 3,3′-dithiodipropionic acid.

G16. The composition of embodiment G14, wherein the second compound comprises 5% (wt/wt) of the composition.

G17. A composition, comprising:
porous silica particles having a greatest dimension of at least 70 microns, the porous silica particles comprising a plurality of pores, the plurality of pores having a volume greater than 0.8 mL/g and a size of at least 90 angstroms; and
a first polymeric amine compound comprising a plurality of amine moieties, wherein the first compound is bonded to a surface of the porous silica particles and forms a surface modification layer on the surface of the porous silica particles through van der Waals interactions.

G18. A method, comprising:
introducing a first reagent comprising a first compound comprising a plurality of amine moieties into a liquid mixture comprising a liquid and porous silica particles under conditions sufficient to cause the pluralities of amine moieties to chemically bond to a surface of the porous silica particles to form modified silica particles;
removing the modified silica particles from the liquid; and
drying the modified silica particles in a vacuum oven until a hydration threshold is reached.

G19. The method of embodiment G18, wherein the functionalized silica particles are for use in removal of carbon dioxide from a fluid.

G20. The method of embodiment G18, wherein the liquid comprises methanol, cyclohexane, ethanol, or water.

G21. The method of embodiment G20, wherein the liquid comprises cyclohexane and ethanol at a mixture ratio in a range from 1:1 to 5:1 by volume.

G22. The method of embodiment G18, wherein the removing the functionalized porous silica particles from the liquid comprises evaporating the liquid from the functionalized porous silica particles.

G23. The method of embodiment G18, further comprising:
introducing a second reagent comprising a second compound comprising a sulfur-containing compound into a second liquid mixture comprising a second liquid and the modified silica particles under conditions sufficient to cause an amine moiety of the second compound to chemically bond to the amine moiety of the first compound to form functionalized silica oxide particles;
removing the functionalized silica oxide particles from the second liquid; and
drying the modified silica particles in a vacuum oven until a hydration threshold is reached.

G24. The method of embodiment G23, wherein the second compound is included in the second liquid mixture within a range from 10% to 50% (wt/wt) of the second compound to silica oxide material.

G25. The method of embodiment G23, wherein the second compound is included in the liquid mixture at about 30% (wt/wt) of the second compound to silica oxide material.

G26. A composition comprising porous silica particles modified according to the method of embodiment G18.

G27. A method, comprising:
introducing a first reagent comprising a polyethylenimine compound comprising a plurality of amine moieties into a liquid mixture comprising a methanol or ethanol and porous silica particles under conditions sufficient to cause the plurality of amine moieties of the polyethylenimine compound to chemically bond to a surface of the porous silica particles to form modified silica particles;
removing the modified silica particles from the liquid by evaporating the liquid from the modified silica particles; and
drying the modified silica particles in a vacuum oven until a hydration threshold of 5% wt/wt first liquid to modified silica particles is reached.

G28. A method, comprising using the composition of embodiment G1 to remove atmospheric CO₂ from air by direct air capture.

G29. The composition of embodiment G1, wherein the compound further comprises a hydrophobic compound.

G30. The composition of embodiment G29, wherein the hydrophobic compound is a hydrophobic silane compound or a hydrophobic polymer.

G31. The composition of embodiment G30, wherein the hydrophobic silane compound comprises a silane molecule and one, two, or three alkyl chains.

G32. The composition of embodiment G31, wherein the hydrophobic polymer comprises polydimethylsiloxane (PDMS), silicone oil, polyethylene, polytetrafluorethylene, or polyurethanes.

### Non-Limiting Embodiment H

H1. A composition, comprising:
porous silica particles, and
a first compound comprising a plurality of amine moieties, wherein the first compound is bonded to a surface of the porous silica particles and forms a surface modification layer on the surface of the porous silica particles.

H2. The composition of embodiment H1, wherein the porous silica particles comprise a plurality of pores.

H3. The composition of embodiment H2, wherein the pores have a size in a range from 60 to 400 angstroms.

H4. The composition of embodiment H2, wherein the pores have a size in a range from 100 to 150 angstroms.

H5. The composition of embodiment H2, wherein the plurality of pores have a volume greater than 0.5 mL/g.

H6. The composition of embodiment H1, wherein the first compound is an ethylene amine/oligomer mixture, small molecule mixture, or a combination of both.

H7. The composition of embodiment H6, wherein the first compound is a linear or a branched ethylene amine/oligomer mixture, small molecule mixture, or a combination of both.

H8. The composition of embodiment H7, wherein the first compound is selected from a group comprising Amix 1000, tetraethylenepentamine (TEPA), or triethylenetetramine (TETA).

H9. The composition of embodiment H1, the porous silica particles having an average diameter within a range from 25 μm to 3 mm or 25 μm or 4 mm.

H10. The composition of embodiment H1, wherein the plurality of amine moieties are reactive to carbon dioxide.

H11. The composition of embodiment H1, wherein the composition adsorbs between about 0.5 mol to 1.8 mol of CO₂ per dry kilogram.

H12. The composition of embodiment H1, wherein the composition desorbs between about 65° to 90° C.

H13. The composition of embodiment H1, wherein the composition adsorbs CO₂ at a relative humidity in a range from 5% to 95% relative humidity.

H14. The composition of embodiment H1, further comprising a second compound wherein the second compound is an organic sulfur-containing compound.

H15. The composition of embodiment H14, wherein the second compound is 2,2-thiodiethanol, 2-hydroxyethyl disulfide, or 3,3′-dithiodipropionic acid.

H16. The composition of embodiment H14, wherein the second compound comprises 5% (wt/wt) of the composition.

H17. A composition, comprising:
porous silica particles having a greatest dimension of at least 70 microns, the porous silica particles comprising a plurality of pores, the plurality of pores having a volume greater than 0.8 mL/g and a size of at least 90 angstroms; and
a first ethylene amine/oligomer compound comprising a plurality of amine moieties, wherein the first compound is bonded to a surface of the porous silica particles and forms a surface modification layer on the surface of the porous silica particles through van der Waals interactions.

H18. A method, comprising:
introducing a first reagent comprising a first compound comprising a plurality of amine moieties into a liquid mixture comprising a liquid and porous silica particles under conditions sufficient to cause the pluralities of amine moieties to chemically bond to a surface of the porous silica particles to form modified silica particles;
removing the modified silica particles from the liquid; and
drying the modified silica particles in a vacuum oven until a hydration threshold is reached.

H19. The method of embodiment H18, wherein the functionalized silica particles are for use in the removal of carbon dioxide from a fluid.

H20. The method of embodiment H18, wherein the liquid comprises methanol, cyclohexane, ethanol, or water.

H21. The method of embodiment H20, wherein the liquid comprises cyclohexane and ethanol at a mixture ratio in a range from 1:1 to 5:1 by volume.

H22. The method of embodiment H18, wherein the removing the functionalized porous silica particles from the liquid comprises evaporating the liquid from the functionalized porous silica particles.

H23. The method of embodiment H18, further comprising:
introducing a second reagent comprising a second compound comprising a sulfur-containing compound into a second liquid mixture comprising a second liquid and the modified silica particles under conditions sufficient to cause an amine moiety of the second compound to chemically bond to the amine moiety of the first compound to form functionalized silica oxide particles;
removing the functionalized silica oxide particles from the second liquid; and
drying the modified silica particles in a vacuum oven until a hydration threshold is reached.

H24. The method of embodiment H23, wherein the second compound is included in the second liquid mixture at a range from 10% to 50% (wt/wt) of the second compound to silica oxide material.

H25. The method of embodiment H23, wherein the second compound is included in the liquid mixture at about 30% (wt/wt) of the second compound to silica oxide material.

H26. A composition comprising porous silica particles modified according to the method of embodiment H18.

H27. A method comprising:
introducing a first reagent comprising an ethylene amine mixture compound comprising a plurality of amine moieties into a liquid mixture comprising a methanol or ethanol and porous silica particles under conditions sufficient to cause the plurality of amine moieties of the ethylene amine mixture compound to chemically bond to a surface of the porous silica particles to form modified silica particles;
removing the modified silica particles from the liquid by evaporating the liquid from the modified silica particles; and
drying the modified silica particles in a vacuum oven until a hydration threshold of 5% wt/wt first liquid to modified silica particles is reached.

H28. A method comprising using the composition of embodiment H1 to remove atmospheric CO₂ from air by direct air capture.

H29. The composition of embodiment H1, wherein the compound further comprises a hydrophobic compound.

H30. The composition of embodiment H29, wherein the hydrophobic compound is a hydrophobic silane compound or a hydrophobic polymer.

H31. The composition of embodiment H30, wherein the hydrophobic silane compound comprises a silane molecule and one, two, or three alkyl chains.

H32. The composition of embodiment H31, wherein the hydrophobic polymer comprises polydimethylsiloxane (PDMS), silicone oil, polyethylene, polytetrafluorethylene, or polyurethane.

### Non-Limiting Embodiment I

I1. A method, comprising:
introducing a first reagent comprising a polymeric amine and a second reagent comprising a silane moiety and an amine functional group into a volume of water to form a functionalization mixture;
introducing porous silica particles into the functionalization mixture;
resting the porous silica particles in the functionalization mixture for a time period and under conditions sufficient to interact the first reagent and the second reagent with a surface of the porous silica particles to form functionalized silica particles; and
removing the functionalized silica particles from the volume of water.

I2. The method of embodiment I1, wherein the conditions to form functionalized silica particles comprise ambient pressure and a temperature in a range from 20° to 70° C.

I3. The method of embodiment I1, wherein the second reagent comprises (3-aminopropyl)trimethoxysilane, (3-aminopropyl)triethoxysilane, [3-(2-aminoethylamino)propyl]trimethoxysilane, N-(2-aminoethyl)-3-aminopropyl silanetriol, N1-(3-trimethoxysilylpropyl)diethylenetriamine, 3-aminopropylsilanetriol, N-(2-aminoethyl)-3-aminopropylsilanetriol, tris(ethylmethylamino)chlorosilane, or tris(dimethylamino)chlorosilane.

I4. The method of embodiment I1, further comprising: drying the functionalized silica particles at 50° C. or more until a hydration threshold is reached, or under a flow of nitrogen in an oven at 50° C. or more.

I5. The method of embodiment I4, wherein the drying is performed in a double cone vacuum dryer, a conveyor belt dryer, a Blet dryer, or a Nutsche filter dryer.

I6. The method of embodiment I1, wherein the porous silica particles comprises a quantity of porous silica particles of at least 25 kilograms.

I7. The method of embodiment I6, wherein the quantity is in a range from 100 kilograms to 10,000 kilograms.

I8. The method of embodiment I1, wherein the first reagent is included in the volume of water at a range from 5% to 20% (wt/wt) of the second reagent to silica oxide material.

I9. The method of embodiment I1, wherein the second reagent is included in the volume of water at a range from 20% to 70% (wt/wt) of the second reagent to silica oxide material.

I10. The method of embodiment I1, wherein introducing comprises consecutively introducing a plurality of quantities of porous silica particles into the functionalization mixture to form a plurality of quantities of functionalized silica particles, and removing comprises consecutively removing the plurality of quantities of functionalized silica particles.

I11. The method of embodiment I1, further comprising using the functionalized silica particles to remove carbon dioxide from a fluid.

I12. The method of embodiment I1, further comprising introducing a third reagent comprising an antioxidant compound to the volume of water.

I13. The method of embodiment I12, wherein the antioxidant compound is an organic sulfur-containing compound selected from a list comprising 2,2-thiodiethanol, 2-hydroxyethyl disulfide, and 3,3′-dithiodipropionic acid.

I14. The method of embodiment I1, wherein the porous silica particles are maintained in the functionalization mixture for 3 hours to 72 hours.

I15. A composition, comprising:
porous silica particles;
a first compound comprising at least two amine moieties, wherein an amine moiety of the first compound is bonded to a surface of the porous silica particles; and
a second compound comprising a silane moiety and at least one amine functional group where the second compound is chemically bonded to the surface of the porous silica particles and the amine moieties are chemically bonded to the silane moiety.

I16. The composition of embodiment I15, wherein the porous silica particles comprise a plurality of pores.

I17. The composition of embodiment I16, wherein the pores have a size in a range from 60 to 400 angstroms.

I18. The composition of embodiment I16, wherein the pores have a size in a range from 100 to 150 angstroms.

I19. The composition of embodiment I16, wherein the plurality of pores have a volume greater than 0.5 mL/g.

I20. The composition of embodiment I15, wherein the silane moiety is selected from a group comprising methoxysilane, silanetriol, or ethoxysilane.

I21. The composition of embodiment I15, wherein the second compound is selected from a group comprising (3-aminopropyl)trimethoxysilane, (3-aminopropyl)triethoxysilane, [3-(2-aminoethylamino)propyl]trimethoxysilane, N-(2-aminoethyl)-3-aminopropyl silanetriol, N1-(3-trimethoxysilylpropyl)diethylenetriamine, 3-aminopropylsilanetriol, N-(2-aminoethyl)-3-aminopropylsilanetriol, tris(ethylmethylamino)chlorosilane, or tris(dimethylamino)chlorosilane.

I22. The composition of embodiment I15, wherein the first compound is a polymeric amine.

I23. The composition of embodiment I22, wherein the first compound is a linear or a branched polymeric amine.

I24. The composition of embodiment I23, wherein the first compound is selected from a group comprising polyethylenimine (PEI), poly(propylenimine) (PPI), or other large molecule amine mixture, tetraethylenepentamine (TEPA), triethylenetetramine (TETA), ethanolamine, diethylenetriamine, piperazine, pentaethylenehexamine, or tetramethylethylenediamine.

I25. The composition of embodiment I15, the porous silica particles having an average radius of at least 0.5 millimeter.

I26. The composition of embodiment I15, wherein the amine moieties of the first compound and second compound are reactive with carbon dioxide.

I27. The composition of embodiment I15, wherein the composition adsorbs between 1 mol to 2 mol of CO₂ per dry kilogram.

I28. The composition of embodiment I15, wherein the composition desorbs CO₂ at a temperature between 65° C. to 90° C.

I29. The composition of embodiment I15, wherein the composition adsorbs CO₂ at a relative humidity in a range from 5% to 90% relative humidity.

I30. A composition comprising:
porous silica particles having a greatest dimension in a range from 0.5 mm to 2 mm, the porous silica particles comprising a plurality of pores, the plurality of pores having a volume greater than 0.5 mL/g and a size in a range from 60 to 400 angstroms;
a first compound comprising at least two amine moieties; and
a second compound comprising a silane moiety and at least one amine moiety, wherein the silane moiety is bonded to a surface of the porous silica particles, and the at least two amine moieties of the first compound are non-covalently bonded to the at least one amine moiety of the second compound.

I31. A composition comprising porous silica particles modified according to the method of embodiment I1.

I32. A method, comprising: using the composition of embodiment I15 to remove atmospheric CO₂ from air by direct air capture.

### NON-LIMITING EMBODIMENT J

J1. A reactor comprising:
a reaction chamber extending along a first direction from a first chamber wall to a second chamber wall opposite the first chamber wall, the reaction chamber comprising a hollow compartment extending from a base to a top wall in a second direction perpendicular to the first direction, the compartment having, in cross-section perpendicular to the first direction, a base portion proximal to the base and a top portion distal to the base, the base portion being narrower than the top portion;
an inlet into the reaction chamber at the first chamber wall, the inlet providing access for delivery of a powdered adsorbent material into the reaction chamber;
an outlet from the reaction chamber at the second chamber wall, the outlet providing an egress for removal of the powdered adsorbent material from the reaction chamber;
one or more air chambers each in fluid communication with the hollow compartment via a channel at the base of the hollow compartment;
one or more blowers each arranged to receive ambient air and blow air into a corresponding one of the air chambers during operation of the reactor; and
one or more exhaust ports, the exhaust ports being configured to remove air from the compartment of the reaction chamber during operation of the reactor.

J2. The reactor of embodiment J1, further comprising a distribution plate in fluid communication with the one or more air chambers and the hollow compartment.

J3. The reactor of embodiment J2, wherein the distribution plate is W-shaped.

J4. The reactor of embodiment J2, wherein the distribution plate is flat.

J5. The reactor of embodiment J2, wherein a first distribution plate is W-shaped and a second distribution plate is flat.

J6. The reactor of embodiment J1, wherein the one or more exhaust ports are arranged at the top wall of the reaction chamber.

J7. The reactor of embodiment J1, further comprising a feed arranged in fluid communication with the inlet, the feed being configured to deliver the powdered adsorbent material to the reaction chamber during operation of the reactor.

J8. The reactor of embodiment J7, wherein the inlet is located proximate to the base.

J9. The reactor of embodiment J1, wherein the reactor is configured so that, during operation, a pressure drop from the reaction chamber to the air chamber is 9.0 psi, 0.1 psi, or less.

J10. The reactor of embodiment J1, wherein the reactor is configured so that, during operation, the adsorbent chamber contains about ten liters or more of air per gram of adsorbent material.

J11. The reactor of embodiment J1, wherein the powdered adsorbent material comprises particles with a diameter of 50-1,700 μm or 50-3,000 μm or 25-4,000 μm.

J12. The reactor of embodiment J1, further comprising louvers arranged along the first direction and located on one or more walls of the reactor, wherein the louvers are configured to draw ambient air into the one or more air chambers.

J13. The reactor of embodiment J1, wherein the powdered adsorbent material is a CO₂ adsorbent.

J14. The reactor of embodiment J1, wherein the hollow compartment, in cross section, comprises a first tapered portion proximal to the base.

J15. The reactor of embodiment J14, wherein the hollow compartment further comprises, in cross section, a second tapered portion spaced apart from the first tapered portion.

J16. A method for removing CO₂ from the atmosphere, comprising:
providing ambient air comprising CO₂ to a reactor comprising one or more air chambers;
blowing the ambient air so that it travels from the one or more air chambers into a reaction chamber;
delivering a powdered adsorbent material to the reaction chamber through an inlet;
creating a fluidized bed of the powdered adsorbent material and the air under conditions in which the powdered adsorbent material adsorbs the CO₂ from the air to form CO₂-reduced air and used powdered adsorbent material;
continuously removing used powdered adsorbent material from the reaction chamber; and
continuously removing CO₂-reduced air from the reaction chamber through one or more exhaust ports.

J17. A direct air capture (DAC) system, comprising:
a fluidized bed adsorption reactor configured to adsorb CO₂ from ambient air using a powdered adsorbent material;
a desorption reactor configured to receive the powdered adsorbent material from the fluidized bed adsorption reactor and to desorb CO₂ from the powdered adsorbent material; and
an industrial process facility which produces waste heat that is provided to the desorption reactor to heat the powdered adsorbent material.

### Non-Limiting Embodiment K

K1. A structure comprising:
a chamber bordered by a plurality of panels, each panel being suspended between a pair of beams extending in a first direction from a base of the structure, a height of each panel extending in the first direction from a bottom of the panel to a top of the panel, each panel comprising:
a porous inner sheet;
a porous outer sheet; and
a cavity between the inner sheet and the outer sheet, the cavity extending from the top of the panel to the bottom of the panel;
an inlet providing access for delivery of an adsorbent material to the cavities at the tops of the plurality of panels;
an outlet providing an egress for removal of the adsorbent material from the bottom of the cavities of the plurality of panels; and
a blower arranged to direct a fluid into the chamber.

K2. The structure of embodiment K1, wherein the adsorbent material in the cavities of the panels forms a vertical falling moving bed absorber.

K3. The structure of any one of embodiments K1 or K2, wherein the cavity between the inner sheet and the outer sheet is divided into multiple channels separated by fabric ribs connecting the inner sheet and the outer sheet at intervals between side edges of the panel.

K4. The structure of embodiment K3, wherein each channel of the multiple channels has a substantially square cross section in a plane perpendicular to the first direction.

K5. The structure of any one of embodiments K1 to K4, wherein the cavity has a thickness between the inner sheet and the outer sheet, the thickness being twenty centimeters or less.

K6. The structure of any one of embodiments K1 to K5, wherein the chamber has a substantially cylindrical shape, with a cylindrical axis extending in the first direction.

K7. The structure of any one of embodiments K1 to K5, wherein the chamber has a substantially rectangular prismic shape having four walls.

K8. The structure of embodiment K7, wherein at least one wall of the four walls comprises a panel of the plurality of panels.

K9. The structure of any one of embodiments K1 to K8, comprising a metering device configured to control a flow of adsorbent material from the cavities to the outlet.

K10. The structure of any one of embodiments K1 to K9, wherein the inner sheet and the outer sheet comprise a fabric material.

K11. The structure of any one of embodiments K1 to K10, wherein the adsorbent material has a pelletized form.

K12. The structure of any one of embodiments K1 to K11, wherein the adsorbent material is configured to adsorb carbon dioxide from the fluid.

K13. The structure of any one of embodiments K1 to K12, wherein the blower is positioned in the chamber.

K14. The structure of any one of embodiments K1 to K13, wherein the blower is positioned in a lower third portion of the chamber in the first direction, the lower third portion being the portion that is nearest to the base of the structure.

K15. The structure of any one of embodiments K1 to K13, wherein the blower is positioned in a center third portion of the chamber in the first direction.

K16. The structure of any one of embodiments K1 to K15, wherein the blower is configured to direct the fluid in the first direction.

K17. The structure of any one of embodiments K1 to K16, wherein the fluid comprises a gas.

K18. The structure of any one of embodiments K1 to K17, wherein the fluid comprises air.

K19. A method comprising:
feeding adsorbent material at an inlet of a structure, the structure comprising a chamber bordered by a plurality of panels, each panel being suspended between a pair of beams each panel comprising:
a porous inner sheet;
a porous outer sheet; and
   a cavity between the inner sheet and the outer sheet, the cavity extending from a top of the panel to a bottom of the panel, wherein the inlet provides access for delivery of the adsorbent material to the cavities at the tops of the plurality of panels;
extracting adsorbent material from an outlet of the structure, wherein the outlet provides an egress for removal of the adsorbent material from the bottom of the cavities of the plurality of panels, wherein extracting adsorbent material from the outlet causes adsorbent material in the cavities to fall due to gravity; and
directing a fluid through the plurality of panels in a direction from the inner sheet towards the outer sheet.

K20. The method of embodiment K19, comprising controlling a rate of extracting the adsorbent material from the outlet to control a volumetric flow rate of the adsorbent material through the cavities due to gravity.

K21. The method of embodiment K20, comprising controlling a rate of feeding the adsorbent material at the inlet of the structure based on the rate of extracting the adsorbent material from the outlet.

K22. The method of any one of embodiments K20 or K21, comprising controlling the rate of extracting the adsorbent material from the outlet to control an exposure time of the adsorbent material to the fluid.

K23. The method of embodiment K22, comprising controlling the exposure time of the adsorbent material to the fluid to be thirty minutes or more.

K24. The method of any one of embodiments K22 or K23, comprising controlling the exposure time of the adsorbent material to the fluid to be ninety minutes or less.

K25. A structure comprising:
a first beam extending in a first direction from a base of the structure toward a top of the structure;
a second beam spaced apart from the first beam and extending parallel to the first beam;
a panel coupled at a first edge to the first beam and at a second edge to the second beam, a width of the panel extending from the first edge to the second edge in a direction orthogonal to the first direction; a height of the panel extending in the first direction from a bottom of the panel to a top of the panel, the panel comprising:
   a porous inner sheet;
   a porous outer sheet; and
   a cavity between the inner sheet and the outer sheet, the cavity extending from the top of the panel to the bottom of the panel;
an inlet providing access for delivery of an adsorbent material to the cavity at the top of the panel;
an outlet providing an egress for removal of the adsorbent material from the bottom of the cavity; and
a blower arranged to direct fluid through the panel in a direction from the inner sheet towards the outer sheet.

### Non-Limiting Embodiment L

L1. A system for removing carbon dioxide from a sorbent material comprising a bulk solid, the system comprising:
a first heat exchanger configured to evaporate water vapor from the sorbent material by transferring heat from a working fluid and from a heat source fluid to the sorbent material;
a condenser configured to condense the water vapor by transferring heat from the water vapor to the working fluid;
a second heat exchanger configured to desorb carbon dioxide from the sorbent material by transferring heat from the working fluid to the sorbent material;
a pump configured to remove the carbon dioxide from the second heat exchanger;
a closed loop flow path for circulating the working fluid between the first heat exchanger, the condenser, and the second heat exchanger;
an open loop flow path for providing the heat source fluid to the first heat exchanger; and
a channel for transporting the sorbent material from the first heat exchanger to the second heat exchanger.

L2. The system of embodiment L1, wherein the first heat exchanger comprises:
a first inlet providing access for delivery of the sorbent material to the first heat exchanger; and
a first outlet providing an egress for removal of the sorbent material from the first heat exchanger,
wherein, during operation, the first inlet has a higher elevation than the first outlet.

L3. The system of embodiment L2, wherein the second heat exchanger comprises:
a second inlet providing access for delivery of the sorbent material to the second heat exchanger; and
a second outlet providing an egress for removal of the sorbent material from the second heat exchanger,
wherein, during operation, the second inlet has a higher elevation than the second outlet.

L4. The system of embodiment L3, wherein, during operation, the second inlet of the second heat exchanger has a higher elevation than the first outlet of the first heat exchanger.

L5. The system of embodiment L3, wherein, during operation, the second inlet of the second heat exchanger has a lower elevation than the first outlet of the first heat exchanger.

L6. The system of any one of embodiments L1 to L5, wherein the closed loop flow path and the open loop flow path are fluidly isolated from each other.

L7. The system of any one of embodiments L1 to L6, comprising a metering device configured to control a flow of sorbent material into the first heat exchanger.

L8. The system of any one of embodiments L1 to L7, wherein the sorbent material has a pelletized form.

L9. The system of any one of embodiments L1 to L8, wherein the sorbent material is configured to adsorb carbon dioxide from fluid.

L10. The system of any one of embodiments L1 to L9, wherein the first heat exchanger and the second heat exchanger comprise plate heat exchangers.

L11. The system of any one of embodiments L1 to L9, wherein the first heat exchanger and the second heat exchanger comprise shell and tube heat exchangers.

L12. The system of any one of embodiments L1 to L9, wherein the first heat exchanger and the second heat exchanger comprise shell and plate heat exchangers.

L13. The system of any one of embodiments L1 to L12, wherein the first heat exchanger comprises an evaporator.

L14. The system of any one of embodiments L1 to L13, wherein the second heat exchanger comprises a desorber.

L15. A method for removing carbon dioxide from a sorbent material comprising a bulk solid, the method comprising:
circulating a working fluid in a closed loop between a first heat exchanger, a condenser, and a second heat exchanger;
providing a heat source fluid to the first heat exchanger;
evaporating water vapor from the sorbent material by transferring heat from the working fluid and from the heat source fluid to the sorbent material in the first heat exchanger;
condensing the water vapor by transferring heat from the water vapor to the working fluid in the condenser;
transporting the sorbent material from the first heat exchanger to the second heat exchanger through a channel;
desorbing carbon dioxide from the sorbent material by transferring heat from the working fluid to the sorbent material in the second heat exchanger; and
removing the carbon dioxide from the second heat exchanger by a pump.

L16. The method of embodiment L15, comprising:
feeding the sorbent material at an inlet of the first heat exchanger; and
extracting the sorbent material from an outlet of the first heat exchanger,
wherein the sorbent material moves from the inlet of the first heat exchanger to the outlet of the first heat exchanger due to gravity.

L17. The method of any one of embodiments L15 or L16, comprising:
feeding the sorbent material at an inlet of the second heat exchanger; and
extracting the sorbent material from an outlet of the second heat exchanger,
wherein the sorbent material moves from the inlet of the second heat exchanger to the outlet of the second heat exchanger due to gravity.

L18. The method of any one of embodiments L15 to L17, comprising:
transferring heat from the water vapor evaporated from the sorbent material in the first heat exchanger to the sorbent material in the second heat exchanger through the working fluid.

L19. The method of any one of embodiments L15 to L18, comprising:
cooling the sorbent material in the second heat exchanger using heat source fluid that was pre-cooled in the first heat exchanger.

L20. The method of any one of embodiments L15 to L19, comprising using a second pump to establish vacuum pressure in the first heat exchanger and to transport the water vapor from the first heat exchanger to the condenser.

L21. The method of any one of embodiments L15 to L20, comprising removing the condensed water vapor from the condenser through a water outlet.

L22. The method of any one of embodiments L15 to L21, comprising:
establishing vacuum pressure in the second heat exchanger using the pump.

L23. The method of any one of embodiments L15 to L22, comprising:
maintaining vacuum pressures in the first heat exchanger and in the second heat exchanger using airlocks.

L24. A system for removing carbon dioxide from a sorbent material comprising a bulk solid, the system comprising:
a first heat exchanger configured to evaporate water vapor from the sorbent material by transferring heat from a heat source fluid to the sorbent material;
a second heat exchanger configured to desorb carbon dioxide from the sorbent material by transferring heat from a working fluid to the sorbent material;
a pump configured to remove the carbon dioxide from the second heat exchanger;
a third heat exchanger configured to cool the sorbent material by transferring heat from the sorbent material to the cooling fluid;
a channel for transporting the sorbent material from the first heat exchanger to the second heat exchanger and to the third heat exchanger.

L25. The system of embodiment L24, wherein the system comprises:
an inlet providing access for delivery of the sorbent material to the first heat exchanger; and
an outlet providing an egress for removal of the sorbent material from the third heat exchanger,
wherein, during operation, the inlet has a higher elevation than the outlet.

L26. The system of embodiment L24, wherein:
the first heat exchanger comprises an evaporator;
the second heat exchanger comprises a desorber; and
the third heat exchanger comprises a cooler, wherein the sorbent material has a pelletized form and is configured to adsorb carbon dioxide from fluid.

L27. The system of embodiment L24, wherein the pump is configured to establish vacuum pressure in the first heat exchanger, the second heat exchanger, and the third heat exchanger.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described herein should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the invention. Accordingly, other implementations are within the scope of the following claims.

1. A functionalized material comprising:
a plurality of porous particles; and
a surface modification layer disposed on at least a portion of a surface of at least one of the plurality of porous particles, wherein the surface modification layer comprises an adsorbing moiety comprising one or more amine moieties,
wherein the material is configured to adsorb atmospheric CO₂ under a first condition and reversibly desorb adsorbed CO₂ under a second condition.

2. The material of claim 1, wherein the plurality of porous particles comprises a plurality of porous silica particles, a plurality of porous metal-organic framework (MOF) particles, or a plurality of ion-exchange resin particles.

3. The material of claim 1, wherein the plurality of porous particles comprises a porous silica or silicate, a porous ceramic, a porous metal-organic substrate, a porous polymeric substrate, a porous ceramic/metal oxide together with porous silica, a porous alumina, a metal-organic framework (MOF), or a resin.

4. The material of claim 3, wherein the plurality of porous particles comprises a substrate provided in a precipitated form, a sol-gel form, a fumed form, a calcined form, an agglomerated form, a granulated form, a powder, or a granule.

5. The material of claim 1, wherein the plurality of porous particles comprises an average dimension or a mean dimension (e.g., diameter) from about 25 μm to 4 mm.

6. The material of claim 1, wherein the plurality of porous particles comprises a plurality of pores.

7. The material of claim 6, wherein the plurality of pores comprises a dimension from about 1 to 200 nm, an average pore size from about 30 to 80 nm, and/or a volume greater than about 0.5 mL/g or from 0.1 to 5 mL/g.

8. The material of claim 1, wherein the plurality of porous particles comprises a greatest dimension of at least 25 μm, and wherein a plurality of pores of the plurality of porous particles comprise a dimension of at least about 1 nm and a volume greater than about 0.5 mL/g.

9. The material of claim 1, wherein the surface modification layer comprises 5% to 60% (wt/wt) of a polyamine to the plurality of porous particles lacking the surface modification layer; or wherein the surface modification layer comprises 5% to 80% (wt/wt) of an aminosilane to the plurality of porous particles lacking the surface modification layer.

10. The material of claim 1, wherein the plurality of porous particles comprise a total surface area greater than about 100 m² per dry gram.

11. The material of claim 1, wherein the material adsorbs greater than about 0.8 mol of CO₂ per dry kilogram or from about 0.8 to 2.5 mol of CO₂ per dry kilogram.

12. The material of claim 1, wherein the material adsorbs CO₂ at a relative humidity in a range from about 5% to 95%.

13. The material of any one of claims 1-12, wherein the surface modification layer comprises (i) an amine moiety and a silane moiety, (ii) a plurality of amine moieties, or (iii) both (i) and (ii).

14. The material of claim 13, wherein the surface modification layer is provided by interacting one or more compounds with at least a portion of the surface of at least one of the plurality of porous particles; and wherein the one or more compounds are selected from the group consisting of an aminosilane and/or a polyamine.

15. The material of claim 14, wherein the aminosilane comprises a structure having one of formulas (I), (Ia)-(If), (II), and (IIa)-(IId); and wherein the polyamine comprises a structure having one of formulas (IIIa)-(IIIi).

16. The material of claim 1, wherein the first condition comprises a first temperature range and the second condition comprises a second temperature range higher than the first temperature range; or wherein the first condition comprises a first gas pressure and the second condition comprises a second gas pressure lower than the first gas pressure; or wherein the first condition comprises a first CO₂ concentration and wherein the second condition comprises a second CO₂ concentration lower than the first CO₂ concentration.

17. The material of claim 1, further comprising an antioxidant moiety, an additive, a hydrophobic silane compound, and/or a hydrophobic polymer.

18. A method of forming a functionalized material, the method comprising:
introducing a first reagent to a plurality of porous particles and a solvent medium, thereby providing a functionalization mixture, wherein the first reagent comprises at least one adsorbing moiety comprising one or more amine moieties;
removing a functionalized material from the functionalization mixture, wherein the functionalized material comprises the plurality of porous particles and a surface modification layer disposed on at least a portion of a surface of at least one of the plurality of porous particles, and wherein the surface modification layer comprises the at least one adsorbing moiety; and
drying the functionalized material.

19. The method of claim 18, wherein the first reagent comprises an aminosilane, and wherein the aminosilane comprises at least one amino moiety and at least one silane moiety.

20. The method of claim 19, wherein the aminosilane comprises a structure having one of formulas (I), (Ia)-(If), (II), and (IIa)-(IId).

21. The method of claim 19, wherein the at least one silane moiety comprises an alkoxysilane moiety, a trihalosilane moiety, a dihalosilane moiety, a monohalosilane moiety, a silanetriol moiety, a dialkoxysilanol moiety, a monoalkoxysilanol moiety, or an aminosilane oligomer.

22. The method of claim 19, wherein the first reagent is provided in the presence of a second reagent, and wherein the second reagent comprises a polyamine.

23. The method of claim 19, wherein the first reagent is provided to the plurality of porous particles and then a second reagent comprising a polyamine is provided to the functionalization mixture.

24. The method of claim 19, wherein a second reagent comprising a polyamine is provided to the functionalization material after removing from the functionalization mixture.

25. The method of claim 18, wherein the first reagent comprises a polyamine.

26. The method of claim 25, wherein the polyamine comprises a structure having one of formulas (IIIa)-(IIIi).

27. The method of claim 25, wherein the first reagent is provided in the presence of a second reagent, and wherein the second reagent comprises an aminosilane.

28. The method of claim 25, wherein the first reagent is provided to the plurality of porous particles and then a second reagent comprising an aminosilane is provided to the functionalization mixture.

29. The method of claim 18, wherein the first reagent comprises a small molecule polyamine or a mixture comprising a plurality of small molecule polyamines.

30. The method of claim 18, wherein the functionalization mixture comprises 5% to 80% (wt/wt) of the first reagent to the plurality of porous particles.

31. The method of claim 30, wherein the first reagent comprises a polyamine, and wherein the functionalization mixture comprises 5% to 60% (wt/wt) of the polyamine to the plurality of porous particles.

32. The method of claim 30, wherein the first reagent comprises an aminosilane, and wherein the functionalization mixture comprises 5% to 80% (wt/wt) of the aminosilane to the plurality of porous particles.

33. The method of claim 18, wherein the solvent medium comprises water.

34. The method of claim 18, wherein the solvent medium comprises a polar aprotic solvent or a neutral aprotic solvent.

35. The method of claim 18, wherein the solvent medium comprises an organic solvent selected from the group consisting of toluene, hexane, cyclohexane, and tetrahydrofuran.

36. The method of claim 18, wherein the solvent medium comprises methanol, cyclohexane, hexane, ethanol, water, or a combination thereof.

37. The method of claim 18, wherein said drying comprises drying to a hydration threshold of about 5% (wt/wt) of the solvent medium to the functionalized material.

38. The method of any one of claims 18-37, wherein the sorbent material comprises the functionalized material of any one of claims 1-17.

39. A method of forming a functionalized material, the method comprising:
introducing a first reagent and a second reagent to water, thereby providing a functionalization mixture, wherein the first reagent comprises a polyamine and the second reagent comprises an aminosilane;
introducing a plurality of porous particles into the functionalization mixture for a time period, thereby forming a functionalized material, wherein the functionalized material comprises the plurality of porous particles and a surface modification layer disposed on at least a portion of a surface of at least one of the plurality of porous particles, and wherein the surface modification layer comprises at least one adsorbing moiety;
removing the functionalized material from the functionalization mixture; and
drying the functionalized material.

40. The method of claim 39, wherein the aminosilane comprises a structure having one of formulas (I), (Ia)-(If), (II), and (IIa)-(IId); and wherein the polyamine comprises a structure having one of formulas (IIIa)-(IIIi).

41. The method of claim 39, wherein the plurality of porous particles comprises a quantity of at least 25 kilograms.

42. The method of any one of claims 39-41, wherein said drying comprises drying to a hydration threshold of about 5% (wt/wt) of the solvent medium to the functionalized material.

43. The method of any one of claims 39-42, wherein said drying is performed in a double cone vacuum dryer, a conveyor belt dryer, or a Nutsche filter dryer.

44. The method of any one of claims 39-43, wherein the sorbent material comprises the functionalized material of any one of claims 1-17.

45. A method for removing CO₂ from air, the method comprising:
providing ambient air comprising CO₂ to a holder comprising a sorbent material, thereby providing a rich sorbent material; and
optionally desorbing CO₂ from the rich sorbent material, thereby providing a lean material,
wherein the sorbent material comprises the functionalized material of any one of claims 1-17.

46. A direct air capture (DAC) system comprising:
a first inlet configured to receive a sorbent material;
an adsorber system configured to adsorb CO₂ from ambient air using the sorbent material, thereby providing a rich sorbent material;
a desorber system configured to desorb CO₂ from the rich sorbent material, thereby providing a lean material, and to deliver the lean sorbent material to the adsorber system,
wherein the sorbent material comprises a plurality of porous particles; and a surface modification layer disposed on at least a portion of a surface of at least one of the plurality of porous particles, wherein the surface modification layer comprises an adsorbing moiety comprising one or more amine moieties, and
wherein the sorbent material is configured to adsorb atmospheric CO₂ under a first condition and reversibly desorb adsorbed CO₂ under a second condition.

47. The system of claim 46, wherein the sorbent material comprises the functionalized material of any one of claims 1-17.

48. A reactor comprising:
a reaction chamber extending along a first direction from a first chamber wall to a second chamber wall opposite the first chamber wall, the reaction chamber comprising a hollow compartment extending from a base to a top wall in a second direction perpendicular to the first direction, the compartment having, in cross-section perpendicular to the first direction, a base portion proximal to the base and a top portion distal to the base, the base portion being narrower than the top portion;
an inlet into the reaction chamber at the first chamber wall, the inlet providing access for delivery of a powdered sorbent material into the reaction chamber;
an outlet from the reaction chamber at the second chamber wall, the outlet providing an egress for removal of the powdered sorbent material from the reaction chamber;
one or more air chambers each in fluid communication with the hollow compartment via a channel at the base of the hollow compartment;
one or more blowers each arranged to receive ambient air and blow air into a corresponding one of the air chambers during operation of the reactor; and
one or more exhaust ports, the exhaust ports being configured to remove air from the compartment of the reaction chamber during operation of the reactor.

49. The reactor of claim 48, further comprising a distribution plate in fluid communication with the one or more air chambers and the hollow compartment.

50. The reactor of claim 49, wherein the distribution plate is W-shaped.

51. The reactor of claim 50, further comprising an additional distribution plate, wherein the additional distribution plate is flat.

52. The reactor of claim 49, wherein the distribution plate is flat.

53. The reactor of claim 48, wherein the one or more exhaust ports are arranged at the top wall of the reaction chamber.

54. The reactor of claim 48, further comprising a feed arranged in fluid communication with the inlet, the feed being configured to deliver the powdered sorbent material to the reaction chamber during operation of the reactor.

55. The reactor of claim 54, wherein the inlet is located proximate to the base.

56. The reactor of claim 48, wherein the reactor is configured so that, during operation, a pressure drop from the reaction chamber to the air chamber is 9.0 psi or less.

57. The reactor of claim 48, wherein the reactor is configured so that, during operation, a sorbent chamber contains about ten liters or more of air per gram of sorbent material.

58. The reactor of claim 48, wherein the powdered sorbent material comprises particles with a diameter of 25-4,000 μm.

59. The reactor of claim 48, further comprising louvers arranged along the first direction and located on one or more walls of the reactor, wherein the louvers are configured to draw ambient air into the one or more air chambers.

60. The reactor of claim 48, wherein the powdered sorbent material is a CO₂ sorbent.

61. The reactor of claim 48, wherein the powdered sorbent material comprises the functionalized material of any one of claims 1-17.

62. The reactor of claim 48, wherein the hollow compartment, in cross section, comprises a first tapered portion proximal to the base.

63. The reactor of claim 62, wherein the hollow compartment further comprises, in cross section, a second tapered portion spaced apart from the first tapered portion.

64. A method for removing CO₂ from the atmosphere, comprising:
providing ambient air comprising CO₂ to a reactor comprising one or more air chambers;
blowing the ambient air so that it travels from the one or more air chambers into a reaction chamber;
delivering a powdered sorbent material to the reaction chamber through an inlet;
creating a fluidized bed of the powdered sorbent material and the air under conditions in which the powdered sorbent material adsorbs the CO₂ from the air to form CO₂-reduced air and used powdered sorbent material;
continuously removing used powdered sorbent material from the reaction chamber; and
continuously removing CO₂-reduced air from the reaction chamber through one or more exhaust ports.

65. The method of claim 64, wherein the powdered sorbent material comprises the functionalized material of any one of claims 1-17.

66. A direct air capture (DAC) system, comprising:
a fluidized bed adsorption reactor configured to adsorb CO₂ from ambient air using a powdered sorbent material;
a desorption reactor configured to receive the powdered sorbent material from the fluidized bed adsorption reactor and to desorb CO₂ from the powdered sorbent material; and
an industrial process facility which produces waste heat that is provided to the desorption reactor to heat the powdered sorbent material.

67. The system of claim 66, wherein the powdered sorbent material comprises the functionalized material of any one of claims 1-17.

68. A structure comprising:
a chamber bordered by a plurality of panels, each panel being suspended between a pair of beams extending in a first direction from a base of the structure, a height of each panel extending in the first direction from a bottom of the panel to a top of the panel, each panel comprising:
a porous inner sheet;
a porous outer sheet; and
a cavity between the inner sheet and the outer sheet, the cavity extending from the top of the panel to the bottom of the panel;
an inlet providing access for delivery of a sorbent material to the cavities at the tops of the plurality of panels;
an outlet providing an egress for removal of the sorbent material from the bottom of the cavities of the plurality of panels; and
a blower arranged to direct a fluid into the chamber.

69. The structure of claim 68, wherein the sorbent material in the cavities of the panels forms a vertical falling moving bed absorber.

70. The structure of claim 68, wherein the cavity between the inner sheet and the outer sheet is divided into multiple channels separated by fabric ribs connecting the inner sheet and the outer sheet at intervals between side edges of the panel.

71. The structure of claim 70, wherein each channel of the multiple channels has a substantially square cross section in a plane perpendicular to the first direction.

72. The structure of claim 68, wherein the cavity has a thickness between the inner sheet and the outer sheet, the thickness being twenty centimeters or less.

73. The structure of claim 68, wherein the chamber has a substantially cylindrical shape, with a cylindrical axis extending in the first direction.

74. The structure of claim 68, wherein the chamber has a substantially rectangular prismic shape having four walls.

75. The structure of claim 74, wherein at least one wall of the four walls comprises a panel of the plurality of panels.

76. The structure of claim 68, comprising a metering device configured to control a flow of sorbent material from the cavities to the outlet.

77. The structure of claim 68, wherein the inner sheet and the outer sheet comprise a fabric material.

78. The structure of claim 68, wherein the sorbent material has a pelletized form and is configured to adsorb carbon dioxide from the fluid.

79. The structure of claim 68, wherein the sorbent material comprises the functionalized material of any one of claims 1-17.

80. The structure of claim 68, wherein the blower is positioned in a lower third portion of the chamber in the first direction, the lower third portion being the portion that is nearest to the base of the structure, or in a center third portion of the chamber in the first direction.

81. The structure of claim 68, wherein the blower is configured to direct the fluid in the first direction.

82. The structure of claim 68, wherein the fluid comprises a gas or air.

83. A method comprising:
feeding a sorbent material at an inlet of a structure, the structure comprising a chamber bordered by a plurality of panels, each panel being suspended between a pair of beams each panel comprising:
a porous inner sheet;
a porous outer sheet; and
a cavity between the inner sheet and the outer sheet, the cavity extending from a top of the panel to a bottom of the panel, wherein the inlet provides access for delivery of the sorbent material to the cavities at the tops of the plurality of panels;
extracting sorbent material from an outlet of the structure, wherein the outlet provides an egress for removal of the sorbent material from the bottom of the cavities of the plurality of panels, wherein extracting sorbent material from the outlet causes sorbent material in the cavities to fall due to gravity; and
directing a fluid through the plurality of panels in a direction from the inner sheet towards the outer sheet.

84. The method of claim 83, comprising controlling a rate of extracting the sorbent material from the outlet to control a volumetric flow rate of the sorbent material through the cavities due to gravity.

85. The method of claim 84, comprising controlling a rate of feeding the sorbent material at the inlet of the structure based on the rate of extracting the sorbent material from the outlet.

86. The method of claim 83, comprising controlling the rate of extracting the sorbent material from the outlet to control an exposure time of the sorbent material to the fluid.

87. The method of claim 86, comprising controlling the exposure time of the sorbent material to the fluid to be thirty minutes or more and ninety minutes or less.

88. A structure comprising:
a first beam extending in a first direction from a base of the structure toward a top of the structure;
a second beam spaced apart from the first beam and extending parallel to the first beam;
a panel coupled at a first edge to the first beam and at a second edge to the second beam, a width of the panel extending from the first edge to the second edge in a direction orthogonal to the first direction; a height of the panel extending in the first direction from a bottom of the panel to a top of the panel, the panel comprising:
a porous inner sheet;
a porous outer sheet; and
a cavity between the inner sheet and the outer sheet, the cavity extending from the top of the panel to the bottom of the panel;
an inlet providing access for delivery of a sorbent material to the cavity at the top of the panel;
an outlet providing an egress for removal of the sorbent material from the bottom of the cavity; and
a blower arranged to direct fluid through the panel in a direction from the inner sheet towards the outer sheet.

89. A system for removing carbon dioxide from a sorbent material comprising a bulk solid, the system comprising:
a first heat exchanger configured to evaporate water vapor from the sorbent material by transferring heat from a working fluid and from a heat source fluid to the sorbent material;
a condenser configured to condense the water vapor by transferring heat from the water vapor to the working fluid;
a second heat exchanger configured to desorb carbon dioxide from the sorbent material by transferring heat from the working fluid to the sorbent material;
a pump configured to remove the carbon dioxide from the second heat exchanger;
a closed loop flow path for circulating the working fluid between the first heat exchanger, the condenser, and the second heat exchanger;
an open loop flow path for providing the heat source fluid to the first heat exchanger; and
a channel for transporting the sorbent material from the first heat exchanger to the second heat exchanger.

90. The system of claim 89, wherein the first heat exchanger comprises:
a first inlet providing access for delivery of the sorbent material to the first heat exchanger; and
a first outlet providing an egress for removal of the sorbent material from the first heat exchanger,
wherein, during operation, the first inlet has a higher elevation than the first outlet.

91. The system of claim 90, wherein the second heat exchanger comprises:
a second inlet providing access for delivery of the sorbent material to the second heat exchanger; and
a second outlet providing an egress for removal of the sorbent material from the second heat exchanger,
wherein, during operation, the second inlet has a higher elevation than the second outlet.

92. The system of claim 91, wherein, during operation, the second inlet of the second heat exchanger has a higher elevation than the first outlet of the first heat exchanger.

93. The system of claim 91, wherein, during operation, the second inlet of the second heat exchanger has a lower elevation than the first outlet of the first heat exchanger.

94. The system of claim 89, wherein the closed loop flow path and the open loop flow path are fluidly isolated from each other.

95. The system of claim 89, comprising a metering device configured to control a flow of sorbent material into the first heat exchanger.

96. The system of claim 89, wherein the sorbent material has a pelletized form and is configured to adsorb carbon dioxide from fluid.

97. The system of claim 89, wherein the sorbent material comprises the functionalized material of any one of claims 1-17.

98. The system of claim 89, wherein the first heat exchanger and the second heat exchanger comprise plate heat exchangers, shell and tube heat exchangers, or shell and plate heat exchangers.

99. The system of claim 89, wherein the first heat exchanger comprises an evaporator and the second heat exchanger comprises a desorber.

100. A method for removing carbon dioxide from a sorbent material comprising a bulk solid, the method comprising:
circulating a working fluid in a closed loop between a first heat exchanger, a condenser, and a second heat exchanger;
providing a heat source fluid to the first heat exchanger;
evaporating water vapor from the sorbent material by transferring heat from the working fluid and from the heat source fluid to the sorbent material in the first heat exchanger;
condensing the water vapor by transferring heat from the water vapor to the working fluid in the condenser;
transporting the sorbent material from the first heat exchanger to the second heat exchanger through a channel;
desorbing carbon dioxide from the sorbent material by transferring heat from the working fluid to the sorbent material in the second heat exchanger; and
removing the carbon dioxide from the second heat exchanger by a pump.

101. The method of claim 100, comprising:
feeding the sorbent material at an inlet of the first heat exchanger; and
extracting the sorbent material from an outlet of the first heat exchanger,
wherein the sorbent material moves from the inlet of the first heat exchanger to the outlet of the first heat exchanger due to gravity.

102. The method of claim 100, comprising:
feeding the sorbent material at an inlet of the second heat exchanger; and
extracting the sorbent material from an outlet of the second heat exchanger,
wherein the sorbent material moves from the inlet of the second heat exchanger to the outlet of the second heat exchanger due to gravity.

103. The method of claim 100, comprising:
transferring heat from the water vapor evaporated from the sorbent material in the first heat exchanger to the sorbent material in the second heat exchanger through the working fluid; and
cooling the sorbent material in the second heat exchanger using heat source fluid that was pre-cooled in the first heat exchanger.

104. The method of claim 100, comprising using a second pump to establish vacuum pressure in the first heat exchanger and to transport the water vapor from the first heat exchanger to the condenser.

105. The method of claim 100, comprising removing the condensed water vapor from the condenser through a water outlet.

106. The method of claim 100, comprising:
establishing vacuum pressure in the second heat exchanger using the pump; and
maintaining vacuum pressures in the first heat exchanger and in the second heat exchanger using airlocks.

107. The method of claim 100, wherein the sorbent material comprises the functionalized material of any one of claims 1-17.

108. A system for removing carbon dioxide from a sorbent material comprising a bulk solid, the system comprising:
a first heat exchanger configured to evaporate water vapor from the sorbent material by transferring heat from a heat source fluid to the sorbent material;
a second heat exchanger configured to desorb carbon dioxide from the sorbent material by transferring heat from a working fluid to the sorbent material;
a pump configured to remove the carbon dioxide from the second heat exchanger;
a third heat exchanger configured to cool the sorbent material by transferring heat from the sorbent material to the cooling fluid;
a channel for transporting the sorbent material from the first heat exchanger to the second heat exchanger and to the third heat exchanger.

109. The system of claim 108, wherein the system comprises:
an inlet providing access for delivery of the sorbent material to the first heat exchanger; and
an outlet providing an egress for removal of the sorbent material from the third heat exchanger,
wherein, during operation, the inlet has a higher elevation than the outlet.

110. The system of claim 108, wherein:
the first heat exchanger comprises an evaporator;
the second heat exchanger comprises a desorber; and
the third heat exchanger comprises a cooler, wherein the sorbent material has a pelletized form and is configured to adsorb carbon dioxide from fluid.

111. The system of claim 108, wherein the pump is configured to establish vacuum pressure in the first heat exchanger, the second heat exchanger, and the third heat exchanger.

112. The system of claim 108, wherein the sorbent material comprises the functionalized material of any one of claims 1-17.
